(19) United States
(12) Patent Application Publication
(10) Pub. No.: US 2020/0063721 A1
(43) Pub. Date: Feb. 27, 2020

(54) ELECTROMAGNETIC ENERGY MOMENTUM THRUSTER USING TAPERED CAVITY RESONATOR EVANESCENT MODES

(71) Applicant: Prime Lightworks Inc., Torrance, CA (US)

(72) Inventors: Kyle Bernard Flanagan, Hermosa Beach, CA (US); Peter Clinton Dohm, El Segundo, CA (US)

(21) Appl. No.: 16/271,275

(22) Filed: Feb. 8, 2019

Related U.S. Application Data
(60) Provisional application No. 62/629,106, filed on Feb. 11, 2018.

(51) Int. Cl. F03H 1/00; B64G 1/40; B64G 1/66

(52) U.S. Cl. CPC F03H 1/0081; B64G 1/66; B64G 1/409

(57) ABSTRACT

An electromagnetic energy momentum thruster has a cavity resonator and an electromagnetic radiation source for emitting an electromagnetic wave in evanescence into the cavity resonator. The electromagnetic wave produces a greater electromagnetic field amplitude and a greater electromagnetic radiation pressure on a primary interior surface area of the cavity resonator than on a secondary interior surface area of the cavity resonator. The difference between the electromagnetic field amplitude on the primary interior surface area and on the secondary interior surface area of the cavity resonator forms a highly directional electromagnetic energy momentum tensor and provides a highly directional general relativistic metric tensor. As a result, a force is produced on the cavity resonator in the form of a thrust or an acceleration that propels the device in a direction substantially perpendicular to the primary interior surface area.

### PRIORITY

This patent application claims priority from provisional U.S. patent application No. 62/629,106, filed Feb. 11, 2018, entitled, “ELECTROMAGNETIC ENERGY MOMENTUM THRUSTER USING TAPERED CAVITY RESONATOR EVANESCENT MODES,” and naming Kyle Bernard Flanagan and Peter Clinton Dohm as inventors, the disclosure of which is incorporated herein, in its entirety, by reference.

### BACKGROUND

An electromagnetic energy momentum thruster, also known as a radio frequency (RF) resonant cavity thruster or an EmDrive, is an electromagnetic thruster comprising a cavity resonator and an electromagnetic radiation source which produces a thrust from an electromagnetic field inside the cavity resonator. Such electromagnetic energy momentum thrusters provide direct conversion of electrical energy to thrust without the use of a propellant.

Eagleworks Laboratories at NASA's Johnson Space Center led by Dr. Harold “Sonny” White has successfully tested an electromagnetic energy momentum thruster in a vacuum. Thrust measurement test results of the EmDrive were presented at the 50^{th} AIAA/ASME/SAE/ASEE Joint Propulsion Conference in Cleveland, Ohio on Jul. 28-30, 2014, and were published in AIAA Journal of Propulsion and Power in July 2017 in an article entitled, “Measurement of Impulsive Thrust from a Closed Radio-Frequency Cavity in Vacuum”.

### SUMMARY

Although electromagnetic energy momentum thrusters have been developed, many such devices known the inventors exhibit suboptimal propulsion efficiencies and produce low thrust. The suboptimal propulsion efficiencies of previously available electromagnetic energy momentum thrusters may be attributed to the inclusion of extraneous elements within the cavity resonator, suboptimal geometric designs, and insufficient treatment of superconducting materials on the interior surface of the cavity resonator. These limitations of previously available electromagnetic energy momentum thrusters reduce the transmission of electromagnetic energy due to absorption losses, and exhibit lower electromagnetic energy densities, electromagnetic momentum asymmetries, quality factors, propulsion efficiencies, and thrust capabilities.

Provided herein are electromagnetic energy momentum thrusters which exhibit high propulsion efficiencies and are configured to produce high thrust. In some embodiments, the shape of the cavity resonators provided herein enable an optimized RF tuning quality factor, and form large electric and magnetic field asymmetries. In some embodiments, the cavity resonators are designed with specific equations and boundary conditions which enable more efficient propulsion.

In some embodiments, the electromagnetic energy momentum thrusters provided herein comprise a cavity resonator, which is configured for highly efficient conversion of electrical energy to thrust or momentum. In some embodiments, at least one of a lack of extraneous interior elements, the evacuation of the cavity resonator below a critical pressure threshold, the cooling of the cavity resonator below a critical temperature threshold, and a superconductive coating within the cavity resonator enables such highly efficient propulsion. In some embodiments, the superconductive material within the cavity resonator is optimized for high quality factor. In some embodiments, the highly directional electromagnetic energy momentum tensor provides a highly directional general relativistic metric tensor and a corresponding free fall acceleration which is an equal and opposite reaction to an action of thrust from the highly asymmetric electromagnetic radiation pressure.

Various embodiments include an electromagnetic energy momentum thruster comprising: a cavity resonator forming a cavity having a base interior surface and a tapered interior surface, the tapered interior surface converging to an apex point; and an electromagnetic radiation source in communication with the cavity resonator, the electromagnetic radiation source configured to emit an electromagnetic wave having a frequency between about 1.0 MHz to about 1000 THz into the cavity resonator.

In some embodiments, the electromagnetic radiation source is configured to emit an electromagnetic wave into the cavity resonator having a frequency between about 10\hat{ }0 MHz to about 10\hat{ }9 MHz. In some embodiments, the electromagnetic radiation source is configured to emit an electromagnetic wave into the cavity resonator having a frequency of at least about 10\hat{ }0 MHz. In some embodiments, the electromagnetic radiation source is configured to emit an electromagnetic wave into the cavity resonator having a frequency of at most about 10\hat{ }9 MHz. In some embodiments, the electromagnetic radiation source is configured to emit an electromagnetic wave into the cavity resonator having a frequency between about 10\hat{ }0 MHz to about 10\hat{ }1 MHz, between about 10\hat{ }0 MHz to about 10\hat{ }2 MHz, between about 10\hat{ }0 MHz to about 10\hat{ }3 MHz, between about 10\hat{ }0 MHz to about 10\hat{ }4 MHz, between about 10\hat{ }0 MHz to about 10\hat{ }5 MHz, between about 10\hat{ }0 MHz to about 10\hat{ }6 MHz, between about 10\hat{ }0 MHz to about 10\hat{ }7 MHz, between about 10\hat{ }0 MHz to about 10\hat{ }8 MHz, between about 10\hat{ }0 MHz to about 10\hat{ }9 MHz, between about 10\hat{ }1 MHz to about 10\hat{ }2 MHz, between about 10\hat{ }1 MHz to about 10\hat{ }3 MHz, between about 10\hat{ }1 MHz to about 10\hat{ }4 MHz, between about 10\hat{ }1 MHz to about 10\hat{ }5 MHz, between about 10\hat{ }1 MHz to about 10\hat{ }6 MHz, between about 10\hat{ }1 MHz to about 10\hat{ }7 MHz, between about 10\hat{ }1 MHz to about 10\hat{ }8 MHz, between about 10\hat{ }1 MHz to about 10\hat{ }9 MHz, between about 10\hat{ }2 MHz to about 10\hat{ }3 MHz, between about 10\hat{ }2 MHz to about 10\hat{ }4 MHz, between about 10\hat{ }2 MHz to about 10\hat{ }5 MHz, between about 10\hat{ }2 MHz to about 10\hat{ }6 MHz, between about 10\hat{ }2 MHz to about 10\hat{ }7 MHz, between about 10\hat{ }2 MHz to about 10\hat{ }8 MHz, between about 10\hat{ }2 MHz to about 10\hat{ }9 MHz, between about 10\hat{ }3 MHz to about 10\hat{ }4 MHz, between about 10\hat{ }3 MHz to about 10\hat{ }5 MHz, between about 10\hat{ }3 MHz to about 10\hat{ }6 MHz, between about 10\hat{ }3 MHz to about 10\hat{ }7 MHz, between about 10\hat{ }3 MHz to about 10\hat{ }8 MHz, between about 10\hat{ }3 MHz to about 10\hat{ }9 MHz, between about 10\hat{ }4 MHz to about 10\hat{ }5 MHz, between about 10\hat{ }4 MHz to about 10\hat{ }6 MHz, between about 10\hat{ }4 MHz to about 10\hat{ }7 MHz, between about 10\hat{ }4 MHz to about 10\hat{ }8 MHz, between about 10\hat{ }4 MHz to about 10\hat{ }9 MHz, between about 10\hat{ }5 MHz to about 10\hat{ }6 MHz, between about 10\hat{ }5 MHz to about 10\hat{ }7 MHz, between about 10\hat{ }5 MHz to about 10\hat{ }8 MHz, between about 10\hat{ }5 MHz to about 10\hat{ }9 MHz, between about 10\hat{ }6 MHz to about 10\hat{ }7 MHz, between about 10\hat{ }6 MHz to about 10\hat{ }8 MHz, between about 10\hat{ }6 MHz to about 10\hat{ }9 MHz, between about 10\hat{ }7 MHz to about 10\hat{ }8 MHz, between about 10\hat{ }7 MHz to about 10\hat{ }9 MHz, or between about 10\hat{ }8 MHz to about 10\hat{ }9 MHz. In some embodiments, the electromagnetic radiation source is configured to emit an electromagnetic wave into the cavity resonator having a frequency of about 10\hat{ }0 MHz, about 10\hat{ }1 MHz, about 10\hat{ }2 MHz, about 10\hat{ }3 MHz, about 10\hat{ }4 MHz, about 10\hat{ }5 MHz, about 10\hat{ }6 MHz, about 10\hat{ }7 MHz, about 10\hat{ }8 MHz, or about 10\hat{ }9 MHz, including increments therein.

In some embodiments, the electromagnetic radiation source is configured to produce the frequency of the electromagnetic wave in evanescence so that the electromagnetic wave has a maximum field amplitude and an asymptotic field amplitude, the maximum field amplitude being at, or adjacent to, the base interior surface, the asymptotic field amplitude being at, or adjacent to, one or both the tapered interior surface and the apex point. In some embodiments, the electromagnetic radiation source is configured to produce the frequency of the electromagnetic wave in evanescence so that the electromagnetic wave has a maximum field amplitude and an asymptotic field amplitude, the maximum field amplitude being at, or adjacent to, one or both the tapered interior surface and the apex point, and the asymptotic field amplitude being at, or adjacent to, the base interior surface.

In some embodiments, the cavity includes an overall interior surface that includes the base and tapered interior surfaces, substantially the entire overall interior surface being electrically conductive, wherein the cavity resonator has a quality factor between about 10\hat{ }3 to about 10\hat{ }9. In some embodiments, the cavity resonator has a quality factor of at least about 10\hat{ }3. In some embodiments, the cavity resonator has a quality factor of at most about 10\hat{ }9. In some embodiments, the cavity resonator has a quality factor between about 10\hat{ }3 to about 10\hat{ }4, between about 10\hat{ }3 to about 10\hat{ }5, between about 10\hat{ }3 to about 10\hat{ }6, between about 10\hat{ }3 to about 10\hat{ }7, between about 10\hat{ }3 to about 10\hat{ }8, between about 10\hat{ }3 to about 10\hat{ }9, between about 10\hat{ }4 to about 10\hat{ }5, between about 10\hat{ }4 to about 10\hat{ }6, between about 10\hat{ }4 to about 10\hat{ }7, between about 10\hat{ }4 to about 10\hat{ }8, between about 10\hat{ }4 to about 10\hat{ }9, between about 10\hat{ }5 to about 10\hat{ }6, between about 10\hat{ }5 to about 10\hat{ }7, between about 10\hat{ }5 to about 10\hat{ }8, between about 10\hat{ }5 to about 10\hat{ }9, between about 10\hat{ }6 to about 10\hat{ }7, between about 10\hat{ }6 to about 10\hat{ }8, between about 10\hat{ }6 to about 10\hat{ }9, between about 10\hat{ }7 to about 10\hat{ }8, between about 10\hat{ }7 to about 10\hat{ }9, or between about 10\hat{ }8 to about 10\hat{ }9. In some embodiments, the cavity resonator has a quality factor of about 10\hat{ }3, about 10\hat{ }4, about 10\hat{ }5, about 10\hat{ }6, about 10\hat{ }7, about 10\hat{ }8, or about 10\hat{ }9, including increments therein.

In some embodiments, the overall interior surface comprises aluminum, antimony, arsenic, barium, beryllium, bismuth, cadmium, calcium, carbon, chromium, cobalt, copper, gallium, gold, hydrogen, indium, iron, lanthanum, lead, lithium, magnesium, manganese, mercury, molybdenum, nickel, niobium, nitrogen, oxygen, palladium, phosphorus, platinum, scandium, silicon, silver, strontium, sulfur, tantalum, technetium, tin, titanium, tungsten, vanadium, yttrium, zinc, zirconium, or any combination thereof.

In some embodiments, the cavity includes an overall interior surface that includes the base and tapered interior surfaces, substantially the entire overall interior surface being superconductive, wherein the cavity resonator has a quality factor between about 10\hat{ }6 to about 10\hat{ }15. In some embodiments, the cavity resonator has a quality factor of at least about 10\hat{ }6. In some embodiments, the cavity resonator has a quality factor of at most about 10\hat{ }15. In some embodiments, the cavity resonator has a quality factor of between about 10\hat{ }6 to about 10\hat{ }7, between about 10\hat{ }6 to about 10\hat{ }8, between about 10\hat{ }6 to about 10\hat{ }9, between about 10\hat{ }6 to about 10\hat{ }10, between about 10\hat{ }6 to about 10\hat{ }11, between about 10\hat{ }6 to about 10\hat{ }12, between about 10\hat{ }6 to about 10\hat{ }13, between about 10\hat{ }6 to about 10\hat{ }14, between about 10\hat{ }6 to about 10\hat{ }15, between about 10\hat{ }7 to about 10\hat{ }8, between about 10\hat{ }7 to about 10\hat{ }9, between about 10\hat{ }7 to about 10\hat{ }10, between about 10\hat{ }7 to about 10\hat{ }11, between about 10\hat{ }7 to about 10\hat{ }12, between about 10\hat{ }7 to about 10\hat{ }13, between about 10\hat{ }7 to about 10\hat{ }14, between about 10\hat{ }7 to about 10\hat{ }15, between about 10\hat{ }8 to about 10\hat{ }9, between about 10\hat{ }8 to about 10\hat{ }10, between about 10\hat{ }8 to about 10\hat{ }11, between about 10\hat{ }8 to about 10\hat{ }12, between about 10\hat{ }8 to about 10\hat{ }13, between about 10\hat{ }8 to about 10\hat{ }14, between about 10\hat{ }8 to about 10\hat{ }15, between about 10\hat{ }9 to about 10\hat{ }10, between about 10\hat{ }9 to about 10\hat{ }11, between about 10\hat{ }9 to about 10\hat{ }12, between about 10\hat{ }9 to about 10\hat{ }13, between about 10\hat{ }9 to about 10\hat{ }14, between about 10\hat{ }9 to about 10\hat{ }15, between about 10\hat{ }10 to about 10\hat{ }11, between about 10\hat{ }10 to about 10\hat{ }12, between about 10\hat{ }10 to about 10\hat{ }13, between about 10\hat{ }10 to about 10\hat{ }14, between about 10\hat{ }10 to about 10\hat{ }15, between about 10\hat{ }11 to about 10\hat{ }12, between about 10\hat{ }11 to about 10\hat{ }13, between about 10\hat{ }11 to about 10\hat{ }14, between about 10\hat{ }11 to about 10\hat{ }15, between about 10\hat{ }12 to about 10\hat{ }13, between about 10\hat{ }12 to about 10\hat{ }14, between about 10\hat{ }12 to about 10\hat{ }15, between about 10\hat{ }13 to about 10\hat{ }14, between about 10\hat{ }13 to about 10\hat{ }15, or between about 10\hat{ }14 to about 10\hat{ }15. In some embodiments, the cavity resonator has a quality factor of about 10\hat{ }6, about 10\hat{ }7, about 10\hat{ }8, about 10\hat{ }9, about 10\hat{ }10, about 10\hat{ }11, about 10\hat{ }12, about 10\hat{ }13, about 10\hat{ }14, or about 10\hat{ }15, including increments therein.

In some embodiments, the overall interior surface comprises aluminum, barium, beryllium, bismuth, cadmium, calcium, copper, gallium, gadolinium, germanium, lanthanum, lead, lithium, indium, mercury, molybdenum, niobium, nitrogen, osmium, oxygen, protactinium, rhenium, ruthenium, silicon, strontium, sulfur, tantalum, technetium, thallium, thorium, titanium, tin, vanadium, yttrium, zinc, zirconium, NbTi, PbMoS, V₃Ga, NbN, V₃Si, Nb₃Sn, Nb₃Al, Nb₃(AlGe), Nb₃Ge, Bi₂Sr₂CuO₆, Bi₂Sr₂CaCu₂O₈, Bi₂Sr₂Ca₂Cu₃O₁₀, YBa₂Cu₃O₇, YBa₂Cu₄O₈, Y₂Ba₄Cu₇O₁₅, Y₃Ba₅Cu₈O₁₈, Tl₂Ba₂CuO₆, Tl₂Ba₂CaCu₂O₈, Tl₂Ba₂Ca₂Cu₃O₁₀, TlBa₂Ca₃Cu₄O₁₁, HgBa₂CuO₄, HgBa₂CaCu₂O₆, HgBa₂Ca₂Cu₃O₈, or any combination thereof.

In some embodiments, the cavity is empty. In some embodiments, the cavity comprises a vacuum with a pressure between about 10\hat{ }-24 Torr to about 10\hat{ }3 Torr. In some embodiments, the cavity comprises a vacuum with a pressure of at least about 10\hat{ }-24 Torr. In some embodiments, the cavity comprises a vacuum with a pressure of at most about 10\hat{ }3 Torr. In some embodiments, the cavity comprises a vacuum with a pressure between about 10\hat{ }-24 Torr to about 10\hat{ }-21 Torr, between about 10\hat{ }-24 Torr to about 10\hat{ }-18 Torr, between about 10\hat{ }-24 Torr to about 10\hat{ }-15 Torr, between about 10\hat{ }-24 Torr to about 10\hat{ }-12 Torr, between about 10\hat{ }-24 Torr to about 10\hat{ }-9 Torr, between about 10\hat{ }-24 Torr to about 10\hat{ }-6 Torr, between about 10\hat{ }-24 Torr to about 10\hat{ }-3 Torr, between about 10\hat{ }-24 Torr to about 1.0 Torr, between about 10\hat{ }-24 Torr to about 10\hat{ }3 Torr, between about 10\hat{ }-21 Torr to about 10\hat{ }-18 Torr, between about 10\hat{ }-21 Torr to about 10\hat{ }-15 Torr, between about 10\hat{ }-21 Torr to about 10\hat{ }-12 Torr, between about 10\hat{ }-21 Torr to about 10\hat{ }-9 Torr, between about 10\hat{ }-21 Torr to about 10\hat{ }-6 Torr, between about 10\hat{ }-21 Torr to about 10\hat{ }-3 Torr, between about 10\hat{ }-21 Torr to about 1.0 Torr, between about 10\hat{ }-21 Torr to about 10\hat{ }3 Torr, between about 10\hat{ }-18 Torr to about 10\hat{ }-15 Torr, between about 10\hat{ }-18 Torr to about 10\hat{ }-12 Torr, between about 10\hat{ }-18 Torr to about 10\hat{ }-9 Torr, between about 10\hat{ }-18 Torr to about 10\hat{ }-6 Torr, between about 10\hat{ }-18 Torr to about 10\hat{ }-3 Torr, between about 10\hat{ }-18 Torr to about 1.0 Torr, between about 10\hat{ }-18 Torr to about 10\hat{ }3 Torr, between about 10\hat{ }-15 Torr to about 10\hat{ }-12 Torr, between about 10\hat{ }-15 Torr to about 10\hat{ }-9 Torr, between about 10\hat{ }-15 Torr to about 10\hat{ }-6 Torr, between about 10\hat{ }-15 Torr to about 10\hat{ }-3 Torr, between about 10\hat{ }-15 Torr to about 1.0 Torr, between about 10\hat{ }-15 Torr to about 10\hat{ }3 Torr, between about 10\hat{ }-12 Torr to about 10\hat{ }-9 Torr, between about 10\hat{ }-12 Torr to about 10\hat{ }-6 Torr, between about 10\hat{ }-12 Torr to about 10\hat{ }-3 Torr, between about 10\hat{ }-12 Torr to about 1.0 Torr, between about 10\hat{ }-12 Torr to about 10\hat{ }3 Torr, between about 10\hat{ }-9 Torr to about 10\hat{ }-6 Torr, between about 10\hat{ }-9 Torr to about 10\hat{ }-3 Torr, between about 10\hat{ }-9 Torr to about 1.0 Torr, between about 10\hat{ }-9 Torr to about 10\hat{ }3 Torr, between about 10\hat{ }-6 Torr to about 10\hat{ }-3 Torr, between about 10\hat{ }-6 Torr to about 1.0 Torr, between about 10\hat{ }-6 Torr to about 10\hat{ }3 Torr, between about 10\hat{ }-3 Torr to about 1.0 Torr, between about 10\hat{ }-3 Torr to about 10\hat{ }3 Torr, or between about 1.0 Torr to about 10\hat{ }3 Torr. In some embodiments, the cavity comprises a vacuum with a pressure of about 10\hat{ }-24 Torr, about 10\hat{ }-21 Torr, about 10\hat{ }-18 Torr, about 10\hat{ }-15 Torr, about 10\hat{ }-12 Torr, about 10\hat{ }-9 Torr, about 10\hat{ }-6 Torr, about 10\hat{ }-3 Torr, about 1.0 Torr, or about 10\hat{ }3 Torr, including increments therein.

In some embodiments, the cavity comprises a thermal reservoir with a temperature between about 10\hat{ }-3 Kelvin to about 10\hat{ }3 Kelvin. In some embodiments, the cavity comprises a thermal reservoir with a temperature of at least about 10\hat{ }-3 Kelvin. In some embodiments, the cavity comprises a thermal reservoir with a temperature of at most about 10\hat{ }3 Kelvin. In some embodiments, the cavity comprises a thermal reservoir with a temperature between about 10\hat{ }-3 Kelvin to about 1 Kelvin, between about 10\hat{ }-3 Kelvin to about 5 Kelvin, between about 10\hat{ }-3 Kelvin to about 10 Kelvin, between about 10\hat{ }-3 Kelvin to about 25 Kelvin, between about 10\hat{ }-3 Kelvin to about 50 Kelvin, between about 10\hat{ }-3 Kelvin to about 100 Kelvin, between about 10\hat{ }-3 Kelvin to about 200 Kelvin, between about 10\hat{ }-3 Kelvin to about 300 Kelvin, between about 10\hat{ }-3 Kelvin to about 10\hat{ }3 Kelvin, between about 1 Kelvin to about 5 Kelvin, between about 1 Kelvin to about 10 Kelvin, between about 1 Kelvin to about 25 Kelvin, between about 1 Kelvin to about 50 Kelvin, between about 1 Kelvin to about 100 Kelvin, between about 1 Kelvin to about 200 Kelvin, between about 1 Kelvin to about 300 Kelvin, between about 1 Kelvin to about 10\hat{ }3 Kelvin, between about 5 Kelvin to about 10 Kelvin, between about 5 Kelvin to about 25 Kelvin, between about 5 Kelvin to about 50 Kelvin, between about 5 Kelvin to about 100 Kelvin, between about 5 Kelvin to about 200 Kelvin, between about 5 Kelvin to about 300 Kelvin, between about 5 Kelvin to about 10\hat{ }3 Kelvin, between about 10 Kelvin to about 25 Kelvin, between about 10 Kelvin to about 50 Kelvin, between about 10 Kelvin to about 100 Kelvin, between about 10 Kelvin to about 200 Kelvin, between about 10 Kelvin to about 300 Kelvin, between about 10 Kelvin to about 10\hat{ }3 Kelvin, between about 25 Kelvin to about 50 Kelvin, between about 25 Kelvin to about 100 Kelvin, between about 25 Kelvin to about 200 Kelvin, between about 25 Kelvin to about 300 Kelvin, between about 25 Kelvin to about 10\hat{ }3 Kelvin, between about 50 Kelvin to about 100 Kelvin, between about 50 Kelvin to about 200 Kelvin, between about 50 Kelvin to about 300 Kelvin, between about 50 Kelvin to about 10\hat{ }3 Kelvin, between about 100 Kelvin to about 200 Kelvin, between about 100 Kelvin to about 300 Kelvin, between about 100 Kelvin to about 10\hat{ }3 Kelvin, between about 200 Kelvin to about 300 Kelvin, between about 200 Kelvin to about 10\hat{ }3 Kelvin, or between about 300 Kelvin to about 10\hat{ }3 Kelvin. In some embodiments, the cavity comprises a thermal reservoir with a temperature of about 10\hat{ }-3 Kelvin, about 1 Kelvin, about 5 Kelvin, about 10 Kelvin, about 25 Kelvin, about 50 Kelvin, about 75 Kelvin, about 100 Kelvin, about 150 Kelvin, about 200 Kelvin, about 300 Kelvin, or about 10\hat{ }3 Kelvin, including increments therein.

In some embodiments, the electromagnetic wave comprises a transverse magnetic wave with a polar mode number of N1 and an azimuthal mode number of N2, where N1 and N2 are integers from 0 to 1000, and N1 is greater than or equal to N2. In some embodiments, the electromagnetic wave comprises a transverse magnetic wave with a polar mode number of N and an azimuthal mode number of 0, where N is an integer from 0 to 1000. In some embodiments, the electromagnetic wave comprises a transverse magnetic wave with a polar mode number of N and an azimuthal mode number of N, where N is an integer from 0 to 1000. In some embodiments, the electromagnetic wave comprises a transverse electric wave with a polar mode number of N1 and an azimuthal mode number of N2, where N1 and N2 are an integers from 0 to 1000, and N1 is greater than or equal to N2. In some embodiments, the electromagnetic wave comprises a transverse electric wave with a polar mode number of N and an azimuthal mode number of 0, where N is an integer from 0 to 1000. In some embodiments, the electromagnetic wave comprises a transverse electric wave with a polar mode number of N and an azimuthal mode number of N, where N is an integer from 0 to 1000.

In some embodiments, the electromagnetic radiation source is located inside the cavity at, or adjacent to, a maximum field amplitude or an asymptotic field amplitude of the electromagnetic wave.

In some embodiments, the cavity has at least one of a width and a height between about 10\hat{ }-9 meters to about 10\hat{ }3 meters. In some embodiments, the cavity has at least one of a width and a height of at least about 10\hat{ }-9 meters. In some embodiments, the cavity has at least one of a width and a height of at most about 10\hat{ }3 meters. In some embodiments, the cavity has at least one of a width and a height between about 10\hat{ }-9 meters to about 10\hat{ }-6 meters, between about 10\hat{ }-9 meters to about 10\hat{ }-3 meters, between about 10\hat{ }-9 meters to about 10\hat{ }-2 meters, between about 10\hat{ }-9 meters to about 10\hat{ }-1 meters, between about 10\hat{ }-9 meters to about 1.0 meter, between about 10\hat{ }-9 meters to about 10\hat{ }3 meters, between about 10\hat{ }-6 meters to about 10\hat{ }-3 meters, between about 10\hat{ }-6 meters to about 10\hat{ }-2 meters, between about 10\hat{ }-6 meters to about 10\hat{ }-1 meters, between about 10\hat{ }-6 meters to about 1.0 meter, between about 10\hat{ }-6 meters to about 10\hat{ }3 meters, between about 10\hat{ }-3 meters to about 10\hat{ }-2 meters, between about 10\hat{ }-3 meters to about 10\hat{ }-1 meters, between about 10\hat{ }-3 meters to about 1.0 meter, between about 10\hat{ }-3 meters to about 10\hat{ }3 meters, between about 10\hat{ }-2 meters to about 10\hat{ }-1 meters, between about 10\hat{ }-2 meters to about 1.0 meter, between about 10\hat{ }-2 meters to about 10\hat{ }3 meters, between about 10\hat{ }-1 meters to about 1.0 meter, between about 10\hat{ }-1 meters to about 10\hat{ }3 meters, or between about 1.0 meter to about 10\hat{ }3 meters. In some embodiments, the cavity has at least one of a width and a height of about 10\hat{ }-9 meters, about 10\hat{ }-6 meters, about 10\hat{ }-3 meters, about 10\hat{ }-2 meters, about 10\hat{ }-1 meters, about 1.0 meter, or about 10\hat{ }3 meters, including increments therein.

In some embodiments, the tapered interior surface forms an aperture angle between about 5 degrees to about 175 degrees. In some embodiments, the tapered interior surface forms an aperture angle of at least about 5 degrees. In some embodiments, the tapered interior surface forms an aperture angle of at most about 175 degrees. In some embodiments, the tapered interior surface forms an aperture angle between about 5 degrees to about 10 degrees, between about 5 degrees to about 20 degrees, between about 5 degrees to about 40 degrees, between about 5 degrees to about 60 degrees, between about 5 degrees to about 80 degrees, between about 5 degrees to about 100 degrees, between about 5 degrees to about 120 degrees, between about 5 degrees to about 140 degrees, between about 5 degrees to about 160 degrees, between about 5 degrees to about 175 degrees, between about 10 degrees to about 20 degrees, between about 10 degrees to about 40 degrees, between about 10 degrees to about 60 degrees, between about 10 degrees to about 80 degrees, between about 10 degrees to about 100 degrees, between about 10 degrees to about 120 degrees, between about 10 degrees to about 140 degrees, between about 10 degrees to about 160 degrees, between about 10 degrees to about 175 degrees, between about 20 degrees to about 40 degrees, between about 20 degrees to about 60 degrees, between about 20 degrees to about 80 degrees, between about 20 degrees to about 100 degrees, between about 20 degrees to about 120 degrees, between about 20 degrees to about 140 degrees, between about 20 degrees to about 160 degrees, between about 20 degrees to about 175 degrees, between about 40 degrees to about 60 degrees, between about 40 degrees to about 80 degrees, between about 40 degrees to about 100 degrees, between about 40 degrees to about 120 degrees, between about 40 degrees to about 140 degrees, between about 40 degrees to about 160 degrees, between about 40 degrees to about 175 degrees, between about 60 degrees to about 80 degrees, between about 60 degrees to about 100 degrees, between about 60 degrees to about 120 degrees, between about 60 degrees to about 140 degrees, between about 60 degrees to about 160 degrees, between about 60 degrees to about 175 degrees, between about 80 degrees to about 100 degrees, between about 80 degrees to about 120 degrees, between about 80 degrees to about 140 degrees, between about 80 degrees to about 160 degrees, between about 80 degrees to about 175 degrees, between about 100 degrees to about 120 degrees, between about 100 degrees to about 140 degrees, between about 100 degrees to about 160 degrees, between about 100 degrees to about 175 degrees, between about 120 degrees to about 140 degrees, between about 120 degrees to about 160 degrees, between about 120 degrees to about 175 degrees, between about 140 degrees to about 160 degrees, between about 140 degrees to about 175 degrees, or between about 160 degrees to about 175 degrees. In some embodiments, the tapered interior surface forms an aperture angle of about 5 degrees, about 10 degrees, about 20 degrees, about 40 degrees, about 60 degrees, about 80 degrees, about 100 degrees, about 120 degrees, about 140 degrees, about 160 degrees, or about 175 degrees, including increments therein.

In some embodiments, the cavity has a wall with a wall thickness between about 10\hat{ }-9 meters to about 1.0 meter. In some embodiments, the cavity has a wall with a wall thickness of at least about 10\hat{ }-9 meters. In some embodiments, the cavity has a wall with a wall thickness of at most about 1.0 meter. In some embodiments, the cavity has a wall with a wall thickness between about 10\hat{ }-9 meters to about 10\hat{ }-6 meters, between about 10\hat{ }-9 meters to about 10\hat{ }-5 meters, between about 10\hat{ }-9 meters to about 10\hat{ }-4 meters, between about 10\hat{ }-9 meters to about 10\hat{ }-3 meters, between about 10\hat{ }-9 meters to about 1.0 meter, between about 10\hat{ }-6 meters to about 10\hat{ }-5 meters, between about 10\hat{ }-6 meters to about 10\hat{ }-4 meters, between about 10\hat{ }-6 meters to about 10\hat{ }-3 meters, between about 10\hat{ }-6 meters to about 1.0 meter, between about 10\hat{ }-5 meters to about 10\hat{ }-4 meters, between about 10\hat{ }-5 meters to about 10\hat{ }-3 meters, between about 10\hat{ }-5 meters to about 1.0 meter, between about 10\hat{ }-4 meters to about 10\hat{ }-3 meters, between about 10\hat{ }-4 meters to about 1.0 meter, or between about 10\hat{ }-3 meters to about 1.0 meter. In some embodiments, the cavity has a wall with a wall thickness of about 10\hat{ }-9 meters, about 10\hat{ }-6 meters, about 10\hat{ }-5 meters, about 10\hat{ }-4 meters, about 10\hat{ }-3 meters, or about 1.0 meter, including increments therein.

In some embodiments, the base interior surface is substantially elliptical. In some embodiments, the base interior surface is substantially circular. In some embodiments, the base interior surface is substantially flat.

In some embodiments, the electromagnetic wave forms an electromagnetic energy momentum tensor with an amplitude maximum at, or adjacent to, the base interior surface, which results in one or more of a metric tensor curvature, a thrust, and an acceleration of the thruster. In some embodiments, the electromagnetic wave forms an electromagnetic energy momentum tensor with an amplitude maximum at, or adjacent to, one or both the tapered interior surface and the apex point, which results in one or more of a metric tensor curvature, a thrust, and an acceleration of the thruster.

Another embodiment includes an electromagnetic energy momentum thruster comprising: a cavity resonator forming a cavity having a base interior surface, a tapered interior surface, and a truncated interior surface opposing the base interior surface, the tapered interior surface being between the base and truncated interior surfaces; and an electromagnetic radiation source in communication with the cavity resonator, the electromagnetic radiation source configured to emit an electromagnetic wave having a frequency between about 1.0 MHz to about 1000 THz into the cavity resonator, the electromagnetic radiation source configured to produce the electromagnetic wave in evanescence so that the electromagnetic wave has a maximum field amplitude and an asymptotic field amplitude.

In some embodiments, the electromagnetic radiation source is configured to emit an electromagnetic wave into the cavity resonator having a frequency between about 10\hat{ }0 MHz to about 10\hat{ }9 MHz. In some embodiments, the electromagnetic radiation source is configured to emit an electromagnetic wave into the cavity resonator having a frequency of at least about 10\hat{ }0 MHz. In some embodiments, the electromagnetic radiation source is configured to emit an electromagnetic wave into the cavity resonator having a frequency of at most about 10\hat{ }9 MHz. In some embodiments, the electromagnetic radiation source is configured to emit an electromagnetic wave into the cavity resonator having a frequency between about 10\hat{ }0 MHz to about 10\hat{ }1 MHz, between about 10\hat{ }0 MHz to about 10\hat{ }2 MHz, between about 10\hat{ }0 MHz to about 10\hat{ }3 MHz, between about 10\hat{ }0 MHz to about 10\hat{ }4 MHz, between about 10\hat{ }0 MHz to about 10\hat{ }5 MHz, between about 10\hat{ }0 MHz to about 10\hat{ }6 MHz, between about 10\hat{ }0 MHz to about 10\hat{ }7 MHz, between about 10\hat{ }0 MHz to about 10\hat{ }8 MHz, between about 10\hat{ }0 MHz to about 10\hat{ }9 MHz, between about 10\hat{ }1 MHz to about 10\hat{ }2 MHz, between about 10\hat{ }1 MHz to about 10\hat{ }3 MHz, between about 10\hat{ }1 MHz to about 10\hat{ }4 MHz, between about 10\hat{ }1 MHz to about 10\hat{ }5 MHz, between about 10\hat{ }1 MHz to about 10\hat{ }6 MHz, between about 10\hat{ }1 MHz to about 10\hat{ }7 MHz, between about 10\hat{ }1 MHz to about 10\hat{ }8 MHz, between about 10\hat{ }1 MHz to about 10\hat{ }9 MHz, between about 10\hat{ }2 MHz to about 10\hat{ }3 MHz, between about 10\hat{ }2 MHz to about 10\hat{ }4 MHz, between about 10\hat{ }2 MHz to about 10\hat{ }5 MHz, between about 10\hat{ }2 MHz to about 10\hat{ }6 MHz, between about 10\hat{ }2 MHz to about 10\hat{ }7 MHz, between about 10\hat{ }2 MHz to about 10\hat{ }8 MHz, between about 10\hat{ }2 MHz to about 10\hat{ }9 MHz, between about 10\hat{ }3 MHz to about 10\hat{ }4 MHz, between about 10\hat{ }3 MHz to about 10\hat{ }5 MHz, between about 10\hat{ }3 MHz to about 10\hat{ }6 MHz, between about 10\hat{ }3 MHz to about 10\hat{ }7 MHz, between about 10\hat{ }3 MHz to about 10\hat{ }8 MHz, between about 10\hat{ }3 MHz to about 10\hat{ }9 MHz, between about 10\hat{ }4 MHz to about 10\hat{ }5 MHz, between about 10\hat{ }4 MHz to about 10\hat{ }6 MHz, between about 10\hat{ }4 MHz to about 10\hat{ }7 MHz, between about 10\hat{ }4 MHz to about 10\hat{ }8 MHz, between about 10\hat{ }4 MHz to about 10\hat{ }9 MHz, between about 10\hat{ }5 MHz to about 10\hat{ }6 MHz, between about 10\hat{ }5 MHz to about 10\hat{ }7 MHz, between about 10\hat{ }5 MHz to about 10\hat{ }8 MHz, between about 10\hat{ }5 MHz to about 10\hat{ }9 MHz, between about 10\hat{ }6 MHz to about 10\hat{ }7 MHz, between about 10\hat{ }6 MHz to about 10\hat{ }8 MHz, between about 10\hat{ }6 MHz to about 10\hat{ }9 MHz, between about 10\hat{ }7 MHz to about 10\hat{ }8 MHz, between about 10\hat{ }7 MHz to about 10\hat{ }9 MHz, or between about 10\hat{ }8 MHz to about 10\hat{ }9 MHz. In some embodiments, the electromagnetic radiation source is configured to emit an electromagnetic wave into the cavity resonator having a frequency of about 10\hat{ }0 MHz, about 10\hat{ }1 MHz, about 10\hat{ }2 MHz, about 10\hat{ }3 MHz, about 10\hat{ }4 MHz, about 10\hat{ }5 MHz, about 10\hat{ }6 MHz, about 10\hat{ }7 MHz, about 10\hat{ }8 MHz, or about 10\hat{ }9 MHz, including increments therein.

In some embodiments, the maximum field amplitude is at, or adjacent to, the base interior surface, and the asymptotic field amplitude is at, or adjacent to, one or both the tapered interior surface and the truncated interior surface. In some embodiments, the maximum field amplitude is at, or adjacent to, one or both the tapered interior surface and the truncated interior surface, and the asymptotic field amplitude is at, or adjacent to, the base interior surface.

In some embodiments, the cavity includes an overall interior surface that includes the base, tapered, and truncated interior surfaces, substantially the entire overall interior surface being electrically conductive, wherein the cavity resonator has a quality factor between about 10\hat{ }3 to about 10\hat{ }9. In some embodiments, the cavity resonator has a quality factor of at least about 10\hat{ }3. In some embodiments, the cavity resonator has a quality factor of at most about 10\hat{ }9. In some embodiments, the cavity resonator has a quality factor between about 10\hat{ }3 to about 10\hat{ }4, between about 10\hat{ }3 to about 10\hat{ }5, between about 10\hat{ }3 to about 10\hat{ }6, between about 10\hat{ }3 to about 10\hat{ }7, between about 10\hat{ }3 to about 10\hat{ }8, between about 10\hat{ }3 to about 10\hat{ }9, between about 10\hat{ }4 to about 10\hat{ }5, between about 10\hat{ }4 to about 10\hat{ }6, between about 10\hat{ }4 to about 10\hat{ }7, between about 10\hat{ }4 to about 10\hat{ }8, between about 10\hat{ }4 to about 10\hat{ }9, between about 10\hat{ }5 to about 10\hat{ }6, between about 10\hat{ }5 to about 10\hat{ }7, between about 10\hat{ }5 to about 10\hat{ }8, between about 10\hat{ }5 to about 10\hat{ }9, between about 10\hat{ }6 to about 10\hat{ }7, between about 10\hat{ }6 to about 10\hat{ }8, between about 10\hat{ }6 to about 10\hat{ }9, between about 10\hat{ }7 to about 10\hat{ }8, between about 10\hat{ }7 to about 10\hat{ }9, or between about 10\hat{ }8 to about 10\hat{ }9. In some embodiments, the cavity resonator has a quality factor of about 10\hat{ }3, about 10\hat{ }4, about 10\hat{ }5, about 10\hat{ }6, about 10\hat{ }7, about 10\hat{ }8, or about 10\hat{ }9, including increments therein.

In some embodiments, the overall interior surface comprises aluminum, antimony, arsenic, barium, beryllium, bismuth, cadmium, calcium, carbon, chromium, cobalt, copper, gallium, gold, hydrogen, indium, iron, lanthanum, lead, lithium, magnesium, manganese, mercury, molybdenum, nickel, niobium, nitrogen, oxygen, palladium, phosphorus, platinum, scandium, silicon, silver, strontium, sulfur, tantalum, technetium, tin, titanium, tungsten, vanadium, yttrium, zinc, zirconium, or any combination thereof.

In some embodiments, the cavity includes an overall interior surface that includes the base, tapered, and/or truncated interior surfaces, substantially the entire overall interior surface being superconductive, wherein the cavity resonator has a quality factor between about 10\hat{ }6 to about 10\hat{ }15. In some embodiments, the cavity resonator has a quality factor of at least about 10\hat{ }6. In some embodiments, the cavity resonator has a quality factor of at most about 10\hat{ }15. In some embodiments, the cavity resonator has a quality factor between about 10\hat{ }6 to about 10\hat{ }7, between about 10\hat{ }6 to about 10\hat{ }8, between about 10\hat{ }6 to about 10\hat{ }9, between about 10\hat{ }6 to about 10\hat{ }10, between about 10\hat{ }6 to about 10\hat{ }11, between about 10\hat{ }6 to about 10\hat{ }12, between about 10\hat{ }6 to about 10\hat{ }13, between about 10\hat{ }6 to about 10\hat{ }14, between about 10\hat{ }6 to about 10\hat{ }15, between about 10\hat{ }7 to about 10\hat{ }8, between about 10\hat{ }7 to about 10\hat{ }9, between about 10\hat{ }7 to about 10\hat{ }10, between about 10\hat{ }7 to about 10\hat{ }11, between about 10\hat{ }7 to about 10\hat{ }12, between about 10\hat{ }7 to about 10\hat{ }13, between about 10\hat{ }7 to about 10\hat{ }14, between about 10\hat{ }7 to about 10\hat{ }15, between about 10\hat{ }8 to about 10\hat{ }9, between about 10\hat{ }8 to about 10\hat{ }10, between about 10\hat{ }8 to about 10\hat{ }11, between about 10\hat{ }8 to about 10\hat{ }12, between about 10\hat{ }8 to about 10\hat{ }13, between about 10\hat{ }8 to about 10\hat{ }14, between about 10\hat{ }8 to about 10\hat{ }15, between about 10\hat{ }9 to about 10\hat{ }10, between about 10\hat{ }9 to about 10\hat{ }11, between about 10\hat{ }9 to about 10\hat{ }12, between about 10\hat{ }9 to about 10\hat{ }13, between about 10\hat{ }9 to about 10\hat{ }14, between about 10\hat{ }9 to about 10\hat{ }15, between about 10\hat{ }10 to about 10\hat{ }11, between about 10\hat{ }10 to about 10\hat{ }12, between about 10\hat{ }10 to about 10\hat{ }13, between about 10\hat{ }10 to about 10\hat{ }14, between about 10\hat{ }10 to about 10\hat{ }15, between about 10\hat{ }11 to about 10\hat{ }12, between about 10\hat{ }11 to about 10\hat{ }13, between about 10\hat{ }11 to about 10\hat{ }14, between about 10\hat{ }11 to about 10\hat{ }15, between about 10\hat{ }12 to about 10\hat{ }13, between about 10\hat{ }12 to about 10\hat{ }14, between about 10\hat{ }12 to about 10\hat{ }15, between about 10\hat{ }13 to about 10\hat{ }14, between about 10\hat{ }13 to about 10\hat{ }15, or between about 10\hat{ }14 to about 10\hat{ }15. In some embodiments, the cavity resonator has a quality factor of about 10\hat{ }6, about 10\hat{ }7, about 10\hat{ }8, about 10\hat{ }9, about 10\hat{ }10, about 10\hat{ }11, about 10\hat{ }12, about 10\hat{ }13, about 10\hat{ }14, or about 10\hat{ }15, including increments therein.

In some embodiments, the overall interior surface comprises aluminum, barium, beryllium, bismuth, cadmium, calcium, copper, gallium, gadolinium, germanium, lanthanum, lead, lithium, indium, mercury, molybdenum, niobium, nitrogen, osmium, oxygen, protactinium, rhenium, ruthenium, silicon, strontium, sulfur, tantalum, technetium, thallium, thorium, titanium, tin, vanadium, yttrium, zinc, zirconium, NbTi, PbMoS, V₃Ga, NbN, V₃Si, Nb₃Sn, Nb₃Al, Nb₃(AlGe), Nb₃Ge, Bi₂Sr₂CuO₆, Bi₂Sr₂CaCu₂O₈, Bi₂Sr₂Ca₂Cu₃O₁₀, YBa₂Cu₃O₇, YBa₂Cu₄O₈, Y₂Ba₄Cu₇O₁₅, Y₃Ba₅Cu₈O₁₈, Tl₂Ba₂CuO₆, Tl₂Ba₂CaCu₂O₈, Tl₂Ba₂Ca₂Cu₃O₁₀, TlBa₂Ca₃Cu₄O₁₁, HgBa₂CuO₄, HgBa₂CaCu₂O₆, HgBa₂Ca₂Cu₃O₈, or any combination thereof.

In some embodiments, the cavity is empty. In some embodiments, the cavity comprises a vacuum with a pressure between about 10\hat{ }-24 Torr to about 10\hat{ }3 Torr. In some embodiments, the cavity comprises a vacuum with a pressure of at least about 10\hat{ }-24 Torr. In some embodiments, the cavity comprises a vacuum with a pressure of at most about 10\hat{ }3 Torr. In some embodiments, the cavity comprises a vacuum with a pressure between about 10\hat{ }-24 Torr to about 10\hat{ }-21 Torr, between about 10\hat{ }-24 Torr to about 10\hat{ }-18 Torr, between about 10\hat{ }-24 Torr to about 10\hat{ }-15 Torr, between about 10\hat{ }-24 Torr to about 10\hat{ }-12 Torr, between about 10\hat{ }-24 Torr to about 10\hat{ }-9 Torr, between about 10\hat{ }-24 Torr to about 10\hat{ }-6 Torr, between about 10\hat{ }-24 Torr to about 10\hat{ }-3 Torr, between about 10\hat{ }-24 Torr to about 1.0 Torr, between about 10\hat{ }-24 Torr to about 10\hat{ }3 Torr, between about 10\hat{ }-21 Torr to about 10\hat{ }-18 Torr, between about 10\hat{ }-21 Torr to about 10\hat{ }-15 Torr, between about 10\hat{ }-21 Torr to about 10\hat{ }-12 Torr, between about 10\hat{ }-21 Torr to about 10\hat{ }-9 Torr, between about 10\hat{ }-21 Torr to about 10\hat{ }-6 Torr, between about 10\hat{ }-21 Torr to about 10\hat{ }-3 Torr, between about 10\hat{ }-21 Torr to about 1.0 Torr, between about 10\hat{ }-21 Torr to about 10\hat{ }3 Torr, between about 10\hat{ }-18 Torr to about 10\hat{ }-15 Torr, between about 10\hat{ }-18 Torr to about 10\hat{ }-12 Torr, between about 10\hat{ }-18 Torr to about 10\hat{ }-9 Torr, between about 10\hat{ }-18 Torr to about 10\hat{ }-6 Torr, between about 10\hat{ }-18 Torr to about 10\hat{ }-3 Torr, between about 10\hat{ }-18 Torr to about 1.0 Torr, between about 10\hat{ }-18 Torr to about 10\hat{ }3 Torr, between about 10\hat{ }-15 Torr to about 10\hat{ }-12 Torr, between about 10\hat{ }-15 Torr to about 10\hat{ }-9 Torr, between about 10\hat{ }-15 Torr to about 10\hat{ }-6 Torr, between about 10\hat{ }-15 Torr to about 10\hat{ }-3 Torr, between about 10\hat{ }-15 Torr to about 1.0 Torr, between about 10\hat{ }-15 Torr to about 10\hat{ }3 Torr, between about 10\hat{ }-12 Torr to about 10\hat{ }-9 Torr, between about 10\hat{ }-12 Torr to about 10\hat{ }-6 Torr, between about 10\hat{ }-12 Torr to about 10\hat{ }-3 Torr, between about 10\hat{ }-12 Torr to about 1.0 Torr, between about 10\hat{ }-12 Torr to about 10\hat{ }3 Torr, between about 10\hat{ }-9 Torr to about 10\hat{ }-6 Torr, between about 10\hat{ }-9 Torr to about 10\hat{ }-3 Torr, between about 10\hat{ }-9 Torr to about 1.0 Torr, between about 10\hat{ }-9 Torr to about 10\hat{ }3 Torr, between about 10\hat{ }-6 Torr to about 10\hat{ }-3 Torr, between about 10\hat{ }-6 Torr to about 1.0 Torr, between about 10\hat{ }-6 Torr to about 10\hat{ }3 Torr, between about 10\hat{ }-3 Torr to about 1.0 Torr, between about 10\hat{ }-3 Torr to about 10\hat{ }3 Torr, or between about 1.0 Torr to about 10\hat{ }3 Torr. In some embodiments, the cavity comprises a vacuum with a pressure of about 10\hat{ }-24 Torr, about 10\hat{ }-21 Torr, about 10\hat{ }-18 Torr, about 10\hat{ }-15 Torr, about 10\hat{ }-12 Torr, about 10\hat{ }-9 Torr, about 10\hat{ }-6 Torr, about 10\hat{ }-3 Torr, about 1.0 Torr, or about 10\hat{ }3 Torr, including increments therein.

In some embodiments, the cavity comprises a thermal reservoir with a temperature between about 10\hat{ }-3 Kelvin about 10\hat{ }3 Kelvin. In some embodiments, the cavity comprises a thermal reservoir with a temperature of at least about 10\hat{ }-3 Kelvin. In some embodiments, the cavity comprises a thermal reservoir with a temperature of at most about 10\hat{ }3 Kelvin. In some embodiments, the cavity comprises a thermal reservoir with a temperature between about 10\hat{ }-3 Kelvin to about 1 Kelvin, between about 10\hat{ }-3 Kelvin to about 5 Kelvin, between about 10\hat{ }-3 Kelvin to about 10 Kelvin, between about 10\hat{ }-3 Kelvin to about 25 Kelvin, between about 10\hat{ }-3 Kelvin to about 50 Kelvin, between about 10\hat{ }-3 Kelvin to about 100 Kelvin, between about 10\hat{ }-3 Kelvin to about 200 Kelvin, between about 10\hat{ }-3 Kelvin to about 300 Kelvin, between about 10\hat{ }-3 Kelvin to about 10\hat{ }3 Kelvin, between about 1 Kelvin to about 5 Kelvin, between about 1 Kelvin to about 10 Kelvin, between about 1 Kelvin to about 25 Kelvin, between about 1 Kelvin to about 50 Kelvin, between about 1 Kelvin to about 100 Kelvin, between about 1 Kelvin to about 200 Kelvin, between about 1 Kelvin to about 300 Kelvin, between about 1 Kelvin to about 10\hat{ }3 Kelvin, between about 5 Kelvin to about 10 Kelvin, between about 5 Kelvin to about 25 Kelvin, between about 5 Kelvin to about 50 Kelvin, between about 5 Kelvin to about 100 Kelvin, between about 5 Kelvin to about 200 Kelvin, between about 5 Kelvin to about 300 Kelvin, between about 5 Kelvin to about 10\hat{ }3 Kelvin, between about 10 Kelvin to about 25 Kelvin, between about 10 Kelvin to about 50 Kelvin, between about 10 Kelvin to about 100 Kelvin, between about 10 Kelvin to about 200 Kelvin, between about 10 Kelvin to about 300 Kelvin, between about 10 Kelvin to about 10\hat{ }3 Kelvin, between about 25 Kelvin to about 50 Kelvin, between about 25 Kelvin to about 100 Kelvin, between about 25 Kelvin to about 200 Kelvin, between about 25 Kelvin to about 300 Kelvin, between about 25 Kelvin to about 10\hat{ }3 Kelvin, between about 50 Kelvin to about 100 Kelvin, between about 50 Kelvin to about 200 Kelvin, between about 50 Kelvin to about 300 Kelvin, between about 50 Kelvin to about 10\hat{ }3 Kelvin, between about 100 Kelvin to about 200 Kelvin, between about 100 Kelvin to about 300 Kelvin, between about 100 Kelvin to about 10\hat{ }3 Kelvin, between about 200 Kelvin to about 300 Kelvin, between about 200 Kelvin to about 10\hat{ }3 Kelvin, or between about 300 Kelvin to about 10\hat{ }3 Kelvin. In some embodiments, the cavity comprises a thermal reservoir with a temperature of about 10\hat{ }-3 Kelvin, about 1 Kelvin, about 5 Kelvin, about 10 Kelvin, about 25 Kelvin, about 50 Kelvin, about 75 Kelvin, about 100 Kelvin, about 150 Kelvin, about 200 Kelvin, about 300 Kelvin, or about 10\hat{ }3 Kelvin, including increments therein.

In some embodiments, the electromagnetic wave comprises a transverse magnetic wave with a polar mode number of N1 and an azimuthal mode number of N2, where N1 and N2 are an integers from 0 to 1000, and N1 is greater than or equal to N2. In some embodiments, the electromagnetic wave comprises a transverse magnetic wave with a polar mode number of N and an azimuthal mode number of 0, where N is an integer from 0 to 1000. In some embodiments, the electromagnetic wave comprises a transverse magnetic wave with a polar mode number of N and an azimuthal mode number of N, where N is an integer from 0 to 1000. In some embodiments, the electromagnetic wave comprises a transverse electric wave with a polar mode number of N1 and an azimuthal mode number of N2, where N1 and N2 are an integers from 0 to 1000, and N1 is greater than or equal to N2. In some embodiments, the electromagnetic wave comprises a transverse electric wave with a polar mode number of N and an azimuthal mode number of 0, where N is an integer from 0 to 1000. In some embodiments, the electromagnetic wave comprises a transverse electric wave with a polar mode number of N and an azimuthal mode number of N, where N is an integer from 0 to 1000.

In some embodiments, the electromagnetic radiation source is located inside the cavity at, or adjacent to, a maximum field amplitude or an asymptotic field amplitude of the electromagnetic wave.

In some embodiments, the cavity has at least one of a width and a height between about 10\hat{ }-9 meters to about 10\hat{ }3 meters. In some embodiments, the cavity has at least one of a width and a height of at least about 10\hat{ }-9 meters. In some embodiments, the cavity has at least one of a width and a height of at most about 10\hat{ }3 meters. In some embodiments, the cavity has at least one of a width and a height between about 10\hat{ }-9 meters to about 10\hat{ }-6 meters, between about 10\hat{ }-9 meters to about 10\hat{ }-3 meters, between about 10\hat{ }-9 meters to about 10\hat{ }-2 meters, between about 10\hat{ }-9 meters to about 10\hat{ }-1 meters, between about 10\hat{ }-9 meters to about 1.0 meter, between about 10\hat{ }-9 meters to about 10\hat{ }3 meters, between about 10\hat{ }-6 meters to about 10\hat{ }-3 meters, between about 10\hat{ }-6 meters to about 10\hat{ }-2 meters, between about 10\hat{ }-6 meters to about 10\hat{ }-1 meters, between about 10\hat{ }-6 meters to about 1.0 meter, between about 10\hat{ }-6 meters to about 10\hat{ }3 meters, between about 10\hat{ }-3 meters to about 10\hat{ }-2 meters, between about 10\hat{ }-3 meters to about 10\hat{ }-1 meters, between about 10\hat{ }-3 meters to about 1.0 meter, between about 10\hat{ }-3 meters to about 10\hat{ }3 meters, between about 10\hat{ }-2 meters to about 10\hat{ }-1 meters, between about 10\hat{ }-2 meters to about 1.0 meter, between about 10\hat{ }-2 meters to about 10\hat{ }3 meters, between about 10\hat{ }-1 meters to about 1.0 meter, between about 10\hat{ }-1 meters to about 10\hat{ }3 meters, or between about 1.0 meter to about 10\hat{ }3 meters. In some embodiments, the cavity has at least one of a width and a height of about 10\hat{ }-9 meters, about 10\hat{ }-6 meters, about 10\hat{ }-3 meters, about 10\hat{ }-2 meters, about 10\hat{ }-1 meters, about 1.0 meter, or about 10\hat{ }3 meters, including increments therein.

In some embodiments, the tapered interior surface forms an aperture angle between about 5 degrees to about 175 degrees. In some embodiments, the tapered interior surface forms an aperture angle of at least about 5 degrees. In some embodiments, the tapered interior surface forms an aperture angle of at most about 175 degrees. In some embodiments, the tapered interior surface forms an aperture angle between about 5 degrees to about 10 degrees, between about 5 degrees to about 20 degrees, between about 5 degrees to about 40 degrees, between about 5 degrees to about 60 degrees, between about 5 degrees to about 80 degrees, between about 5 degrees to about 100 degrees, between about 5 degrees to about 120 degrees, between about 5 degrees to about 140 degrees, between about 5 degrees to about 160 degrees, between about 5 degrees to about 175 degrees, between about 10 degrees to about 20 degrees, between about 10 degrees to about 40 degrees, between about 10 degrees to about 60 degrees, between about 10 degrees to about 80 degrees, between about 10 degrees to about 100 degrees, between about 10 degrees to about 120 degrees, between about 10 degrees to about 140 degrees, between about 10 degrees to about 160 degrees, between about 10 degrees to about 175 degrees, between about 20 degrees to about 40 degrees, between about 20 degrees to about 60 degrees, between about 20 degrees to about 80 degrees, between about 20 degrees to about 100 degrees, between about 20 degrees to about 120 degrees, between about 20 degrees to about 140 degrees, between about 20 degrees to about 160 degrees, between about 20 degrees to about 175 degrees, between about 40 degrees to about 60 degrees, between about 40 degrees to about 80 degrees, between about 40 degrees to about 100 degrees, between about 40 degrees to about 120 degrees, between about 40 degrees to about 140 degrees, between about 40 degrees to about 160 degrees, between about 40 degrees to about 175 degrees, between about 60 degrees to about 80 degrees, between about 60 degrees to about 100 degrees, between about 60 degrees to about 120 degrees, between about 60 degrees to about 140 degrees, between about 60 degrees to about 160 degrees, between about 60 degrees to about 175 degrees, between about 80 degrees to about 100 degrees, between about 80 degrees to about 120 degrees, between about 80 degrees to about 140 degrees, between about 80 degrees to about 160 degrees, between about 80 degrees to about 175 degrees, between about 100 degrees to about 120 degrees, between about 100 degrees to about 140 degrees, between about 100 degrees to about 160 degrees, between about 100 degrees to about 175 degrees, between about 120 degrees to about 140 degrees, between about 120 degrees to about 160 degrees, between about 120 degrees to about 175 degrees, between about 140 degrees to about 160 degrees, between about 140 degrees to about 175 degrees, between or about 160 degrees to about 175 degrees. In some embodiments, the tapered interior surface forms an aperture angle of about 5 degrees, about 10 degrees, about 20 degrees, about 40 degrees, about 60 degrees, about 80 degrees, about 100 degrees, about 120 degrees, about 140 degrees, about 160 degrees, or about 175 degrees, including increments therein.

In some embodiments, the cavity has a wall with a wall thickness between about 10\hat{ }-9 meters to about 1.0 meter. In some embodiments, the cavity has a wall with a wall thickness of at least about 10\hat{ }-9 meters. In some embodiments, the cavity has a wall with a wall thickness of at most about 1.0 meter. In some embodiments, the cavity has a wall with a wall thickness between about 10\hat{ }-9 meters to about 10\hat{ }-6 meters, between about 10\hat{ }-9 meters to about 10\hat{ }-5 meters, between about 10\hat{ }-9 meters to about 10\hat{ }-4 meters, between about 10\hat{ }-9 meters to about 10\hat{ }-3 meters, between about 10\hat{ }-9 meters to about 1.0 meter, between about 10\hat{ }-6 meters to about 10\hat{ }-5 meters, between about 10\hat{ }-6 meters to about 10\hat{ }-4 meters, between about 10\hat{ }-6 meters to about 10\hat{ }-3 meters, between about 10\hat{ }-6 meters to about 1.0 meter, between about 10\hat{ }-5 meters to about 10\hat{ }-4 meters, between about 10\hat{ }-5 meters to about 10\hat{ }-3 meters, between about 10\hat{ }-5 meters to about 1.0 meter, between about 10\hat{ }-4 meters to about 10\hat{ }-3 meters, between about 10\hat{ }-4 meters to about 1.0 meter, or between about 10\hat{ }-3 meters to about 1.0 meter. In some embodiments, the cavity has a wall with a wall thickness of about 10\hat{ }-9 meters, about 10\hat{ }-6 meters, about 10\hat{ }-5 meters, about 10\hat{ }-4 meters, about 10\hat{ }-3 meters, or about 1.0 meter, including increments therein.

In some embodiments, one or both the base interior surface and the truncated interior surface of the cavity is substantially elliptical. In some embodiments, one or both the base interior surface and the truncated interior surface of the cavity is substantially circular. In some embodiments, one or both the base interior surface and the truncated interior surface of the cavity is substantially flat.

In some embodiments, the electromagnetic wave forms an electromagnetic energy momentum tensor with an amplitude maximum at, or adjacent to, the base interior surface, which results in one or more of a metric tensor curvature, a thrust, and an acceleration of the thruster. In some embodiments, the electromagnetic wave forms an electromagnetic energy momentum tensor with an amplitude maximum at, or adjacent to, one or both the tapered interior surface and the truncated interior surface, which results in one or more of a metric tensor curvature, a thrust, and an acceleration of the thruster.

Another embodiment includes an electromagnetic energy momentum thruster comprising: a cavity resonator forming a pyramidal cavity having a base interior surface and at least three tapered interior surfaces, the tapered interior surfaces converging to an apex point; and an electromagnetic radiation source in communication with the cavity resonator, the electromagnetic radiation source configured to emit an electromagnetic wave having a frequency between about 1.0 MHz to about 1000 THz into the cavity resonator.

In some embodiments, the electromagnetic radiation source configured to emit an electromagnetic wave into the cavity resonator having a frequency between about 10\hat{ }0 MHz to about 10\hat{ }9 MHz. In some embodiments, the electromagnetic radiation source configured to emit an electromagnetic wave into the cavity resonator having a frequency of at least about 10\hat{ }0 MHz. In some embodiments, the electromagnetic radiation source configured to emit an electromagnetic wave into the cavity resonator having a frequency of at most about 10\hat{ }9 MHz. In some embodiments, the electromagnetic radiation source configured to emit an electromagnetic wave into the cavity resonator having a frequency between about 10\hat{ }0 MHz to about 10\hat{ }1 MHz, between about 10\hat{ }0 MHz to about 10\hat{ }2 MHz, between about 10\hat{ }0 MHz to about 10\hat{ }3 MHz, between about 10\hat{ }0 MHz to about 10\hat{ }4 MHz, between about 10\hat{ }0 MHz to about 10\hat{ }5 MHz, between about 10\hat{ }0 MHz to about 10\hat{ }6 MHz, between about 10\hat{ }0 MHz to about 10\hat{ }7 MHz, between about 10\hat{ }0 MHz to about 10\hat{ }8 MHz, between about 10\hat{ }0 MHz to about 10\hat{ }9 MHz, between about 10\hat{ }1 MHz to about 10\hat{ }2 MHz, between about 10\hat{ }1 MHz to about 10\hat{ }3 MHz, between about 10\hat{ }1 MHz to about 10\hat{ }4 MHz, between about 10\hat{ }1 MHz to about 10\hat{ }5 MHz, between about 10\hat{ }1 MHz to about 10\hat{ }6 MHz, between about 10\hat{ }1 MHz to about 10\hat{ }7 MHz, between about 10\hat{ }1 MHz to about 10\hat{ }8 MHz, between about 10\hat{ }1 MHz to about 10\hat{ }9 MHz, between about 10\hat{ }2 MHz to about 10\hat{ }3 MHz, between about 10\hat{ }2 MHz to about 10\hat{ }4 MHz, between about 10\hat{ }2 MHz to about 10\hat{ }5 MHz, between about 10\hat{ }2 MHz to about 10\hat{ }6 MHz, between about 10\hat{ }2 MHz to about 10\hat{ }7 MHz, between about 10\hat{ }2 MHz to about 10\hat{ }8 MHz, between about 10\hat{ }2 MHz to about 10\hat{ }9 MHz, between about 10\hat{ }3 MHz to about 10\hat{ }4 MHz, between about 10\hat{ }3 MHz to about 10\hat{ }5 MHz, between about 10\hat{ }3 MHz to about 10\hat{ }6 MHz, between about 10\hat{ }3 MHz to about 10\hat{ }7 MHz, between about 10\hat{ }3 MHz to about 10\hat{ }8 MHz, between about 10\hat{ }3 MHz to about 10\hat{ }9 MHz, between about 10\hat{ }4 MHz to about 10\hat{ }5 MHz, between about 10\hat{ }4 MHz to about 10\hat{ }6 MHz, between about 10\hat{ }4 MHz to about 10\hat{ }7 MHz, between about 10\hat{ }4 MHz to about 10\hat{ }8 MHz, between about 10\hat{ }4 MHz to about 10\hat{ }9 MHz, between about 10\hat{ }5 MHz to about 10\hat{ }6 MHz, between about 10\hat{ }5 MHz to about 10\hat{ }7 MHz, between about 10\hat{ }5 MHz to about 10\hat{ }8 MHz, between about 10\hat{ }5 MHz to about 10\hat{ }9 MHz, between about 10\hat{ }6 MHz to about 10\hat{ }7 MHz, between about 10\hat{ }6 MHz to about 10\hat{ }8 MHz, between about 10\hat{ }6 MHz to about 10\hat{ }9 MHz, between about 10\hat{ }7 MHz to about 10\hat{ }8 MHz, between about 10\hat{ }7 MHz to about 10\hat{ }9 MHz, or between about 10\hat{ }8 MHz to about 10\hat{ }9 MHz. In some embodiments, the electromagnetic radiation source configured to emit an electromagnetic wave into the cavity resonator having a frequency of about 10\hat{ }0 MHz, about 10\hat{ }1 MHz, about 10\hat{ }2 MHz, about 10\hat{ }3 MHz, about 10\hat{ }4 MHz, about 10\hat{ }5 MHz, about 10\hat{ }6 MHz, about 10\hat{ }7 MHz, about 10\hat{ }8 MHz, or about 10\hat{ }9 MHz, including increments therein.

In some embodiments, the electromagnetic radiation source is configured to produce the frequency of the electromagnetic wave in evanescence so that the electromagnetic wave has a maximum field amplitude and an asymptotic field amplitude, the maximum field amplitude being at, or adjacent to, the base interior surface, the asymptotic field amplitude being at, or adjacent to, one or more of the at least three tapered interior surfaces and the apex point. In some embodiments, the electromagnetic radiation source is configured to produce the frequency of the electromagnetic wave in evanescence so that the electromagnetic wave has a maximum field amplitude and an asymptotic field amplitude, the maximum field amplitude being at, or adjacent to, one or more of the at least three tapered interior surfaces and the apex point, and the asymptotic field amplitude being at, or adjacent to, the base interior surface.

In some embodiments, the cavity includes an overall interior surface that includes the base and tapered interior surfaces, substantially the entire overall interior surface being electrically conductive, wherein the cavity resonator has a quality factor between about 10\hat{ }3 to about 10\hat{ }9. In some embodiments, the cavity resonator has a quality factor of at least about 10\hat{ }3. In some embodiments, the cavity resonator has a quality factor of at most about 10\hat{ }9. In some embodiments, the cavity resonator has a quality factor between about 10\hat{ }3 to about 10\hat{ }4, between about 10\hat{ }3 to about 10\hat{ }5, between about 10\hat{ }3 to about 10\hat{ }6, between about 10\hat{ }3 to about 10\hat{ }7, between about 10\hat{ }3 to about 10\hat{ }8, between about 10\hat{ }3 to about 10\hat{ }9, between about 10\hat{ }4 to about 10\hat{ }5, between about 10\hat{ }4 to about 10\hat{ }6, between about 10\hat{ }4 to about 10\hat{ }7, between about 10\hat{ }4 to about 10\hat{ }8, between about 10\hat{ }4 to about 10\hat{ }9, between about 10\hat{ }5 to about 10\hat{ }6, between about 10\hat{ }5 to about 10\hat{ }7, between about 10\hat{ }5 to about 10\hat{ }8, between about 10\hat{ }5 to about 10\hat{ }9, between about 10\hat{ }6 to about 10\hat{ }7, between about 10\hat{ }6 to about 10\hat{ }8, between about 10\hat{ }6 to about 10\hat{ }9, between about 10\hat{ }7 to about 10\hat{ }8, between about 10\hat{ }7 to about 10\hat{ }9, or between about 10\hat{ }8 to about 10\hat{ }9. In some embodiments, the cavity resonator has a quality factor of about 10\hat{ }3, about 10\hat{ }4, about 10\hat{ }5, about 10\hat{ }6, about 10\hat{ }7, about 10\hat{ }8, or about 10\hat{ }9, including increments therein.

In some embodiments, the overall interior surface comprises aluminum, antimony, arsenic, barium, beryllium, bismuth, cadmium, calcium, carbon, chromium, cobalt, copper, gallium, gold, hydrogen, indium, iron, lanthanum, lead, lithium, magnesium, manganese, mercury, molybdenum, nickel, niobium, nitrogen, oxygen, palladium, phosphorus, platinum, scandium, silicon, silver, strontium, sulfur, tantalum, technetium, tin, titanium, tungsten, vanadium, yttrium, zinc, zirconium, or any combination thereof.

In some embodiments, the cavity includes an overall interior surface that includes the base and tapered interior surfaces, substantially the entire overall interior surface being superconductive, wherein the cavity resonator has a quality factor between about 10\hat{ }6 to about 10\hat{ }15. In some embodiments, the cavity resonator has a quality factor of at least about 10\hat{ }6. In some embodiments, the cavity resonator has a quality factor of at most about 10\hat{ }15. In some embodiments, the cavity resonator has a quality factor between about 10\hat{ }6 to about 10\hat{ }7, between about 10\hat{ }6 to about 10\hat{ }8, between about 10\hat{ }6 to about 10\hat{ }9, between about 10\hat{ }6 to about 10\hat{ }10, between about 10\hat{ }6 to about 10\hat{ }11, between about 10\hat{ }6 to about 10\hat{ }12, between about 10\hat{ }6 to about 10\hat{ }13, between about 10\hat{ }6 to about 10\hat{ }14, between about 10\hat{ }6 to about 10\hat{ }15, between about 10\hat{ }7 to about 10\hat{ }8, between about 10\hat{ }7 to about 10\hat{ }9, between about 10\hat{ }7 to about 10\hat{ }10, between about 10\hat{ }7 to about 10\hat{ }11, between about 10\hat{ }7 to about 10\hat{ }12, between about 10\hat{ }7 to about 10\hat{ }13, between about 10\hat{ }7 to about 10\hat{ }14, between about 10\hat{ }7 to about 10\hat{ }15, between about 10\hat{ }8 to about 10\hat{ }9, between about 10\hat{ }8 to about 10\hat{ }10, between about 10\hat{ }8 to about 10\hat{ }11, between about 10\hat{ }8 to about 10\hat{ }12, between about 10\hat{ }8 to about 10\hat{ }13, between about 10\hat{ }8 to about 10\hat{ }14, between about 10\hat{ }8 to about 10\hat{ }15, between about 10\hat{ }9 to about 10\hat{ }10, between about 10\hat{ }9 to about 10\hat{ }11, between about 10\hat{ }9 to about 10\hat{ }12, between about 10\hat{ }9 to about 10\hat{ }13, between about 10\hat{ }9 to about 10\hat{ }14, between about 10\hat{ }9 to about 10\hat{ }15, between about 10\hat{ }10 to about 10\hat{ }11, between about 10\hat{ }10 to about 10\hat{ }12, between about 10\hat{ }10 to about 10\hat{ }13, between about 10\hat{ }10 to about 10\hat{ }14, between about 10\hat{ }10 to about 10\hat{ }15, between about 10\hat{ }11 to about 10\hat{ }12, between about 10\hat{ }11 to about 10\hat{ }13, between about 10\hat{ }11 to about 10\hat{ }14, between about 10\hat{ }11 to about 10\hat{ }15, between about 10\hat{ }12 to about 10\hat{ }13, between about 10\hat{ }12 to about 10\hat{ }14, between about 10\hat{ }12 to about 10\hat{ }15, between about 10\hat{ }13 to about 10\hat{ }14, between about 10\hat{ }13 to about 10\hat{ }15, or between about 10\hat{ }14 to about 10\hat{ }15. In some embodiments, the cavity resonator has a quality factor of about 10\hat{ }6, about 10\hat{ }7, about 10\hat{ }8, about 10\hat{ }9, about 10\hat{ }10, about 10\hat{ }11, about 10\hat{ }12, about 10\hat{ }13, about 10\hat{ }14, or about 10\hat{ }15, including increments therein.

In some embodiments, the overall interior surface comprises aluminum, barium, beryllium, bismuth, cadmium, calcium, copper, gallium, gadolinium, germanium, lanthanum, lead, lithium, indium, mercury, molybdenum, niobium, nitrogen, osmium, oxygen, protactinium, rhenium, ruthenium, silicon, strontium, sulfur, tantalum, technetium, thallium, thorium, titanium, tin, vanadium, yttrium, zinc, zirconium, NbTi, PbMoS, V₃Ga, NbN, V₃Si, Nb₃Sn, Nb₃Al, Nb₃(AlGe), Nb₃Ge, Bi₂Sr₂CuO₆, Bi₂Sr₂CaCu₂O₈, Bi₂Sr₂Ca₂Cu₃O₁₀, YBa₂Cu₃O₇, YBa₂Cu₄O₈, Y₂Ba₄Cu₇O₁₅, Y₃Ba₅Cu₈O₁₈, Tl₂Ba₂CuO₆, Tl₂Ba₂CaCu₂O₈, Tl₂Ba₂Ca₂Cu₃O₁₀, TlBa₂Ca₃Cu₄O₁₁, HgBa₂CuO₄, HgBa₂CaCu₂O₆, HgBa₂Ca₂Cu₃O₈, or any combination thereof.

In some embodiments, the cavity is empty. In some embodiments, the cavity comprises a vacuum with a pressure between about 10\hat{ }-24 Torr to about 10\hat{ }3 Torr. In some embodiments, the cavity comprises a vacuum with a pressure of at least about 10\hat{ }-24 Torr. In some embodiments, the cavity comprises a vacuum with a pressure of at most about 10\hat{ }3 Torr. In some embodiments, the cavity comprises a vacuum with a pressure between about 10\hat{ }-24 Torr to about 10\hat{ }-21 Torr, between about 10\hat{ }-24 Torr to about 10\hat{ }-18 Torr, between about 10\hat{ }-24 Torr to about 10\hat{ }-15 Torr, between about 10\hat{ }-24 Torr to about 10\hat{ }-12 Torr, between about 10\hat{ }-24 Torr to about 10\hat{ }-9 Torr, between about 10\hat{ }-24 Torr to about 10\hat{ }-6 Torr, between about 10\hat{ }-24 Torr to about 10\hat{ }-3 Torr, between about 10\hat{ }-24 Torr to about 1.0 Torr, between about 10\hat{ }-24 Torr to about 10\hat{ }3 Torr, between about 10\hat{ }-21 Torr to about 10\hat{ }-18 Torr, between about 10\hat{ }-21 Torr to about 10\hat{ }-15 Torr, between about 10\hat{ }-21 Torr to about 10\hat{ }-12 Torr, between about 10\hat{ }-21 Torr to about 10\hat{ }-9 Torr, between about 10\hat{ }-21 Torr to about 10\hat{ }-6 Torr, between about 10\hat{ }-21 Torr to about 10\hat{ }-3 Torr, between about 10\hat{ }-21 Torr to about 1.0 Torr, between about 10\hat{ }-21 Torr to about 10\hat{ }3 Torr, between about 10\hat{ }-18 Torr to about 10\hat{ }-15 Torr, between about 10\hat{ }-18 Torr to about 10\hat{ }-12 Torr, between about 10\hat{ }-18 Torr to about 10\hat{ }-9 Torr, between about 10\hat{ }-18 Torr to about 10\hat{ }-6 Torr, between about 10\hat{ }-18 Torr to about 10\hat{ }-3 Torr, between about 10\hat{ }-18 Torr to about 1.0 Torr, between about 10\hat{ }-18 Torr to about 10\hat{ }3 Torr, between about 10\hat{ }-15 Torr to about 10\hat{ }-12 Torr, between about 10\hat{ }-15 Torr to about 10\hat{ }-9 Torr, between about 10\hat{ }-15 Torr to about 10\hat{ }-6 Torr, between about 10\hat{ }-15 Torr to about 10\hat{ }-3 Torr, between about 10\hat{ }-15 Torr to about 1.0 Torr, between about 10\hat{ }-15 Torr to about 10\hat{ }3 Torr, between about 10\hat{ }-12 Torr to about 10\hat{ }-9 Torr, between about 10\hat{ }-12 Torr to about 10\hat{ }-6 Torr, between about 10\hat{ }-12 Torr to about 10\hat{ }-3 Torr, between about 10\hat{ }-12 Torr to about 1.0 Torr, between about 10\hat{ }-12 Torr to about 10\hat{ }3 Torr, between about 10\hat{ }-9 Torr to about 10\hat{ }-6 Torr, between about 10\hat{ }-9 Torr to about 10\hat{ }-3 Torr, between about 10\hat{ }-9 Torr to about 1.0 Torr, between about 10\hat{ }-9 Torr to about 10\hat{ }3 Torr, between about 10\hat{ }-6 Torr to about 10\hat{ }-3 Torr, between about 10\hat{ }-6 Torr to about 1.0 Torr, between about 10\hat{ }-6 Torr to about 10\hat{ }3 Torr, between about 10\hat{ }-3 Torr to about 1.0 Torr, between about 10\hat{ }-3 Torr to about 10\hat{ }3 Torr, or between about 1.0 Torr to about 10\hat{ }3 Torr. In some embodiments, the cavity comprises a vacuum with a pressure of about 10\hat{ }-24 Torr, about 10\hat{ }-21 Torr, about 10\hat{ }-18 Torr, about 10\hat{ }-15 Torr, about 10\hat{ }-12 Torr, about 10\hat{ }-9 Torr, about 10\hat{ }-6 Torr, about 10\hat{ }-3 Torr, about 1.0 Torr, or about 10\hat{ }3 Torr, including increments therein.

In some embodiments, the cavity comprises a thermal reservoir with a temperature between about 10\hat{ }-3 Kelvin about 10\hat{ }3 Kelvin. In some embodiments, the cavity comprises a thermal reservoir with a temperature of at least about 10\hat{ }-3 Kelvin. In some embodiments, the cavity comprises a thermal reservoir with a temperature of at most about 10\hat{ }3 Kelvin. In some embodiments, the cavity comprises a thermal reservoir with a temperature between about 10\hat{ }-3 Kelvin to about 1 Kelvin, between about 10\hat{ }-3 Kelvin to about 5 Kelvin, between about 10\hat{ }-3 Kelvin to about 10 Kelvin, between about 10\hat{ }-3 Kelvin to about 25 Kelvin, between about 10\hat{ }-3 Kelvin to about 50 Kelvin, between about 10\hat{ }-3 Kelvin to about 100 Kelvin, between about 10\hat{ }-3 Kelvin to about 200 Kelvin, between about 10\hat{ }-3 Kelvin to about 300 Kelvin, between about 10\hat{ }-3 Kelvin to about 10\hat{ }3 Kelvin, between about 1 Kelvin to about 5 Kelvin, between about 1 Kelvin to about 10 Kelvin, between about 1 Kelvin to about 25 Kelvin, between about 1 Kelvin to about 50 Kelvin, between about 1 Kelvin to about 100 Kelvin, between about 1 Kelvin to about 200 Kelvin, between about 1 Kelvin to about 300 Kelvin, between about 1 Kelvin to about 10\hat{ }3 Kelvin, between about 5 Kelvin to about 10 Kelvin, between about 5 Kelvin to about 25 Kelvin, between about 5 Kelvin to about 50 Kelvin, between about 5 Kelvin to about 100 Kelvin, between about 5 Kelvin to about 200 Kelvin, between about 5 Kelvin to about 300 Kelvin, between about 5 Kelvin to about 10\hat{ }3 Kelvin, between about 10 Kelvin to about 25 Kelvin, between about 10 Kelvin to about 50 Kelvin, between about 10 Kelvin to about 100 Kelvin, between about 10 Kelvin to about 200 Kelvin, between about 10 Kelvin to about 300 Kelvin, between about 10 Kelvin to about 10\hat{ }3 Kelvin, between about 25 Kelvin to about 50 Kelvin, between about 25 Kelvin to about 100 Kelvin, between about 25 Kelvin to about 200 Kelvin, between about 25 Kelvin to about 300 Kelvin, between about 25 Kelvin to about 10\hat{ }3 Kelvin, between about 50 Kelvin to about 100 Kelvin, between about 50 Kelvin to about 200 Kelvin, between about 50 Kelvin to about 300 Kelvin, between about 50 Kelvin to about 10\hat{ }3 Kelvin, between about 100 Kelvin to about 200 Kelvin, between about 100 Kelvin to about 300 Kelvin, between about 100 Kelvin to about 10\hat{ }3 Kelvin, between about 200 Kelvin to about 300 Kelvin, between about 200 Kelvin to about 10\hat{ }3 Kelvin, or between about 300 Kelvin to about 10\hat{ }3 Kelvin. In some embodiments, the cavity comprises a thermal reservoir with a temperature of about 10\hat{ }-3 Kelvin, about 1 Kelvin, about 5 Kelvin, about 10 Kelvin, about 25 Kelvin, about 50 Kelvin, about 75 Kelvin, about 100 Kelvin, about 150 Kelvin, about 200 Kelvin, about 300 Kelvin, or about 10\hat{ }3 Kelvin, including increments therein.

In some embodiments, the electromagnetic wave comprises a transverse magnetic wave with a polar mode number of N1 and an azimuthal mode number of N2, where N1 and N2 are an integers from 0 to 1000, and N1 is greater than or equal to N2. In some embodiments, the electromagnetic wave comprises a transverse magnetic wave with a polar mode number of N and an azimuthal mode number of 0, where N is an integer from 0 to 1000. In some embodiments, the electromagnetic wave comprises a transverse magnetic wave with a polar mode number of N and an azimuthal mode number of N, where N is an integer from 0 to 1000. In some embodiments, the electromagnetic wave comprises a transverse electric wave with a polar mode number of N1 and an azimuthal mode number of N2, where N1 and N2 are an integers from 0 to 1000, and N1 is greater than or equal to N2. In some embodiments, the electromagnetic wave comprises a transverse electric wave with a polar mode number of N and an azimuthal mode number of 0, where N is an integer from 0 to 1000.

In some embodiments, the electromagnetic wave comprises a transverse electric wave with a polar mode number of N and an azimuthal mode number of N, where N is an integer from 0 to 1000.

In some embodiments, the electromagnetic radiation source is located inside the cavity at, or adjacent to, a maximum field amplitude or an asymptotic field amplitude of the electromagnetic wave.

In some embodiments, the cavity has at least one of a width and a height between about 10\hat{ }-9 meters to about 10\hat{ }3 meters. In some embodiments, the cavity has at least one of a width and a height of at least about 10\hat{ }-9 meters. In some embodiments, the cavity has at least one of a width and a height of at most about 10\hat{ }3 meters. In some embodiments, the cavity has at least one of a width and a height between about 10\hat{ }-9 meters to about 10\hat{ }-6 meters, between about 10\hat{ }-9 meters to about 10\hat{ }-3 meters, between about 10\hat{ }-9 meters to about 10\hat{ }-2 meters, between about 10\hat{ }-9 meters to about 10\hat{ }-1 meters, between about 10\hat{ }-9 meters to about 1.0 meter, between about 10\hat{ }-9 meters to about 10\hat{ }3 meters, between about 10\hat{ }-6 meters to about 10\hat{ }-3 meters, between about 10\hat{ }-6 meters to about 10\hat{ }-2 meters, between about 10\hat{ }-6 meters to about 10\hat{ }-1 meters, between about 10\hat{ }-6 meters to about 1.0 meter, between about 10\hat{ }-6 meters to about 10\hat{ }3 meters, between about 10\hat{ }-3 meters to about 10\hat{ }-2 meters, between about 10\hat{ }-3 meters to about 10\hat{ }-1 meters, between about 10\hat{ }-3 meters to about 1.0 meter, between about 10\hat{ }-3 meters to about 10\hat{ }3 meters, between about 10\hat{ }-2 meters to about 10\hat{ }-1 meters, between about 10\hat{ }-2 meters to about 1.0 meter, between about 10\hat{ }-2 meters to about 10\hat{ }3 meters, between about 10\hat{ }-1 meters to about 1.0 meter, between about 10\hat{ }-1 meters to about 10\hat{ }3 meters, or between about 1.0 meter to about 10\hat{ }3 meters. In some embodiments, the cavity has at least one of a width and a height of about 10\hat{ }-9 meters, about 10\hat{ }-6 meters, about 10\hat{ }-3 meters, about 10\hat{ }-2 meters, about 10\hat{ }-1 meters, about 1.0 meter, or about 10\hat{ }3 meters, including increments therein.

In some embodiments, two or more of the at least three tapered interior surfaces form an aperture angle between about 5 degrees to about 175 degrees. In some embodiments, two or more of the at least three tapered interior surfaces form an aperture angle of at least about 5 degrees. In some embodiments, two or more of the at least three tapered interior surfaces form an aperture angle of at most about 175 degrees. In some embodiments, two or more of the at least three tapered interior surfaces form an aperture angle between about 5 degrees to about 10 degrees, between about 5 degrees to about 20 degrees, between about 5 degrees to about 40 degrees, between about 5 degrees to about 60 degrees, between about 5 degrees to about 80 degrees, between about 5 degrees to about 100 degrees, between about 5 degrees to about 120 degrees, between about 5 degrees to about 140 degrees, between about 5 degrees to about 160 degrees, between about 5 degrees to about 175 degrees, between about 10 degrees to about 20 degrees, between about 10 degrees to about 40 degrees, between about 10 degrees to about 60 degrees, between about 10 degrees to about 80 degrees, between about 10 degrees to about 100 degrees, between about 10 degrees to about 120 degrees, between about 10 degrees to about 140 degrees, between about 10 degrees to about 160 degrees, between about 10 degrees to about 175 degrees, between about 20 degrees to about 40 degrees, between about 20 degrees to about 60 degrees, between about 20 degrees to about 80 degrees, between about 20 degrees to about 100 degrees, between about 20 degrees to about 120 degrees, between about 20 degrees to about 140 degrees, between about 20 degrees to about 160 degrees, between about 20 degrees to about 175 degrees, between about 40 degrees to about 60 degrees, between about 40 degrees to about 80 degrees, between about 40 degrees to about 100 degrees, between about 40 degrees to about 120 degrees, between about 40 degrees to about 140 degrees, between about 40 degrees to about 160 degrees, between about 40 degrees to about 175 degrees, between about 60 degrees to about 80 degrees, between about 60 degrees to about 100 degrees, between about 60 degrees to about 120 degrees, between about 60 degrees to about 140 degrees, between about 60 degrees to about 160 degrees, between about 60 degrees to about 175 degrees, between about 80 degrees to about 100 degrees, between about 80 degrees to about 120 degrees, between about 80 degrees to about 140 degrees, between about 80 degrees to about 160 degrees, between about 80 degrees to about 175 degrees, between about 100 degrees to about 120 degrees, between about 100 degrees to about 140 degrees, between about 100 degrees to about 160 degrees, between about 100 degrees to about 175 degrees, between about 120 degrees to about 140 degrees, between about 120 degrees to about 160 degrees, between about 120 degrees to about 175 degrees, between about 140 degrees to about 160 degrees, between about 140 degrees to about 175 degrees, or between about 160 degrees to about 175 degrees. In some embodiments, two or more of the at least three tapered interior surfaces form an aperture angle of about 5 degrees, about 10 degrees, about 20 degrees, about 40 degrees, about 60 degrees, about 80 degrees, about 100 degrees, about 120 degrees, about 140 degrees, about 160 degrees, or about 175 degrees, including increments therein.

In some embodiments, the cavity has a wall with a wall thickness between about 10\hat{ }-9 meters to about 1.0 meter. In some embodiments, the cavity has a wall with a wall thickness of at least about 10\hat{ }-9 meters. In some embodiments, the cavity has a wall with a wall thickness of at most about 1.0 meter. In some embodiments, the cavity has a wall with a wall thickness between about 10\hat{ }-9 meters to about 10\hat{ }-6 meters, between about 10\hat{ }-9 meters to about 10\hat{ }-5 meters, between about 10\hat{ }-9 meters to about 10\hat{ }-4 meters, between about 10\hat{ }-9 meters to about 10\hat{ }-3 meters, between about 10\hat{ }-9 meters to about 1.0 meter, between about 10\hat{ }-6 meters to about 10\hat{ }-5 meters, between about 10\hat{ }-6 meters to about 10\hat{ }-4 meters, between about 10\hat{ }-6 meters to about 10\hat{ }-3 meters, between about 10\hat{ }-6 meters to about 1.0 meter, between about 10\hat{ }-5 meters to about 10\hat{ }-4 meters, between about 10\hat{ }-5 meters to about 10\hat{ }-3 meters, between about 10\hat{ }-5 meters to about 1.0 meter, between about 10\hat{ }-4 meters to about 10\hat{ }-3 meters, between about 10\hat{ }-4 meters to about 1.0 meter, or between about 10\hat{ }-3 meters to about 1.0 meter. In some embodiments, the cavity has a wall with a wall thickness of about 10\hat{ }-9 meters, about 10\hat{ }-6 meters, about 10\hat{ }-5 meters, about 10\hat{ }-4 meters, about 10\hat{ }-3 meters, or about 1.0 meter, including increments therein.

In some embodiments, the base interior surface of the cavity comprises 3, 4, 5, 6, 7, 8, 9, 10, 11, 12, 13, 14, 15, 16, 17, 18, 19, 20, 21, 22, 23, or 24 sides. In some embodiments, the base interior surface of the cavity is substantially equilateral. In some embodiments, the base interior surface is substantially flat.

In some embodiments, the electromagnetic wave forms an electromagnetic energy momentum tensor with an amplitude maximum at, or adjacent to, the base interior surface, which results in one or more of a metric tensor curvature, a thrust, and an acceleration of the thruster. In some embodiments, the electromagnetic wave forms an electromagnetic energy momentum tensor with an amplitude maximum at, or adjacent to, one or more of the at least three tapered interior surfaces and the apex point, which results in one or more of a metric tensor curvature, a thrust, and an acceleration of the thruster.

Another embodiment includes an electromagnetic energy momentum thruster comprising: a cavity resonator forming a pyramidal cavity having a base interior surface, at least three tapered interior surfaces, and a truncated interior surface opposing the base interior surface, the tapered interior surfaces being between the base and truncated interior surfaces; and an electromagnetic radiation source in communication with the cavity resonator, the electromagnetic radiation source configured to emit an electromagnetic wave having a frequency between about 1.0 MHz to about 1000 THz into the cavity resonator.

In some embodiments, the electromagnetic radiation source is configured to emit an electromagnetic wave into the cavity resonator having a frequency between about 10\hat{ }0 MHz to about 10\hat{ }9 MHz. In some embodiments, the electromagnetic radiation source is configured to emit an electromagnetic wave into the cavity resonator having a frequency of at least about 10\hat{ }0 MHz. In some embodiments, the electromagnetic radiation source is configured to emit an electromagnetic wave into the cavity resonator having a frequency of at most about 10\hat{ }9 MHz. In some embodiments, the electromagnetic radiation source is configured to emit an electromagnetic wave into the cavity resonator having a frequency between about 10\hat{ }0 MHz to about 10\hat{ }1 MHz, between about 10\hat{ }0 MHz to about 10\hat{ }2 MHz, between about 10\hat{ }0 MHz to about 10\hat{ }3 MHz, between about 10\hat{ }0 MHz to about 10\hat{ }4 MHz, between about 10\hat{ }0 MHz to about 10\hat{ }5 MHz, between about 10\hat{ }0 MHz to about 10\hat{ }6 MHz, between about 10\hat{ }0 MHz to about 10\hat{ }7 MHz, between about 10\hat{ }0 MHz to about 10\hat{ }8 MHz, between about 10\hat{ }0 MHz to about 10\hat{ }9 MHz, between about 10\hat{ }1 MHz to about 10\hat{ }2 MHz, between about 10\hat{ }1 MHz to about 10\hat{ }3 MHz, between about 10\hat{ }1 MHz to about 10\hat{ }4 MHz, between about 10\hat{ }1 MHz to about 10\hat{ }5 MHz, between about 10\hat{ }1 MHz to about 10\hat{ }6 MHz, between about 10\hat{ }1 MHz to about 10\hat{ }7 MHz, between about 10\hat{ }1 MHz to about 10\hat{ }8 MHz, between about 10\hat{ }1 MHz to about 10\hat{ }9 MHz, between about 10\hat{ }2 MHz to about 10\hat{ }3 MHz, between about 10\hat{ }2 MHz to about 10\hat{ }4 MHz, between about 10\hat{ }2 MHz to about 10\hat{ }5 MHz, between about 10\hat{ }2 MHz to about 10\hat{ }6 MHz, between about 10\hat{ }2 MHz to about 10\hat{ }7 MHz, between about 10\hat{ }2 MHz to about 10\hat{ }8 MHz, between about 10\hat{ }2 MHz to about 10\hat{ }9 MHz, between about 10\hat{ }3 MHz to about 10\hat{ }4 MHz, between about 10\hat{ }3 MHz to about 10\hat{ }5 MHz, between about 10\hat{ }3 MHz to about 10\hat{ }6 MHz, between about 10\hat{ }3 MHz to about 10\hat{ }7 MHz, between about 10\hat{ }3 MHz to about 10\hat{ }8 MHz, between about 10\hat{ }3 MHz to about 10\hat{ }9 MHz, between about 10\hat{ }4 MHz to about 10\hat{ }5 MHz, between about 10\hat{ }4 MHz to about 10\hat{ }6 MHz, between about 10\hat{ }4 MHz to about 10\hat{ }7 MHz, between about 10\hat{ }4 MHz to about 10\hat{ }8 MHz, between about 10\hat{ }4 MHz to about 10\hat{ }9 MHz, between about 10\hat{ }5 MHz to about 10\hat{ }6 MHz, between about 10\hat{ }5 MHz to about 10\hat{ }7 MHz, between about 10\hat{ }5 MHz to about 10\hat{ }8 MHz, between about 10\hat{ }5 MHz to about 10\hat{ }9 MHz, between about 10\hat{ }6 MHz to about 10\hat{ }7 MHz, between about 10\hat{ }6 MHz to about 10\hat{ }8 MHz, between about 10\hat{ }6 MHz to about 10\hat{ }9 MHz, between about 10\hat{ }7 MHz to about 10\hat{ }8 MHz, between about 10\hat{ }7 MHz to about 10\hat{ }9 MHz, or between about 10\hat{ }8 MHz to about 10\hat{ }9 MHz. In some embodiments, the electromagnetic radiation source is configured to emit an electromagnetic wave into the cavity resonator having a frequency of about 10\hat{ }0 MHz, about 10\hat{ }1 MHz, about 10\hat{ }2 MHz, about 10\hat{ }3 MHz, about 10\hat{ }4 MHz, about 10\hat{ }5 MHz, about 10\hat{ }6 MHz, about 10\hat{ }7 MHz, about 10\hat{ }8 MHz, or about 10\hat{ }9 MHz, including increments therein.

In some embodiments, the electromagnetic radiation source is configured to produce the frequency of the electromagnetic wave in evanescence so that the electromagnetic wave has a maximum field amplitude and an asymptotic field amplitude, the maximum field amplitude being at, or adjacent to, the base interior surface, the asymptotic field amplitude being at, or adjacent to, one or more of the at least three tapered interior surfaces and the truncated interior surface. In some embodiments, the electromagnetic radiation source is configured to produce the frequency of the electromagnetic wave in evanescence so that the electromagnetic wave has a maximum field amplitude and an asymptotic field amplitude, the maximum field amplitude being at, or adjacent to, one or more of the at least three tapered interior surfaces and the truncated interior surface, the asymptotic field amplitude being at, or adjacent to, the base interior surface.

In some embodiments, the cavity includes an overall interior surface that includes the base, tapered, and truncated interior surfaces, substantially the entire overall interior surface being electrically conductive, wherein the cavity resonator has a quality factor between about 10\hat{ }3 to about 10\hat{ }9. In some embodiments, the cavity resonator has a quality factor of at least about 10\hat{ }3. In some embodiments, the cavity resonator has a quality factor of at most about 10\hat{ }9. In some embodiments, the cavity resonator has a quality factor between about 10\hat{ }3 to about 10\hat{ }4, between about 10\hat{ }3 to about 10\hat{ }5, between about 10\hat{ }3 to about 10\hat{ }6, between about 10\hat{ }3 to about 10\hat{ }7, between about 10\hat{ }3 to about 10\hat{ }8, between about 10\hat{ }3 to about 10\hat{ }9, between about 10\hat{ }4 to about 10\hat{ }5, about 10\hat{ }4 to about 10\hat{ }6, about 10\hat{ }4 to about 10\hat{ }7, about 10\hat{ }4 to about 10\hat{ }8, about 10\hat{ }4 to about 10\hat{ }9, about 10\hat{ }5 to about 10\hat{ }6, about 10\hat{ }5 to about 10\hat{ }7, about 10\hat{ }5 to about 10\hat{ }8, about 10\hat{ }5 to about 10\hat{ }9, about 10\hat{ }6 to about 10\hat{ }7, about 10\hat{ }6 to about 10\hat{ }8, about 10\hat{ }6 to about 10\hat{ }9, about 10\hat{ }7 to about 10\hat{ }8, about 10\hat{ }7 to about 10\hat{ }9, or about 10\hat{ }8 to about 10\hat{ }9. In some embodiments, the cavity resonator has a quality factor of about 10\hat{ }3, about 10\hat{ }4, about 10\hat{ }5, about 10\hat{ }6, about 10\hat{ }7, about 10\hat{ }8, or about 10\hat{ }9, including increments therein.

In some embodiments, the overall interior surface comprises aluminum, antimony, arsenic, barium, beryllium, bismuth, cadmium, calcium, carbon, chromium, cobalt, copper, gallium, gold, hydrogen, indium, iron, lanthanum, lead, lithium, magnesium, manganese, mercury, molybdenum, nickel, niobium, nitrogen, oxygen, palladium, phosphorus, platinum, scandium, silicon, silver, strontium, sulfur, tantalum, technetium, tin, titanium, tungsten, vanadium, yttrium, zinc, zirconium, or any combination thereof.

In some embodiments, the cavity includes an overall interior surface that includes the base, tapered, and truncated interior surfaces, substantially the entire overall interior surface being superconductive, wherein the cavity resonator has a quality factor between about 10\hat{ }6 to about 10\hat{ }15. In some embodiments, the cavity resonator has a quality factor of at least about 10\hat{ }6. In some embodiments, the cavity resonator has a quality factor of at most about 10\hat{ }15. In some embodiments, the cavity resonator has a quality factor between about 10\hat{ }6 to about 10\hat{ }7, between about 10\hat{ }6 to about 10\hat{ }8, between about 10\hat{ }6 to about 10\hat{ }9, between about 10\hat{ }6 to about 10\hat{ }10, between about 10\hat{ }6 to about 10\hat{ }11, between about 10\hat{ }6 to about 10\hat{ }12, between about 10\hat{ }6 to about 10\hat{ }13, between about 10\hat{ }6 to about 10\hat{ }14, between about 10\hat{ }6 to about 10\hat{ }15, between about 10\hat{ }7 to about 10\hat{ }8, between about 10\hat{ }7 to about 10\hat{ }9, between about 10\hat{ }7 to about 10\hat{ }10, between about 10\hat{ }7 to about 10\hat{ }11, between about 10\hat{ }7 to about 10\hat{ }12, between about 10\hat{ }7 to about 10\hat{ }13, between about 10\hat{ }7 to about 10\hat{ }14, between about 10\hat{ }7 to about 10\hat{ }15, between about 10\hat{ }8 to about 10\hat{ }9, between about 10\hat{ }8 to about 10\hat{ }10, between about 10\hat{ }8 to about 10\hat{ }11, between about 10\hat{ }8 to about 10\hat{ }12, between about 10\hat{ }8 to about 10\hat{ }13, between about 10\hat{ }8 to about 10\hat{ }14, between about 10\hat{ }8 to about 10\hat{ }15, between about 10\hat{ }9 to about 10\hat{ }10, between about 10\hat{ }9 to about 10\hat{ }11, between about 10\hat{ }9 to about 10\hat{ }12, between about 10\hat{ }9 to about 10\hat{ }13, between about 10\hat{ }9 to about 10\hat{ }14, between about 10\hat{ }9 to about 10\hat{ }15, between about 10\hat{ }10 to about 10\hat{ }11, between about 10\hat{ }10 to about 10\hat{ }12, between about 10\hat{ }10 to about 10\hat{ }13, between about 10\hat{ }10 to about 10\hat{ }14, between about 10\hat{ }10 to about 10\hat{ }15, between about 10\hat{ }11 to about 10\hat{ }12, between about 10\hat{ }11 to about 10\hat{ }13, between about 10\hat{ }11 to about 10\hat{ }14, between about 10\hat{ }11 to about 10\hat{ }15, between about 10\hat{ }12 to about 10\hat{ }13, between about 10\hat{ }12 to about 10\hat{ }14, between about 10\hat{ }12 to about 10\hat{ }15, between about 10\hat{ }13 to about 10\hat{ }14, between about 10\hat{ }13 to about 10\hat{ }15, or between about 10\hat{ }14 to about 10\hat{ }15. In some embodiments, the cavity resonator has a quality factor of about 10\hat{ }6, about 10\hat{ }7, about 10\hat{ }8, about 10\hat{ }9, about 10\hat{ }10, about 10\hat{ }11, about 10\hat{ }12, about 10\hat{ }13, about 10\hat{ }14, or about 10\hat{ }15, including increments therein.

In some embodiments, the overall interior surface comprises aluminum, barium, beryllium, bismuth, cadmium, calcium, copper, gallium, gadolinium, germanium, lanthanum, lead, lithium, indium, mercury, molybdenum, niobium, nitrogen, osmium, oxygen, protactinium, rhenium, ruthenium, silicon, strontium, sulfur, tantalum, technetium, thallium, thorium, titanium, tin, vanadium, yttrium, zinc, zirconium, NbTi, PbMoS, V₃Ga, NbN, V₃Si, Nb₃Sn, Nb₃Al, Nb₃(AlGe), Nb₃Ge, Bi₂Sr₂CuO₆, Bi₂Sr₂CaCu₂O₈, Bi₂Sr₂Ca₂Cu₃O₁₀, YBa₂Cu₃O₇, YBa₂Cu₄O₈, Y₂Ba₄Cu₇O₁₅, Y₃Ba₅Cu₈O₁₈, Tl₂Ba₂CuO₆, Tl₂Ba₂CaCu₂O₈, Tl₂Ba₂Ca₂Cu₃O₁₀, TlBa₂Ca₃Cu₄O₁₁, HgBa₂CuO₄, HgBa₂CaCu₂O₆, HgBa₂Ca₂Cu₃O₈, or any combination thereof.

In some embodiments, the cavity is empty. In some embodiments, the cavity comprises a vacuum with a pressure between about 10\hat{ }-24 Torr to about 10\hat{ }3 Torr. In some embodiments, the cavity comprises a vacuum with a pressure of at least about 10\hat{ }-24 Torr. In some embodiments, the cavity comprises a vacuum with a pressure of at most about 10\hat{ }3 Torr. In some embodiments, the cavity comprises a vacuum with a pressure between about 10\hat{ }-24 Torr to about 10\hat{ }-21 Torr, between about 10\hat{ }-24 Torr to about 10\hat{ }-18 Torr, between about 10\hat{ }-24 Torr to about 10\hat{ }-15 Torr, between about 10\hat{ }-24 Torr to about 10\hat{ }-12 Torr, between about 10\hat{ }-24 Torr to about 10\hat{ }-9 Torr, between about 10\hat{ }-24 Torr to about 10\hat{ }-6 Torr, between about 10\hat{ }-24 Torr to about 10\hat{ }-3 Torr, between about 10\hat{ }-24 Torr to about 1.0 Torr, between about 10\hat{ }-24 Torr to about 10\hat{ }3 Torr, between about 10\hat{ }-21 Torr to about 10\hat{ }-18 Torr, between about 10\hat{ }-21 Torr to about 10\hat{ }-15 Torr, between about 10\hat{ }-21 Torr to about 10\hat{ }-12 Torr, between about 10\hat{ }-21 Torr to about 10\hat{ }-9 Torr, between about 10\hat{ }-21 Torr to about 10\hat{ }-6 Torr, between about 10\hat{ }-21 Torr to about 10\hat{ }-3 Torr, between about 10\hat{ }-21 Torr to about 1.0 Torr, between about 10\hat{ }-21 Torr to about 10\hat{ }3 Torr, between about 10\hat{ }-18 Torr to about 10\hat{ }-15 Torr, between about 10\hat{ }-18 Torr to about 10\hat{ }-12 Torr, between about 10\hat{ }-18 Torr to about 10\hat{ }-9 Torr, between about 10\hat{ }-18 Torr to about 10\hat{ }-6 Torr, between about 10\hat{ }-18 Torr to about 10\hat{ }-3 Torr, between about 10\hat{ }-18 Torr to about 1.0 Torr, between about 10\hat{ }-18 Torr to about 10\hat{ }3 Torr, between about 10\hat{ }-15 Torr to about 10\hat{ }-12 Torr, between about 10\hat{ }-15 Torr to about 10\hat{ }-9 Torr, between about 10\hat{ }-15 Torr to about 10\hat{ }-6 Torr, between about 10\hat{ }-15 Torr to about 10\hat{ }-3 Torr, between about 10\hat{ }-15 Torr to about 1.0 Torr, between about 10\hat{ }-15 Torr to about 10\hat{ }3 Torr, between about 10\hat{ }-12 Torr to about 10\hat{ }-9 Torr, between about 10\hat{ }-12 Torr to about 10\hat{ }-6 Torr, between about 10\hat{ }-12 Torr to about 10\hat{ }-3 Torr, between about 10\hat{ }-12 Torr to about 1.0 Torr, between about 10\hat{ }-12 Torr to about 10\hat{ }3 Torr, between about 10\hat{ }-9 Torr to about 10\hat{ }-6 Torr, between about 10\hat{ }-9 Torr to about 10\hat{ }-3 Torr, between about 10\hat{ }-9 Torr to about 1.0 Torr, between about 10\hat{ }-9 Torr to about 10\hat{ }3 Torr, between about 10\hat{ }-6 Torr to about 10\hat{ }-3 Torr, between about 10\hat{ }-6 Torr to about 1.0 Torr, between about 10\hat{ }-6 Torr to about 10\hat{ }3 Torr, between about 10\hat{ }-3 Torr to about 1.0 Torr, between about 10\hat{ }-3 Torr to about 10\hat{ }3 Torr, or between about 1.0 Torr to about 10\hat{ }3 Torr. In some embodiments, the cavity comprises a vacuum with a pressure of about 10\hat{ }-24 Torr, about 10\hat{ }-21 Torr, about 10\hat{ }-18 Torr, about 10\hat{ }-15 Torr, about 10\hat{ }-12 Torr, about 10\hat{ }-9 Torr, about 10\hat{ }-6 Torr, about 10\hat{ }-3 Torr, about 1.0 Torr, or about 10\hat{ }3 Torr, including increments therein.

In some embodiments, the cavity comprises a thermal reservoir with a temperature between about 10\hat{ }-3 Kelvin about 10\hat{ }3 Kelvin. In some embodiments, the cavity comprises a thermal reservoir with a temperature of at least about 10\hat{ }-3 Kelvin. In some embodiments, the cavity comprises a thermal reservoir with a temperature of at most about 10\hat{ }3 Kelvin. In some embodiments, the cavity comprises a thermal reservoir with a temperature between about 10\hat{ }-3 Kelvin to about 1 Kelvin, between about 10\hat{ }-3 Kelvin to about 5 Kelvin, between about 10\hat{ }-3 Kelvin to about 10 Kelvin, between about 10\hat{ }-3 Kelvin to about 25 Kelvin, between about 10\hat{ }-3 Kelvin to about 50 Kelvin, between about 10\hat{ }-3 Kelvin to about 100 Kelvin, between about 10\hat{ }-3 Kelvin to about 200 Kelvin, between about 10\hat{ }-3 Kelvin to about 300 Kelvin, between about 10\hat{ }-3 Kelvin to about 10\hat{ }3 Kelvin, between about 1 Kelvin to about 5 Kelvin, between about 1 Kelvin to about 10 Kelvin, between about 1 Kelvin to about 25 Kelvin, between about 1 Kelvin to about 50 Kelvin, between about 1 Kelvin to about 100 Kelvin, between about 1 Kelvin to about 200 Kelvin, between about 1 Kelvin to about 300 Kelvin, between about 1 Kelvin to about 10\hat{ }3 Kelvin, between about 5 Kelvin to about 10 Kelvin, between about 5 Kelvin to about 25 Kelvin, between about 5 Kelvin to about 50 Kelvin, between about 5 Kelvin to about 100 Kelvin, between about 5 Kelvin to about 200 Kelvin, between about 5 Kelvin to about 300 Kelvin, between about 5 Kelvin to about 10\hat{ }3 Kelvin, between about 10 Kelvin to about 25 Kelvin, between about 10 Kelvin to about 50 Kelvin, between about 10 Kelvin to about 100 Kelvin, between about 10 Kelvin to about 200 Kelvin, between about 10 Kelvin to about 300 Kelvin, between about 10 Kelvin to about 10\hat{ }3 Kelvin, between about 25 Kelvin to about 50 Kelvin, between about 25 Kelvin to about 100 Kelvin, between about 25 Kelvin to about 200 Kelvin, between about 25 Kelvin to about 300 Kelvin, between about 25 Kelvin to about 10\hat{ }3 Kelvin, between about 50 Kelvin to about 100 Kelvin, between about 50 Kelvin to about 200 Kelvin, between about 50 Kelvin to about 300 Kelvin, between about 50 Kelvin to about 10\hat{ }3 Kelvin, between about 100 Kelvin to about 200 Kelvin, between about 100 Kelvin to about 300 Kelvin, between about 100 Kelvin to about 10\hat{ }3 Kelvin, between about 200 Kelvin to about 300 Kelvin, between about 200 Kelvin to about 10\hat{ }3 Kelvin, or between about 300 Kelvin to about 10\hat{ }3 Kelvin. In some embodiments, the cavity comprises a thermal reservoir with a temperature of about 10\hat{ }-3 Kelvin, about 1 Kelvin, about 5 Kelvin, about 10 Kelvin, about 25 Kelvin, about 50 Kelvin, about 75 Kelvin, about 100 Kelvin, about 150 Kelvin, about 200 Kelvin, about 300 Kelvin, or about 10\hat{ }3 Kelvin, including increments therein.

In some embodiments, the electromagnetic wave comprises a transverse magnetic wave with a polar mode number of N1 and an azimuthal mode number of N2, where N1 and N2 are an integers from 0 to 1000, and N1 is greater than or equal to N2. In some embodiments, the electromagnetic wave comprises a transverse magnetic wave with a polar mode number of N and an azimuthal mode number of 0, where N is an integer from 0 to 1000. In some embodiments, the electromagnetic wave comprises a transverse magnetic wave with a polar mode number of N and an azimuthal mode number of N, where N is an integer from 0 to 1000. In some embodiments, the electromagnetic wave comprises a transverse electric wave with a polar mode number of N1 and an azimuthal mode number of N2, where N1 and N2 are an integers from 0 to 1000, and N1 is greater than or equal to N2. In some embodiments, the electromagnetic wave comprises a transverse electric wave with a polar mode number of N and an azimuthal mode number of 0, where N is an integer from 0 to 1000. In some embodiments, the electromagnetic wave comprises a transverse electric wave with a polar mode number of N and an azimuthal mode number of N, where N is an integer from 0 to 1000.

In some embodiments, the electromagnetic radiation source is located inside the cavity at, or adjacent to, a maximum field amplitude or an asymptotic field amplitude of the electromagnetic wave.

In some embodiments, the cavity has at least one of a width and a height between about 10\hat{ }-9 meters to about 10\hat{ }3 meters. In some embodiments, the cavity has at least one of a width and a height of at least about 10\hat{ }-9 meters. In some embodiments, the cavity has at least one of a width and a height of at most about 10\hat{ }3 meters. In some embodiments, the cavity has at least one of a width and a height between about 10\hat{ }-9 meters to about 10\hat{ }-6 meters, between about 10\hat{ }-9 meters to about 10\hat{ }-3 meters, between about 10\hat{ }-9 meters to about 10\hat{ }-2 meters, between about 10\hat{ }-9 meters to about 10\hat{ }-1 meters, between about 10\hat{ }-9 meters to about 1.0 meter, between about 10\hat{ }-9 meters to about 10\hat{ }3 meters, between about 10\hat{ }-6 meters to about 10\hat{ }-3 meters, between about 10\hat{ }-6 meters to about 10\hat{ }-2 meters, between about 10\hat{ }-6 meters to about 10\hat{ }-1 meters, between about 10\hat{ }-6 meters to about 1.0 meter, between about 10\hat{ }-6 meters to about 10\hat{ }3 meters, between about 10\hat{ }-3 meters to about 10\hat{ }-2 meters, between about 10\hat{ }-3 meters to about 10\hat{ }-1 meters, between about 10\hat{ }-3 meters to about 1.0 meter, between about 10\hat{ }-3 meters to about 10\hat{ }3 meters, between about 10\hat{ }-2 meters to about 10\hat{ }-1 meters, between about 10\hat{ }-2 meters to about 1.0 meter, between about 10\hat{ }-2 meters to about 10\hat{ }3 meters, between about 10\hat{ }-1 meters to about 1.0 meter, between about 10\hat{ }-1 meters to about 10\hat{ }3 meters, or between about 1.0 meter to about 10\hat{ }3 meters. In some embodiments, the cavity has at least one of a width and a height of about 10\hat{ }-9 meters, about 10\hat{ }-6 meters, about 10\hat{ }-3 meters, about 10\hat{ }-2 meters, about 10\hat{ }-1 meters, about 1.0 meter, or about 10\hat{ }3 meters, including increments therein.

In some embodiments, two or more of the at least three tapered interior surfaces form an aperture angle between about 5 degrees to about 175 degrees. In some embodiments, two or more of the at least three tapered interior surfaces form an aperture angle of at least about 5 degrees. In some embodiments, two or more of the at least three tapered interior surfaces form an aperture angle of at most about 175 degrees. In some embodiments, two or more of the at least three tapered interior surfaces form an aperture angle between about 5 degrees to about 10 degrees, between about 5 degrees to about 20 degrees, between about 5 degrees to about 40 degrees, between about 5 degrees to about 60 degrees, between about 5 degrees to about 80 degrees, between about 5 degrees to about 100 degrees, between about 5 degrees to about 120 degrees, between about 5 degrees to about 140 degrees, between about 5 degrees to about 160 degrees, between about 5 degrees to about 175 degrees, between about 10 degrees to about 20 degrees, between about 10 degrees to about 40 degrees, between about 10 degrees to about 60 degrees, between about 10 degrees to about 80 degrees, between about 10 degrees to about 100 degrees, between about 10 degrees to about 120 degrees, between about 10 degrees to about 140 degrees, between about 10 degrees to about 160 degrees, between about 10 degrees to about 175 degrees, between about 20 degrees to about 40 degrees, between about 20 degrees to about 60 degrees, between about 20 degrees to about 80 degrees, between about 20 degrees to about 100 degrees, between about 20 degrees to about 120 degrees, between about 20 degrees to about 140 degrees, between about 20 degrees to about 160 degrees, between about 20 degrees to about 175 degrees, between about 40 degrees to about 60 degrees, between about 40 degrees to about 80 degrees, between about 40 degrees to about 100 degrees, between about 40 degrees to about 120 degrees, between about 40 degrees to about 140 degrees, between about 40 degrees to about 160 degrees, between about 40 degrees to about 175 degrees, between about 60 degrees to about 80 degrees, between about 60 degrees to about 100 degrees, between about 60 degrees to about 120 degrees, between about 60 degrees to about 140 degrees, between about 60 degrees to about 160 degrees, between about 60 degrees to about 175 degrees, between about 80 degrees to about 100 degrees, between about 80 degrees to about 120 degrees, between about 80 degrees to about 140 degrees, between about 80 degrees to about 160 degrees, between about 80 degrees to about 175 degrees, between about 100 degrees to about 120 degrees, between about 100 degrees to about 140 degrees, between about 100 degrees to about 160 degrees, between about 100 degrees to about 175 degrees, between about 120 degrees to about 140 degrees, between about 120 degrees to about 160 degrees, between about 120 degrees to about 175 degrees, between about 140 degrees to about 160 degrees, between about 140 degrees to about 175 degrees, or between about 160 degrees to about 175 degrees. In some embodiments, two or more of the at least three tapered interior surfaces form an aperture angle of about 5 degrees, about 10 degrees, about 20 degrees, about 40 degrees, about 60 degrees, about 80 degrees, about 100 degrees, about 120 degrees, about 140 degrees, about 160 degrees, or about 175 degrees, including increments therein.

In some embodiments, the cavity has a wall with a wall thickness between about 10\hat{ }-9 meters to about 1.0 meter. In some embodiments, the cavity has a wall with a wall thickness of at least about 10\hat{ }-9 meters. In some embodiments, the cavity has a wall with a wall thickness of at most about 1.0 meter. In some embodiments, the cavity has a wall with a wall thickness between about 10\hat{ }-9 meters to about 10\hat{ }-6 meters, between about 10\hat{ }-9 meters to about 10\hat{ }-5 meters, between about 10\hat{ }-9 meters to about 10\hat{ }-4 meters, between about 10\hat{ }-9 meters to about 10\hat{ }-3 meters, between about 10\hat{ }-9 meters to about 1.0 meter, between about 10\hat{ }-6 meters to about 10\hat{ }-5 meters, between about 10\hat{ }-6 meters to about 10\hat{ }-4 meters, between about 10\hat{ }-6 meters to about 10\hat{ }-3 meters, between about 10\hat{ }-6 meters to about 1.0 meter, between about 10\hat{ }-5 meters to about 10\hat{ }-4 meters, between about 10\hat{ }-5 meters to about 10\hat{ }-3 meters, between about 10\hat{ }-5 meters to about 1.0 meter, between about 10\hat{ }-4 meters to about 10\hat{ }-3 meters, between about 10\hat{ }-4 meters to about 1.0 meter, or between about 10\hat{ }-3 meters to about 1.0 meter. In some embodiments, the cavity has a wall with a wall thickness of about 10\hat{ }-9 meters, about 10\hat{ }-6 meters, about 10\hat{ }-5 meters, about 10\hat{ }-4 meters, about 10\hat{ }-3 meters, or about 1.0 meter, including increments therein.

In some embodiments, one or both the base interior surface and the truncated interior surface of the cavity comprises 3, 4, 5, 6, 7, 8, 9, 10, 11, 12, 13, 14, 15, 16, 17, 18, 19, 20, 21, 22, 23, or 24 sides. In some embodiments, one or both the base interior surface and the truncated interior surface of the cavity is substantially equilateral. In some embodiments, one or both the base interior surface and the truncated interior surface of the cavity is substantially flat.

In some embodiments, the electromagnetic wave forms an electromagnetic energy momentum tensor with an amplitude maximum at, or adjacent to, the base interior surface, which results in one or more of a metric tensor curvature, a thrust, and an acceleration of the thruster. In some embodiments, the electromagnetic wave forms an electromagnetic energy momentum tensor with an amplitude maximum at, or adjacent to, one or more of the at least three tapered interior surfaces and the truncated interior surface, which results in one or more of a metric tensor curvature, a thrust, and an acceleration of the thruster.

### BRIEF DESCRIPTION OF THE DRAWINGS

Various novel features of the disclosure are set forth with particularity in the appended claims. A better understanding of the features and advantages of the present disclosure will be obtained by reference to the following detailed description that sets forth illustrative embodiments and the accompanying drawings.

FIG. 1 is an exemplary schematic diagram of a non-limiting electromagnetic energy momentum thruster.

FIG. 2 is an exemplary perspective view of a non-limiting conical cavity resonator.

FIG. 3 is an exemplary perspective cross section view of a non-limiting conical cavity resonator.

FIG. 4 is an exemplary perspective view of a non-limiting truncated conical cavity resonator.

FIG. 5 is an exemplary perspective cross section view of a non-limiting truncated conical cavity resonator.

FIG. 6 is an exemplary perspective view of a non-limiting pyramidal cavity resonator.

FIG. 7 is an exemplary perspective cross section view of a non-limiting pyramidal cavity resonator.

FIG. 8 is an exemplary perspective view of a non-limiting truncated pyramidal cavity resonator.

FIG. 9 is an exemplary perspective cross section view of a non-limiting truncated pyramidal cavity resonator.

FIG. 10 is an exemplary cross section view of a non-limiting tapered cavity resonator.

FIG. 11 is an exemplary cross section view of a non-limiting tapered cavity resonator comprising a substantially flat base interior surface.

FIG. 12 is an exemplary cross section view of a non-limiting tapered cavity resonator comprising a base radiation source.

FIG. 13 is an exemplary cross section view of a non-limiting tapered cavity resonator comprising a substantially flat base interior surface and a base radiation source.

FIG. 14 is an exemplary cross section view of a non-limiting tapered cavity resonator comprising a side radiation source.

FIG. 15 is an exemplary cross section view of a non-limiting tapered cavity comprising a substantially flat base interior surface and a side radiation source.

FIG. 16 is an exemplary cross section view of a non-limiting truncated tapered cavity resonator.

FIG. 17 is an exemplary cross section view of a non-limiting truncated tapered cavity resonator comprising a substantially flat base and truncated interior surfaces.

FIG. 18 is an exemplary cross section view of a non-limiting truncated tapered cavity resonator comprising a base radiation source.

FIG. 19 is an exemplary cross section view of a non-limiting truncated tapered cavity resonator comprising a substantially flat base and truncated interior surfaces, and a base radiation source.

FIG. 20 is an exemplary cross section view of a non-limiting truncated tapered cavity resonator comprising a side radiation source.

FIG. 21 is an exemplary cross section view of a non-limiting truncated tapered cavity resonator comprising a substantially flat base and truncated interior surfaces, and a side radiation source.

FIG. 22 is a non-limiting exemplary plot of a first azimuthal eigenfunction of a conical cavity resonator.

FIG. 23 is a non-limiting exemplary plot of a second azimuthal eigenfunction of a conical cavity resonator.

FIG. 24 is a non-limiting exemplary plot of a first transverse magnetic polar eigenfunction of a conical cavity resonator.

FIG. 25 is a non-limiting exemplary plot of a second transverse magnetic polar eigenfunction of a conical cavity resonator.

FIG. 26 is a non-limiting exemplary plot of a first transverse magnetic radial eigenfunction of a conical cavity resonator.

FIG. 27 is a non-limiting exemplary plot of a second transverse magnetic radial eigenfunction of a conical cavity resonator.

FIG. 28 is a non-limiting exemplary plot of a first transverse magnetic evanescent radial eigenfunction of a conical cavity resonator.

FIG. 29 is a non-limiting exemplary plot of a second transverse magnetic evanescent radial eigenfunction of a conical cavity resonator.

FIG. 30 is a non-limiting exemplary plot of a first transverse electric polar eigenfunction of a conical cavity resonator.

FIG. 31 is a non-limiting exemplary plot of a second transverse electric polar eigenfunction of a conical cavity resonator.

FIG. 32 is a non-limiting exemplary plot of a first transverse electric radial eigenfunction of a conical cavity resonator.

FIG. 33 is a non-limiting exemplary plot of a second transverse electric radial eigenfunction of a conical cavity resonator.

FIG. 34 is a non-limiting exemplary plot of a first transverse electric evanescent radial eigenfunction of a conical cavity resonator.

FIG. 35 is a non-limiting exemplary plot of a second transverse electric evanescent radial eigenfunction of a conical cavity resonator.

FIG. 36 is a non-limiting exemplary plot of a first azimuthal eigenfunction of a pyramidal cavity resonator.

FIG. 37 is a non-limiting exemplary plot of a second azimuthal eigenfunction of a pyramidal cavity resonator.

FIG. 38 is a non-limiting exemplary plot of a first transverse magnetic polar eigenfunction of a pyramidal cavity resonator.

FIG. 39 is a non-limiting exemplary plot of a second transverse magnetic polar eigenfunction of a pyramidal cavity resonator.

FIG. 40 is a non-limiting exemplary plot of a first transverse magnetic radial eigenfunction of a pyramidal cavity resonator.

FIG. 41 is a non-limiting exemplary plot of a second transverse magnetic radial eigenfunction of a pyramidal cavity resonator.

FIG. 42 is a non-limiting exemplary plot of a first transverse magnetic evanescent radial eigenfunction of a pyramidal cavity resonator.

FIG. 43 is a non-limiting exemplary plot of a second transverse magnetic evanescent radial eigenfunction of a pyramidal cavity resonator.

FIG. 44 is a non-limiting exemplary plot of a first transverse electric polar eigenfunction of a pyramidal cavity resonator.

FIG. 45 is a non-limiting exemplary plot of a second transverse electric polar eigenfunction of a pyramidal cavity resonator.

FIG. 46 is a non-limiting exemplary plot of a first transverse electric radial eigenfunction of a pyramidal cavity resonator.

FIG. 47 is a non-limiting exemplary plot of a second transverse electric radial eigenfunction of a pyramidal cavity resonator.

FIG. 48 is a non-limiting exemplary plot of a first transverse electric evanescent radial eigenfunction of a pyramidal cavity resonator.

FIG. 49 is a non-limiting exemplary plot of a second transverse electric evanescent radial eigenfunction of a pyramidal cavity resonator.

FIG. 50 is an exemplary perspective view of a first three-dimensional electric field vector plot of a non-limiting conical cavity resonator.

FIG. 51 is an exemplary perspective view of a first three-dimensional magnetic field vector plot of a non-limiting conical cavity resonator.

FIG. 52 is an exemplary axial cross section view of a first electric field density plot of a non-limiting conical cavity resonator.

FIG. 53 is an exemplary axial cross section view of a first magnetic field vector plot of a non-limiting conical cavity resonator.

FIG. 54 is an exemplary radial cross section view of a first electric field vector plot of a non-limiting conical cavity resonator.

FIG. 55 is an exemplary radial cross section view of a first electric field vector plot of a non-limiting conical cavity resonator comprising a substantially flat base interior surface.

FIG. 56 is an exemplary radial cross section view of a first magnetic field density plot of a non-limiting conical cavity resonator.

FIG. 57 is an exemplary radial cross section view of a first magnetic field density plot of a non-limiting conical cavity resonator comprising a substantially flat base interior surface.

FIG. 58 is an exemplary radial cross section view of a first electric field vector plot of a non-limiting truncated conical cavity resonator.

FIG. 59 is an exemplary radial cross section view of a first electric field vector plot of a non-limiting truncated conical cavity resonator comprising a substantially flat base and truncated interior surfaces.

FIG. 60 is an exemplary radial cross section view of a first magnetic field density plot of a non-limiting truncated conical cavity resonator.

FIG. 61 is an exemplary radial cross section view of a first magnetic field density plot of a non-limiting truncated conical cavity resonator comprising a substantially flat base and truncated interior surfaces.

FIG. 62 is an exemplary perspective view of a second three-dimensional electric field vector plot of a non-limiting conical cavity resonator.

FIG. 63 is an exemplary perspective view of a second three-dimensional magnetic field vector plot of a non-limiting conical cavity resonator.

FIG. 64 is an exemplary axial cross section view of a second electric field density plot of a non-limiting conical cavity resonator.

FIG. 65 is an exemplary axial cross section view of a second magnetic field vector plot of a non-limiting conical cavity resonator.

FIG. 66 is an exemplary radial cross section view of a second electric field vector plot of a non-limiting conical cavity resonator.

FIG. 67 is an exemplary radial cross section view of a second electric field vector plot of a non-limiting conical cavity resonator comprising a substantially flat base interior surface.

FIG. 68 is an exemplary radial cross section view of a second magnetic field density plot of a non-limiting conical cavity resonator.

FIG. 69 is an exemplary radial cross section view of a second magnetic field density plot of a non-limiting conical cavity resonator comprising a substantially flat base interior surface.

FIG. 70 is an exemplary radial cross section view of a second electric field vector plot of a non-limiting truncated conical cavity resonator.

FIG. 71 is an exemplary radial cross section view of a second electric field vector plot of a non-limiting truncated conical cavity resonator comprising a substantially flat base and truncated interior surfaces.

FIG. 72 is an exemplary radial cross section view of a second magnetic field density plot of a non-limiting truncated conical cavity resonator.

FIG. 73 is an exemplary radial cross section view of a second magnetic field density plot of a non-limiting truncated conical cavity resonator comprising a substantially flat base and truncated interior surfaces.

FIG. 74 is an exemplary perspective view of a third three-dimensional electric field vector plot of a non-limiting conical cavity resonator.

FIG. 75 is an exemplary perspective view of a third three-dimensional magnetic field vector plot of a non-limiting conical cavity resonator.

FIG. 76 is an exemplary axial cross section view of a third electric field vector plot of a non-limiting conical cavity resonator.

FIG. 77 is an exemplary axial cross section view of a third magnetic field vector plot of a non-limiting conical cavity resonator.

FIG. 78 is an exemplary radial cross section view of a third electric field vector plot of a non-limiting conical cavity resonator.

FIG. 79 is an exemplary radial cross section view of a third electric field vector plot of a non-limiting conical cavity resonator comprising a substantially flat base interior surface.

FIG. 80 is an exemplary radial cross section view of a third magnetic field vector plot of a non-limiting conical cavity resonator.

FIG. 81 is an exemplary radial cross section view of a third magnetic field vector plot of a non-limiting conical cavity resonator comprising a substantially flat base interior surface.

FIG. 82 is an exemplary radial cross section view of a third electric field vector plot of a non-limiting truncated conical cavity resonator.

FIG. 83 is an exemplary radial cross section view of a third electric field vector plot of a non-limiting truncated conical cavity resonator comprising a substantially flat base and truncated interior surfaces.

FIG. 84 is an exemplary radial cross section view of a third magnetic field vector plot of a non-limiting truncated conical cavity resonator.

FIG. 85 is an exemplary radial cross section view of a third magnetic field vector plot of a non-limiting truncated conical cavity resonator comprising a substantially flat base and truncated interior surfaces.

FIG. 86 is an exemplary perspective view of a first three-dimensional electric field vector plot of a non-limiting pyramidal cavity resonator.

FIG. 87 is an exemplary perspective view of a first three-dimensional magnetic field vector plot of a non-limiting pyramidal cavity resonator.

FIG. 88 is an exemplary axial cross section view of a first electric field density plot of a non-limiting pyramidal cavity resonator.

FIG. 89 is an exemplary axial cross section view of a first magnetic field vector plot of a non-limiting pyramidal cavity resonator.

FIG. 90 is an exemplary radial cross section view of a first electric field vector plot of a non-limiting pyramidal cavity resonator.

FIG. 91 is an exemplary radial cross section view of a first electric field vector plot of a non-limiting pyramidal cavity resonator comprising a substantially flat base interior surface.

FIG. 92 is an exemplary radial cross section view of a first magnetic field density plot of a non-limiting pyramidal cavity resonator.

FIG. 93 is an exemplary radial cross section view of a first magnetic field density plot of a non-limiting pyramidal cavity resonator comprising a substantially flat base interior surface.

FIG. 94 is an exemplary radial cross section view of a first electric field vector plot of a non-limiting truncated pyramidal cavity resonator.

FIG. 95 is an exemplary radial cross section view of a first electric field vector plot of a non-limiting truncated pyramidal cavity resonator comprising a substantially flat base and truncated interior surfaces.

FIG. 96 is an exemplary radial cross section view of a first magnetic field density plot of a non-limiting truncated pyramidal cavity resonator.

FIG. 97 is an exemplary radial cross section view of a first magnetic field density plot of a non-limiting truncated pyramidal cavity resonator comprising a substantially flat base and truncated interior surfaces.

FIG. 98 is an exemplary perspective view of a second three-dimensional electric field vector plot of a non-limiting pyramidal cavity resonator.

FIG. 99 is an exemplary perspective view of a second three-dimensional magnetic field vector plot of a non-limiting pyramidal cavity resonator.

FIG. 100 is an exemplary axial cross section view of a second electric field density plot of a non-limiting pyramidal cavity resonator.

FIG. 101 is an exemplary axial cross section view of a second magnetic field vector plot of a non-limiting pyramidal cavity resonator.

FIG. 102 is an exemplary radial cross section view of a second electric field vector plot of a non-limiting pyramidal cavity resonator.

FIG. 103 is an exemplary radial cross section view of a second electric field vector plot of a non-limiting pyramidal cavity resonator comprising a substantially flat base interior surface.

FIG. 104 is an exemplary radial cross section view of a second magnetic field density plot of a non-limiting pyramidal cavity resonator.

FIG. 105 is an exemplary radial cross section view of a second magnetic field density plot of a non-limiting pyramidal cavity resonator comprising a substantially flat base interior surface.

FIG. 106 is an exemplary radial cross section view of a second electric field vector plot of a non-limiting truncated pyramidal cavity resonator.

FIG. 107 is an exemplary radial cross section view of a second electric field vector plot of a non-limiting truncated pyramidal cavity resonator comprising a substantially flat base and truncated interior surfaces.

FIG. 108 is an exemplary radial cross section view of a second magnetic field density plot of a non-limiting truncated pyramidal cavity resonator.

FIG. 109 is an exemplary radial cross section view of a second magnetic field density plot of a non-limiting truncated pyramidal cavity resonator comprising a substantially flat base and truncated interior surfaces.

FIG. 110 is an exemplary perspective view of a third three-dimensional electric field vector plot of a non-limiting pyramidal cavity resonator.

FIG. 111 is an exemplary perspective view of a third three-dimensional magnetic field vector plot of a non-limiting pyramidal cavity resonator.

FIG. 112 is an exemplary axial cross section view of a third electric field density plot of a non-limiting pyramidal cavity resonator.

FIG. 113 is an exemplary axial cross section view of a third magnetic field vector plot of a non-limiting pyramidal cavity resonator.

FIG. 114 is an exemplary radial cross section view of a third electric field vector plot of a non-limiting pyramidal cavity resonator.

FIG. 115 is an exemplary radial cross section view of a third electric field vector plot of a non-limiting pyramidal cavity resonator comprising a substantially flat base interior surface.

FIG. 116 is an exemplary radial cross section view of a third magnetic field vector plot of a non-limiting pyramidal cavity resonator.

FIG. 117 is an exemplary radial cross section view of a third magnetic field vector plot of a non-limiting pyramidal cavity resonator comprising a substantially flat base interior surface.

FIG. 118 is an exemplary radial cross section view of a third electric field vector plot of a non-limiting truncated pyramidal cavity resonator.

FIG. 119 is an exemplary radial cross section view of a third electric field vector plot of a non-limiting truncated pyramidal cavity resonator comprising a substantially flat base and truncated interior surfaces.

FIG. 120 is an exemplary radial cross section view of a third magnetic field vector plot of a non-limiting truncated pyramidal cavity resonator.

FIG. 121 is an exemplary radial cross section view of a third magnetic field vector plot of a non-limiting truncated pyramidal cavity resonator comprising a substantially flat base and truncated interior surfaces.

FIG. 122 is an exemplary perspective view of a non-limiting environmental control apparatus.

FIG. 123 is an exemplary cross-section view of a non-limiting environmental control apparatus.

### DETAILED DESCRIPTION OF THE FIGURES

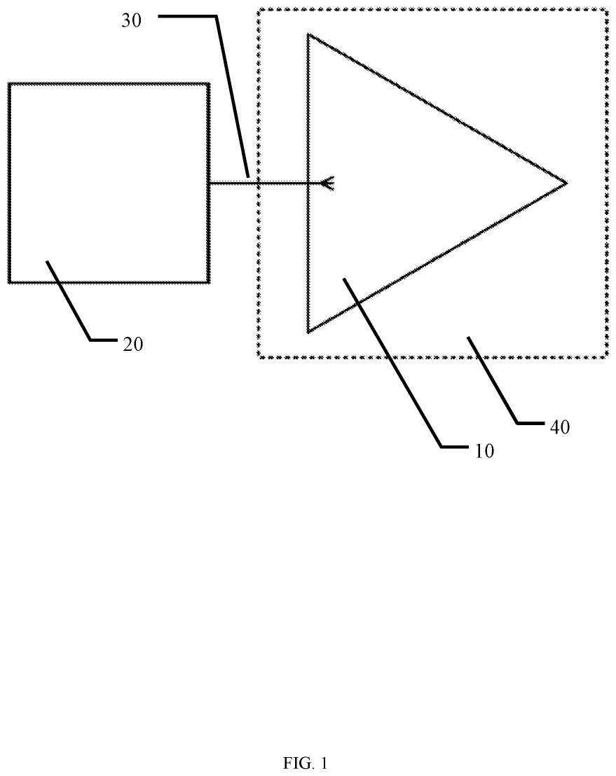

Disclosed herein, per FIG. 1, is an electromagnetic energy momentum thruster comprising a tapered cavity resonator 10 and an electromagnetic radiation source 20 in communication with the cavity resonator 10. In some embodiments, the electromagnetic radiation source 20 is configured to emit an electromagnetic wave into the cavity resonator 10. In some embodiments, the electromagnetic radiation source 20 is configured to emit an electromagnetic wave into the cavity resonator 10 via a transmission line 30. In some embodiments, the electromagnetic wave has a frequency between about 1.0 MHz to about 1000 THz. In some embodiments, the cavity resonator 10 is confined within an environmental control apparatus 40.

### Conical Cavity Resonator Thruster

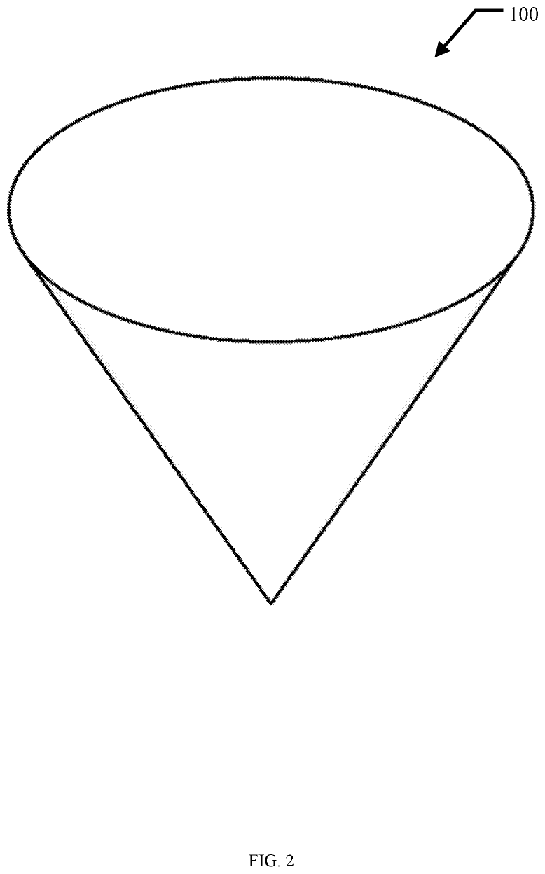

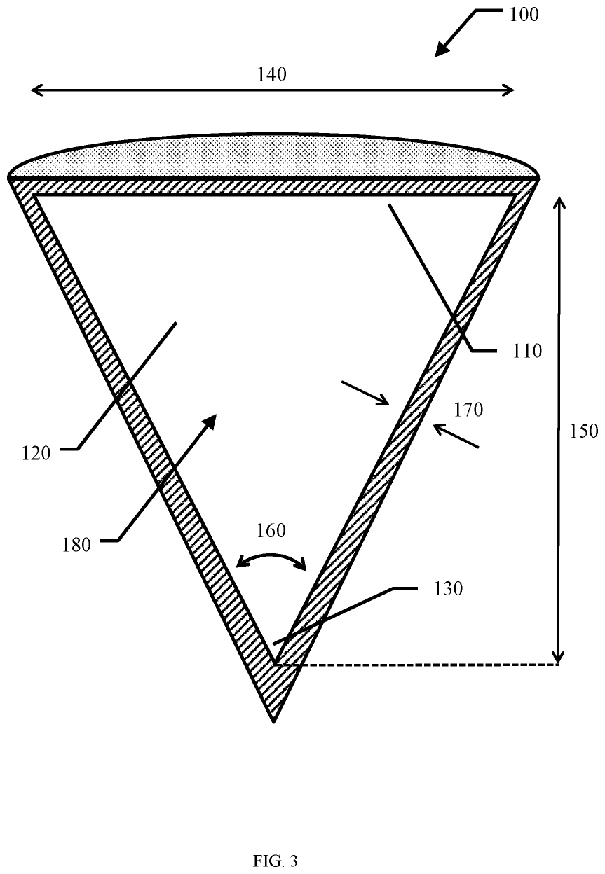

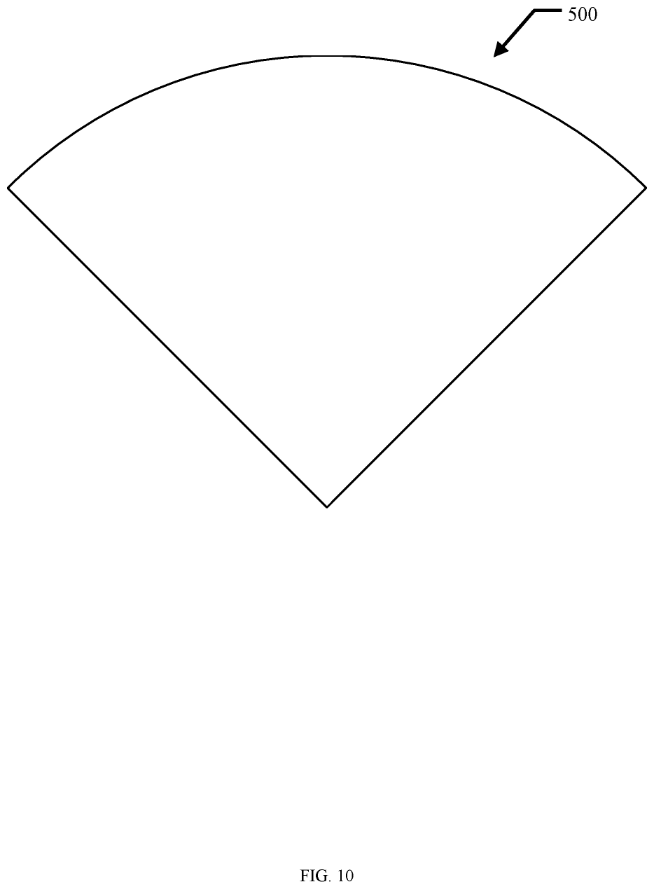

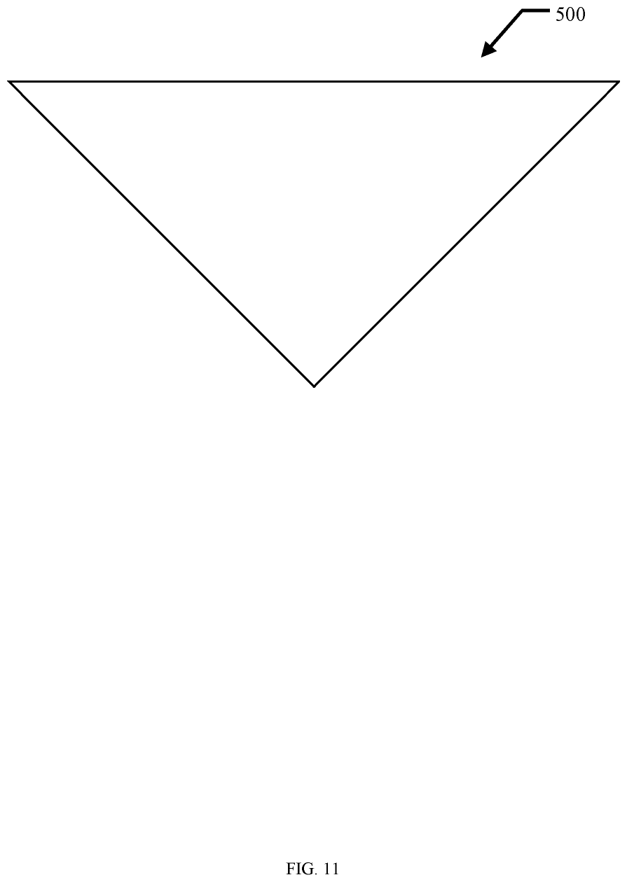

Provided herein per FIGS. 2, 3, and 10-15 is an electromagnetic energy momentum thruster comprising a conical cavity resonator 100 and a base electromagnetic radiation source 600a or a side electromagnetic radiation source 600b. In some embodiments, the cavity resonator 100 forms a cavity 180 having a base interior surface 110 and a tapered interior surface 120, wherein the tapered interior surface converges to an apex point 130.

In some embodiments, the base electromagnetic radiation source 600a is configured to emit an electromagnetic wave into the cavity 180 having a frequency between about 10\hat{ }0 MHz to about 10\hat{ }9 MHz. In some embodiments, the side electromagnetic radiation source 600b is configured to emit an electromagnetic wave into the cavity 180 having a frequency between about 10\hat{ }0 MHz to about 10\hat{ }9 MHz.

In some embodiments, the base electromagnetic radiation source 600a is configured to produce the frequency of the electromagnetic wave in evanescence, so that the electromagnetic wave has a maximum field amplitude and an asymptotic field amplitude. In some embodiments, the maximum field amplitude is at, or adjacent to, the base interior surface 110, and the asymptotic field amplitude is at, or adjacent to, one or both the tapered interior surface 120 and the apex point 130. In some embodiments, the side electromagnetic radiation source 600b is configured to produce the frequency of the electromagnetic wave in evanescence, so that the electromagnetic wave has a maximum field amplitude and an asymptotic field amplitude. In some embodiments, the maximum field amplitude is at, or adjacent to, one or both the tapered interior surface 120 and the apex point 130, and the asymptotic field amplitude is at, or adjacent to, the base interior surface 110.

In some embodiments, the cavity 180 includes an overall interior surface comprising the base interior surface 110 and the tapered interior surface 120. In some embodiments, substantially the entire overall interior surface of the cavity 180 is electrically conductive. In some embodiments, substantially the entire overall interior surface of the cavity 180 is superconductive. In some embodiments, substantially the entire overall interior surface of the cavity 180 is electrically conductive, and has a quality factor between about 10\hat{ }3 to about 10\hat{ }9. In some embodiments, substantially the entire overall interior surface of the cavity 180 is superconductive, and has a quality factor between about 10\hat{ }6 to about 10\hat{ }15.

In some embodiments, substantially the entire overall interior surface of the cavity 180 comprises aluminum, antimony, arsenic, barium, beryllium, bismuth, cadmium, calcium, carbon, chromium, cobalt, copper, gallium, gold, hydrogen, indium, iron, lanthanum, lead, lithium, magnesium, manganese, mercury, molybdenum, nickel, niobium, nitrogen, oxygen, palladium, phosphorus, platinum, scandium, silicon, silver, strontium, sulfur, tantalum, technetium, tin, titanium, tungsten, vanadium, yttrium, zinc, zirconium, or any combination thereof. In some embodiments, substantially the entire overall interior surface of the cavity 180 comprises aluminum, barium, beryllium, bismuth, cadmium, calcium, copper, gallium, gadolinium, germanium, lanthanum, lead, lithium, indium, mercury, molybdenum, niobium, nitrogen, osmium, oxygen, protactinium, rhenium, ruthenium, silicon, strontium, sulfur, tantalum, technetium, thallium, thorium, titanium, tin, vanadium, yttrium, zinc, zirconium, NbTi, PbMoS, V₃Ga, NbN, V₃Si, Nb₃Sn, Nb₃Al, Nb₃(AlGe), Nb₃Ge, Bi₂Sr₂CuO₆, Bi₂Sr₂CaCu₂O₈, Bi₂Sr₂Ca₂Cu₃O₁₀, YBa₂Cu₃O₇, YBa₂Cu₄O₈, Y₂Ba₄Cu₇O₁₅, Y₃Ba₅Cu₈O₁₈, Tl₂Ba₂CuO₆, Tl₂Ba₂CaCu₂O₈, Tl₂Ba₂Ca₂Cu₃O₁₀, TlBa₂Ca₃Cu₄O₁₁, HgBa₂CuO₄, HgBa₂CaCu₂O₆, HgBa₂Ca₂Cu₃O₈, or any combination thereof.

In some embodiments, the cavity 180 is empty. In some embodiments, the cavity 180 comprises a vacuum with a pressure between about 10\hat{ }-24 Torr to about 10\hat{ }3 Torr. In some embodiments, the cavity 180 comprises a vacuum with a pressure of about 10\hat{ }-24 Torr, about 10\hat{ }-21 Torr, about 10\hat{ }-18 Torr, about 10\hat{ }-15 Torr, about 10\hat{ }-12 Torr, about 10\hat{ }-9 Torr, about 10\hat{ }-6 Torr, about 10\hat{ }-3 Torr, about 1.0 Torr, or about 10\hat{ }3 Torr.

In some embodiments, the cavity 180 comprises a thermal reservoir with a temperature between about 10\hat{ }-3 Kelvin to about 10\hat{ }3 Kelvin. In some embodiments, the cavity 180 comprises a thermal reservoir with a temperature of about 10\hat{ }-3 Kelvin, about 1 Kelvin, about 5 Kelvin, about 10 Kelvin, about 25 Kelvin, about 50 Kelvin, about 75 Kelvin, about 100 Kelvin, about 150 Kelvin, about 200 Kelvin, about 300 Kelvin, or about 10\hat{ }3 Kelvin.

In some embodiments, the electromagnetic wave comprises a transverse magnetic wave with a polar mode number of N1 and an azimuthal mode number of N2, where N1 and N2 are an integers from 0 to 1000, and N1 is greater than or equal to N2. In some embodiments, the electromagnetic wave comprises a transverse magnetic wave with a polar mode number of N and an azimuthal mode number of 0, where N is an integer from 0 to 1000. In some embodiments, the electromagnetic wave comprises a transverse magnetic wave with a polar mode number of N and an azimuthal mode number of N, where N is an integer from 0 to 1000. In some embodiments, the electromagnetic wave comprises a transverse electric wave with a polar mode number of N1 and an azimuthal mode number of N2, where N1 and N2 are an integers from 0 to 1000, and N1 is greater than or equal to N2. In some embodiments, the electromagnetic wave comprises a transverse electric wave with a polar mode number of N and an azimuthal mode number of 0, where N is an integer from 0 to 1000. In some embodiments, the electromagnetic wave comprises a transverse electric wave with a polar mode number of N and an azimuthal mode number of N, where N is an integer from 0 to 1000. In some embodiments, the electromagnetic radiation source is located inside the cavity 180 at, or adjacent to, a maximum field amplitude of the electromagnetic wave.

In some embodiments, the cavity 180 has at least one of a width 140 and a height 150 between about 10\hat{ }-9 meters to about 10\hat{ }3 meters. In some embodiments, the width 140 is measured as a maximum diameter of the base interior surface 110. In some embodiments, the height 150 is measured as a distance from the base interior surface 110 to the apex point 130. In some embodiments, the tapered interior surface 120 forms an aperture angle 160 between about 5 degrees to about 175 degrees. In some embodiments, the aperture angle 160 is measured as the interior angle of the tapered interior surface 120 at the apex point 130. In some embodiments, the cavity 180 has a wall with a wall thickness 170 between about 10\hat{ }-9 meters to about 1.0 meter. In some embodiments, the wall thickness 170 is measured as a normal distance between the overall interior surface of the cavity 180 and an exterior of the cavity resonator 100. In some embodiments, the base interior surface 110 has a different wall thickness 170 than the tapered interior surface 120. In some embodiments, the base interior surface 110 has about the same wall thickness 170 as the tapered interior surface 120.

In some embodiments, the base interior surface 110 is substantially elliptical. In some embodiments, the base interior surface 110 is substantially circular. In some embodiments, the base interior surface 110 is substantially flat.

In some embodiments, the electromagnetic wave forms an electromagnetic energy momentum tensor with an amplitude maximum at, or adjacent to, the base interior surface 110, which results in one or more of a metric tensor curvature, a thrust, and an acceleration of the thruster. In some embodiments, the electromagnetic wave forms an electromagnetic energy momentum tensor with an amplitude maximum at, or adjacent to, one or both the tapered interior surface 120 and the apex point 130, which results in one or more of a metric tensor curvature, a thrust, and an acceleration of the thruster.

### Truncated Conical Cavity Resonator Thruster

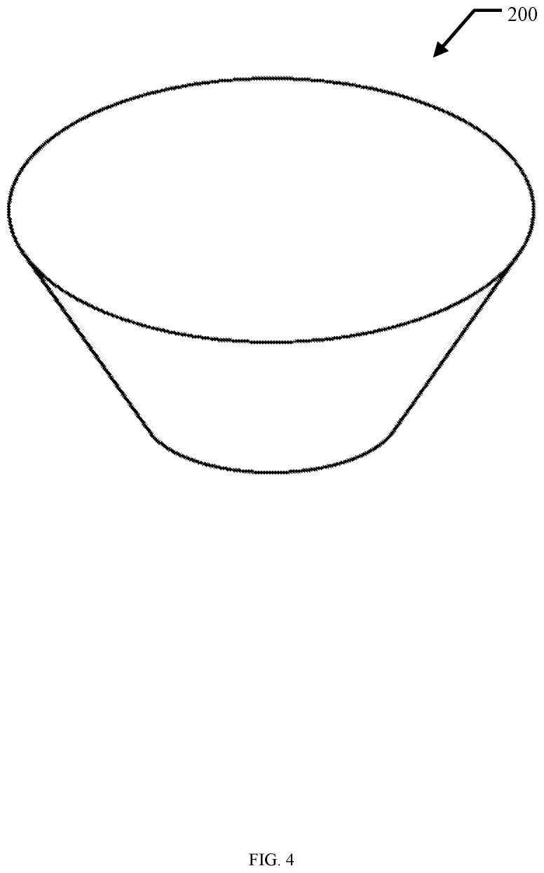

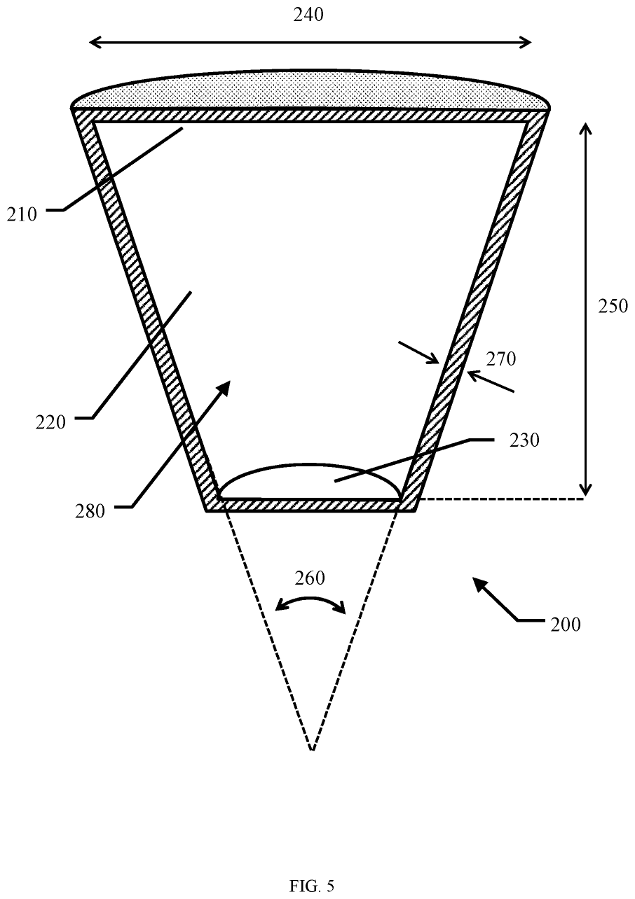

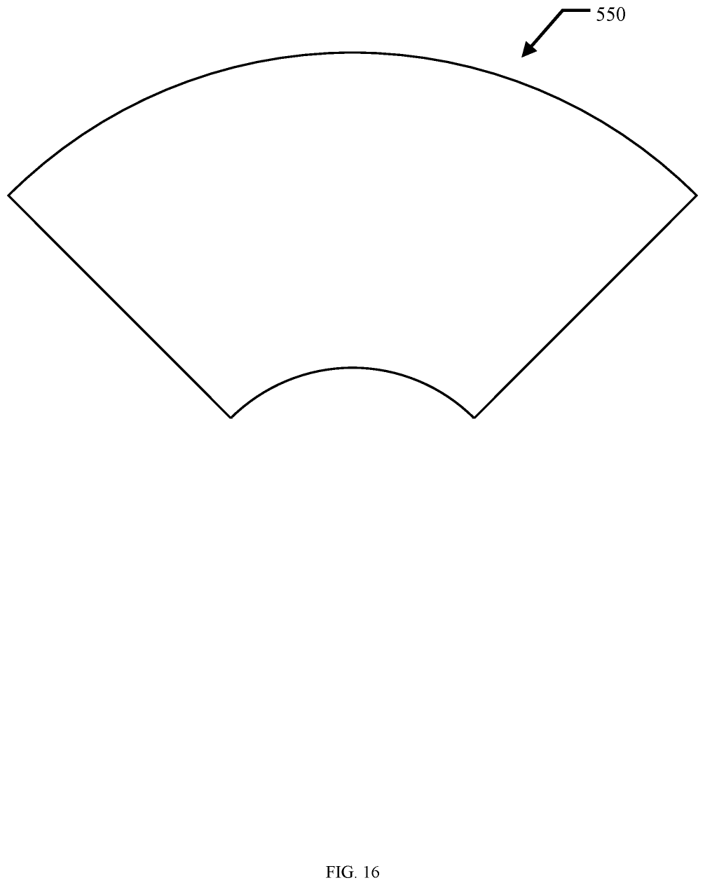

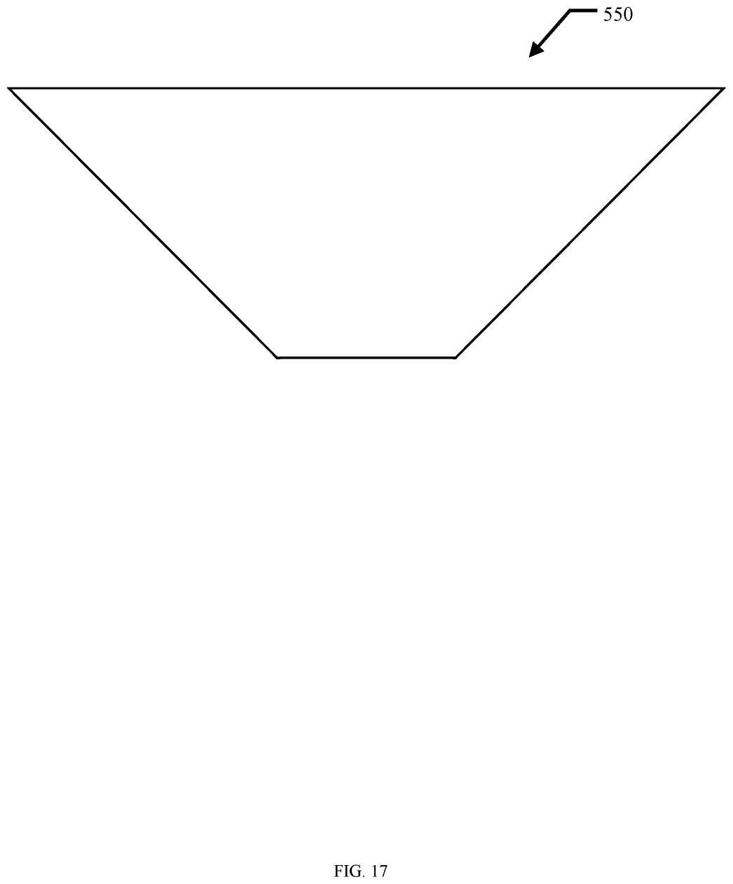

Provided herein per FIGS. 4, 5, and 16-21 is an electromagnetic energy momentum thruster comprising a truncated conical cavity resonator 200 and a base electromagnetic radiation source 600a or a side electromagnetic radiation source 600b. In some embodiments, the cavity resonator 200 forms a cavity 280 having a base interior surface 210, a tapered interior surface 220, and a truncated interior surface 230 opposing the base interior surface 210, the tapered interior surface 220 being between the base interior surface 210 and the truncated interior surface 230.

In some embodiments, the base electromagnetic radiation source 600a is configured to emit an electromagnetic wave into the cavity 280 having a frequency between about 10\hat{ }0 MHz to about 10\hat{ }9 MHz. In some embodiments, the side electromagnetic radiation source 600b is configured to emit an electromagnetic wave into the cavity 280 having a frequency between about 10\hat{ }0 MHz to about 10\hat{ }9 MHz.

In some embodiments, the base electromagnetic radiation source 600a is configured to produce the electromagnetic wave in evanescence so that the electromagnetic wave has a maximum field amplitude and an asymptotic field amplitude. In some embodiments, the maximum field amplitude is at, or adjacent to, the base interior surface 210, and the asymptotic field amplitude is at, or adjacent to, one or both the tapered interior surface 220 and the truncated interior surface 230. In some embodiments, the side electromagnetic radiation source 600b is configured to produce the electromagnetic wave in evanescence so that the electromagnetic wave has a maximum field amplitude and an asymptotic field amplitude. In some embodiments, the maximum field amplitude is at, or adjacent to, one or both the tapered interior surface 220 and the truncated interior surface 230, and the asymptotic field amplitude is at, or adjacent to, the base interior surface 210.

In some embodiments, the cavity 280 includes an overall interior surface comprising the base interior surface 210, the tapered interior surface 220, and the truncated interior surface 230. In some embodiments, substantially the entire overall interior surface of the cavity 280 is electrically conductive. In some embodiments, substantially the entire overall interior surface of the cavity 280 is superconductive. In some embodiments, substantially the entire overall interior surface of the cavity 280 is electrically conductive, and has a quality factor between about 10\hat{ }3 to about 10\hat{ }9. In some embodiments, substantially the entire overall interior surface of the cavity 280 is superconductive, and has a quality factor between about 10\hat{ }6 to about 10\hat{ }15.

In some embodiments, substantially the entire overall interior surface of the cavity 280 comprises aluminum, antimony, arsenic, barium, beryllium, bismuth, cadmium, calcium, carbon, chromium, cobalt, copper, gallium, gold, hydrogen, indium, iron, lanthanum, lead, lithium, magnesium, manganese, mercury, molybdenum, nickel, niobium, nitrogen, oxygen, palladium, phosphorus, platinum, scandium, silicon, silver, strontium, sulfur, tantalum, technetium, tin, titanium, tungsten, vanadium, yttrium, zinc, zirconium, or any combination thereof. In some embodiments, substantially the entire overall interior surface of the cavity 280 comprises aluminum, barium, beryllium, bismuth, cadmium, calcium, copper, gallium, gadolinium, germanium, lanthanum, lead, lithium, indium, mercury, molybdenum, niobium, nitrogen, osmium, oxygen, protactinium, rhenium, ruthenium, silicon, strontium, sulfur, tantalum, technetium, thallium, thorium, titanium, tin, vanadium, yttrium, zinc, zirconium, NbTi, PbMoS, V₃Ga, NbN, V₃Si, Nb₃Sn, Nb₃Al, Nb₃(AlGe), Nb₃Ge, Bi₂Sr₂CuO₆, Bi₂Sr₂CaCu₂O₈, Bi₂Sr₂Ca₂Cu₃O₁₀, YBa₂Cu₃O₇, YBa₂Cu₄O₈, Y₂Ba₄Cu₇O₁₅, Y₃Ba₅Cu₈O₁₈, Tl₂Ba₂CuO₆, Tl₂Ba₂CaCu₂O₈, Tl₂Ba₂Ca₂Cu₃O₁₀, TlBa₂Ca₃Cu₄O₁₁, HgBa₂CuO₄, HgBa₂CaCu₂O₆, HgBa₂Ca₂Cu₃O₈, or any combination thereof.

In some embodiments, the cavity 280 is empty. In some embodiments, the cavity 280 comprises a vacuum with a pressure between about 10\hat{ }-24 Torr to about 10\hat{ }3 Torr. In some embodiments, the cavity 280 comprises a vacuum with a pressure of about 10\hat{ }-24 Torr, about 10\hat{ }-21 Torr, about 10\hat{ }-18 Torr, about 10\hat{ }-15 Torr, about 10\hat{ }-12 Torr, about 10\hat{ }-9 Torr, about 10\hat{ }-6 Torr, about 10\hat{ }-3 Torr, about 1.0 Torr, or about 10\hat{ }3 Torr.

In some embodiments, the cavity 280 comprises a thermal reservoir with a temperature between about 10\hat{ }-3 Kelvin to about 10\hat{ }3 Kelvin. In some embodiments, the cavity 280 comprises a thermal reservoir with a temperature of about 10\hat{ }-3 Kelvin, about 1 Kelvin, about 5 Kelvin, about 10 Kelvin, about 25 Kelvin, about 50 Kelvin, about 75 Kelvin, about 100 Kelvin, about 150 Kelvin, about 200 Kelvin, about 300 Kelvin, or about 10\hat{ }3 Kelvin.

In some embodiments, the electromagnetic wave comprises a transverse magnetic wave with a polar mode number of N1 and an azimuthal mode number of N2, where N1 and N2 are an integers from 0 to 1000, and N1 is greater than or equal to N2. In some embodiments, the electromagnetic wave comprises a transverse magnetic wave with a polar mode number of N and an azimuthal mode number of 0, where N is an integer from 0 to 1000. In some embodiments, the electromagnetic wave comprises a transverse magnetic wave with a polar mode number of N and an azimuthal mode number of N, where N is an integer from 0 to 1000. In some embodiments, the electromagnetic wave comprises a transverse electric wave with a polar mode number of N1 and an azimuthal mode number of N2, where N1 and N2 are an integers from 0 to 1000, and N1 is greater than or equal to N2. In some embodiments, the electromagnetic wave comprises a transverse electric wave with a polar mode number of N and an azimuthal mode number of 0, where N is an integer from 0 to 1000.

In some embodiments, the electromagnetic wave comprises a transverse electric wave with a polar mode number of N and an azimuthal mode number of N, where N is an integer from 0 to 1000. In some embodiments, the electromagnetic radiation source is located inside the cavity 280 at, or adjacent to, a maximum field amplitude of the electromagnetic wave.

In some embodiments, the cavity 280 has at least one of a width 240 and a height 250 between about 10\hat{ }-9 meters to about 10\hat{ }3 meters. In some embodiments, the width 240 is measured as a maximum diameter of the base interior surface 210. In some embodiments, the height 250 is measured as a normal distance from the base interior surface 210 to the truncated interior surface 230. In some embodiments, the tapered interior surface 220 forms an aperture angle 260 between about 5 degrees to about 175 degrees. In some embodiments, the aperture angle 260 is measured as the interior angle of the tapered interior surface 220. In some embodiments, the cavity 280 has a wall with a wall thickness 270 between about 10\hat{ }-9 meters to about 1.0 meter. In some embodiments, the wall thickness 270 is measured as a normal distance between the overall interior surface of the cavity 280 and an exterior of the cavity resonator 200. In some embodiments, the base interior surface 210 has a different wall thickness 270 than the tapered interior surface 220. In some embodiments, the base interior surface 210 has about the same wall thickness 270 as the tapered interior surface 220. In some embodiments, the truncated interior surface 230 has a different wall thickness 270 than the tapered interior surface 220. In some embodiments, the truncated interior surface 230 has about the same wall thickness 270 the tapered interior surface 220. In some embodiments, the base interior surface 210 has a different wall thickness 270 than the truncated interior surface 230. In some embodiments, the base interior surface 210 has about the same wall thickness 270 as the truncated interior surface 230.

In some embodiments, one or both the base interior surface 210 and the truncated interior surface 230 is substantially elliptical. In some embodiments, one or both the base interior surface 210 and the truncated interior surface 230 is substantially circular. In some embodiments, one or both the base interior surface 210 and the truncated interior surface 230 is substantially flat.

In some embodiments, the electromagnetic wave forms an electromagnetic energy momentum tensor with an amplitude maximum at, or adjacent to, the base interior surface 210, which results in one or more of a metric tensor curvature, a thrust, and an acceleration of the thruster. In some embodiments, the electromagnetic wave forms an electromagnetic energy momentum tensor with an amplitude maximum at, or adjacent to, one or both the tapered interior surface 220 and the truncated interior surface 230, which results in one or more of a metric tensor curvature, a thrust, and an acceleration of the thruster.

### Pyramidal Cavity Resonator Thruster

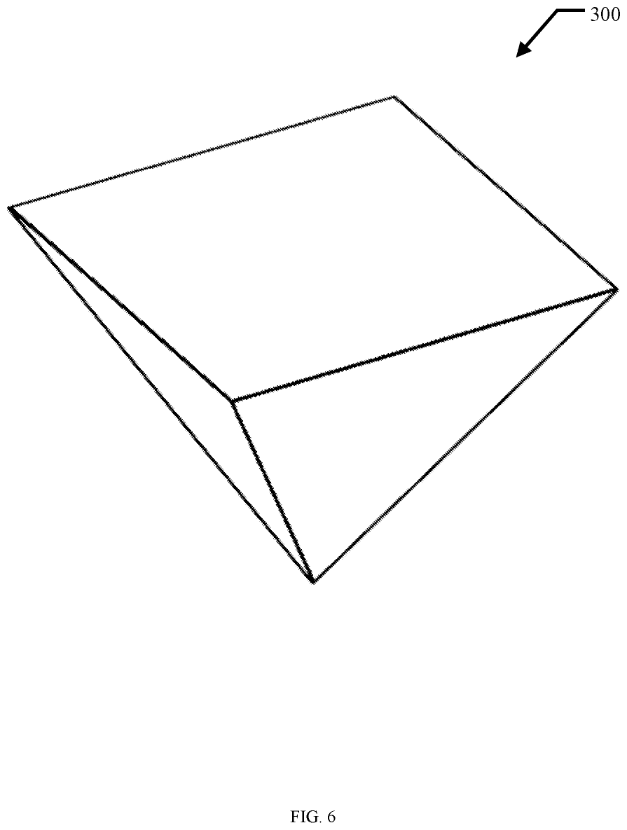

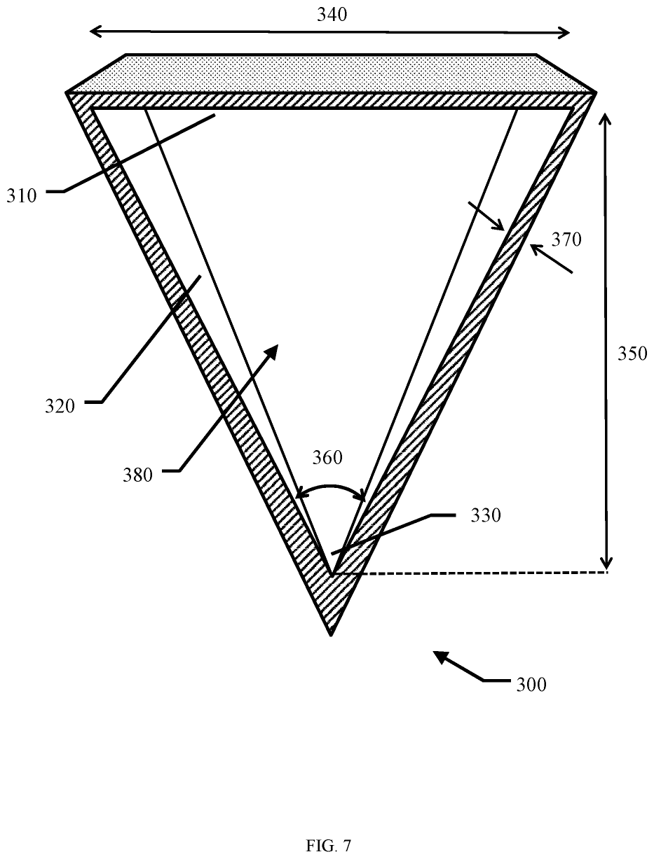

Provided herein per FIGS. 6, 7, and 10-15 is an electromagnetic energy momentum thruster comprising a pyramidal cavity resonator 300 and a base electromagnetic radiation source 600a or a side electromagnetic radiation source 600b. In some embodiments, the cavity resonator 300 forms a cavity 380 having a base interior surface 310 and at least three tapered interior surfaces 320, the tapered interior surfaces 320 converging to an apex point 330.

In some embodiments, the base electromagnetic radiation source 600a is configured to emit an electromagnetic wave into the cavity 380 having a frequency between about 10\hat{ }0 MHz to about 10\hat{ }9 MHz. In some embodiments, the side electromagnetic radiation source 600b is configured to emit an electromagnetic wave into the cavity 380 having a frequency between about 10\hat{ }0 MHz to about 10\hat{ }9 MHz.

In some embodiments, the base electromagnetic radiation source 600a is configured to produce the frequency of the electromagnetic wave in evanescence so that the electromagnetic wave has a maximum field amplitude and an asymptotic field amplitude. In some embodiments, the maximum field amplitude is at, or adjacent to, the base interior surface 310, and the asymptotic field amplitude is at, or adjacent to, one or more of the at least three tapered interior surfaces 320 and the apex point 330. In some embodiments, the side electromagnetic radiation source 600b is configured to produce the frequency of the electromagnetic wave in evanescence so that the electromagnetic wave has a maximum field amplitude and an asymptotic field amplitude. In some embodiments, the maximum field amplitude is at, or adjacent to, one or more of the at least three tapered interior surfaces 320 and the apex point 330, and the asymptotic field amplitude is at, or adjacent to, the base interior surface 310.

In some embodiments, the cavity 380 includes an overall interior surface comprising the base interior surface 310 and the at least three tapered interior surfaces 320. In some embodiments, substantially the entire overall interior surface of the cavity 380 is electrically conductive. In some embodiments, substantially the entire overall interior surface of the cavity 380 is superconductive. In some embodiments, substantially the entire overall interior surface of the cavity 380 is electrically conductive, and has a quality factor between about 10\hat{ }3 to about 10\hat{ }9. In some embodiments, substantially the entire overall interior surface of the cavity 380 is superconductive, and has a quality factor between about 10\hat{ }6 to about 10\hat{ }15.

In some embodiments, substantially the entire overall interior surface of the cavity 380 comprises aluminum, antimony, arsenic, barium, beryllium, bismuth, cadmium, calcium, carbon, chromium, cobalt, copper, gallium, gold, hydrogen, indium, iron, lanthanum, lead, lithium, magnesium, manganese, mercury, molybdenum, nickel, niobium, nitrogen, oxygen, palladium, phosphorus, platinum, scandium, silicon, silver, strontium, sulfur, tantalum, technetium, tin, titanium, tungsten, vanadium, yttrium, zinc, zirconium, or any combination thereof. In some embodiments, substantially the entire overall interior surface of the cavity 380 comprises aluminum, barium, beryllium, bismuth, cadmium, calcium, copper, gallium, gadolinium, germanium, lanthanum, lead, lithium, indium, mercury, molybdenum, niobium, nitrogen, osmium, oxygen, protactinium, rhenium, ruthenium, silicon, strontium, sulfur, tantalum, technetium, thallium, thorium, titanium, tin, vanadium, yttrium, zinc, zirconium, NbTi, PbMoS, V₃Ga, NbN, V₃Si, Nb₃Sn, Nb₃Al, Nb₃(AlGe), Nb₃Ge, Bi₂Sr₂CuO₆, Bi₂Sr₂CaCu₂O₈, Bi₂Sr₂Ca₂Cu₃O₁₀, YBa₂Cu₃O₇, YBa₂Cu₄O₈, Y₂Ba₄Cu₇O₁₅, Y₃Ba₅Cu₈O₁₈, Tl₂Ba₂CuO₆, Tl₂Ba₂CaCu₂O₈, Tl₂Ba₂Ca₂Cu₃O₁₀, TlBa₂Ca₃Cu₄O₁₁, HgBa₂CuO₄, HgBa₂CaCu₂O₆, HgBa₂Ca₂Cu₃O₈, or any combination thereof.

In some embodiments, the cavity 380 is empty. In some embodiments, the cavity 380 comprises a vacuum with a pressure between about 10\hat{ }-24 Torr to about 10\hat{ }3 Torr. In some embodiments, the cavity 380 comprises a vacuum with a pressure of about 10\hat{ }-24 Torr, about 10\hat{ }-21 Torr, about 10\hat{ }-18 Torr, about 10\hat{ }-15 Torr, about 10\hat{ }-12 Torr, about 10\hat{ }-9 Torr, about 10\hat{ }-6 Torr, about 10\hat{ }-3 Torr, about 1.0 Torr, or about 10\hat{ }3 Torr.

In some embodiments, the cavity 380 comprises a thermal reservoir with a temperature between about 10\hat{ }-3 Kelvin to about 10\hat{ }3 Kelvin. In some embodiments, the cavity 380 comprises a thermal reservoir with a temperature of about 10\hat{ }-3 Kelvin, about 1 Kelvin, about 5 Kelvin, about 10 Kelvin, about 25 Kelvin, about 50 Kelvin, about 75 Kelvin, about 100 Kelvin, about 150 Kelvin, about 200 Kelvin, about 300 Kelvin, or about 10\hat{ }3 Kelvin.

In some embodiments, the electromagnetic wave comprises a transverse magnetic wave with a polar mode number of N1 and an azimuthal mode number of N2, where N1 and N2 are an integers from 0 to 1000, and N1 is greater than or equal to N2. In some embodiments, the electromagnetic wave comprises a transverse magnetic wave with a polar mode number of N and an azimuthal mode number of 0, where N is an integer from 0 to 1000. In some embodiments, the electromagnetic wave comprises a transverse magnetic wave with a polar mode number of N and an azimuthal mode number of N, where N is an integer from 0 to 1000. In some embodiments, the electromagnetic wave comprises a transverse electric wave with a polar mode number of N1 and an azimuthal mode number of N2, where N1 and N2 are an integers from 0 to 1000, and N1 is greater than or equal to N2. In some embodiments, the electromagnetic wave comprises a transverse electric wave with a polar mode number of N and an azimuthal mode number of 0, where N is an integer from 0 to 1000. In some embodiments, the electromagnetic wave comprises a transverse electric wave with a polar mode number of N and an azimuthal mode number of N, where N is an integer from 0 to 1000. In some embodiments, the electromagnetic radiation source is located inside the cavity 380 at, or adjacent to, a maximum field amplitude of the electromagnetic wave.

In some embodiments, the cavity 380 has at least one of a width 340 and a height 350 between about 10\hat{ }-9 meters to about 10\hat{ }3 meters. In some embodiments, the width 340 is measured as a maximum diameter of the base interior surface 310. In some embodiments, the height 350 is measured as a distance from the base interior surface 310 to the apex point 330. In some embodiments, two or more of the at least three tapered interior surfaces 320 form an aperture angle 360 between about 5 degrees to about 175 degrees. In some embodiments, the aperture angle 360 is measured as an internal angle between two or more of the at least three tapered interior surfaces 320 at the apex point 330. In some embodiments, the cavity has a wall with a wall thickness 370 between about 10\hat{ }-9 meters to about 1.0 meter. In some embodiments, the wall thickness 370 is measured as a normal distance between the overall interior surface of the cavity 380 and an exterior of the cavity resonator 300. In some embodiments, the base interior surface 310 has a different wall thickness 370 than as at least one of the at least three the tapered interior surfaces 320. In some embodiments, the base interior surface 310 has about the same wall thickness 370 as at least one of the at least three the tapered interior surfaces 320.

In some embodiments, the base interior surface 310 comprises 3, 4, 5, 6, 7, 8, 9, 10, 11, 12, 13, 14, 15, 16, 17, 18, 19, 20, 21, 22, 23, 24, or more sides. In some embodiments the base interior surface 310 is substantially equilateral. In some embodiments, the base interior surface 310 is substantially flat.

In some embodiments, the electromagnetic wave forms an electromagnetic energy momentum tensor with an amplitude maximum at, or adjacent to, the base interior surface 310, which results in one or more of a metric tensor curvature, a thrust, and an acceleration of the thruster. In some embodiments, the electromagnetic wave forms an electromagnetic energy momentum tensor with an amplitude maximum at, or adjacent to, one or more of the at least three tapered interior surfaces 320 and the apex point 330, which results in one or more of a metric tensor curvature, a thrust, and an acceleration of the thruster.

### Truncated Pyramidal Cavity Resonator Thruster

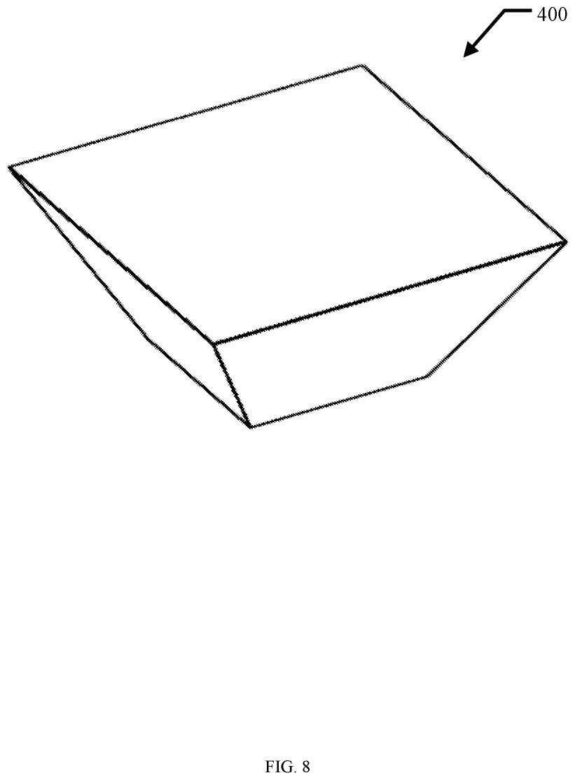

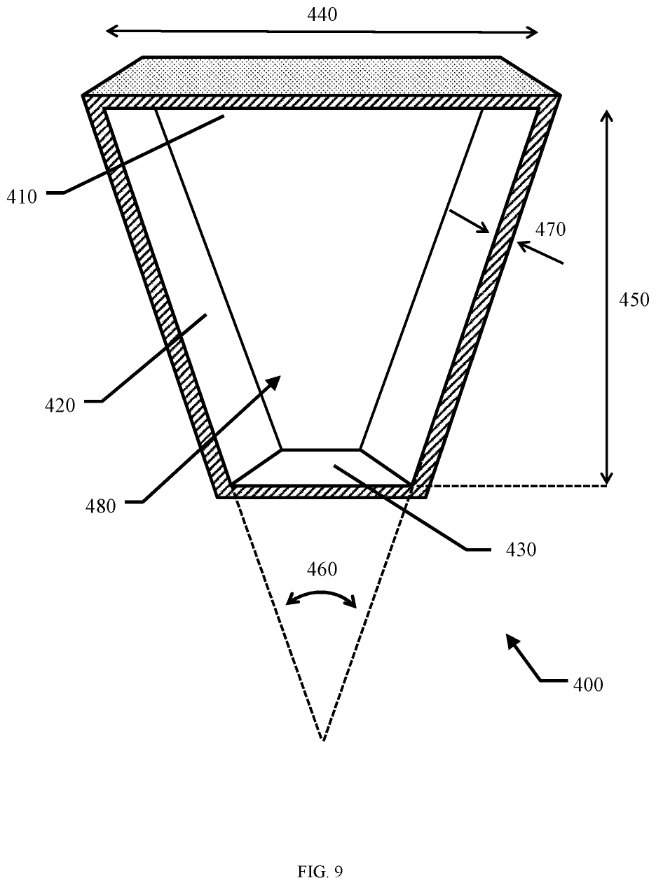

Provided herein per FIGS. 8, 9, and 16-21 is an electromagnetic energy momentum thruster comprising a truncated pyramidal cavity resonator 400 and a base electromagnetic radiation source 600a or a side electromagnetic radiation source 600b. In some embodiments, the cavity resonator 400 forms a cavity 480 having a base interior surface 410, at least three tapered interior surfaces 420, and a truncated interior surface 430 opposing the base interior surface 410, the at least three tapered interior surfaces 420 being between the base interior surface 410 and truncated interior surfaces 430.

In some embodiments, the base electromagnetic radiation source 600a is configured to emit an electromagnetic wave into the cavity 480 having a frequency between about 10\hat{ }0 MHz to about 10\hat{ }9 MHz. In some embodiments, the side electromagnetic radiation source 600b is configured to emit an electromagnetic wave into the cavity 480 having a frequency between about 10\hat{ }0 MHz to about 10\hat{ }9 MHz.

In some embodiments, the base electromagnetic radiation source 600a is configured to produce the frequency of the electromagnetic wave in evanescence so that the electromagnetic wave has a maximum field amplitude and an asymptotic field amplitude. In some embodiments, the maximum field amplitude is at, or adjacent to, the base interior surface 410, and the asymptotic field amplitude is at, or adjacent to, one or more of the at least three tapered interior surfaces 420 and the truncated interior surface 430. In some embodiments, the side electromagnetic radiation source 600b is configured to produce the frequency of the electromagnetic wave in evanescence so that the electromagnetic wave has a maximum field amplitude and an asymptotic field amplitude. In some embodiments, the maximum field amplitude is at, or adjacent to, one or more of the at least three tapered interior surfaces 420 and the truncated interior surface 430, and the asymptotic field amplitude is at, or adjacent to, the base interior surface 410.

In some embodiments, the cavity 480 includes an overall interior surface comprising the base interior surface 410, the at least three tapered interior surfaces 420, and the truncated interior surface 430. In some embodiments, substantially the entire overall interior surface of the cavity 480 is electrically conductive. In some embodiments, substantially the entire overall interior surface of the cavity 480 is superconductive. In some embodiments, substantially the entire overall interior surface of the cavity 480 is electrically conductive, and has a quality factor between about 10\hat{ }3 to about 10\hat{ }9. In some embodiments, the entire overall interior surface of the cavity 480 is superconductive, and has a quality factor between about 10\hat{ }6 to about 10\hat{ }15.

In some embodiments, substantially the entire overall interior surface of the cavity 480 comprises aluminum, antimony, arsenic, barium, beryllium, bismuth, cadmium, calcium, carbon, chromium, cobalt, copper, gallium, gold, hydrogen, indium, iron, lanthanum, lead, lithium, magnesium, manganese, mercury, molybdenum, nickel, niobium, nitrogen, oxygen, palladium, phosphorus, platinum, scandium, silicon, silver, strontium, sulfur, tantalum, technetium, tin, titanium, tungsten, vanadium, yttrium, zinc, zirconium, or any combination thereof. In some embodiments, substantially the entire overall interior surface of the cavity 480 comprises aluminum, barium, beryllium, bismuth, cadmium, calcium, copper, gallium, gadolinium, germanium, lanthanum, lead, lithium, indium, mercury, molybdenum, niobium, nitrogen, osmium, oxygen, protactinium, rhenium, ruthenium, silicon, strontium, sulfur, tantalum, technetium, thallium, thorium, titanium, tin, vanadium, yttrium, zinc, zirconium, NbTi, PbMoS, V₃Ga, NbN, V₃Si, Nb₃Sn, Nb₃Al, Nb₃(AlGe), Nb₃Ge, Bi₂Sr₂CuO₆, Bi₂Sr₂CaCu₂O₈, Bi₂Sr₂Ca₂Cu₃O₁₀, YBa₂Cu₃O₇, YBa₂Cu₄O₈, Y₂Ba₄Cu₇O₁₅, Y₃Ba₅Cu₈O₁₈, Tl₂Ba₂CuO₆, Tl₂Ba₂CaCu₂O₈, Tl₂Ba₂Ca₂Cu₃O₁₀, TlBa₂Ca₃Cu₄O₁₁, HgBa₂CuO₄, HgBa₂CaCu₂O₆, HgBa₂Ca₂Cu₃O₈, or any combination thereof.

In some embodiments, the cavity 480 is empty. In some embodiments, the cavity 480 comprises a vacuum with a pressure between about 10\hat{ }-24 Torr to about 10\hat{ }3 Torr. In some embodiments, the cavity 480 comprises a vacuum with a pressure of about 10\hat{ }-24 Torr, about 10\hat{ }-21 Torr, about 10\hat{ }-18 Torr, about 10\hat{ }-15 Torr, about 10\hat{ }-12 Torr, about 10\hat{ }-9 Torr, about 10\hat{ }-6 Torr, about 10\hat{ }-3 Torr, about 1.0 Torr, or about 10\hat{ }3 Torr.

In some embodiments, the cavity 480 comprises a thermal reservoir with a temperature between about 10\hat{ }-3 Kelvin to about 10\hat{ }3 Kelvin. In some embodiments, the cavity 480 comprises a thermal reservoir with a temperature of about 10\hat{ }-3 Kelvin, about 1 Kelvin, about 5 Kelvin, about 10 Kelvin, about 25 Kelvin, about 50 Kelvin, about 75 Kelvin, about 100 Kelvin, about 150 Kelvin, about 200 Kelvin, about 300 Kelvin, or about 10\hat{ }3 Kelvin.

In some embodiments, the electromagnetic wave comprises a transverse magnetic wave with a polar mode number of N1 and an azimuthal mode number of N2, where N1 and N2 are an integers from 0 to 1000, and N1 is greater than or equal to N2. In some embodiments, the electromagnetic wave comprises a transverse magnetic wave with a polar mode number of N and an azimuthal mode number of 0, where N is an integer from 0 to 1000. In some embodiments, the electromagnetic wave comprises a transverse magnetic wave with a polar mode number of N and an azimuthal mode number of N, where N is an integer from 0 to 1000. In some embodiments, the electromagnetic wave comprises a transverse electric wave with a polar mode number of N1 and an azimuthal mode number of N2, where N1 and N2 are an integers from 0 to 1000, and N1 is greater than or equal to N2. In some embodiments, the electromagnetic wave comprises a transverse electric wave with a polar mode number of N and an azimuthal mode number of 0, where N is an integer from 0 to 1000. In some embodiments, the electromagnetic wave comprises a transverse electric wave with a polar mode number of N and an azimuthal mode number of N, where N is an integer from 0 to 1000. In some embodiments, the electromagnetic radiation source is located inside the cavity 480 at, or adjacent to, a maximum field amplitude of the electromagnetic wave.

In some embodiments, the cavity 480 has at least one of a width 440 and a height 450 between about 10\hat{ }-9 meters to about 10\hat{ }3 meters. In some embodiments, the width 440 is measured as a normal width of the base interior surface 410. In some embodiments, the height 450 is measured as a normal distance from the base interior surface 410 to the truncated interior surface 430. In some embodiments, two or more of the at least three tapered interior surfaces 420 form an aperture angle 460 between about 5 degrees to about 175 degrees. In some embodiments, the aperture angle 460 is measured as an internal angle between two or more of the at least three tapered interior surfaces 420. In some embodiments, the cavity 480 has a wall with a wall thickness 470 between about 10\hat{ }-9 meters to about 1.0 meter. In some embodiments, the wall thickness 470 is measured as a normal distance between the overall interior surface of the cavity 480 and an exterior of the cavity resonator 400. In some embodiments, the base interior surface 410 has a different wall thickness 470 than at least one of the three or more tapered interior surfaces 420. In some embodiments, the base interior surface 410 has about the same wall thickness 470 as at least one of the three or more tapered interior surfaces 420. In some embodiments, the truncated interior surface 430 has a different wall thickness 470 than at least one of the three or more tapered interior surfaces 420. In some embodiments, the truncated interior surface 430 has about the same wall thickness 470 as at least one of the three or more tapered interior surfaces 420. In some embodiments, the base interior surface 410 has a different wall thickness 470 than the truncated interior surface 430. In some embodiments, the base interior surface 410 has about the same wall thickness 470 as the truncated interior surface 430.

In some embodiments, one or both the base interior surface 410 and the truncated interior surface 430 comprises 3, 4, 5, 6, 7, 8, 9, 10, 11, 12, 13, 14, 15, 16, 17, 18, 19, 20, 21, 22, 23, 24, or more sides. In some embodiments, one or both the base interior surface 410 and the truncated interior surface 430 is substantially equilateral. In some embodiments, one or both the base interior surface 410 and the truncated interior surface 430 is substantially flat.

In some embodiments, the electromagnetic wave forms an electromagnetic energy momentum tensor with an amplitude maximum at, or adjacent to, the base interior surface 410, which results in one or more of a metric tensor curvature, a thrust, and an acceleration of the thruster. In some embodiments, the electromagnetic wave forms an electromagnetic energy momentum tensor with an amplitude maximum at, or adjacent to, one or more of the at least three tapered interior surfaces 420 and the truncated interior surface 430, which results in one or more of a metric tensor curvature, a thrust, and an acceleration of the thruster.

### Electromagnetic Radiation Source

Provided herein is an electromagnetic energy momentum thruster comprising a cavity resonator forming a cavity, and an electromagnetic radiation source.

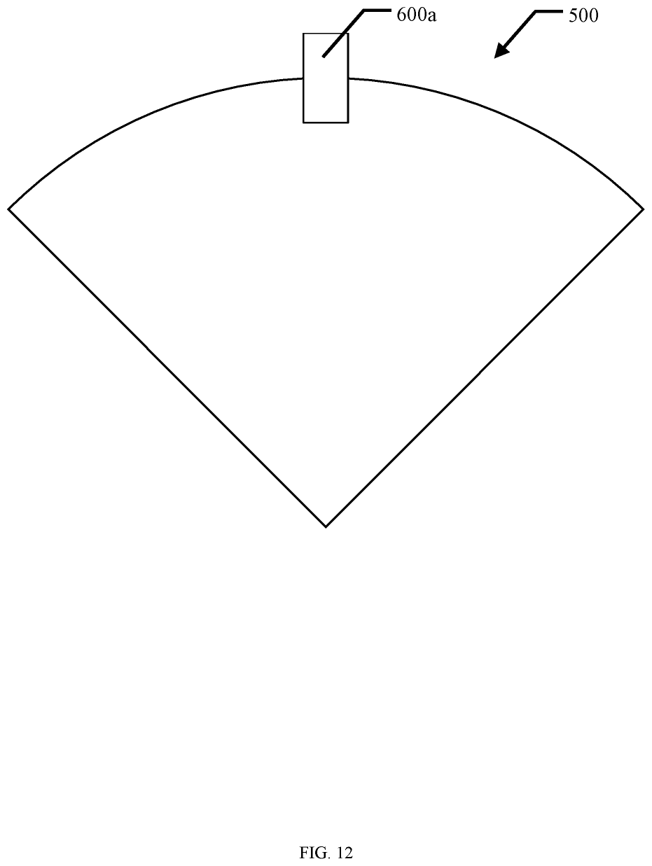

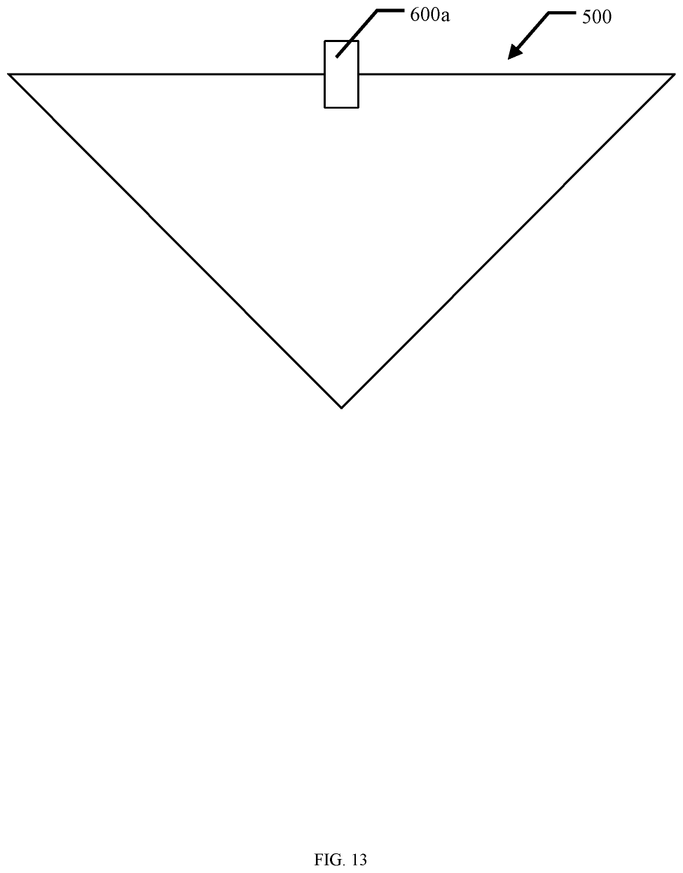

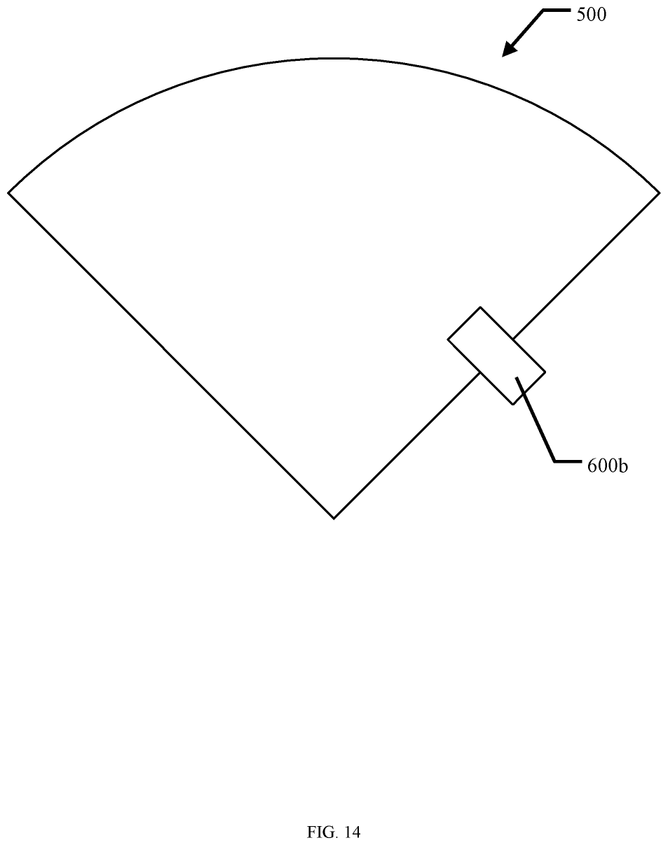

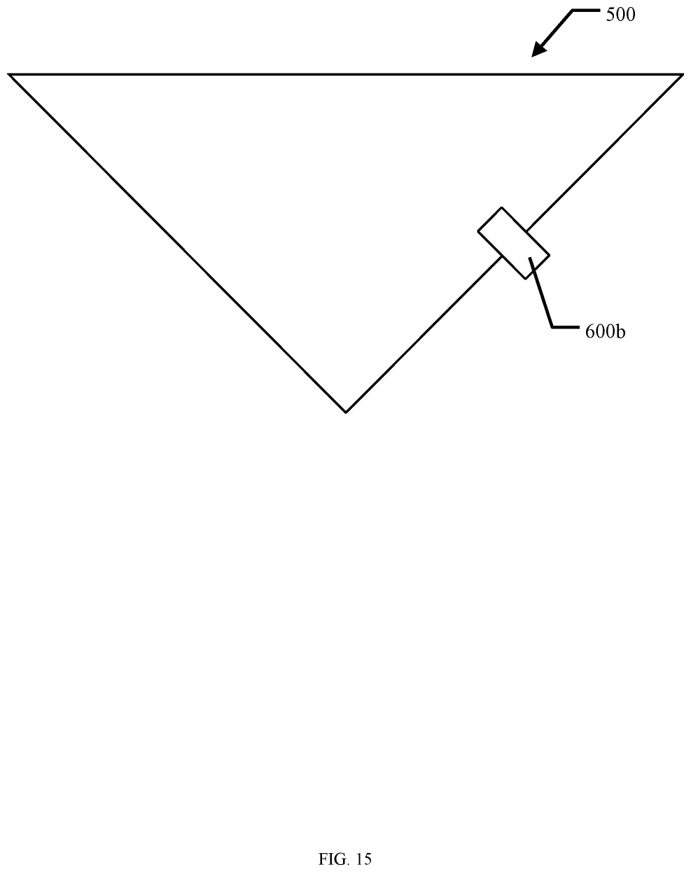

In some embodiments, per FIGS. 12 and 13, the electromagnetic energy momentum thruster comprises a tapered cavity resonator 500 and a base electromagnetic radiation source 600a. In some embodiments, per FIGS. 14 and 15, the electromagnetic energy momentum thruster comprises a tapered cavity resonator 500 and a side electromagnetic radiation source 600b.

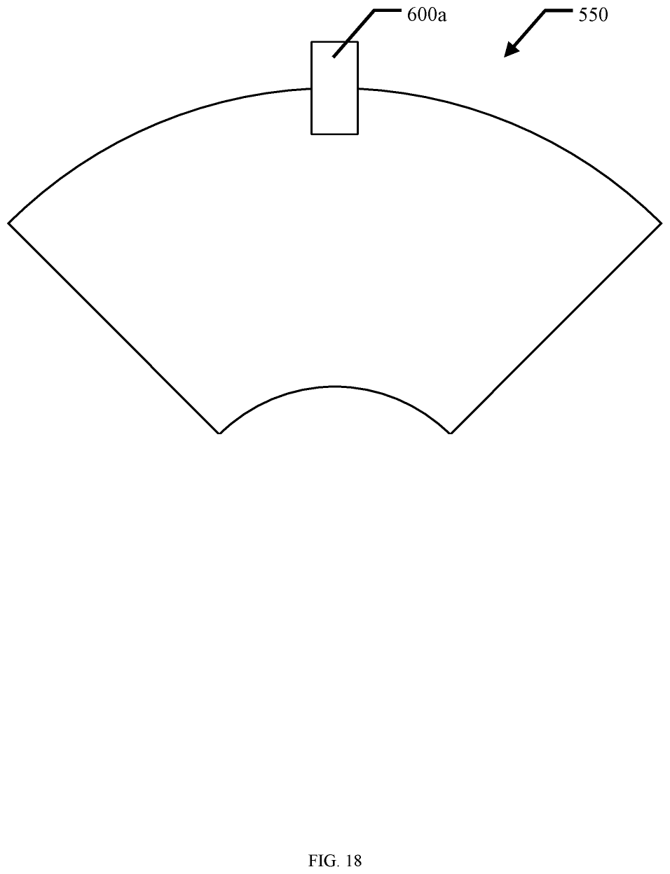

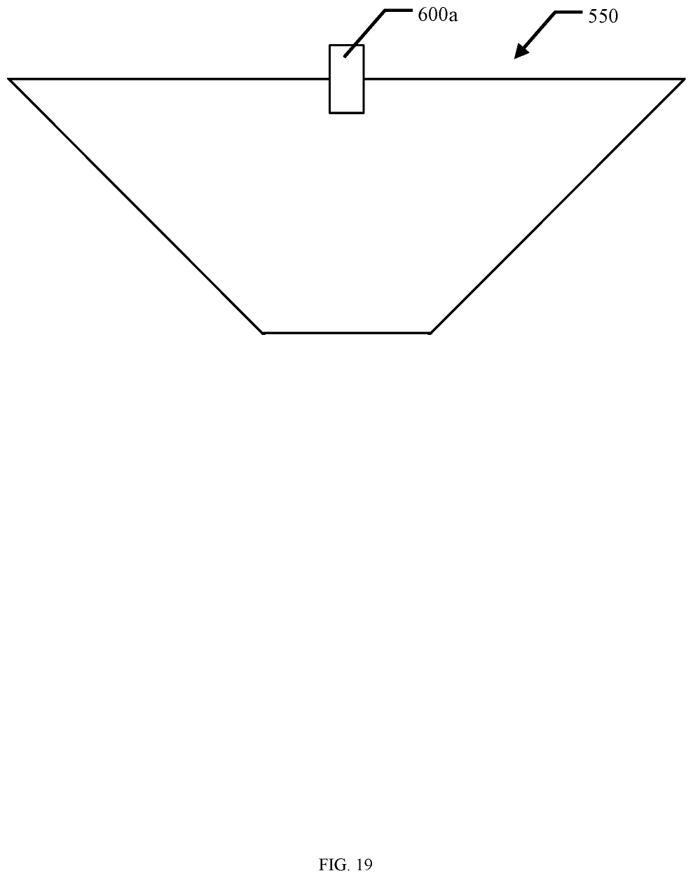

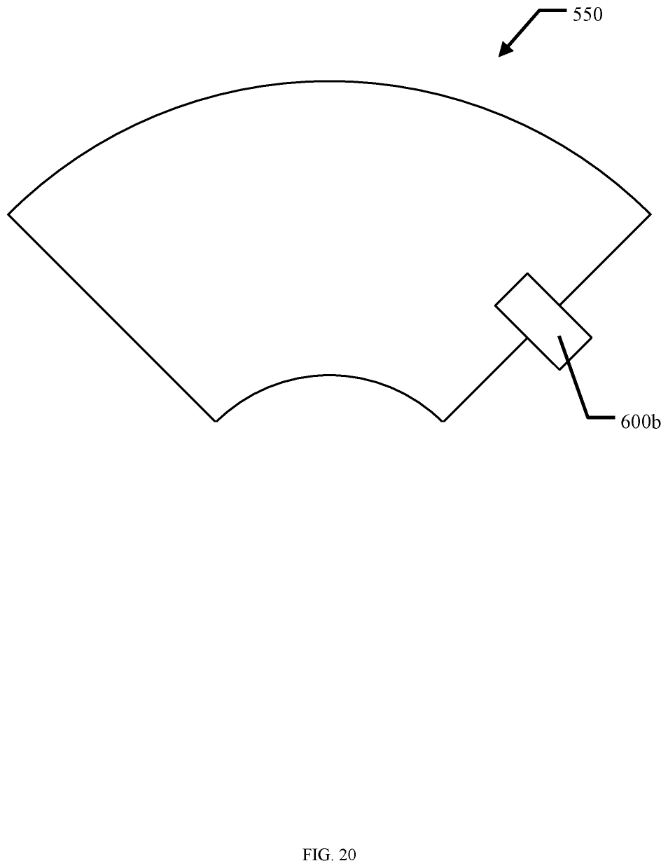

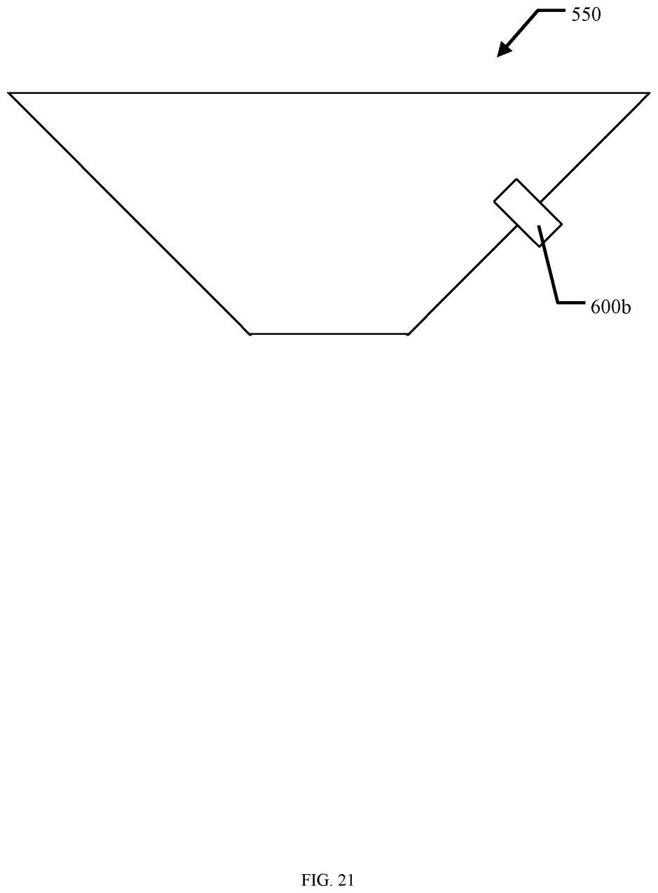

In some embodiments, per FIGS. 18 and 19, the electromagnetic energy momentum thruster comprises a truncated tapered cavity resonator 550 and a base electromagnetic radiation source 600a. In some embodiments, per FIGS. 20 and 21, the electromagnetic energy momentum thruster comprises a truncated tapered cavity resonator 550 and a side electromagnetic radiation source 600b.

In some embodiments, the tapered cavity resonator 500 comprises a pyramidal or a conical cavity resonator. In some embodiments, the truncated tapered cavity resonator 550 comprises a truncated pyramidal or a truncated conical cavity resonator.

In some embodiments, the base radiation source 600a emits the electromagnetic wave from the base interior surface of the tapered cavity resonator 500 or the truncated tapered cavity resonator 550. In some embodiments, the base radiation source 600a is affixed to the base interior surface of the tapered cavity resonator 500 or the truncated tapered cavity resonator 550. In some embodiments, the side radiation source 600b emits the electromagnetic wave from the tapered interior surface of the tapered cavity resonator 500 or the truncated tapered cavity resonator 550. In some embodiments, the side radiation source 600b is affixed to the tapered interior surface of the tapered cavity resonator 500 or the truncated tapered cavity resonator 550.

In some embodiments, the base electromagnetic radiation source 600a is configured to emit an electromagnetic wave into the cavity resonator having a frequency between about 10\hat{ }0 MHz to about 10\hat{ }9 MHz. In some embodiments, the side electromagnetic radiation source 600b is configured to emit an electromagnetic wave into the cavity resonator having a frequency between about 10\hat{ }0 MHz to about 10\hat{ }9 MHz.

### Environmental Control Apparatus

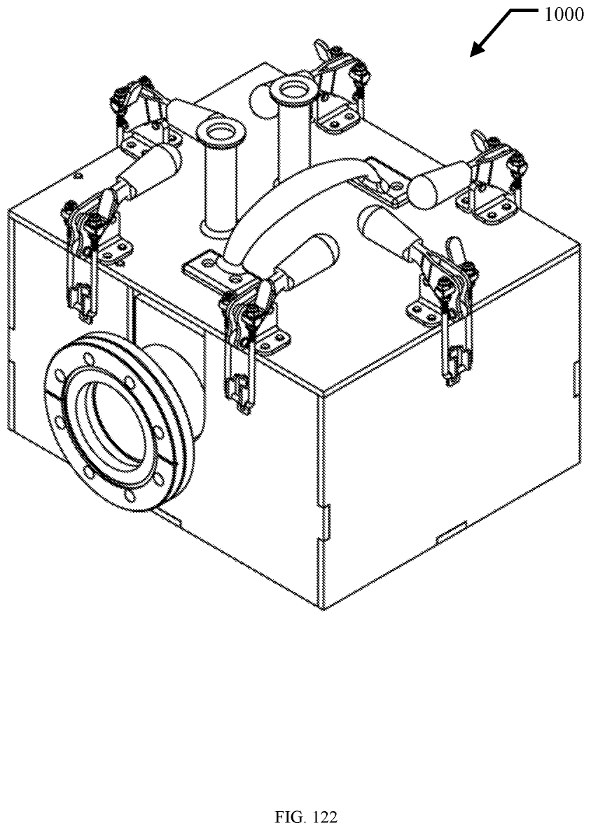

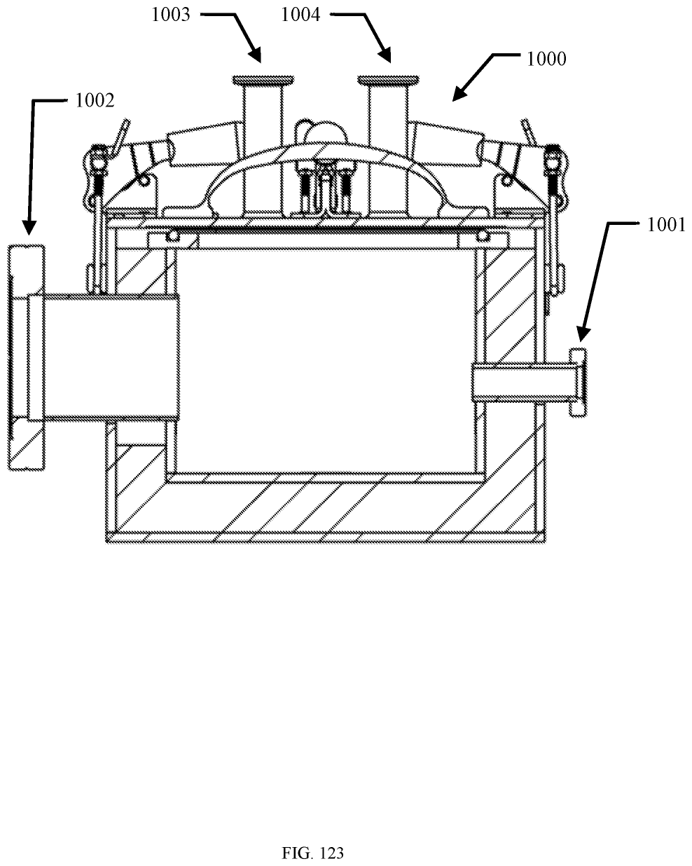

Provided herein, per FIGS. 122 and 123, is an exemplary environmental control apparatus 1000. In some embodiments, the environmental control apparatus 1000 comprises a transmission line 1001, an instrumentation channel 1002, a coolant input 1003, and a coolant output 1004. In some embodiments, the coolant comprises a gaseous coolant, a liquid coolant, a cryogen coolant, or any combination thereof.

In some embodiments, the exemplary environmental control apparatus 1000 comprises at least one of a clamp, a clasp, a cam, a handle, a gasket, an insulator, and a probe.

### EXAMPLES

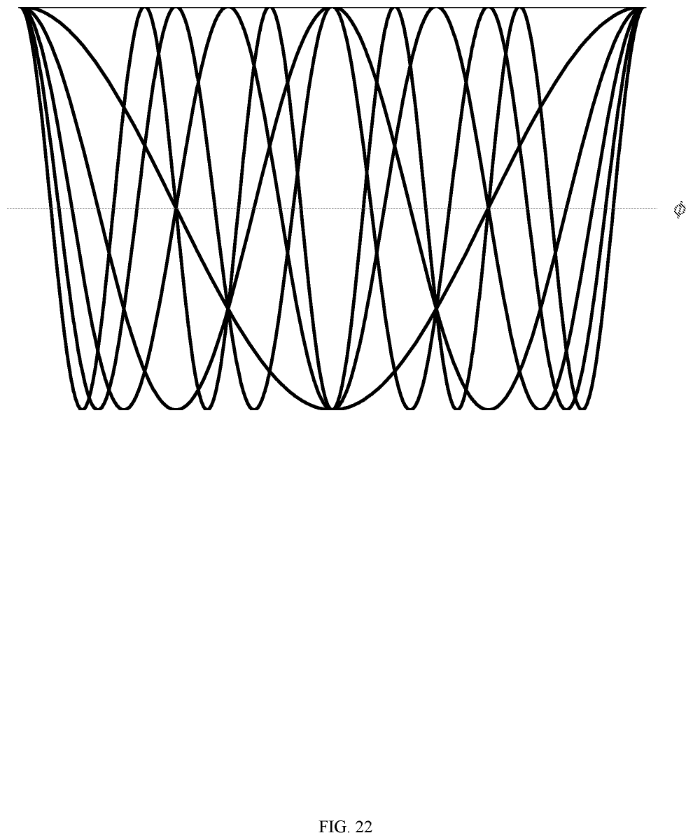

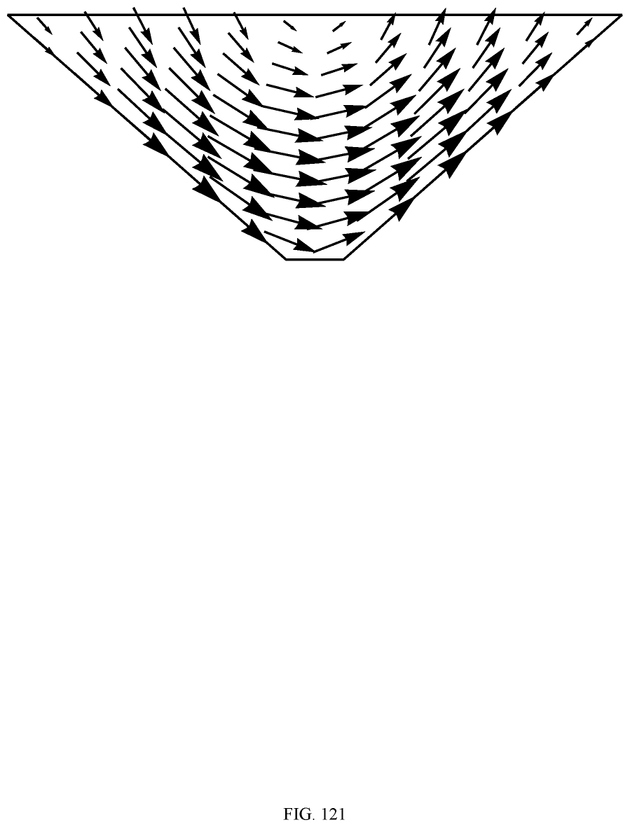

The following illustrative examples are representative of embodiments of the hardware applications, systems, and methods described herein and are not meant to be limiting in any way. Exemplary plots of the transverse magnetic waves and the transverse electric waves of a non-limiting conical cavity resonator, a non-limiting truncated conical cavity resonator, a non-limiting pyramidal cavity resonator, and a non-limiting truncated pyramidal cavity resonator are shown in FIGS. 22-121.

### Example 1—Transverse Electric Wave Frequency of a Conical Cavity Resonator

In some embodiments, a frequency of a hollow conical cavity resonator is calculated per the equations below:

For an azimuthal eigenvalue (m) of the resonator:

m=n where n=0,1,2, . . .

For a polar eigenvalue (l), an azimuthal eigenvalue (m), a taper angle (θ₀), and a polar wave equation (Pₗ^{m}(cos θ)) of the resonator:

$${[ \frac{d}{d θ} [ {P}_{l}^{m} ( cos θ ) ] ]}_{θ = {θ}_{0}} = 0$$

For a radial eigenvalue (k), a polar eigenvalue (l), a radial length (r₁), and a radial wave equation (jₗ(kr)) of the resonator:

[(kr)jₗ(kr)]ᵣ₌₀=0 and [(kr)jₗ(kr)]ᵣ₌ᵣ_{₁}=0

For a radial eigenvalue (k), a polar eigenvalue (l), a radial length (r₁), and a radial wave equation (jₗ(kr)) of the resonator:

$${[ \frac{d}{dr} [ ( kr ) {j}_{l} ( kr ) ] ]}_{r = 0} = 0 {or [ \frac{d}{dr} [ ( kr ) {j}_{l} ( kr ) ] ]}_{r = {r}_{1}} = 0$$

For a frequency (f), a radial eigenvalue (k), and a speed of light (c) of the resonator:

$$f = \frac{kc}{2 π}$$

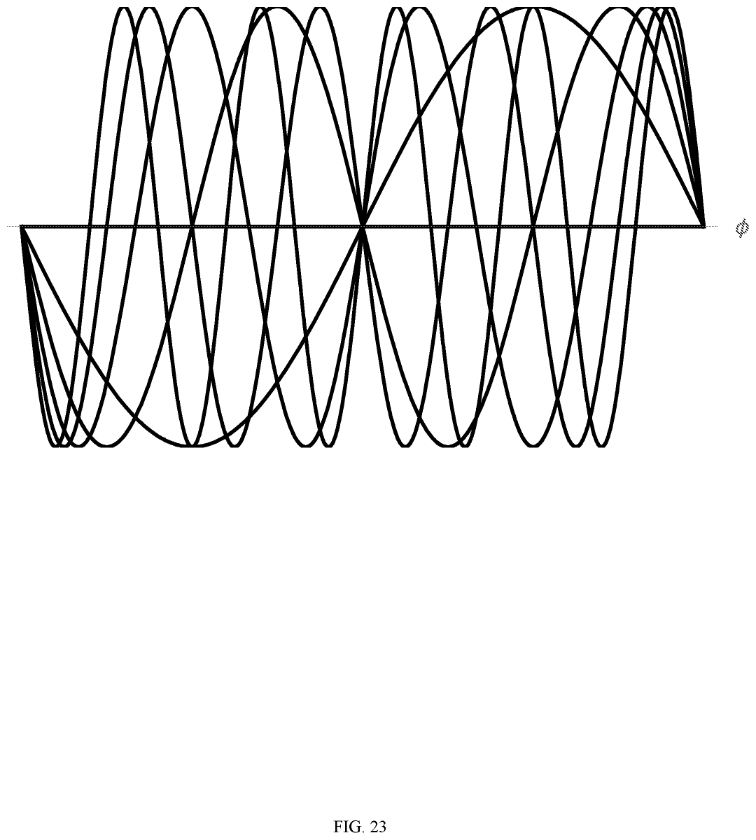

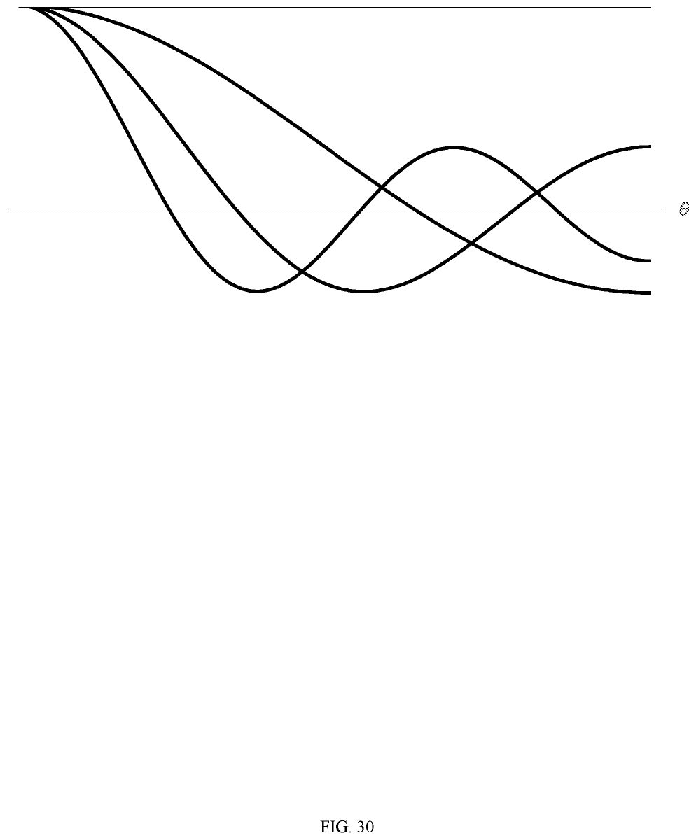

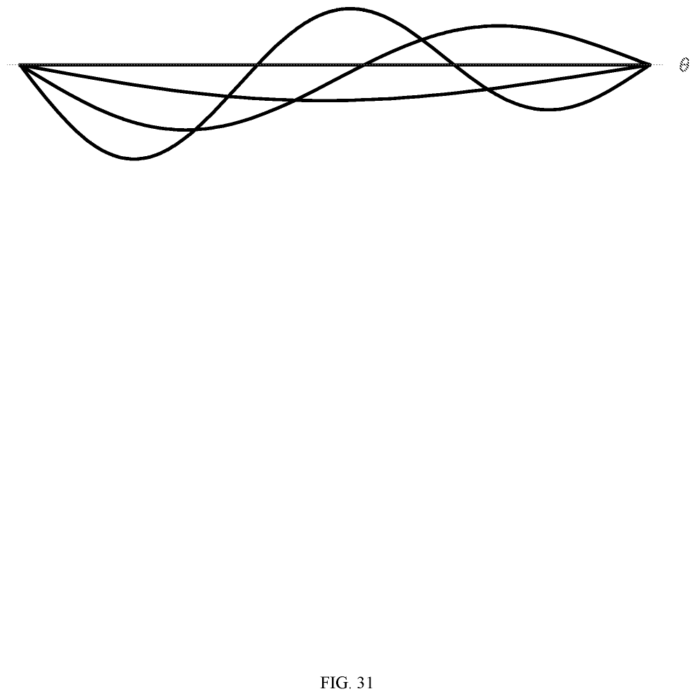

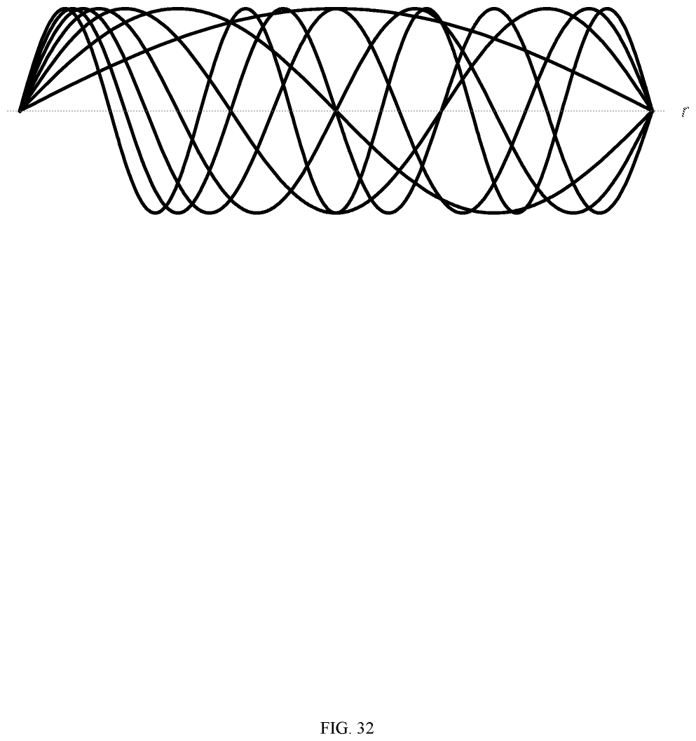

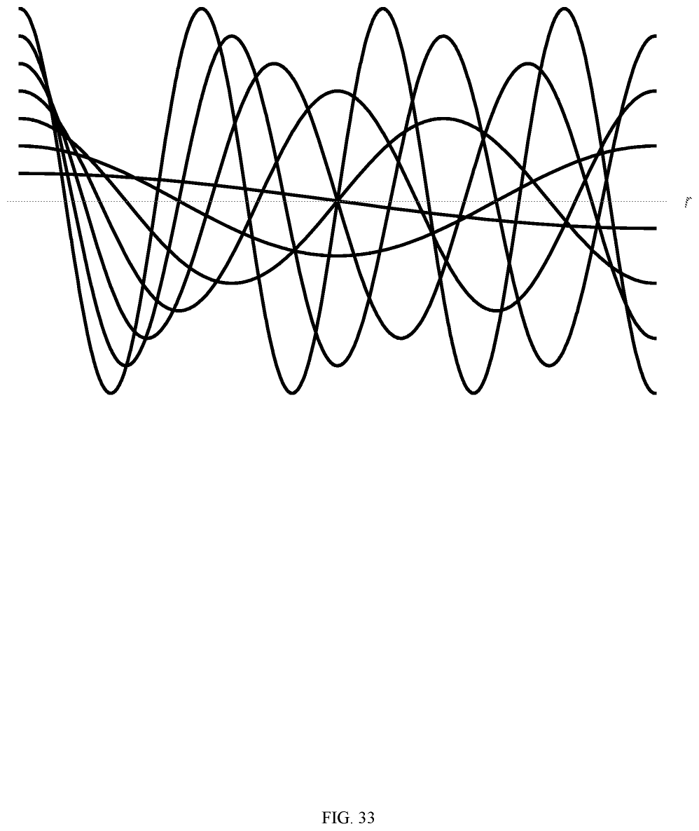

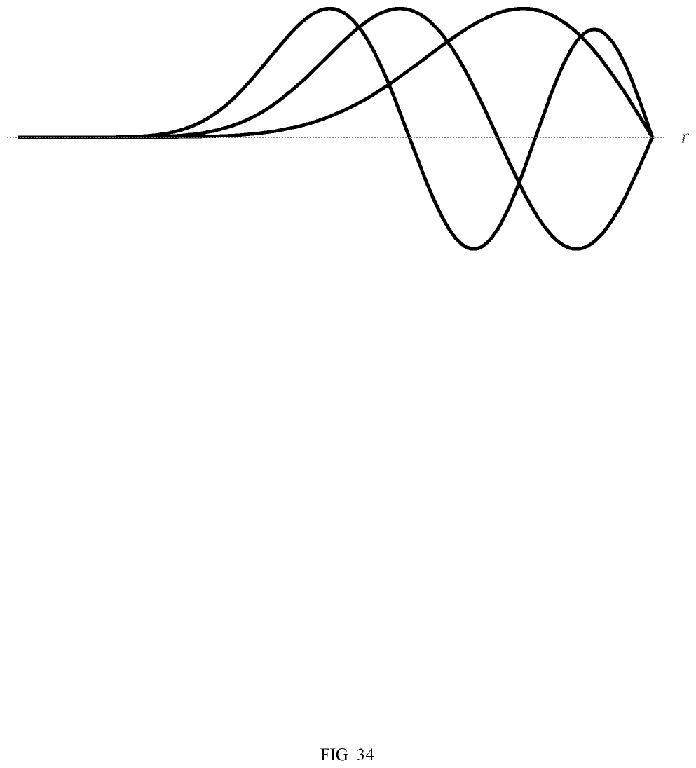

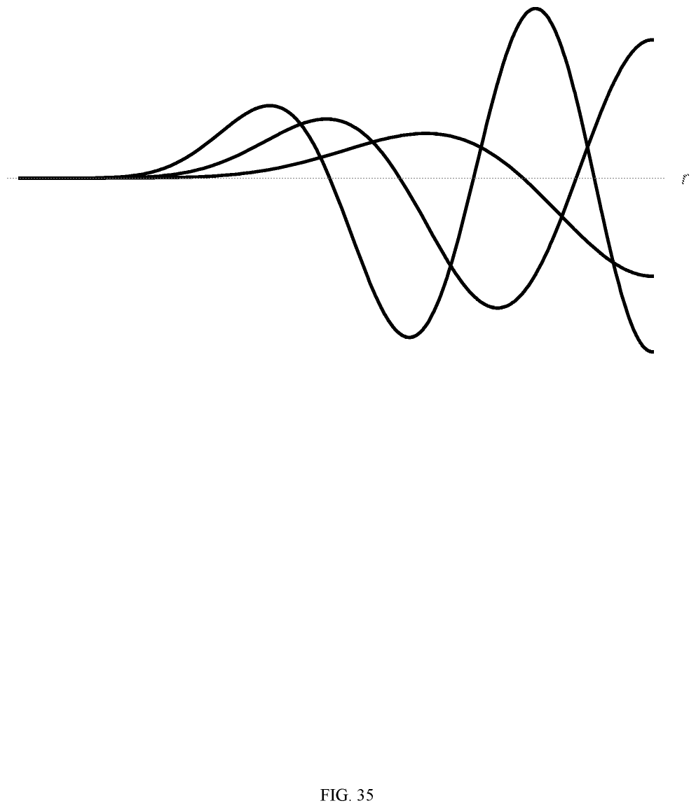

FIGS. 22 and 23 are non-limiting exemplary plots of a first and a second azimuthal eigenfunction of a conical cavity resonator, respectively. FIGS. 30 and 31 are non-limiting exemplary plots of a first and a second transverse electric polar eigenfunction of a conical cavity resonator, respectively. FIGS. 32 and 33 are non-limiting exemplary plots of a first and a second transverse electric radial eigenfunction of a conical cavity resonator, respectively. FIGS. 34 and 35 are non-limiting exemplary plots of a first and a second transverse electric evanescent radial eigenfunction of a conical cavity resonator, respectively.

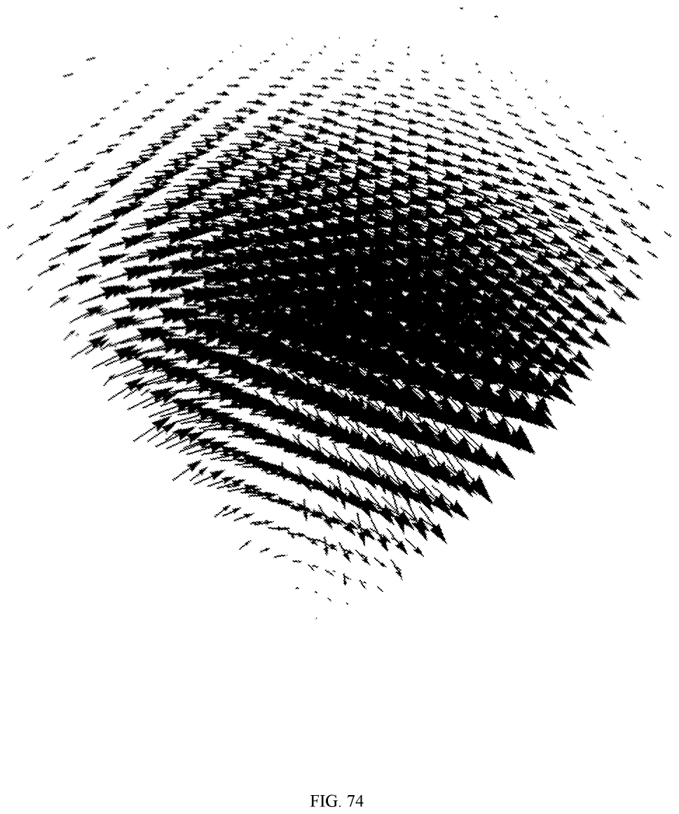

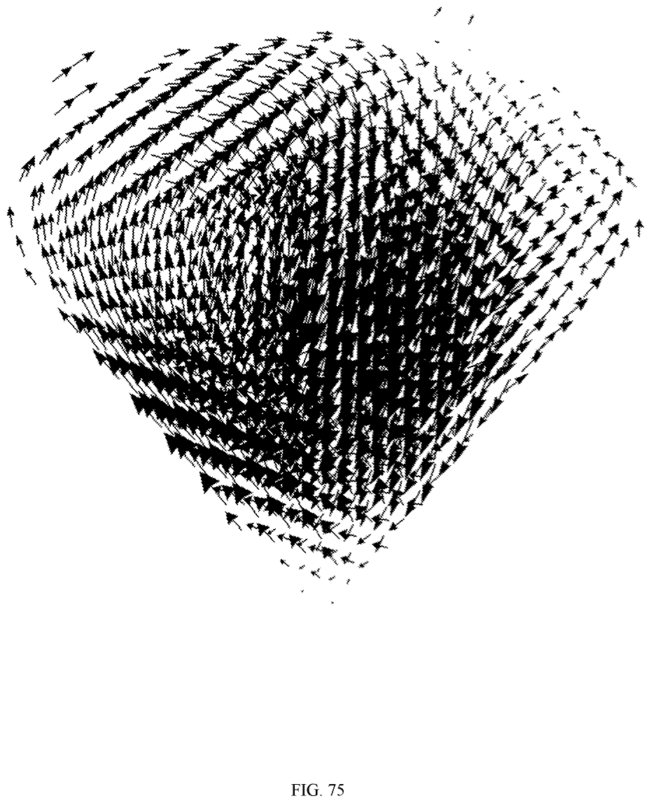

FIG. 74 is an exemplary perspective view of a first transverse electric three-dimensional electric field vector plot of a non-limiting conical cavity resonator. FIG. 75 is an exemplary perspective view of a first transverse electric three-dimensional magnetic field vector plot of a non-limiting conical cavity resonator.

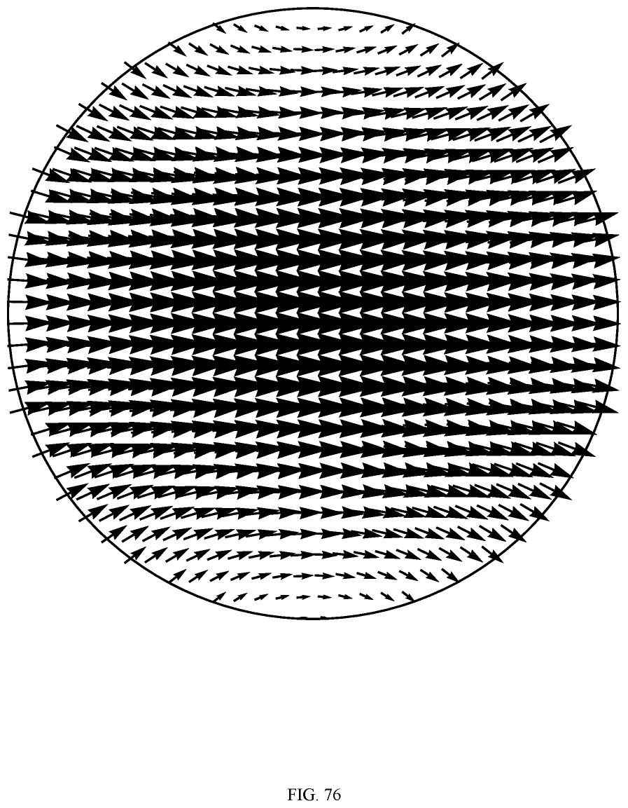

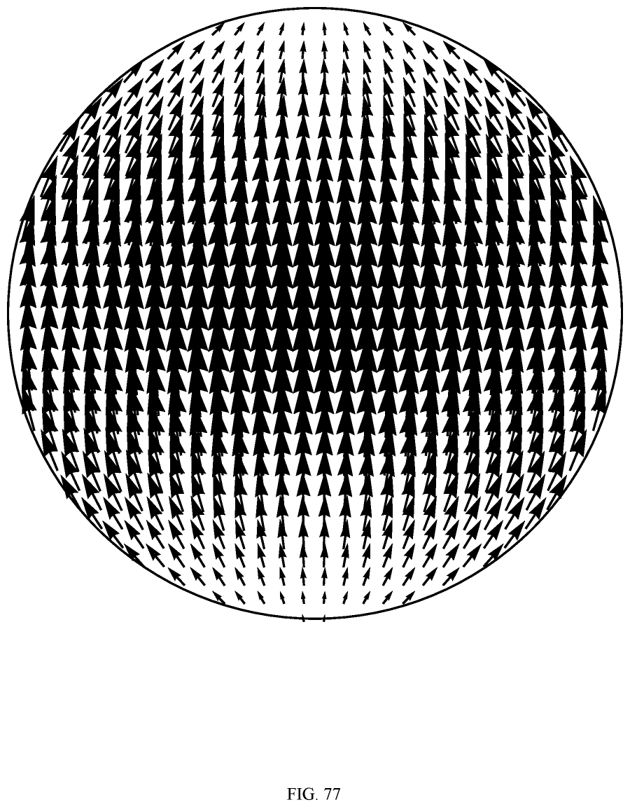

FIG. 76 is an exemplary axial cross section view of a first electric field transverse electric vector plot of a non-limiting conical cavity resonator. FIG. 77 is an exemplary axial cross section view of a first magnetic field transverse electric vector plot of a non-limiting conical cavity resonator.

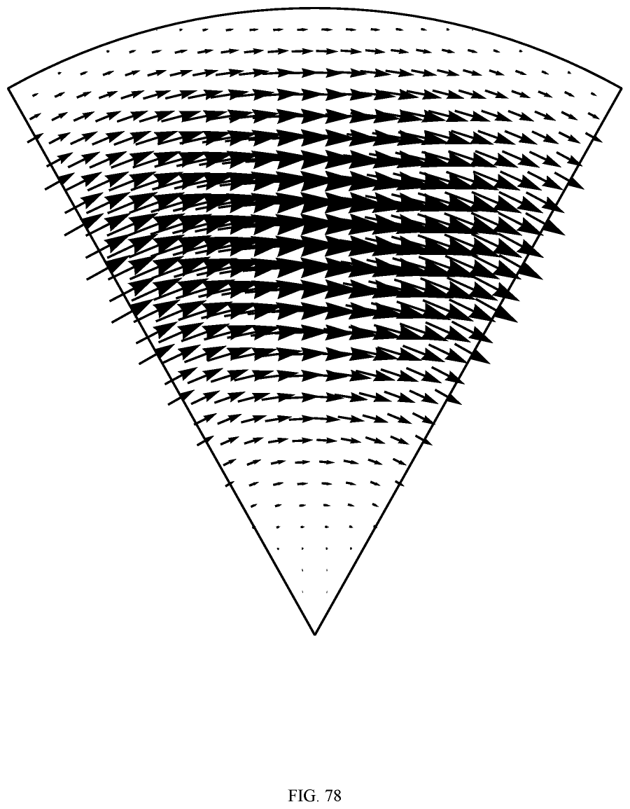

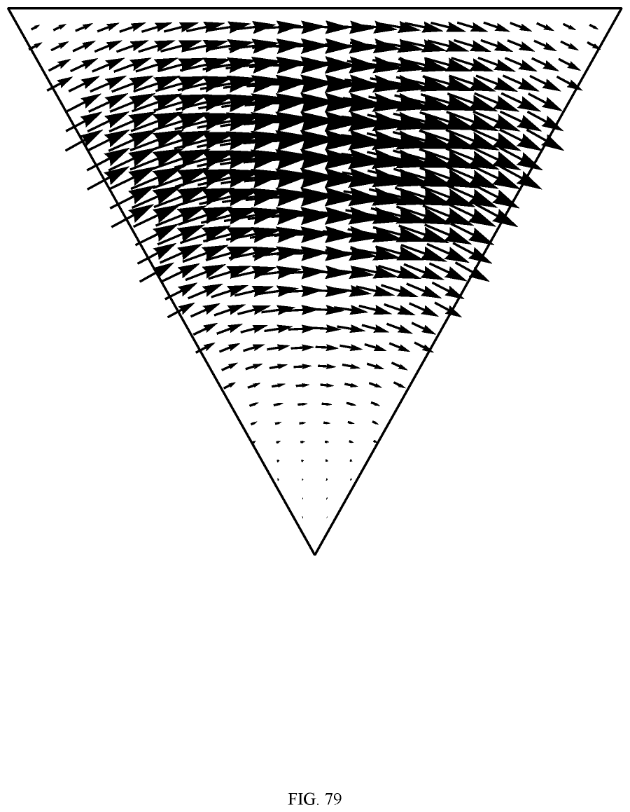

FIG. 78 is an exemplary radial cross section view of a first electric field transverse electric vector plot of a non-limiting conical cavity resonator. FIG. 79 is an exemplary radial cross section view of a first electric field transverse electric vector plot of a non-limiting conical cavity resonator comprising a substantially flat base interior surface.

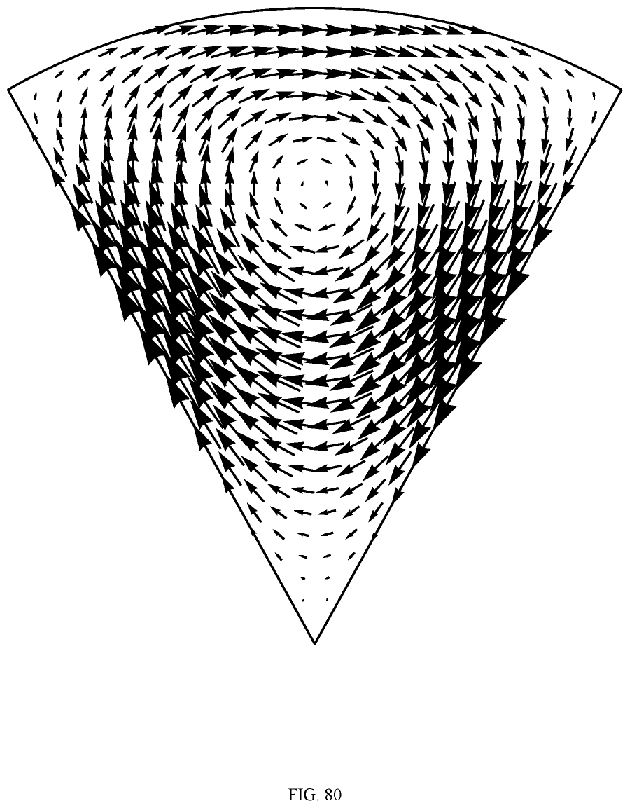

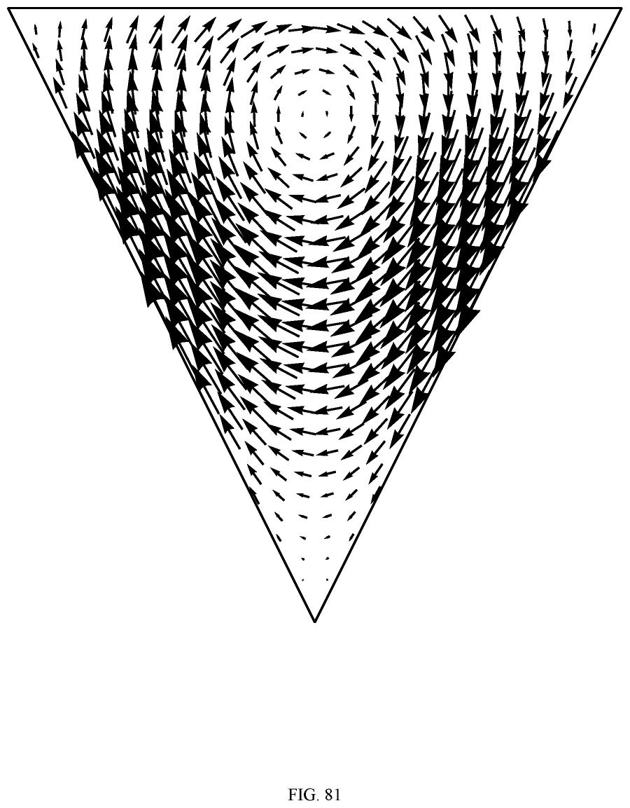

FIG. 80 is an exemplary radial cross section view of a first magnetic field transverse electric vector plot of a non-limiting conical cavity resonator. FIG. 81 is an exemplary radial cross section view of a first magnetic field transverse electric vector plot of a non-limiting conical cavity resonator comprising a substantially flat base interior surface.

As the size of the arrows in the above figures are positively correlated with an electric field and an electric field density, or with a magnetic field and a magnetic field density, the non-limiting conical cavity resonator exhibits one or both a highly asymmetric electric field and a highly asymmetric electric field density, and a highly asymmetric magnetic field and a highly asymmetric magnetic field density, wherein the electric field and the electric field density, and the magnetic field and the magnetic field density, are more concentrated away from the base interior surface.

### Example 2—Transverse Magnetic Wave Frequency of a Conical Cavity Resonator

In some embodiments, a frequency of a hollow conical cavity resonator is calculated per the equations below:

For an azimuthal eigenvalue (m) of the resonator:

m=n where n=0,1,2, . . .

For a polar eigenvalue (l), an azimuthal eigenvalue (m), a taper angle (θ₀), and a polar wave equation (Pₗ^{m}(cos θ)) of the resonator:

[Pₗ^{m}(cos θ)]_{θ=θ}_{₀}=0

For a radial eigenvalue (k), a polar eigenvalue (l), a radial length (r₁), and a radial wave equation (jₗ(kr)) of the resonator:

$${[ \frac{d}{dr} [ ( kr ) {j}_{l} ( kr ) ] ]}_{r = 0} = 0 {and [ \frac{d}{dr} [ ( kr ) {j}_{l} ( kr ) ] ]}_{r = {r}_{1}} = 0$$

For a radial eigenvalue (k), a polar eigenvalue (l), a radial length (r₁), and a radial wave equation (jₗ(kr)) of the resonator:

[(kr)jₗ(kr)]ᵣ₌₀=0 or [(kr)jₗ(kr)]ᵣ₌ᵣ_{₁}=0

For a frequency (f), a radial eigenvalue (k), and a speed of light (c) of the resonator:

$$f = \frac{kc}{2 π}$$

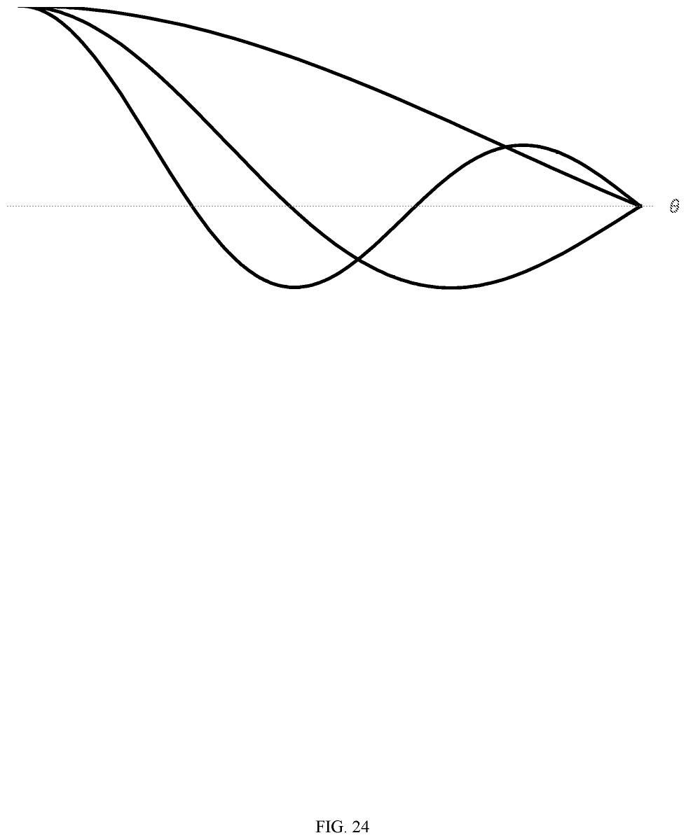

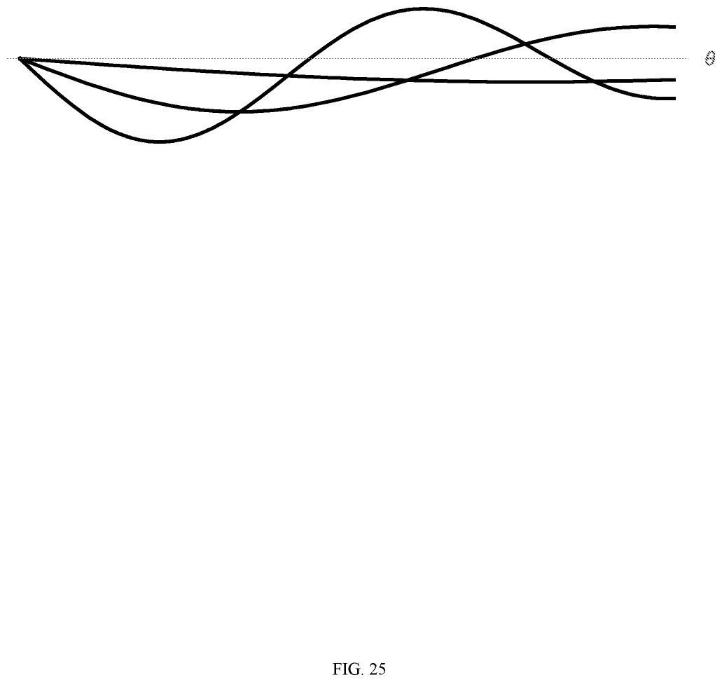

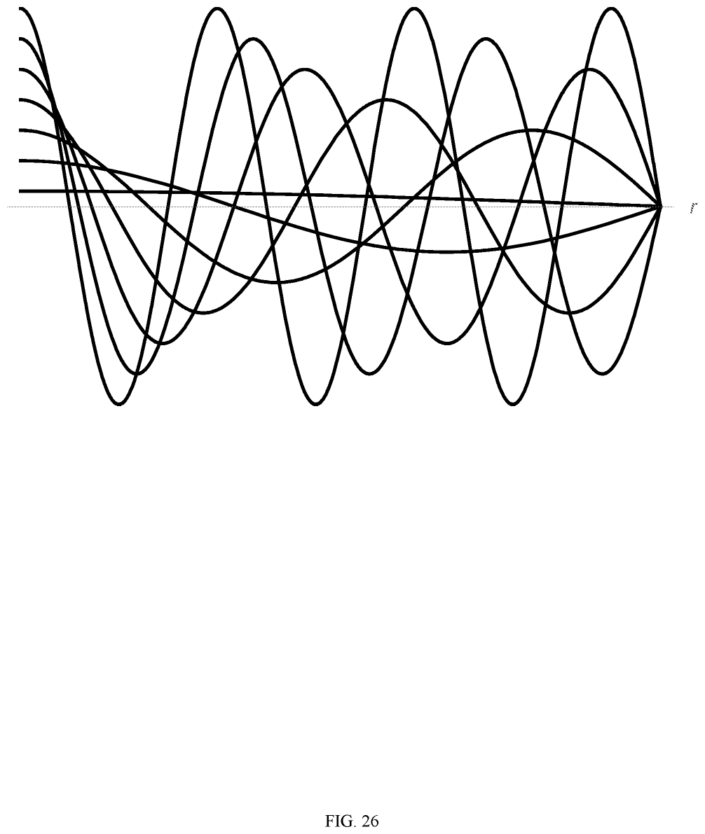

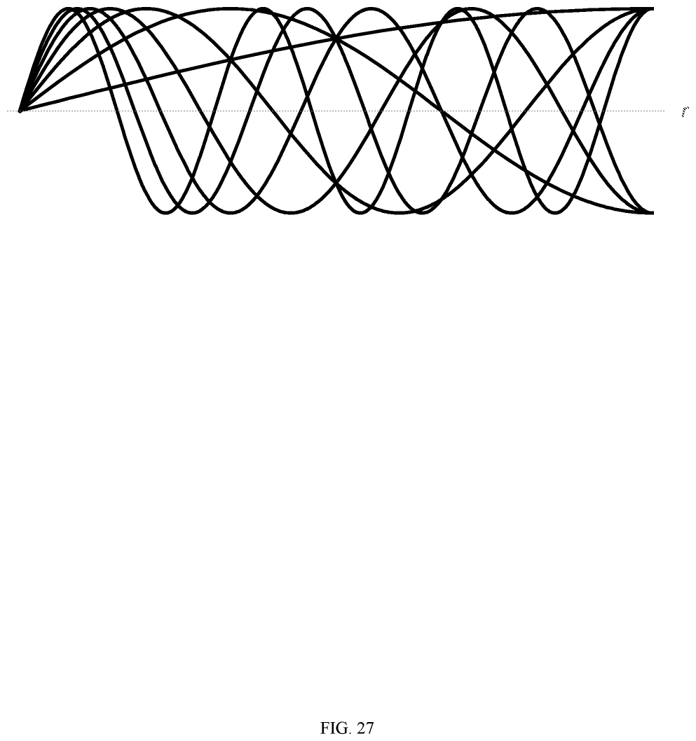

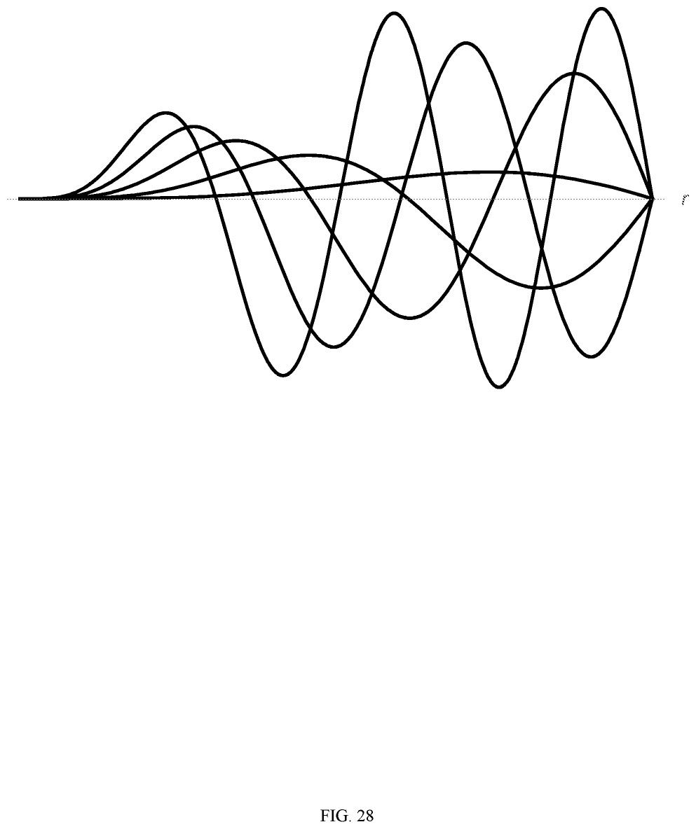

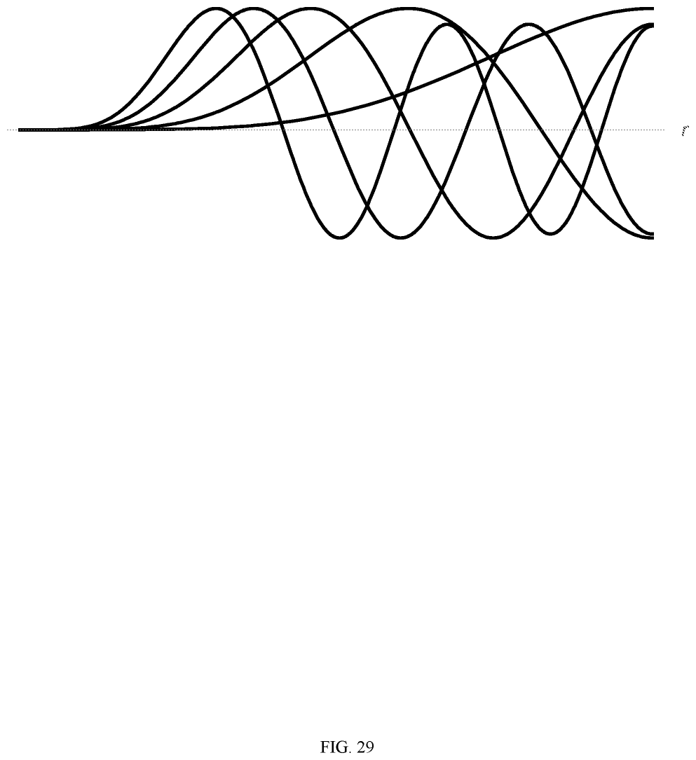

FIGS. 22 and 23 are non-limiting exemplary plots of a first and a second azimuthal eigenfunction of a conical cavity resonator, respectively. FIGS. 24 and 25 are non-limiting exemplary plots of a first and a second transverse magnetic polar eigenfunction of a conical cavity resonator, respectively. FIGS. 26 and 27 are non-limiting exemplary plots of a first and a second transverse magnetic radial eigenfunction of a conical cavity resonator, respectively. FIGS. 28 and 29 are non-limiting exemplary plots of a first and a second transverse magnetic evanescent radial eigenfunction of a conical cavity resonator, respectively.

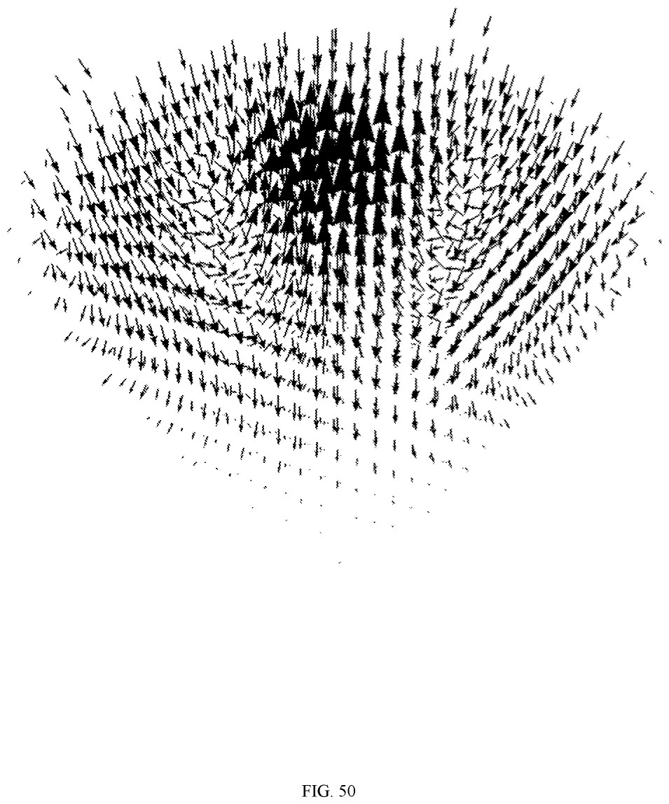

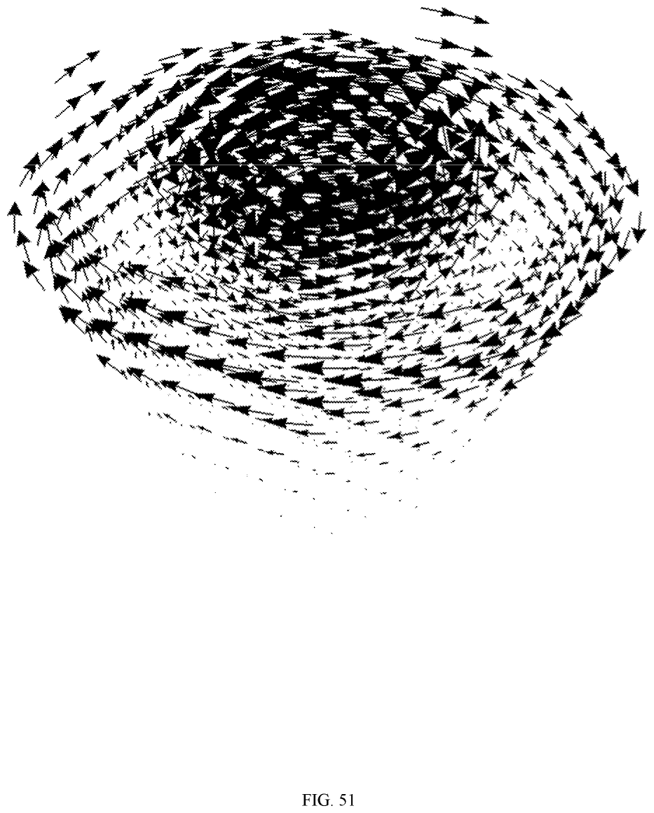

FIG. 50 is an exemplary perspective view of a first transverse magnetic three-dimensional electric field vector plot of a non-limiting conical cavity resonator. FIG. 51 is an exemplary perspective view of a first transverse magnetic three-dimensional magnetic field vector plot of a non-limiting conical cavity resonator.

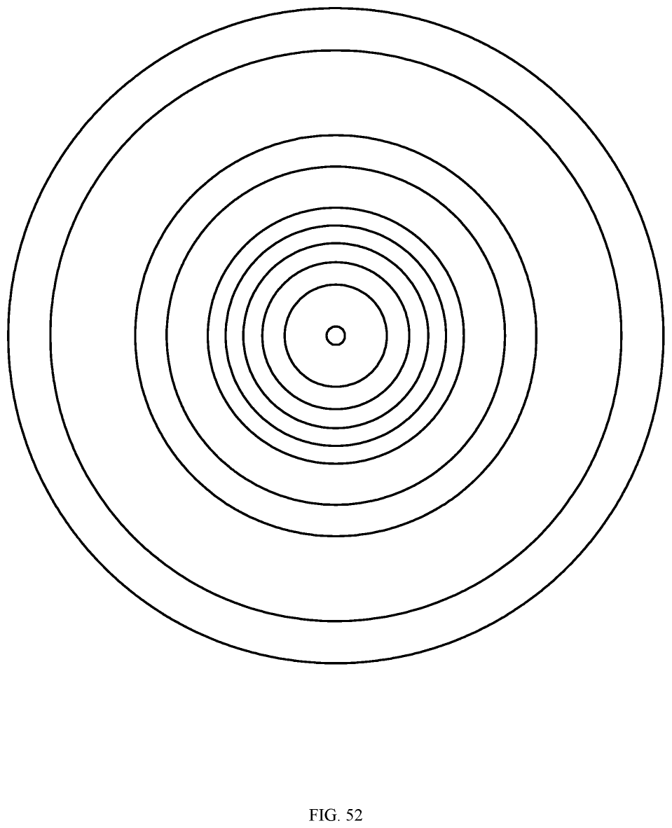

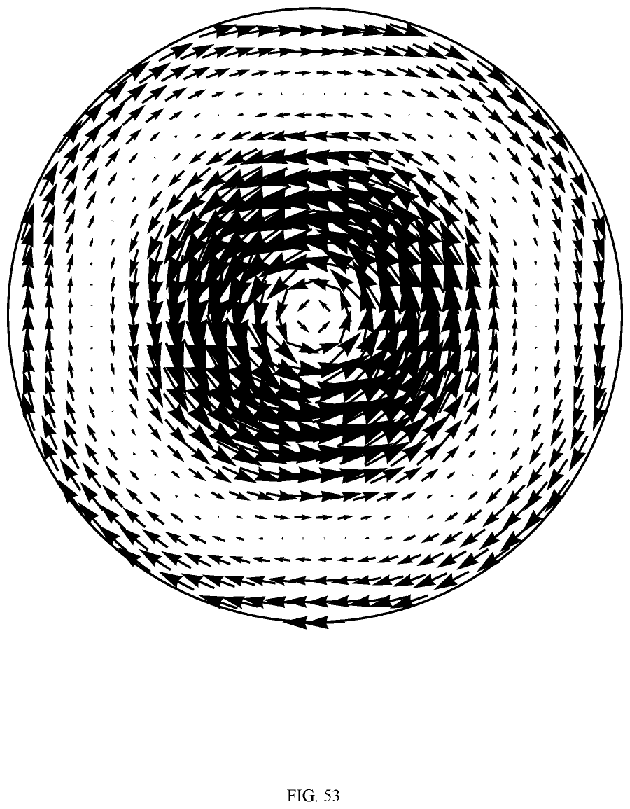

FIG. 52 is an exemplary axial cross section view of a first electric field transverse magnetic density plot of a non-limiting conical cavity resonator. FIG. 53 is an exemplary axial cross section view of a first magnetic field transverse magnetic vector plot of a non-limiting conical cavity resonator.

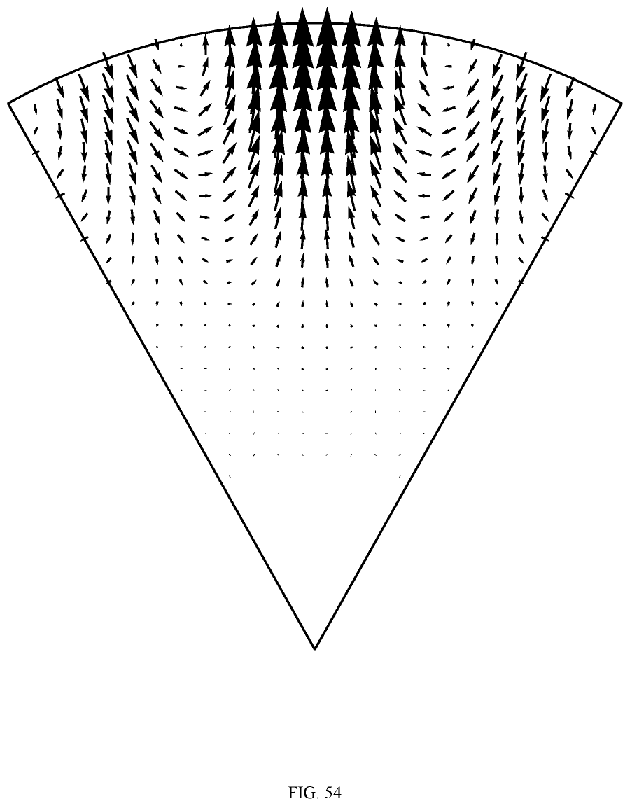

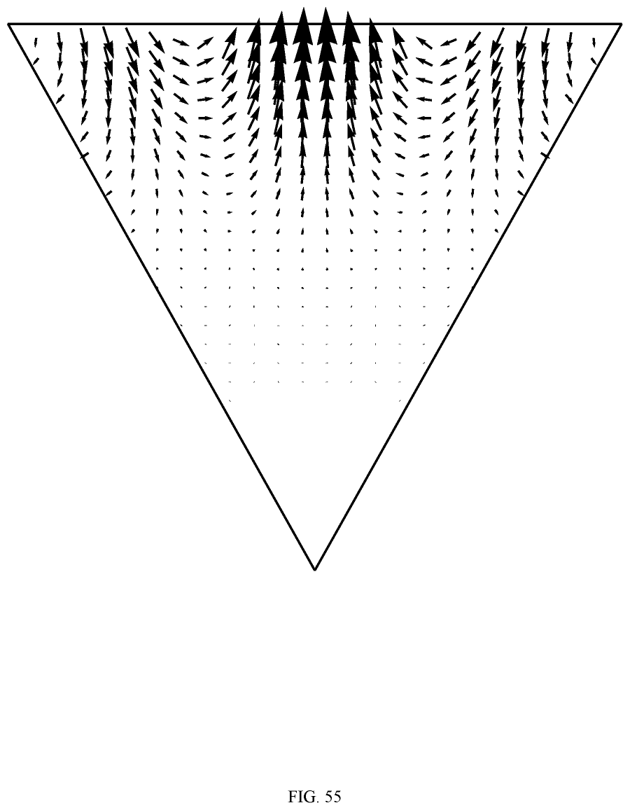

FIG. 54 is an exemplary radial cross section view of a first electric field transverse magnetic vector plot of a non-limiting conical cavity resonator. FIG. 55 is an exemplary radial cross section view of a first electric field transverse magnetic vector plot of a non-limiting conical cavity resonator comprising a substantially flat base interior surface.

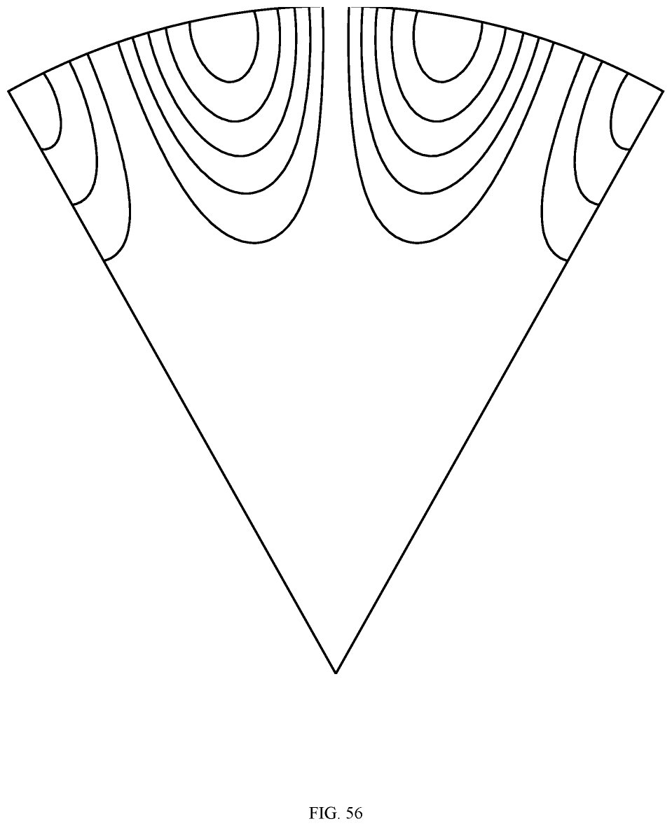

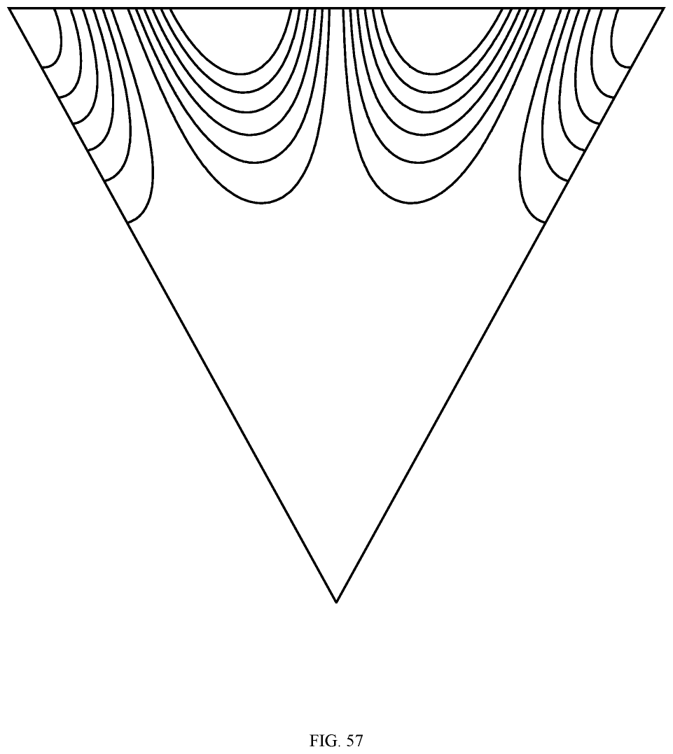

FIG. 56 is an exemplary radial cross section view of a first magnetic field transverse magnetic density plot of a non-limiting conical cavity resonator. FIG. 57 is an exemplary radial cross section view of a first magnetic field transverse magnetic density plot of a non-limiting conical cavity resonator comprising a substantially flat base interior surface.

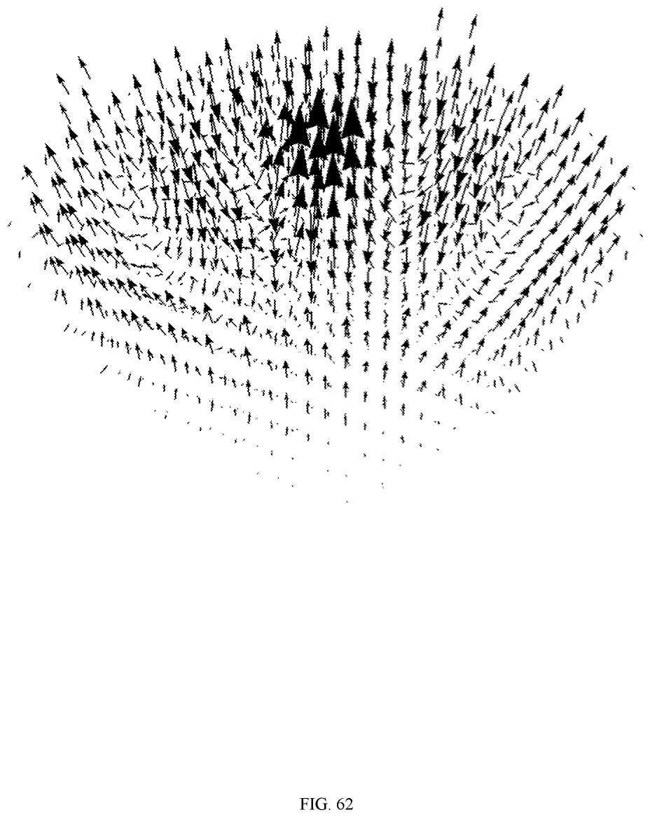

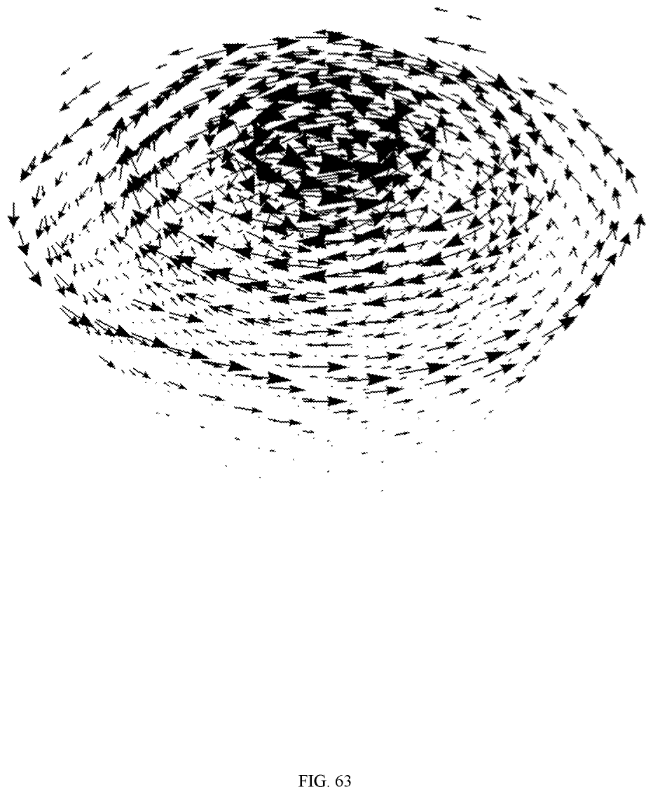

FIG. 62 is an exemplary perspective view of a second transverse magnetic three-dimensional electric field vector plot of a non-limiting conical cavity resonator. FIG. 63 is an exemplary perspective view of a second transverse magnetic three-dimensional magnetic field vector plot of a non-limiting conical cavity resonator.

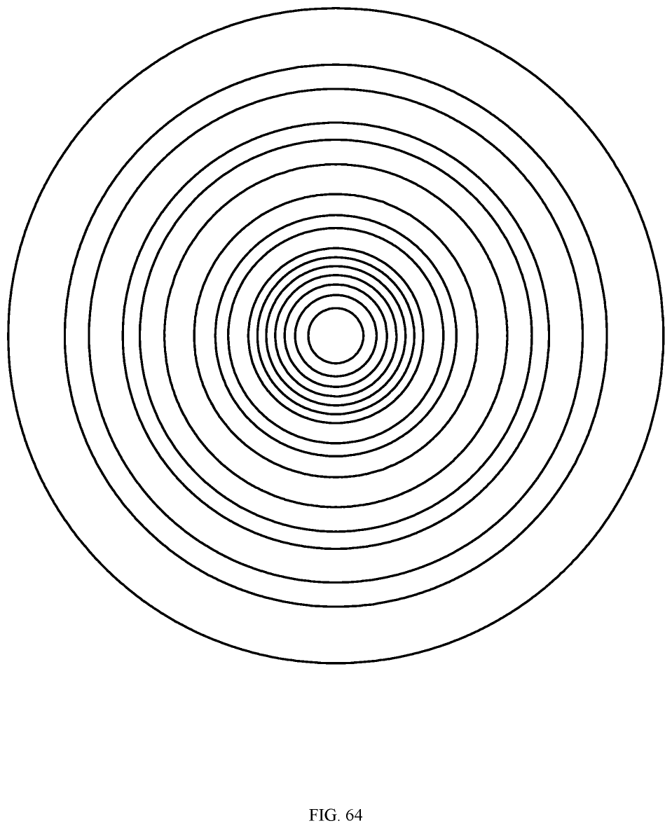

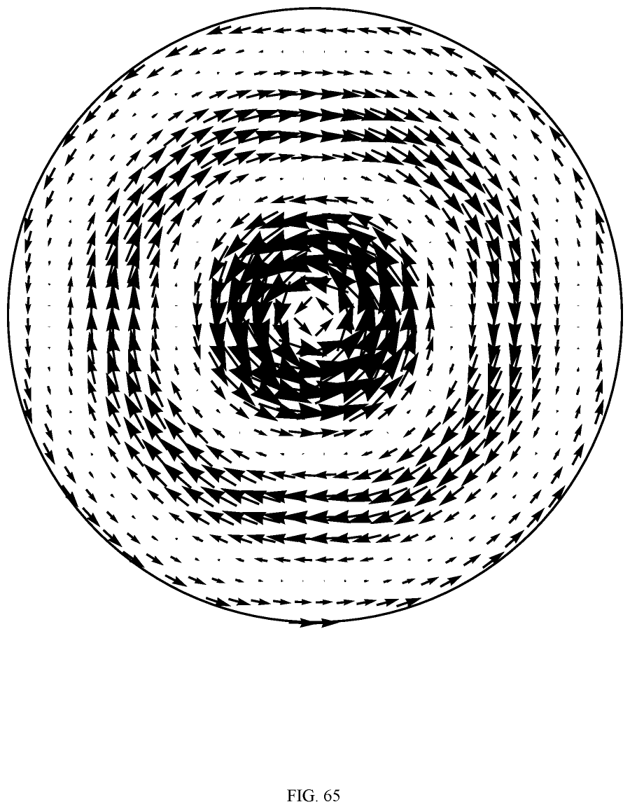

FIG. 64 is an exemplary axial cross section view of a second electric field transverse magnetic density plot of a non-limiting conical cavity resonator. FIG. 65 is an exemplary axial cross section view of a second magnetic field transverse magnetic vector plot of a non-limiting conical cavity resonator.

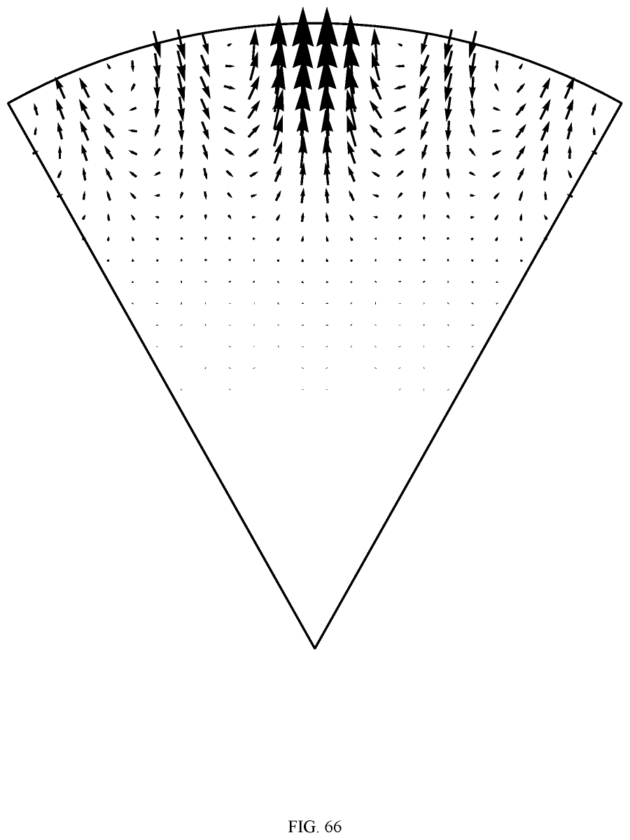

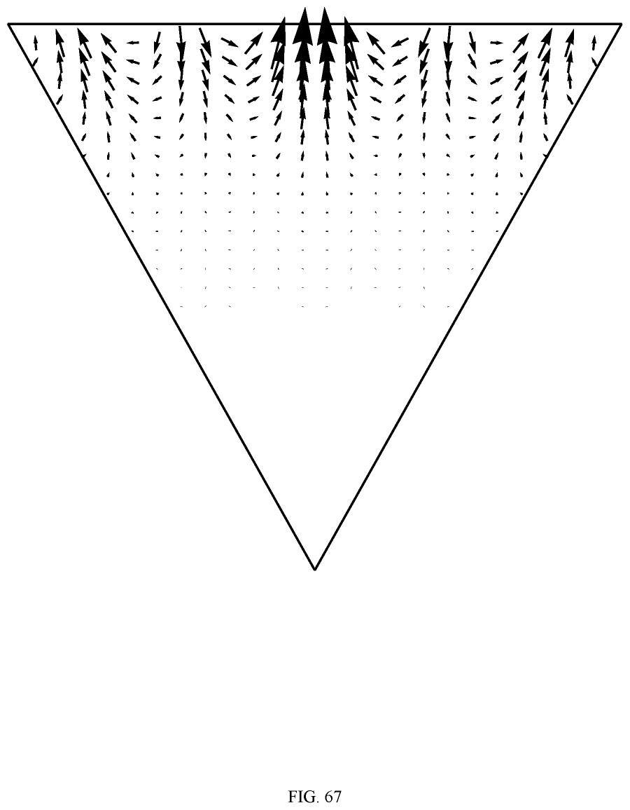

FIG. 66 is an exemplary radial cross section view of a second electric field transverse magnetic vector plot of a non-limiting conical cavity resonator. FIG. 67 is an exemplary radial cross section view of a second electric field transverse magnetic vector plot of a non-limiting conical cavity resonator comprising a substantially flat base interior surface.

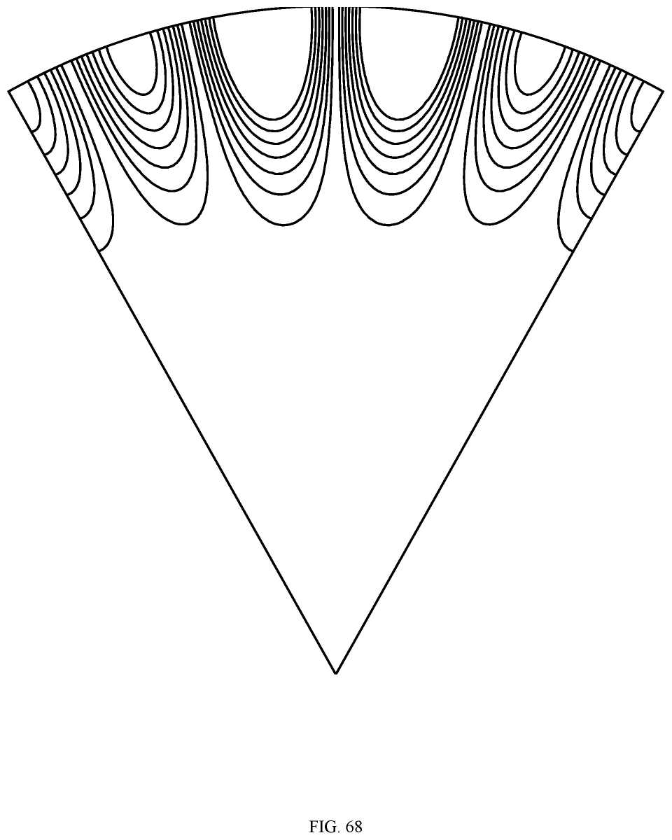

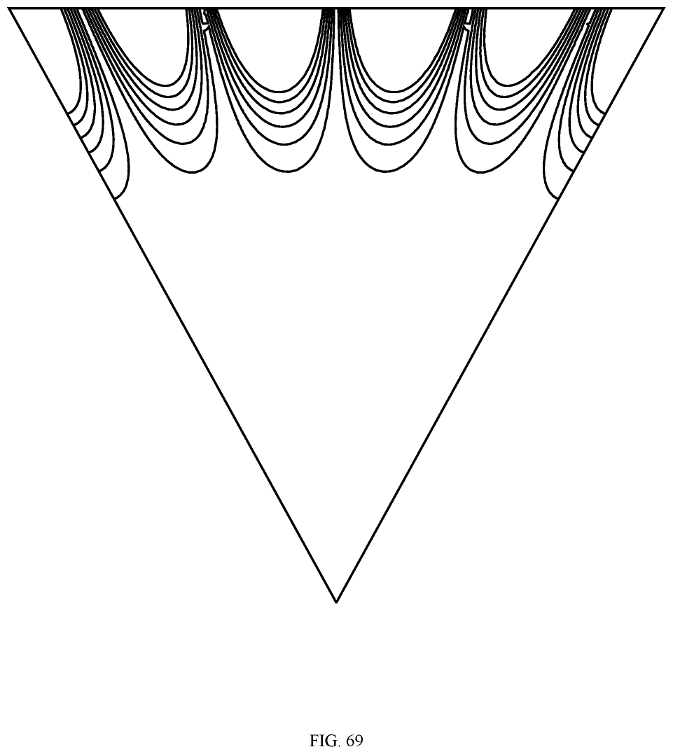

FIG. 68 is an exemplary radial cross section view of a second magnetic field transverse magnetic density plot of a non-limiting conical cavity resonator. FIG. 69 is an exemplary radial cross section view of a second magnetic field transverse magnetic density plot of a non-limiting conical cavity resonator comprising a substantially flat base interior surface.

As the size of the arrows in the above figures are positively correlated with an electric field and an electric field density, or with a magnetic field and a magnetic field density, the non-limiting conical cavity resonator exhibits one or both a highly asymmetric electric field and a highly asymmetric electric field density, and a highly asymmetric magnetic field and a highly asymmetric magnetic field density, wherein the electric field and the electric field density, and the magnetic field and the magnetic field density, are more concentrated away from the tapered interior surface.

### Example 3—Transverse Electric Wave Frequency of a Truncated Conical Cavity Resonator

In some embodiments, a frequency of a hollow conical cavity resonator is calculated per the equations below:

For an azimuthal eigenvalue (m) of the resonator:

m=n where n=0,1,2, . . .

For a polar eigenvalue (l), an azimuthal eigenvalue (m), a taper angle (θ₀), and a polar wave equation (Pₗ^{m}(cos θ)) of the resonator:

$${[ \frac{d}{d θ} [ {P}_{l}^{m} ( cos θ ) ] ]}_{θ = {θ}_{0}} = 0$$

For a radial eigenvalue (k), a polar eigenvalue (l), a truncated radial length (r₀), a radial length (r₁), and a radial wave equation (hₗ(kr)) of the resonator:

[(kr)hₗ(kr)]ᵣ₌ᵣ_{₀}=0 and [(kr)hₗ(kr)]ᵣ₌ᵣ_{₁}=0

For a radial eigenvalue (k), a polar eigenvalue (l), a radial length (r₁), a truncated radial length (r₀), and a radial wave equation (hₗ(kr)) of the resonator:

$${[ \frac{d}{dr} [ ( kr ) {h}_{l} ( kr ) ] ]}_{r = 0} = 0 {or [ \frac{d}{dr} [ ( kr ) {h}_{l} ( kr ) ] ]}_{r = {r}_{1}} = 0$$

For a frequency (f), a radial eigenvalue (k), and a speed of light (c) of the resonator:

$$f = \frac{kc}{2 π}$$

FIGS. 22 and 23 are non-limiting exemplary plots of a first and a second azimuthal eigenfunction of a conical cavity resonator, respectively. FIGS. 30 and 31 are non-limiting exemplary plots of a first and a second transverse electric polar eigenfunction of a conical cavity resonator, respectively. FIGS. 32 and 33 are non-limiting exemplary plots of a first and a second transverse electric radial eigenfunction of a conical cavity resonator, respectively. FIGS. 34 and 35 are non-limiting exemplary plots of a first and a second transverse electric evanescent radial eigenfunction of a conical cavity resonator, respectively.

FIG. 74 is an exemplary perspective view of a first transverse electric three-dimensional electric field vector plot of a non-limiting conical cavity resonator. FIG. 75 is an exemplary perspective view of a first transverse electric three-dimensional magnetic field vector plot of a non-limiting conical cavity resonator.

FIG. 76 is an exemplary axial cross section view of a first electric field transverse electric vector plot of a non-limiting conical cavity resonator. FIG. 77 is an exemplary axial cross section view of a first magnetic field transverse electric vector plot of a non-limiting conical cavity resonator.

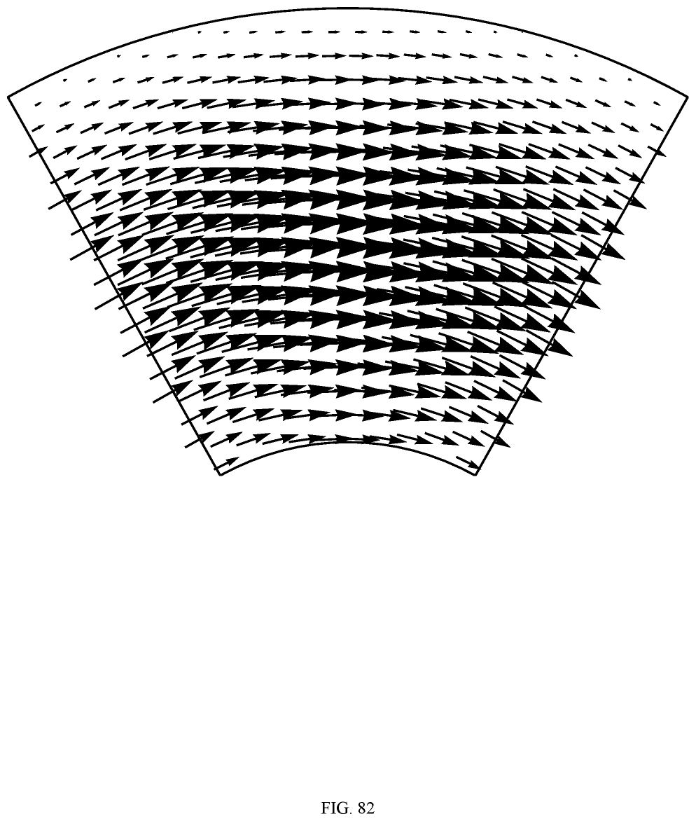

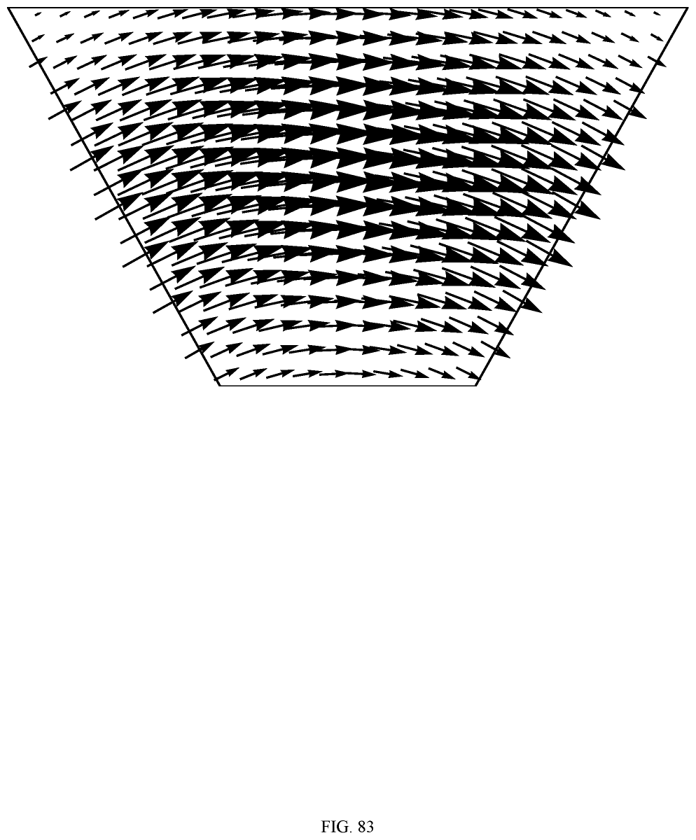

FIG. 82 is an exemplary radial cross section view of a first electric field transverse electric vector plot of a non-limiting truncated conical cavity resonator. FIG. 83 is an exemplary radial cross section view of a first electric field transverse electric vector plot of a non-limiting truncated conical cavity resonator comprising a substantially flat base and truncated interior surfaces.

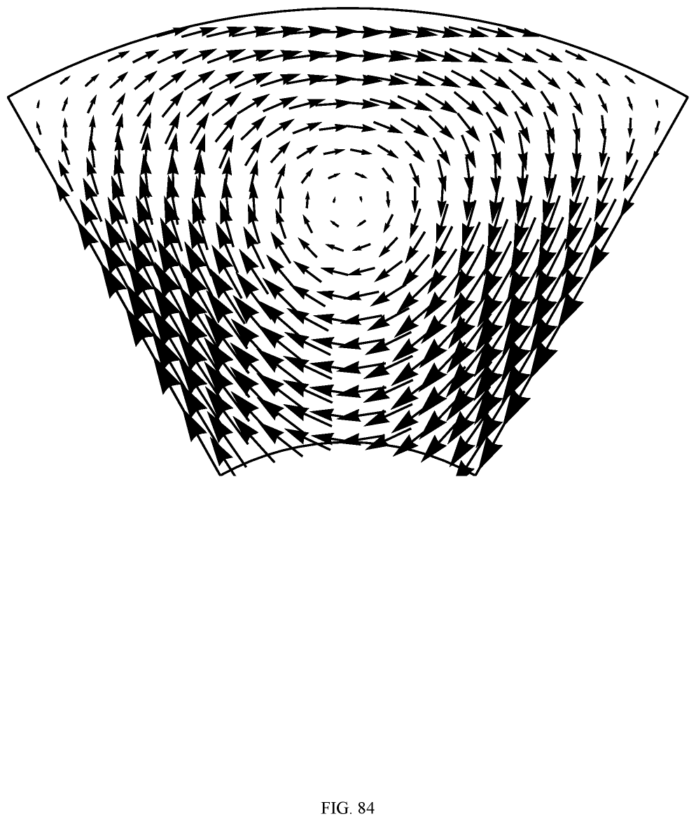

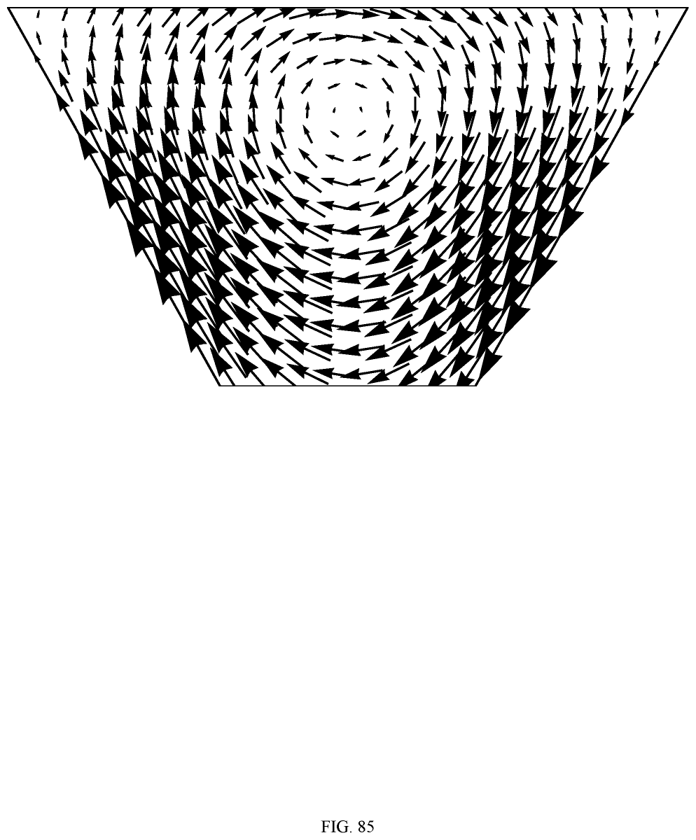

FIG. 84 is an exemplary radial cross section view of a first magnetic field transverse electric vector plot of a non-limiting truncated conical cavity resonator. FIG. 85 is an exemplary radial cross section view of a first magnetic field transverse electric vector plot of a non-limiting truncated conical cavity resonator comprising a substantially flat base and truncated interior surfaces.

As the size of the arrows in the above figures are positively correlated with an electric field and an electric field density, or with a magnetic field and a magnetic field density, the non-limiting conical cavity resonator exhibits one or both a highly asymmetric electric field and a highly asymmetric electric field density, and a highly asymmetric magnetic field and a highly asymmetric magnetic field density, wherein the electric field and the electric field density, and the magnetic field and the magnetic field density, are more concentrated away from the base interior surface.

### Example 4—Transverse Magnetic Wave Frequency of a Truncated Conical Cavity Resonator

In some embodiments, a frequency of a hollow conical cavity resonator is calculated per the equations below:

For an azimuthal eigenvalue (m) of the resonator:

m=n where n=0,1,2, . . .

For a polar eigenvalue (l), an azimuthal eigenvalue (m), a taper angle (θ₀), and a polar wave equation (Pₗ^{m}(cos θ)) of the resonator:

[Pₗ^{m}(cos θ)]_{θ=θ}_{₀}=0

For a radial eigenvalue (k), a polar eigenvalue (l), a truncated radial length (r₀), a radial length (r₁), and a radial wave equation (hₗ(kr)) of the resonator:

$${[ \frac{d}{dr} [ ( kr ) {h}_{l} ( kr ) ] ]}_{r = 0} = 0 {and [ \frac{d}{dr} [ ( kr ) {h}_{l} ( kr ) ] ]}_{r = {r}_{1}}$$

For a radial eigenvalue (k), a polar eigenvalue (l), a truncated radial length (r₀), a radial length (r₁), and a radial wave equation (hₗ(kr)) of the resonator:

[(kr)hₗ(kr)]ᵣ₌ᵣ_{₀}=0 or [(kr)hₗ(kr)]ᵣ₌ᵣ_{₁}=0

For a frequency (f), a radial eigenvalue (k), and a speed of light (c) of the resonator:

$$f = \frac{kc}{2 π}$$

FIGS. 22 and 23 are non-limiting exemplary plots of a first and a second azimuthal eigenfunction of a conical cavity resonator, respectively. FIGS. 24 and 25 are non-limiting exemplary plots of a first and a second transverse magnetic polar eigenfunction of a conical cavity resonator, respectively. FIGS. 26 and 27 are non-limiting exemplary plots of a first and a second transverse magnetic radial eigenfunction of a conical cavity resonator, respectively. FIGS. 28 and 29 are non-limiting exemplary plots of a first and a second transverse magnetic evanescent radial eigenfunction of a conical cavity resonator, respectively.

FIG. 50 is an exemplary perspective view of a first transverse magnetic three-dimensional electric field vector plot of a non-limiting conical cavity resonator. FIG. 51 is an exemplary perspective view of a first transverse magnetic three-dimensional magnetic field vector plot of a non-limiting conical cavity resonator.

FIG. 52 is an exemplary axial cross section view of a first electric field transverse magnetic density plot of a non-limiting conical cavity resonator. FIG. 53 is an exemplary axial cross section view of a first magnetic field transverse magnetic vector plot of a non-limiting conical cavity resonator.

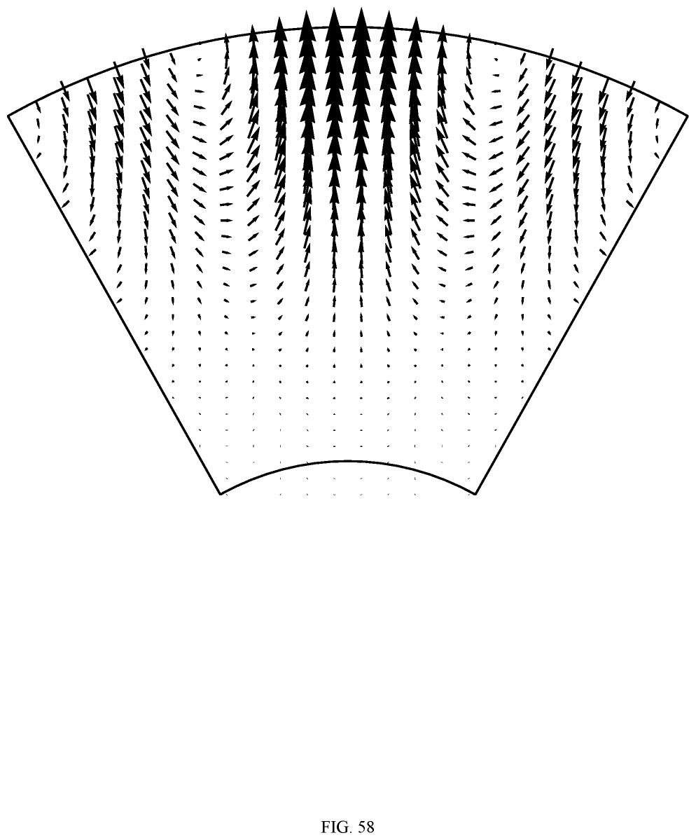

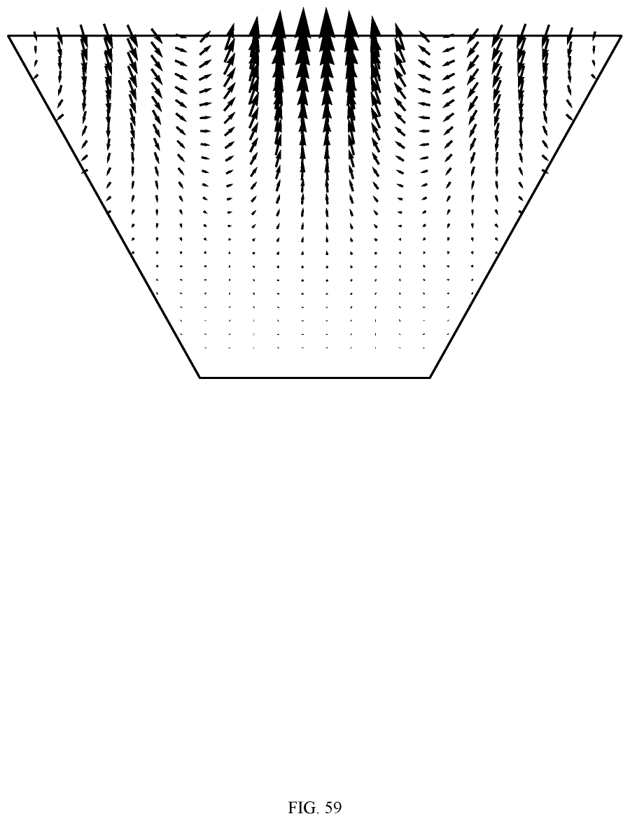

FIG. 58 is an exemplary radial cross section view of a first electric field transverse magnetic vector plot of a non-limiting truncated conical cavity resonator. FIG. 59 is an exemplary radial cross section view of a first electric field transverse magnetic vector plot of a non-limiting truncated conical cavity resonator comprising a substantially flat base and truncated interior surfaces.

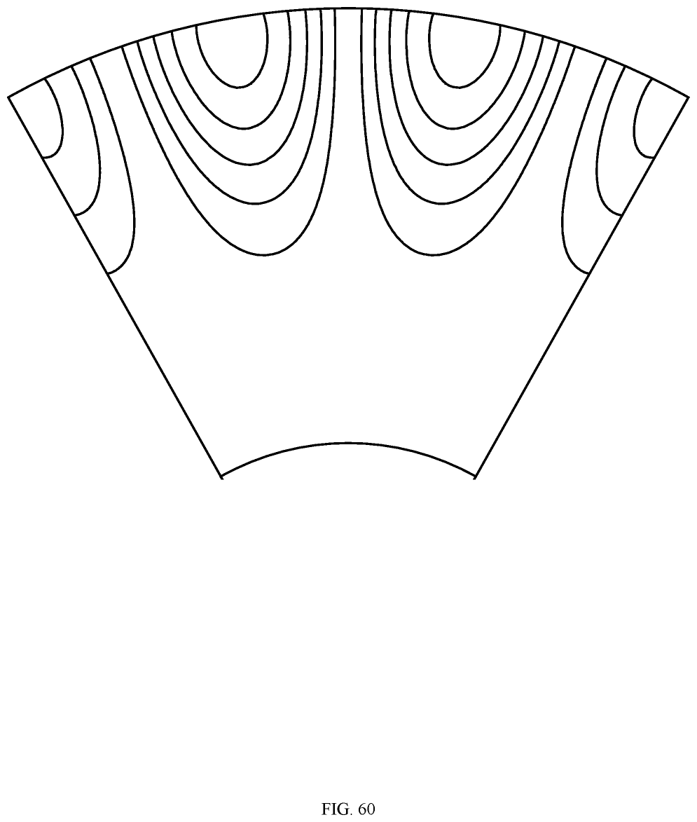

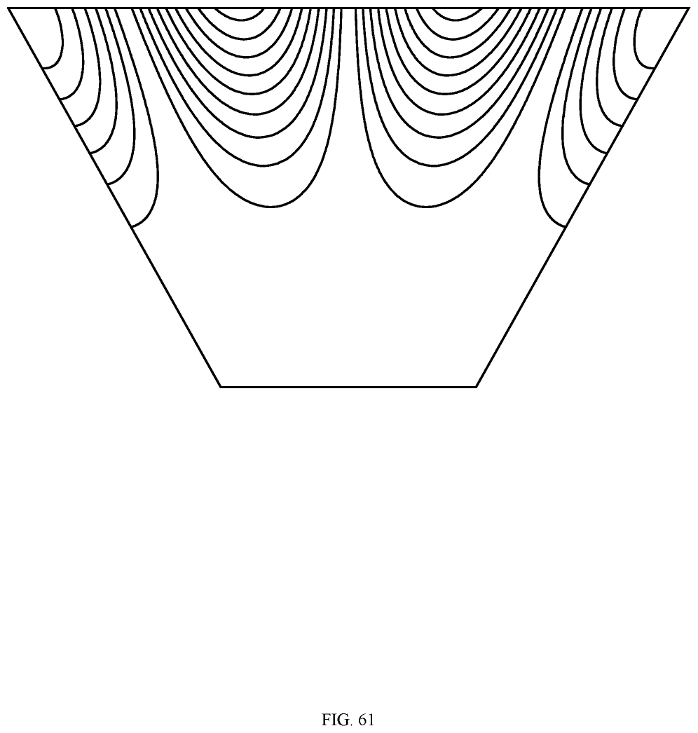

FIG. 60 is an exemplary radial cross section view of a first magnetic field transverse magnetic density plot of a non-limiting truncated conical cavity resonator. FIG. 61 is an exemplary radial cross section view of a first magnetic field transverse magnetic density plot of a non-limiting truncated conical cavity resonator comprising a substantially flat base and truncated interior surfaces.

FIG. 62 is an exemplary perspective view of a second transverse magnetic three-dimensional electric field vector plot of a non-limiting conical cavity resonator. FIG. 63 is an exemplary perspective view of a second transverse magnetic three-dimensional magnetic field vector plot of a non-limiting conical cavity resonator.

FIG. 64 is an exemplary axial cross section view of a second electric field transverse magnetic density plot of a non-limiting conical cavity resonator. FIG. 65 is an exemplary axial cross section view of a second magnetic field transverse magnetic vector plot of a non-limiting conical cavity resonator.

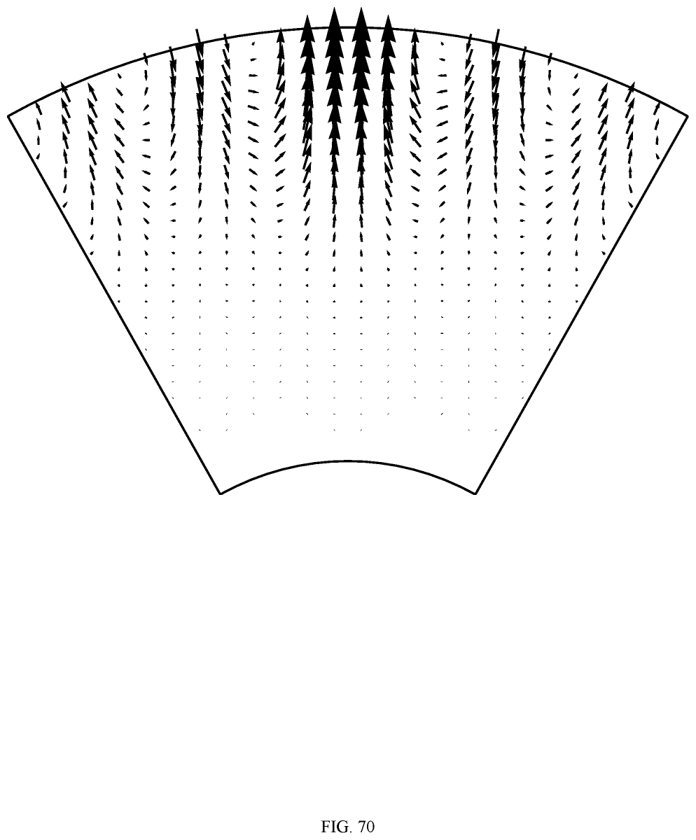

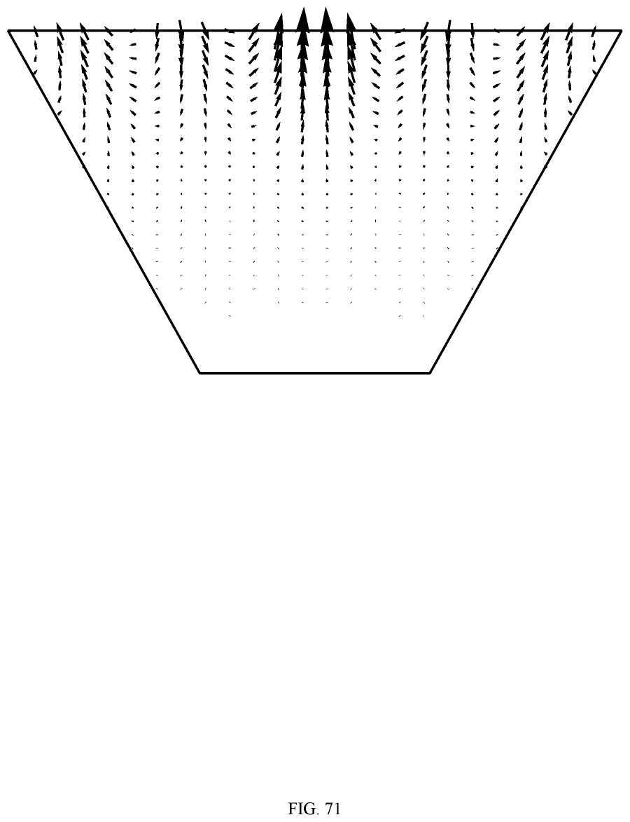

FIG. 70 is an exemplary radial cross section view of a second electric field transverse magnetic vector plot of a non-limiting truncated conical cavity resonator. FIG. 71 is an exemplary radial cross section view of a second electric field transverse magnetic vector plot of a non-limiting truncated conical cavity resonator comprising a substantially flat base and truncated interior surfaces.

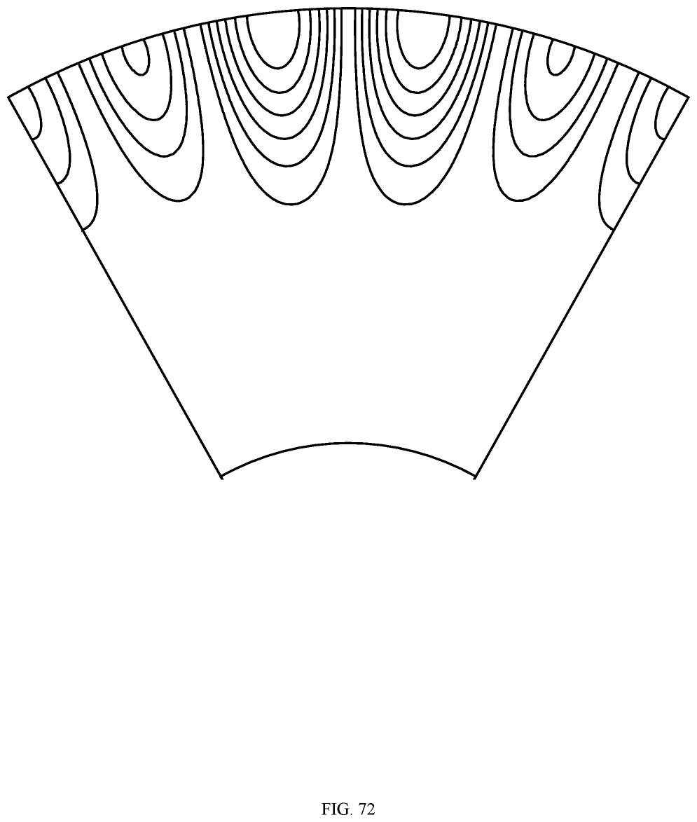

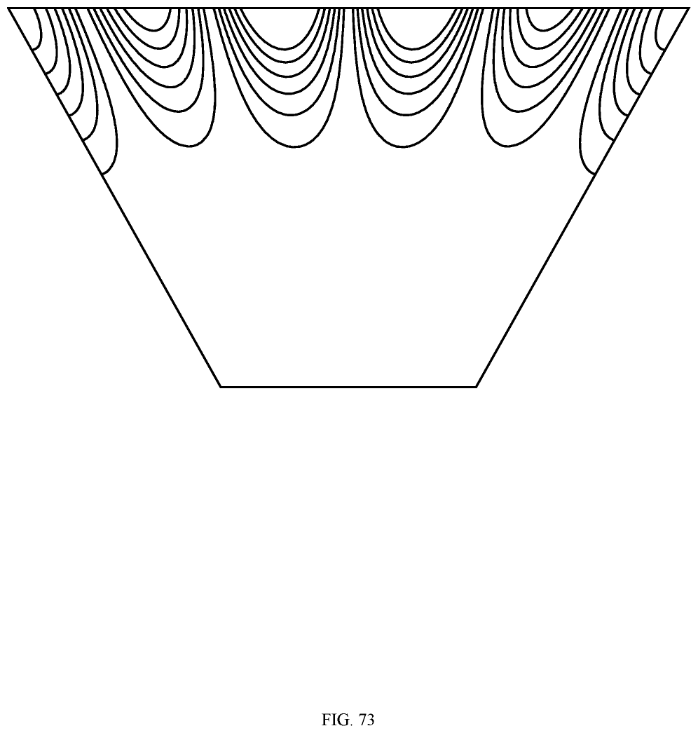

FIG. 72 is an exemplary radial cross section view of a second magnetic field transverse magnetic density plot of a non-limiting truncated conical cavity resonator. FIG. 73 is an exemplary radial cross section view of a second magnetic field transverse magnetic density plot of a non-limiting truncated conical cavity resonator comprising a substantially flat base and truncated interior surfaces.

As the size of the arrows in the above figures are positively correlated with an electric field and an electric field density, or with a magnetic field and a magnetic field density, the non-limiting conical cavity resonator exhibits one or both a highly asymmetric electric field and a highly asymmetric electric field density, and a highly asymmetric magnetic field and a highly asymmetric magnetic field density, wherein the electric field and the electric field density, and the magnetic field and the magnetic field density, are more concentrated away from one or both the tapered interior surface and the truncated interior surface.

### Example 5—Transverse Electric Wave Frequency of a Pyramidal Cavity Resonator

In some embodiments, a frequency of a hollow pyramidal cavity resonator is calculated per the equations below:

For an azimuthal eigenvalue (m) and a taper angle (φ₀) of the resonator:

$$m = \frac{n π}{{ϕ}_{0}} where n = 0 , 1 , 2 , …$$

For a polar eigenvalue (l), an azimuthal eigenvalue (m), a taper angle (θ₀), a polar wave equation (Pₗ^{m}(cos θ)), and a polar wave equation (Qₗ^{m}(cos θ)) of the resonator:

$${[ \frac{d}{d θ} [ {P}_{l}^{m} ( cos \frac{{θ}_{0}}{2} ) {Q}_{l}^{m} ( - cos \frac{{θ}_{0}}{2} ) - {P}_{l}^{m} ( - cos \frac{{θ}_{0}}{2} ) {Q}_{l}^{m} ( cos \frac{{θ}_{0}}{2} ) ] ]}_{θ = {θ}_{0}} = 0$$

For a radial eigenvalue (k), a polar eigenvalue (l), a radial length (r₁), and a radial wave equation (jₗ(kr)) of the resonator:

[(kr)jₗ(kr)]ᵣ₌₀=0 and [(kr)jₗ(kr)]ᵣ₌ᵣ_{₁}=0

For a radial eigenvalue (k), a polar eigenvalue (l), a radial length (r₁), and a radial wave equation (jₗ(kr)) of the resonator:

$${[ \frac{d}{dr} [ ( kr ) {j}_{l} ( kr ) ] ]}_{r = 0} = 0 {or [ \frac{d}{dr} [ ( kr ) {j}_{l} ( kr ) ] ]}_{r = {r}_{1}} = 0$$

For a frequency (f), a radial eigenvalue (k), and a speed of light (c) of the resonator:

$$f = \frac{kc}{2 π}$$

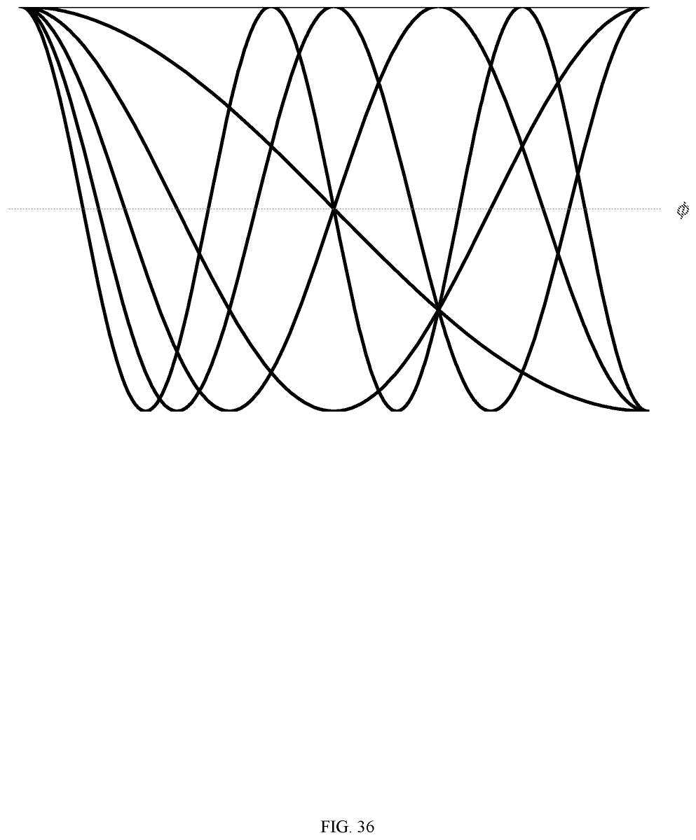

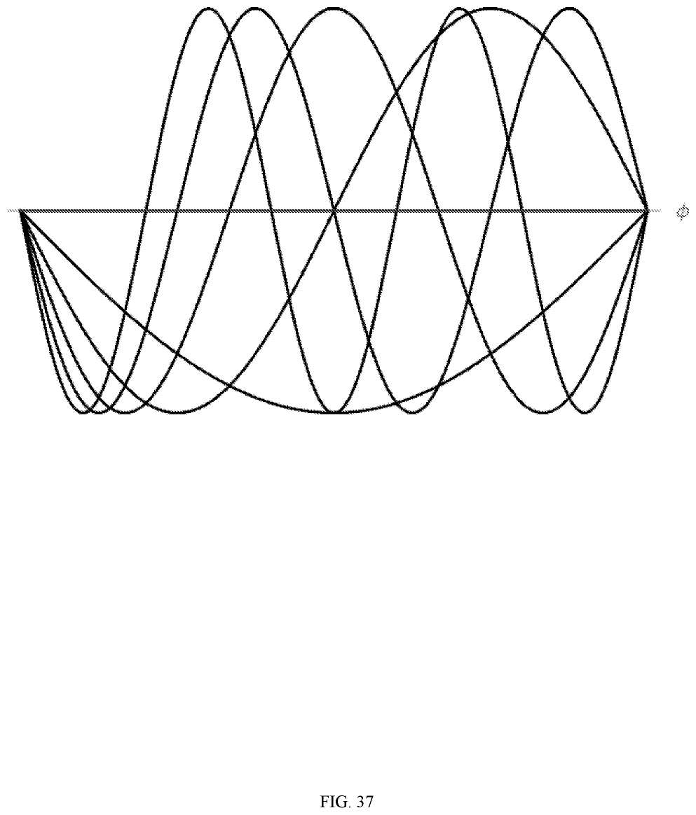

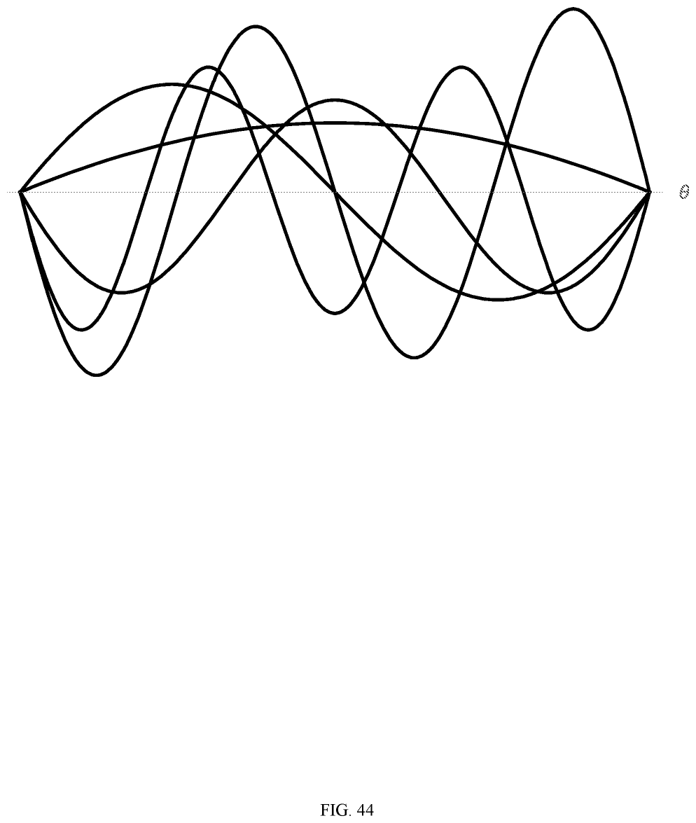

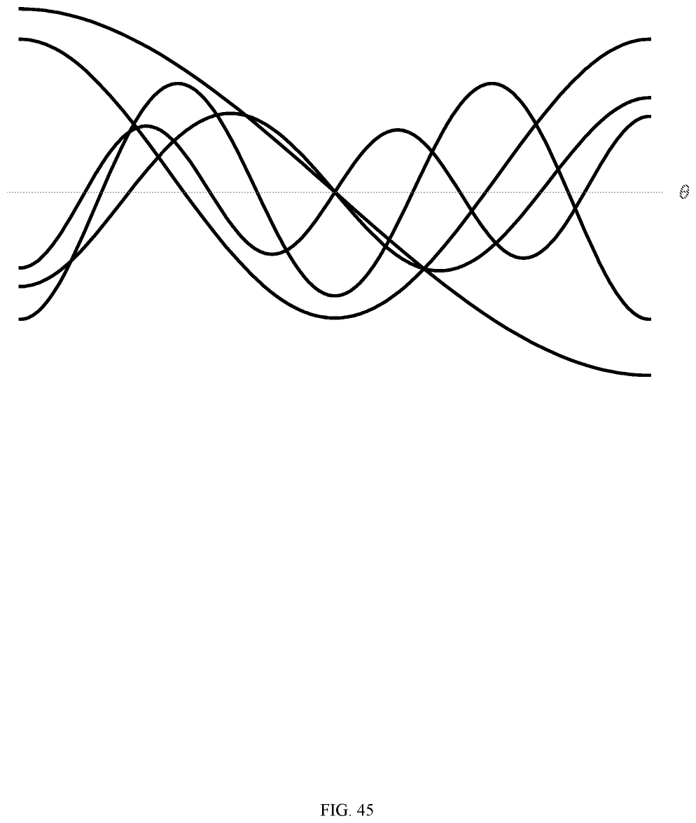

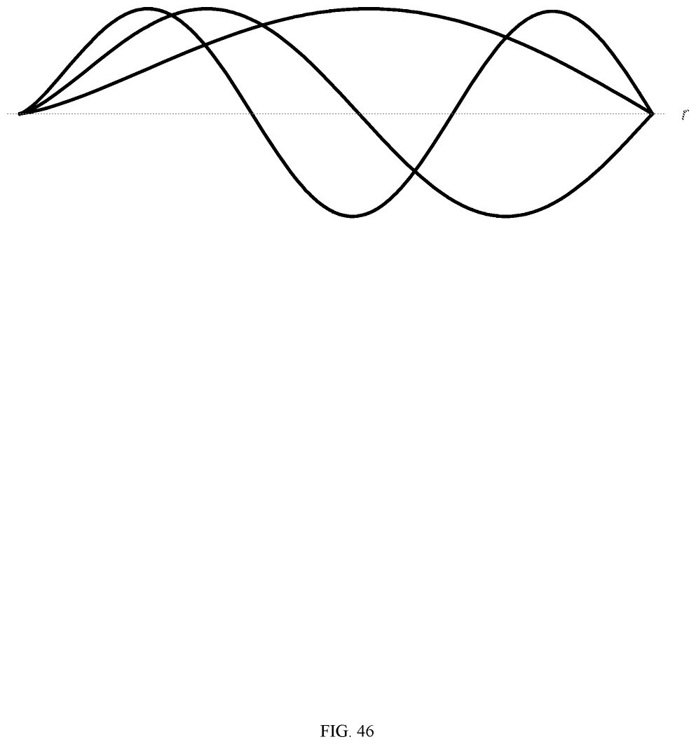

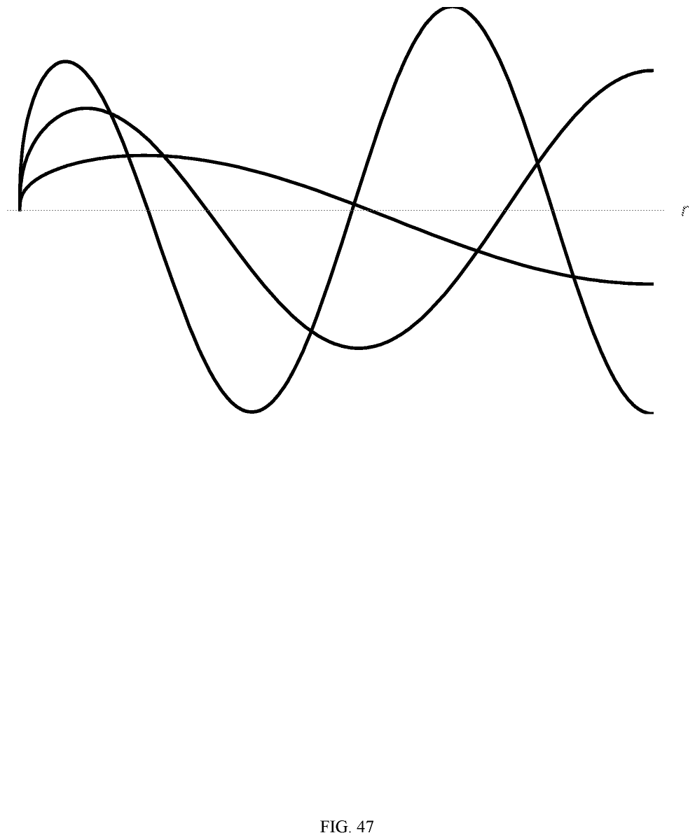

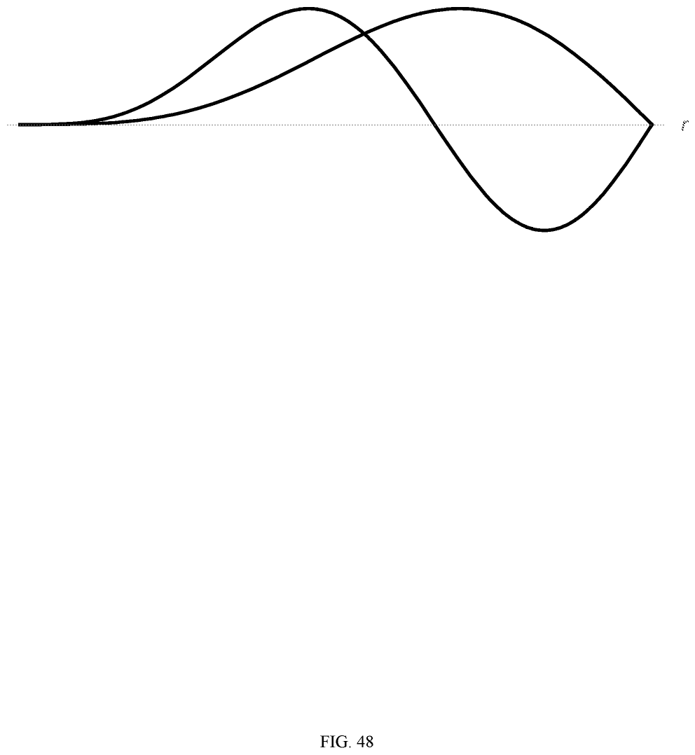

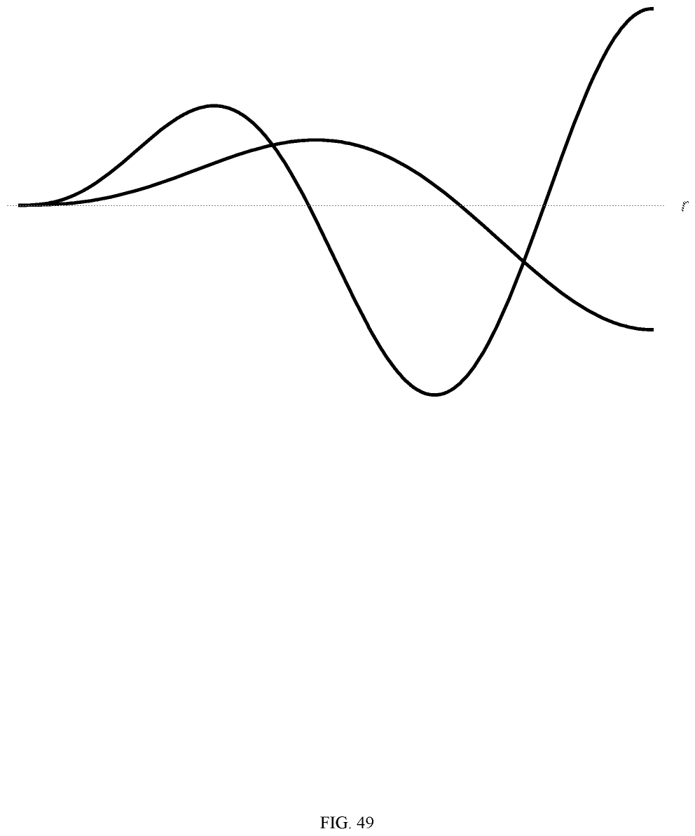

FIGS. 36 and 37 are non-limiting exemplary plots of a first and a second azimuthal eigenfunction of a pyramidal cavity resonator, respectively. FIGS. 44 and 45 are non-limiting exemplary plots of a first and a second transverse electric polar eigenfunction of a pyramidal cavity resonator, respectively. FIGS. 46 and 47 are non-limiting exemplary plots of a first and a second transverse electric radial eigenfunction of a pyramidal cavity resonator, respectively. FIGS. 48 and 49 are non-limiting exemplary plots of a first and a second transverse electric evanescent radial eigenfunction of a pyramidal cavity resonator, respectively.

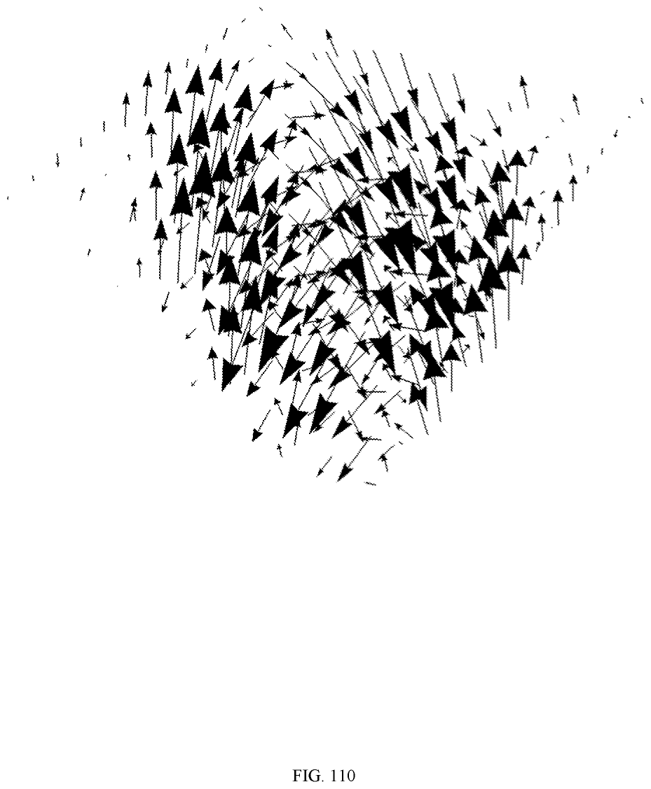

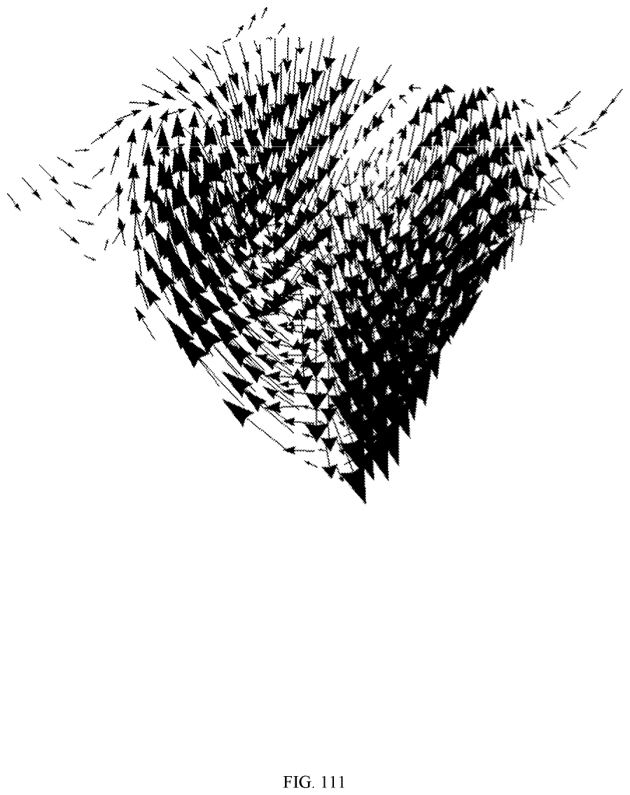

FIG. 110 is an exemplary perspective view of a first transverse electric three-dimensional electric field vector plot of a non-limiting pyramidal cavity resonator. FIG. 111 is an exemplary perspective view of a first transverse electric three-dimensional magnetic field vector plot of a non-limiting pyramidal cavity resonator.

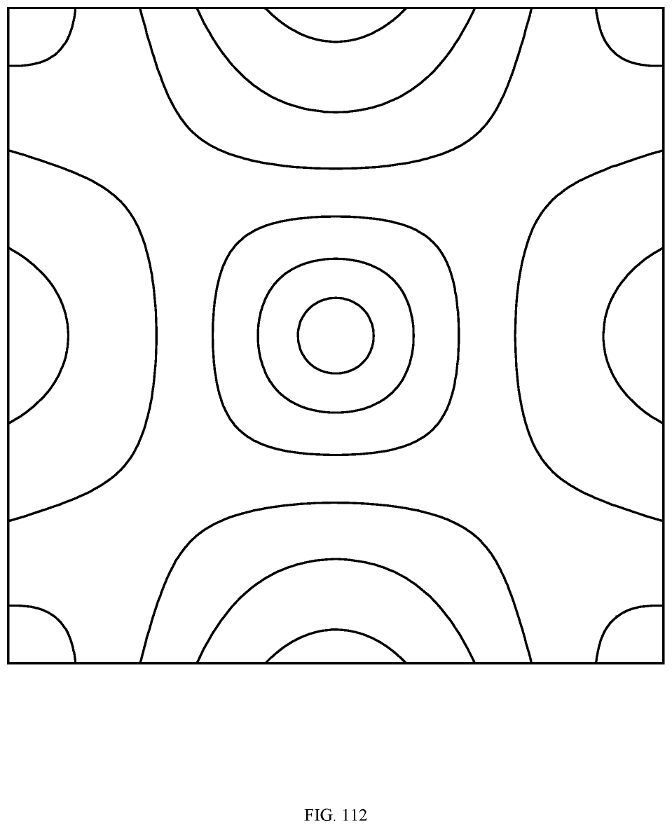

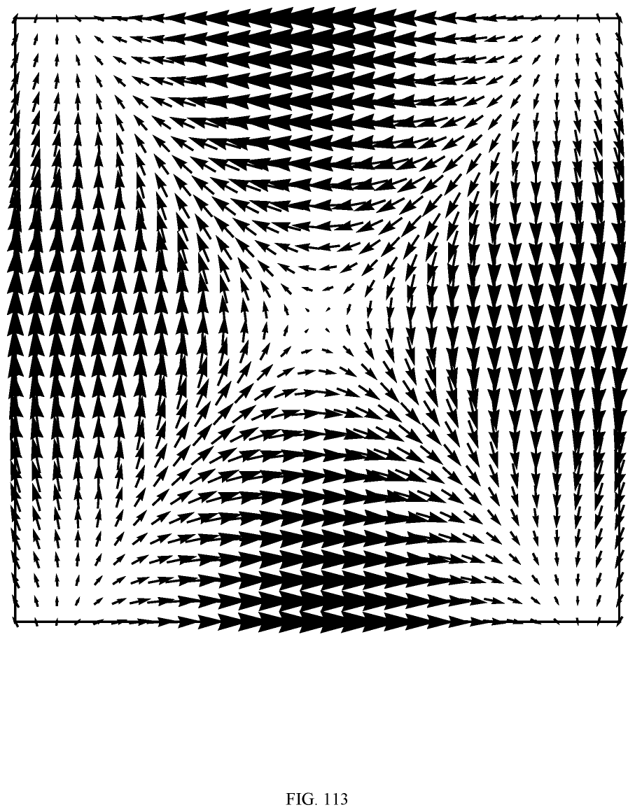

FIG. 112 is an exemplary axial cross section view of a first electric field transverse electric density plot of a non-limiting pyramidal cavity resonator. FIG. 113 is an exemplary axial cross section view of a first magnetic field transverse electric vector plot of a non-limiting pyramidal cavity resonator.

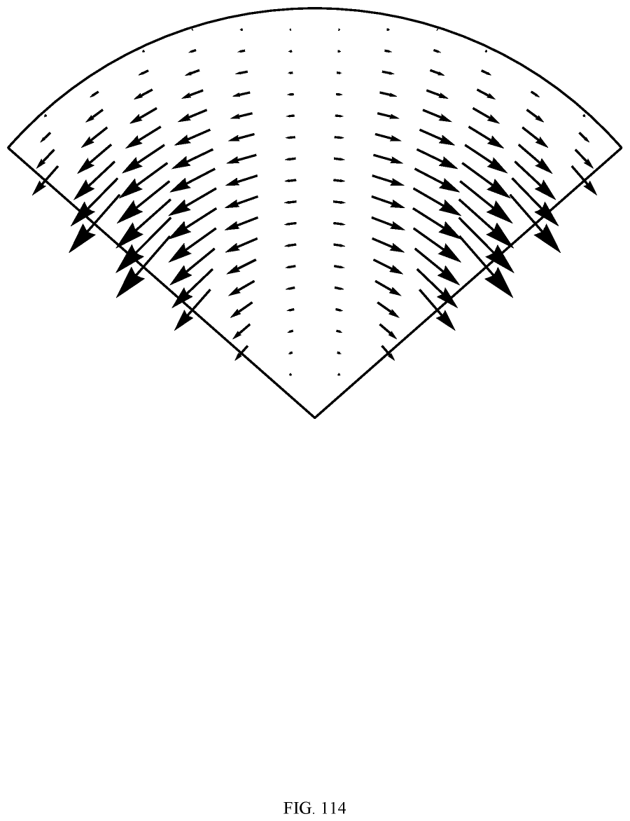

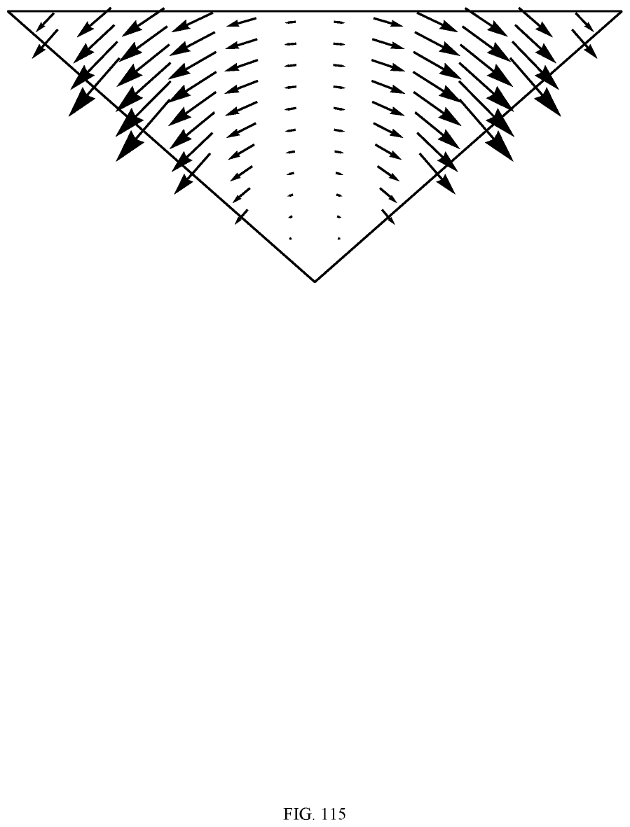

FIG. 114 is an exemplary radial cross section view of a first electric field transverse electric vector plot of a non-limiting pyramidal cavity resonator. FIG. 115 is an exemplary radial cross section view of a first electric field transverse electric vector plot of a non-limiting pyramidal resonator comprising a substantially flat base interior surface.

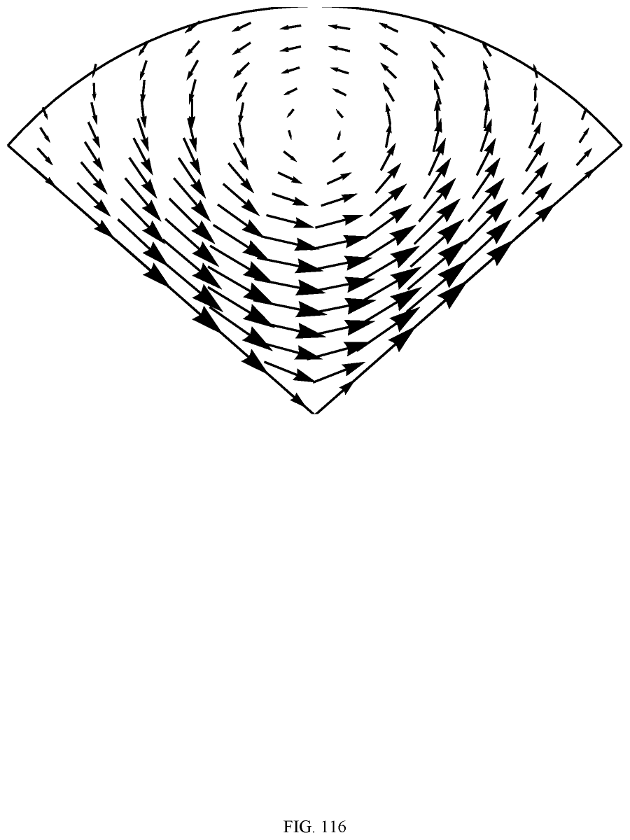

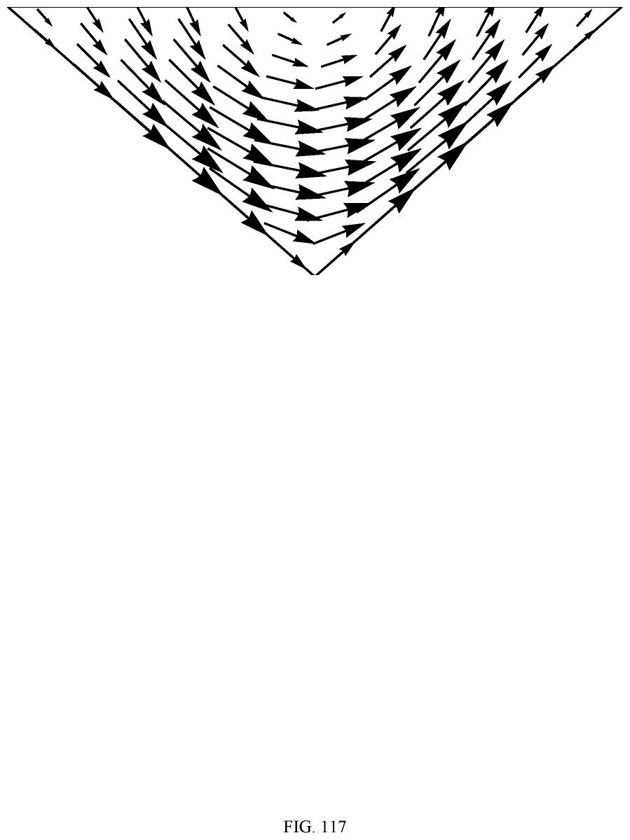

FIG. 116 is an exemplary radial cross section view of a first magnetic field transverse electric vector plot of a non-limiting pyramidal cavity resonator. FIG. 117 is an exemplary radial cross section view of a first magnetic field transverse electric vector plot of a non-limiting pyramidal cavity resonator comprising a substantially flat base interior surface.

As the size of the arrows in the above figures are positively correlated with an electric field and an electric field density, or with a magnetic field and a magnetic field density, the non-limiting pyramidal cavity resonator exhibits one or both a highly asymmetric electric field and a highly asymmetric electric field density, and a highly asymmetric magnetic field and a highly asymmetric magnetic field density, wherein the electric field and the electric field density, and the magnetic field and the magnetic field density, are more concentrated away from the base interior surface.

### Example 6—Transverse Magnetic Wave Frequency of a Pyramidal Cavity Resonator

In some embodiments, a frequency of a hollow pyramidal cavity resonator is calculated per the equations below:

For an azimuthal eigenvalue (m) and a taper angle (φ₀) of the resonator:

$$m = \frac{n π}{{ϕ}_{0}} where n = 0 , 1 , 2 , …$$

For a polar eigenvalue (l), an azimuthal eigenvalue (m), a taper angle (θ₀), a polar wave equation (Pₗ^{m}(cos θ)), and a polar wave equation (Qₗ^{m}(cos θ)) of the resonator:

$${[ {P}_{l}^{m} ( cos \frac{{θ}_{0}}{2} ) {Q}_{l}^{m} ( - cos \frac{{θ}_{0}}{2} ) - {P}_{l}^{m} ( - cos \frac{{θ}_{0}}{2} ) {Q}_{l}^{m} ( cos \frac{{θ}_{0}}{2} ) ]}_{θ = {θ}_{0}} = 0$$

For a radial eigenvalue (k), a polar eigenvalue (l), a radial length (r₁), and a radial wave equation (jₗ(kr)) of the resonator:

$${[ \frac{d}{dr} [ ( kr ) {j}_{l} ( kr ) ] ]}_{r = 0} = 0 {and [ \frac{d}{dr} [ ( kr ) {j}_{l} ( kr ) ] ]}_{r = {r}_{1}} = 0$$

For a radial eigenvalue (k), a polar eigenvalue (l), a radial length (r₁), and a radial wave equation (jₗ(kr)) of the resonator:

[(kr)jₗ(kr)]ᵣ₌₀=0 or [(kr)jₗ(kr)]ᵣ₌ᵣ_{₁}=0

For a frequency (f), a radial eigenvalue (k), and a speed of light (c) of the resonator:

$$f = \frac{kc}{2 π}$$

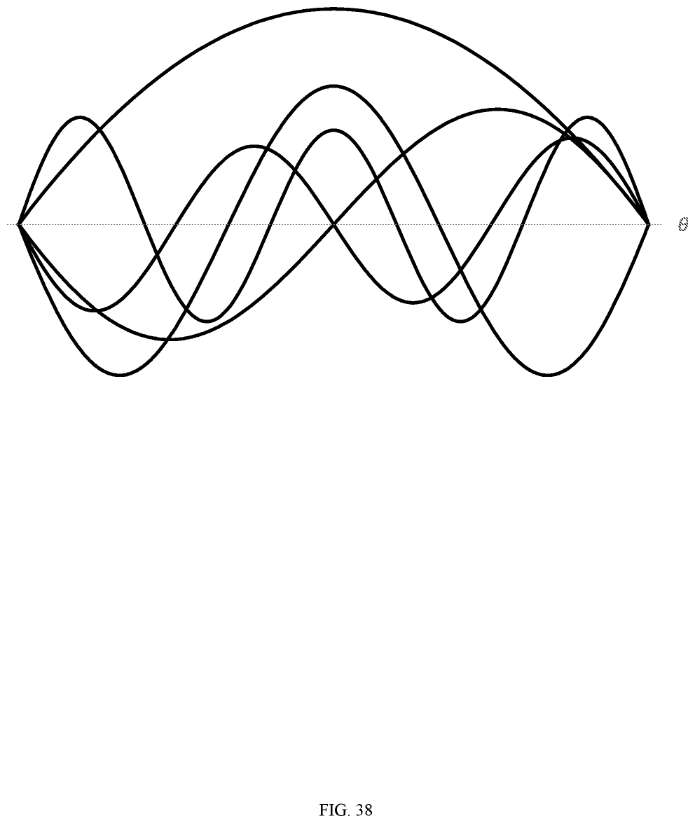

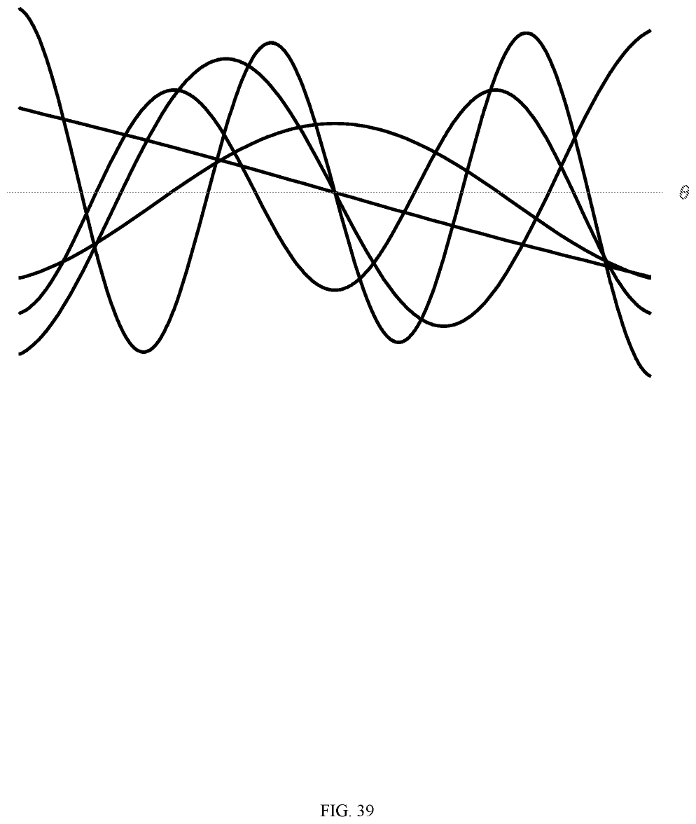

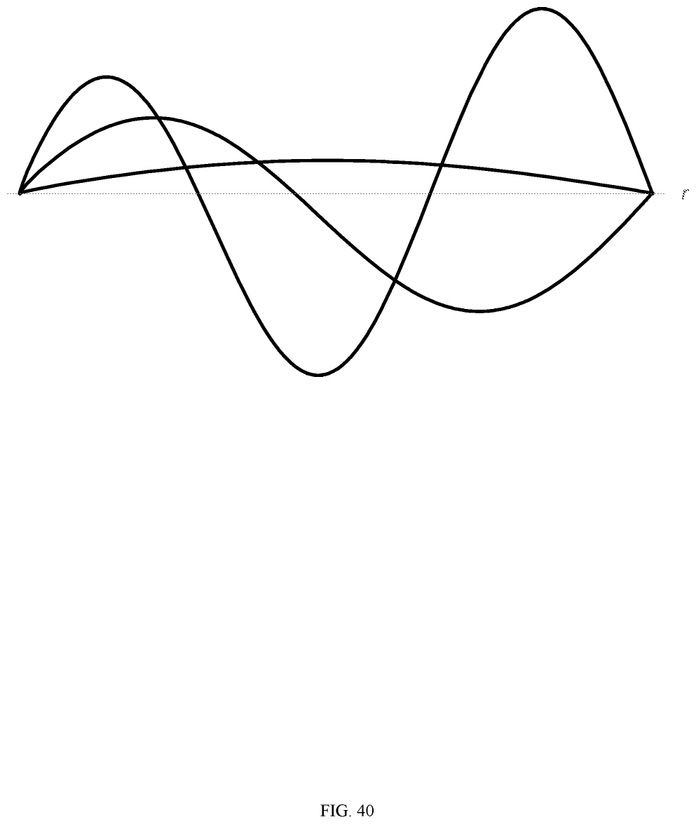

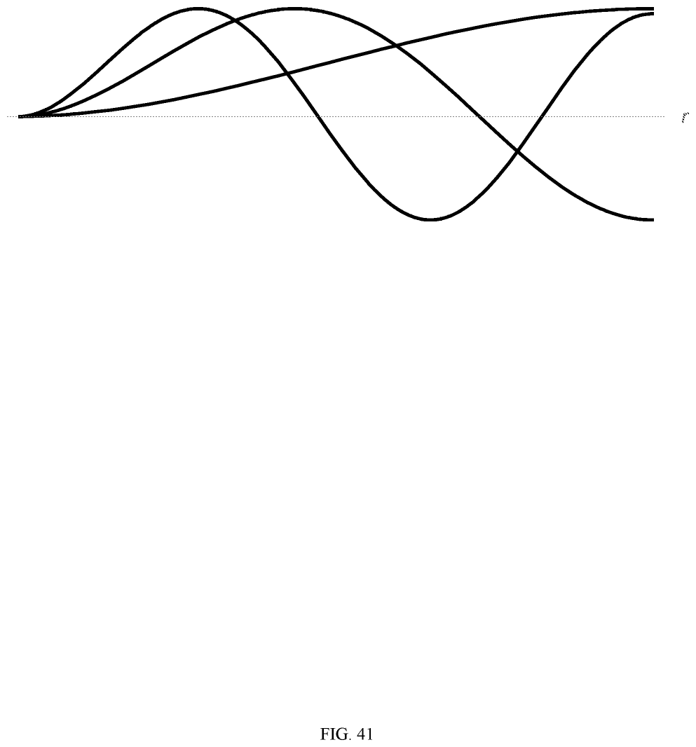

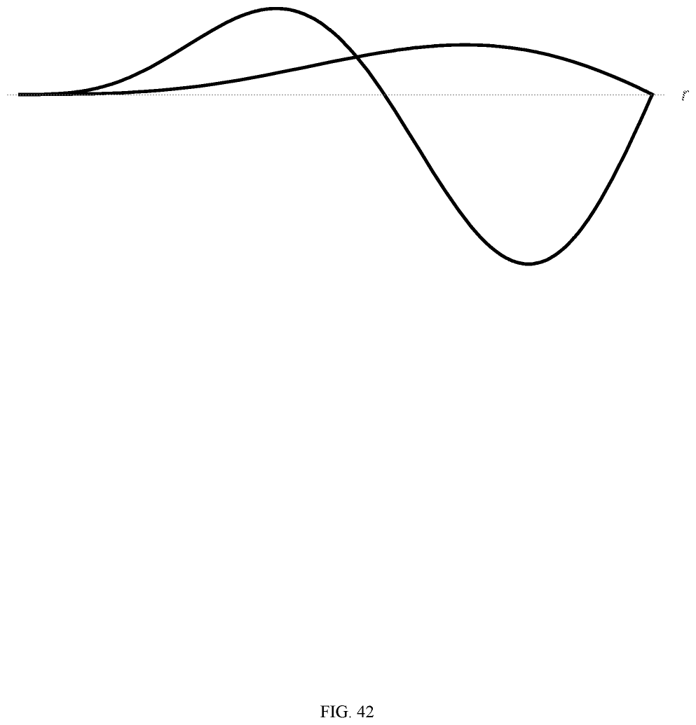

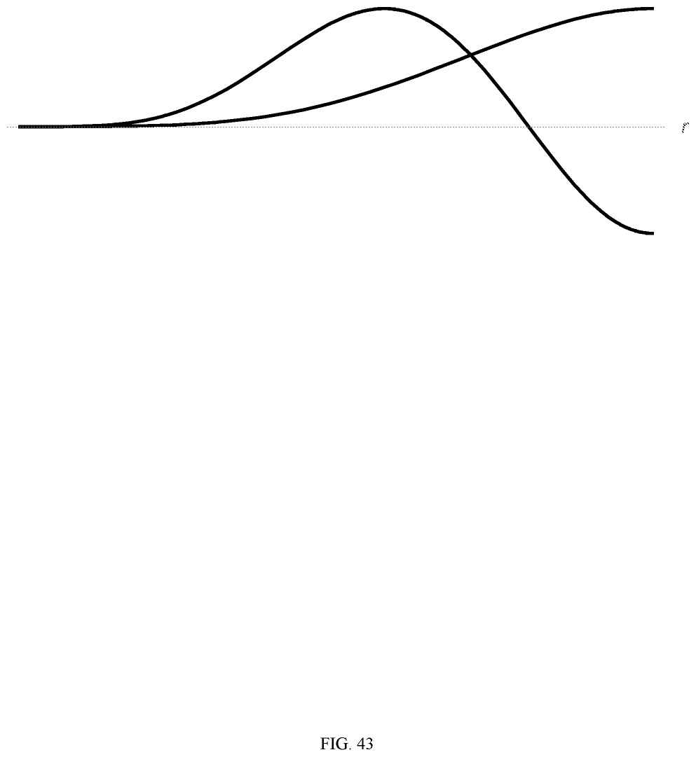

FIGS. 36 and 37 are non-limiting exemplary plots of a first and a second azimuthal eigenfunction of a pyramidal cavity resonator, respectively. FIGS. 38 and 39 are non-limiting exemplary plots of a first and a second transverse magnetic polar eigenfunction of a pyramidal cavity resonator, respectively. FIGS. 40 and 41 are non-limiting exemplary plots of a first and a second transverse magnetic radial eigenfunction of a pyramidal cavity resonator, respectively. FIGS. 42 and 43 are non-limiting exemplary plots of a first and a second transverse magnetic evanescent radial eigenfunction of a pyramidal cavity resonator, respectively.

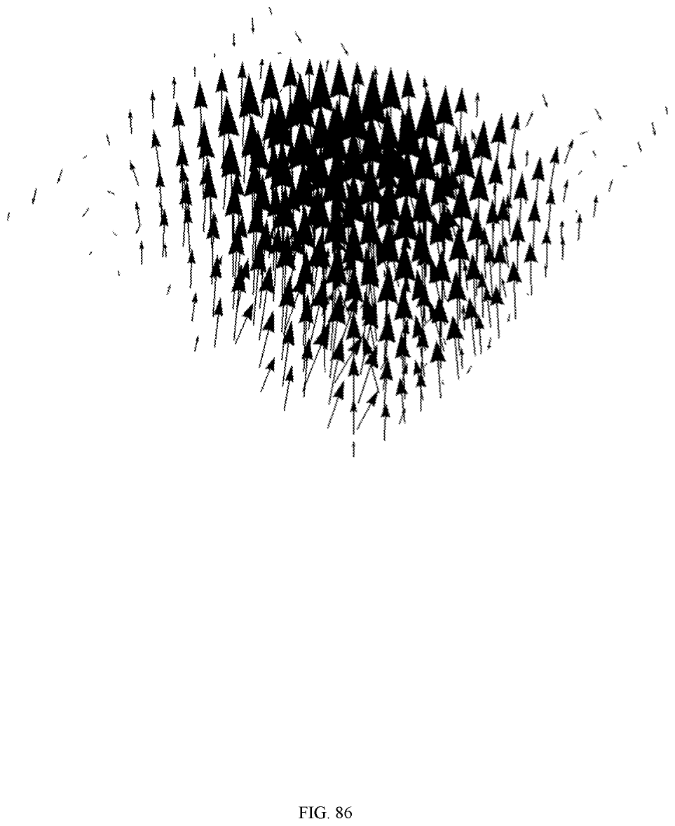

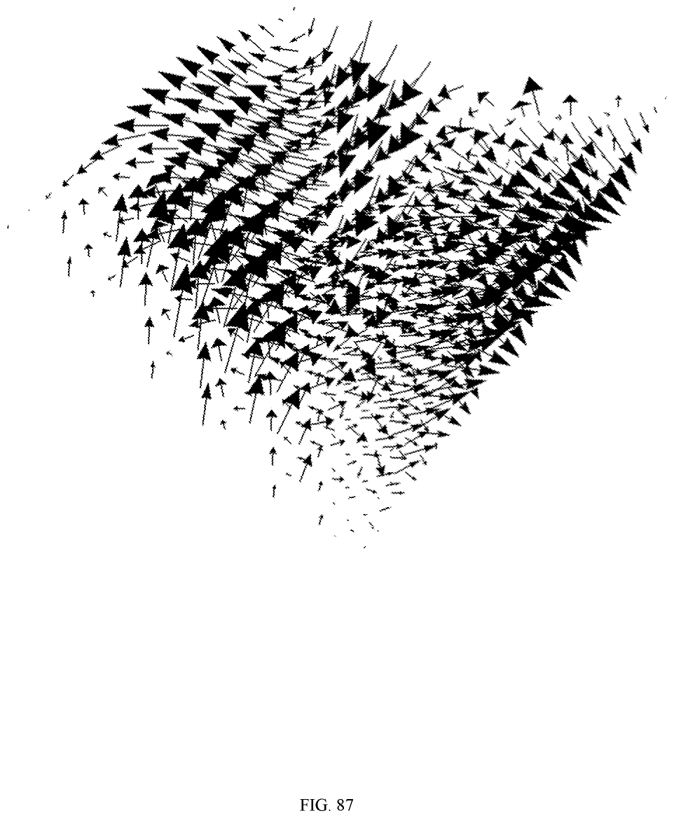

FIG. 86 is an exemplary perspective view of a first transverse magnetic three-dimensional electric field vector plot of a non-limiting pyramidal cavity resonator. FIG. 87 is an exemplary perspective view of a first transverse magnetic three-dimensional magnetic field vector plot of a non-limiting pyramidal cavity resonator.

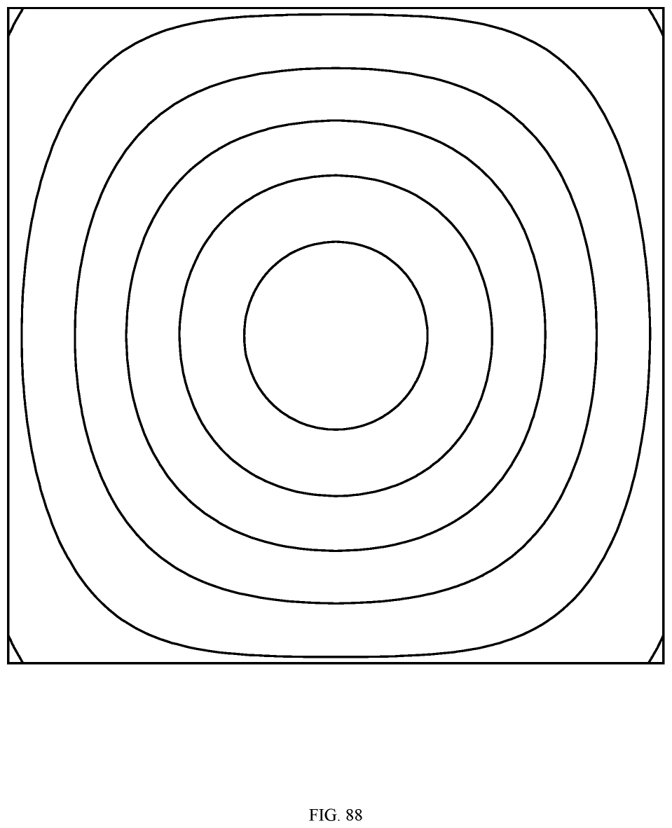

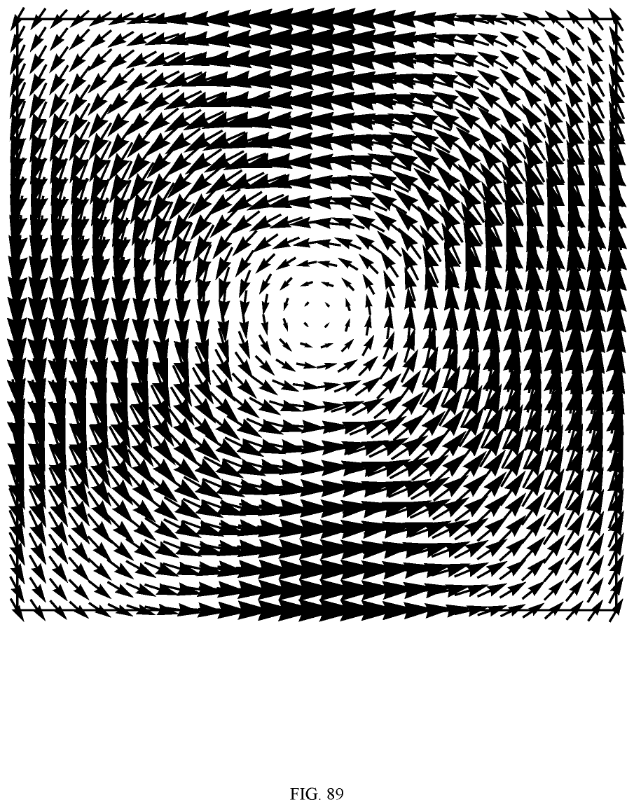

FIG. 88 is an exemplary axial cross section view of a first electric field transverse magnetic density plot of a non-limiting pyramidal cavity resonator. FIG. 89 is an exemplary axial cross section view of a first magnetic field transverse magnetic vector plot of a non-limiting pyramidal cavity resonator.

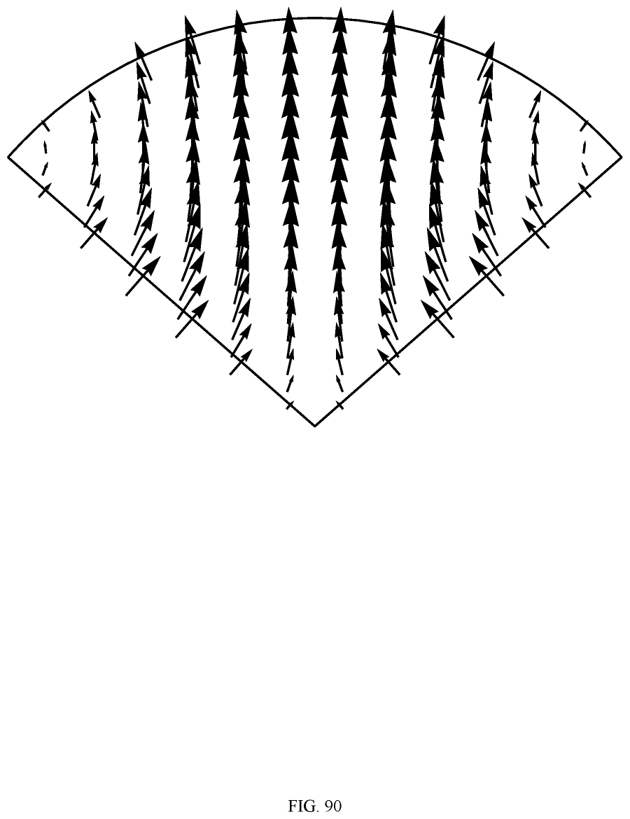

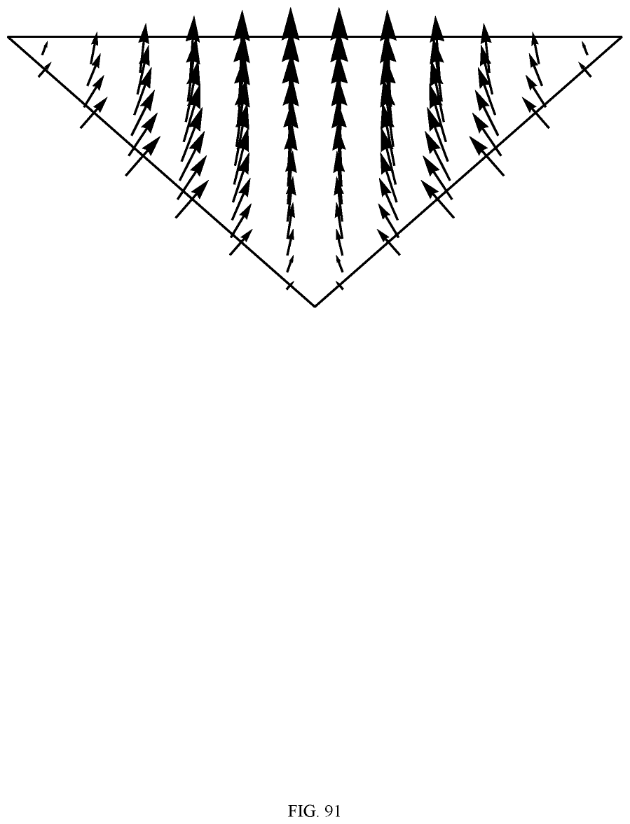

FIG. 90 is an exemplary radial cross section view of a first electric field transverse magnetic vector plot of a non-limiting pyramidal cavity resonator. FIG. 91 is an exemplary radial cross section view of a first electric field transverse magnetic vector plot of a non-limiting pyramidal cavity resonator comprising a substantially flat base interior surface.

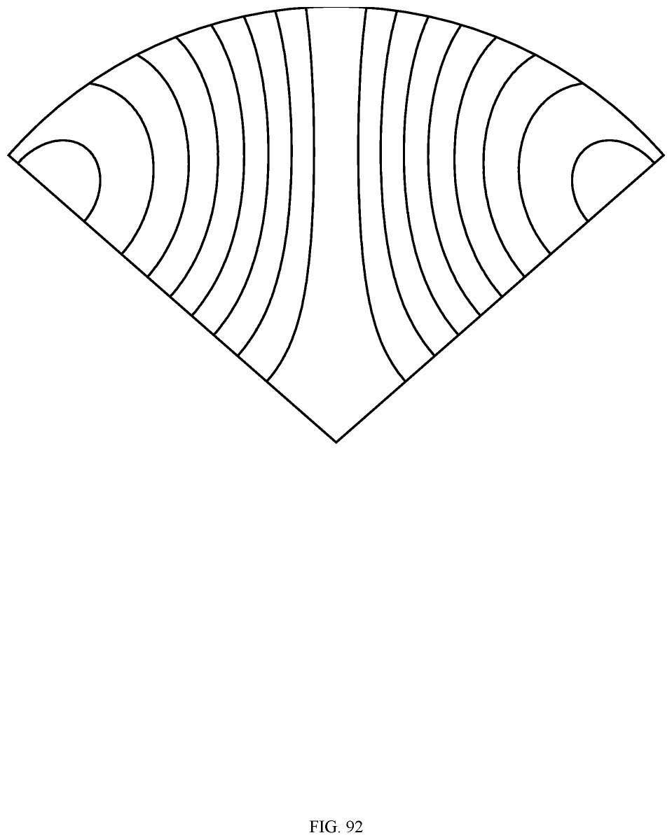

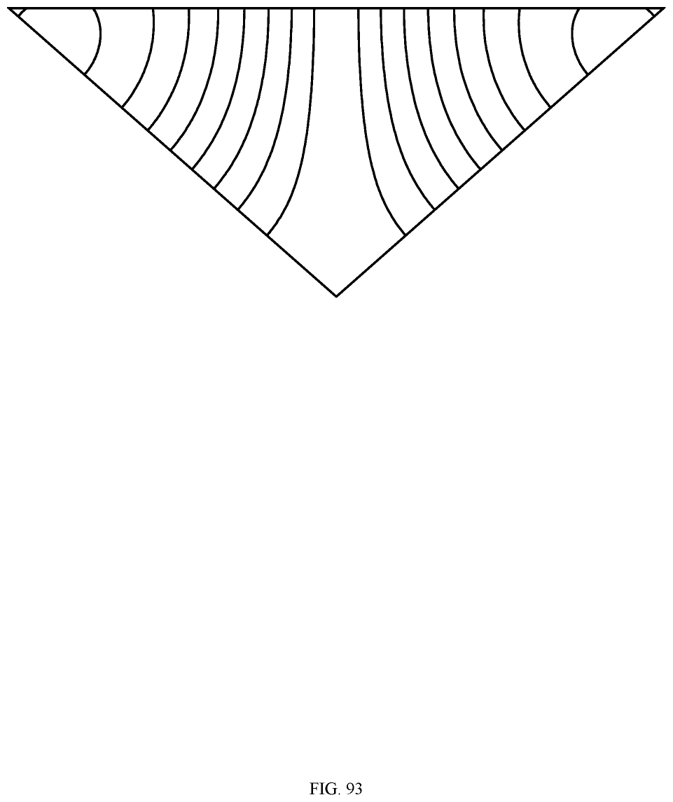

FIG. 92 is an exemplary radial cross section view of a first magnetic field transverse magnetic density plot of a non-limiting pyramidal cavity resonator. FIG. 93 is an exemplary radial cross section view of a first magnetic field transverse magnetic density plot of a non-limiting pyramidal cavity resonator comprising a substantially flat base interior surface.

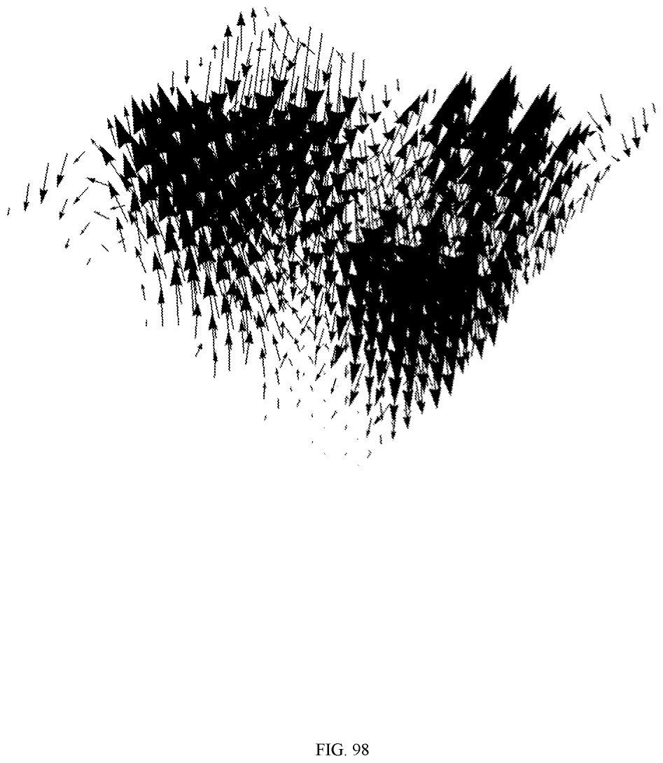

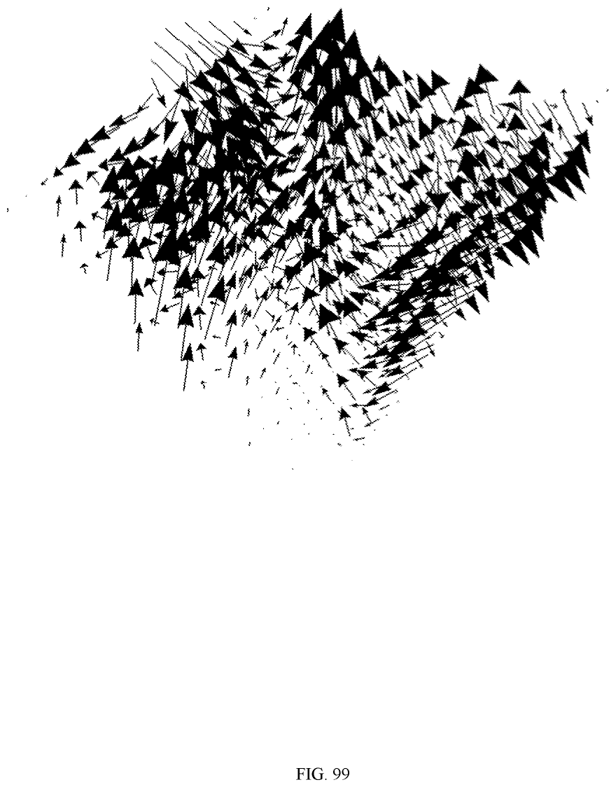

FIG. 98 is an exemplary perspective view of a second transverse magnetic three-dimensional electric field vector plot of a non-limiting pyramidal cavity resonator. FIG. 99 is an exemplary perspective view of a second transverse magnetic three-dimensional magnetic field vector plot of a non-limiting pyramidal cavity resonator.

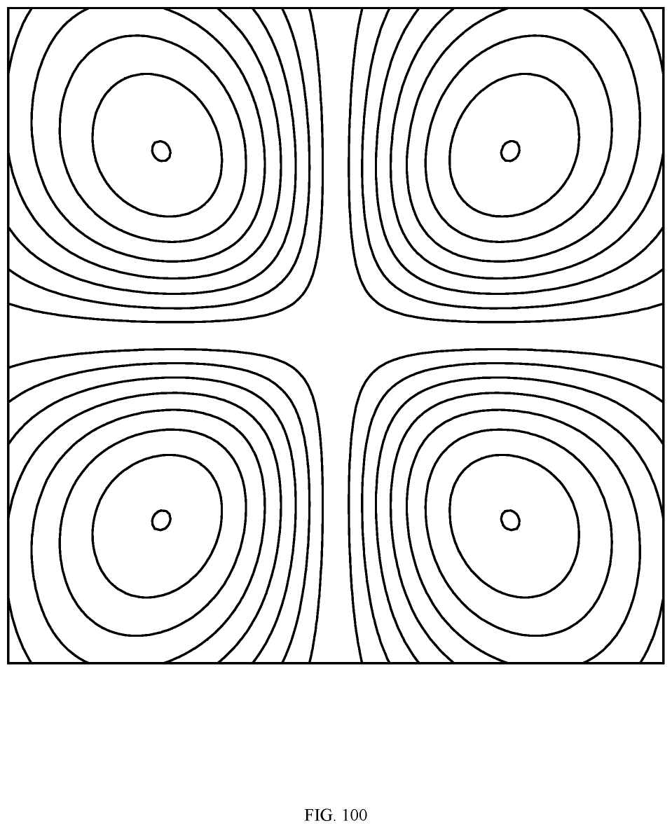

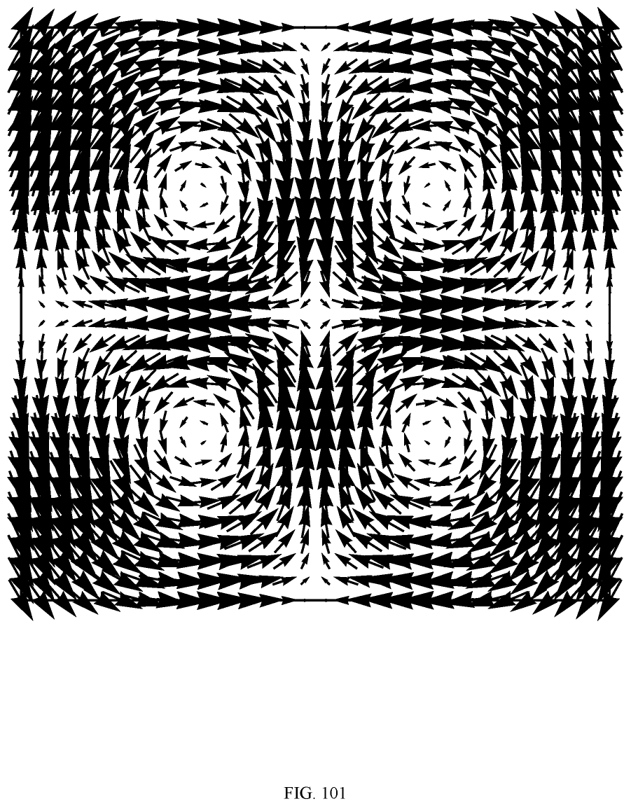

FIG. 100 is an exemplary axial cross section view of a second electric field transverse magnetic density plot of a non-limiting pyramidal cavity resonator. FIG. 101 is an exemplary axial cross section view of a second magnetic field transverse magnetic vector plot of a non-limiting pyramidal cavity resonator.

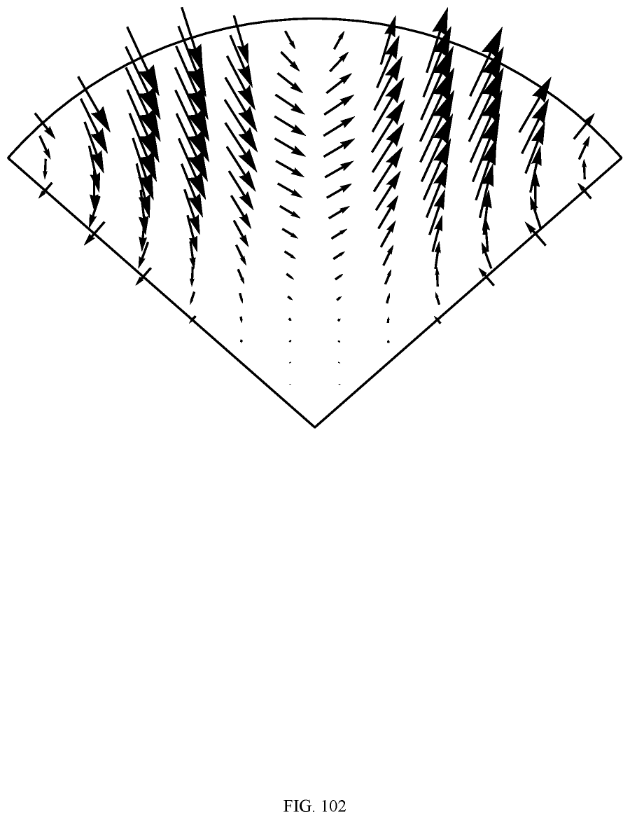

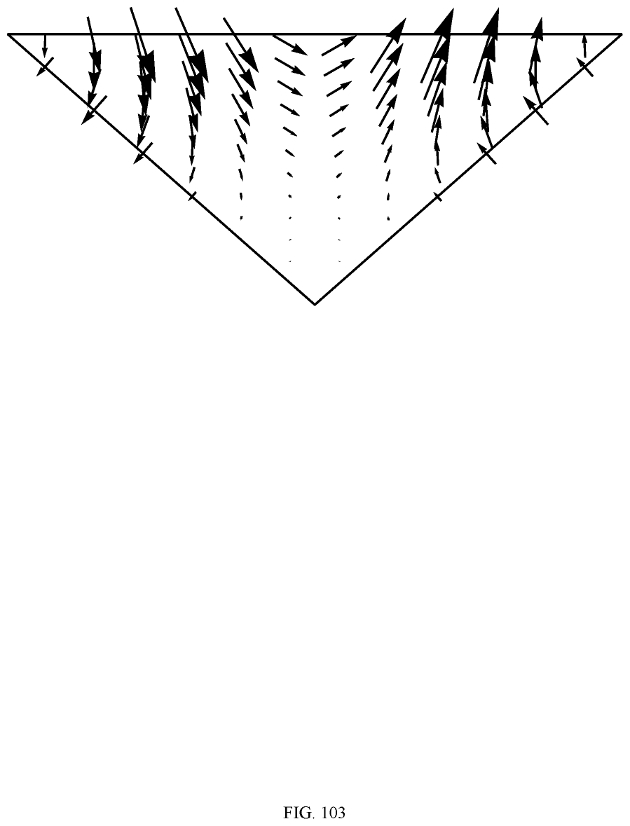

FIG. 102 is an exemplary radial cross section view of a second electric field transverse magnetic vector plot of a non-limiting pyramidal cavity resonator. FIG. 103 is an exemplary radial cross section view of a second electric field transverse magnetic vector plot of a non-limiting pyramidal cavity resonator comprising a substantially flat base interior surface.

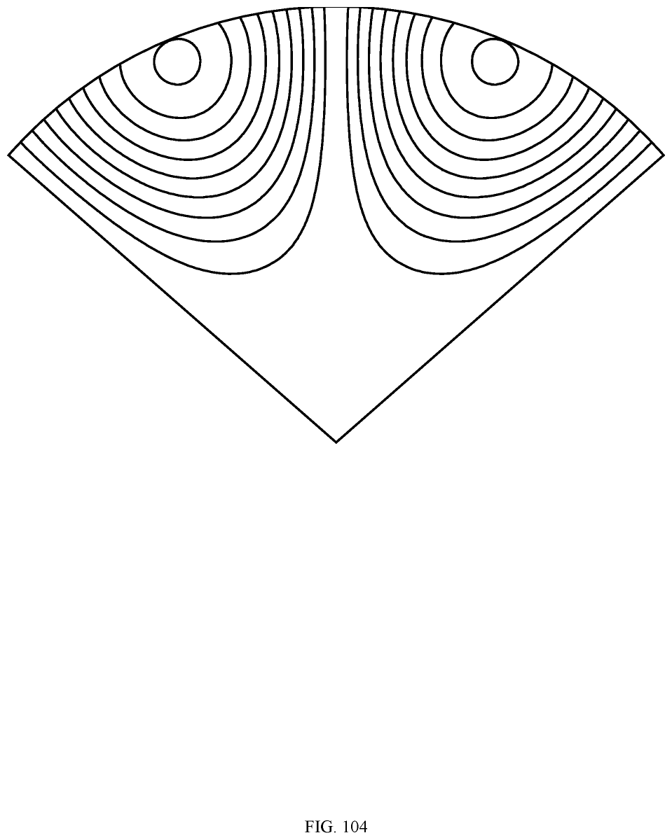

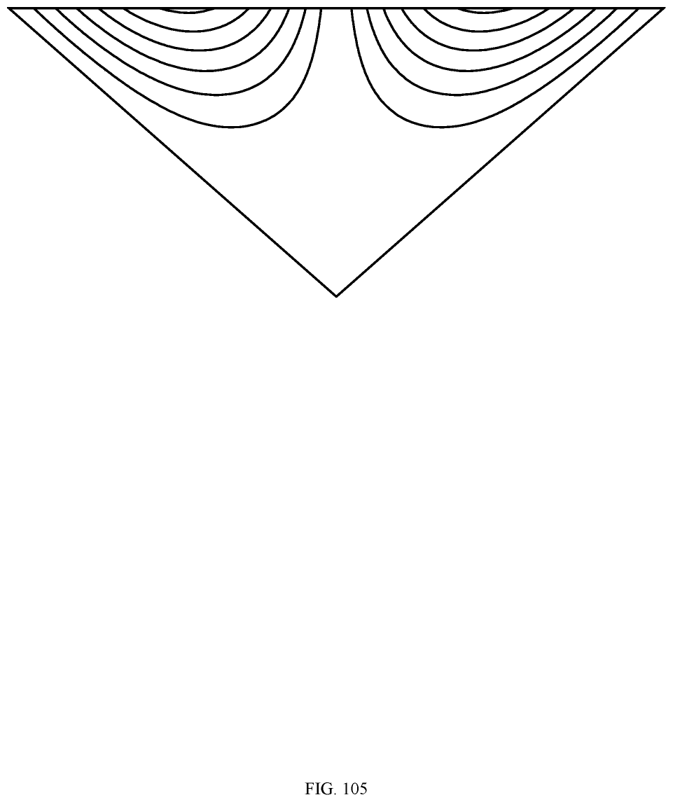

FIG. 104 is an exemplary radial cross section view of a second magnetic field transverse magnetic density plot of a non-limiting pyramidal cavity resonator. FIG. 105 is an exemplary radial cross section view of a second magnetic field transverse magnetic density plot of a non-limiting pyramidal cavity resonator comprising a substantially flat base interior surface.

As the size of the arrows in the above figures are positively correlated with an electric field and an electric field density, or with a magnetic field and a magnetic field density, the non-limiting pyramidal cavity resonator exhibits one or both a highly asymmetric electric field and a highly asymmetric electric field density, and a highly asymmetric magnetic field and a highly asymmetric magnetic field density, wherein the electric field and the electric field density, and the magnetic field and the magnetic field density, are more concentrated away from one or more of the at least three tapered interior surfaces.

### Example 7—Transverse Electric Wave Frequency of a Truncated Pyramidal Cavity Resonator

In some embodiments, a frequency of a hollow pyramidal cavity resonator is calculated per the equations below:

For an azimuthal eigenvalue (m) and a taper angle (φ₀) of the resonator:

$$m = \frac{n π}{{ϕ}_{0}} where n = 0 , 1 , 2 , …$$

For a polar eigenvalue (l), an azimuthal eigenvalue (m), a taper angle (θ₀), a polar wave equation (Pₗ^{m}(cos θ)), and a polar wave equation (Qₗ^{m}(cos θ)) of the resonator:

$${[ \frac{d}{d θ} [ {P}_{l}^{m} ( cos \frac{{θ}_{0}}{2} ) {Q}_{l}^{m} ( - cos \frac{{θ}_{0}}{2} ) - {P}_{l}^{m} ( - cos \frac{{θ}_{0}}{2} ) {Q}_{l}^{m} ( cos \frac{{θ}_{0}}{2} ) ] ]}_{θ = {θ}_{0}} = 0$$

For a radial eigenvalue (k), a polar eigenvalue (l), a truncated radial length (r₀), a radial length (r₁), and a radial wave equation (hₗ(kr)) of the resonator:

[(kr)hₗ(kr)]ᵣ₌ᵣ_{₀}=0 and [(kr)hₗ(kr)]ᵣ₌ᵣ_{₁}=0

For a radial eigenvalue (k), a polar eigenvalue (l), a radial length (r₁), a truncated radial length (r₀), and a radial wave equation (hₗ(kr)) of the resonator:

$${[ \frac{d}{dr} [ ( kr ) {h}_{l} ( kr ) ] ]}_{r = {r}_{0}} = 0 {or [ \frac{d}{dr} [ ( kr ) {h}_{l} ( kr ) ] ]}_{r = {r}_{1}}$$

For a frequency (f), a radial eigenvalue (k), and a speed of light (c) of the resonator:

$$f = \frac{kc}{2 π}$$

FIGS. 36 and 37 are non-limiting exemplary plots of a first and a second azimuthal eigenfunction of a pyramidal cavity resonator, respectively. FIGS. 44 and 45 are non-limiting exemplary plots of a first and a second transverse electric polar eigenfunction of a pyramidal cavity resonator, respectively. FIGS. 46 and 47 are non-limiting exemplary plots of a first and a second transverse electric radial eigenfunction of a pyramidal cavity resonator, respectively. FIGS. 48 and 49 are non-limiting exemplary plots of a first and a second transverse electric evanescent radial eigenfunction of a pyramidal cavity resonator, respectively.

FIG. 110 is an exemplary perspective view of a first transverse electric three-dimensional electric field vector plot of a non-limiting pyramidal cavity resonator. FIG. 111 is an exemplary perspective view of a first transverse electric three-dimensional magnetic field vector plot of a non-limiting pyramidal cavity resonator.

FIG. 112 is an exemplary axial cross section view of a first electric field transverse electric density plot of a non-limiting pyramidal cavity resonator. FIG. 113 is an exemplary axial cross section view of a first magnetic field transverse electric vector plot of a non-limiting pyramidal cavity resonator.

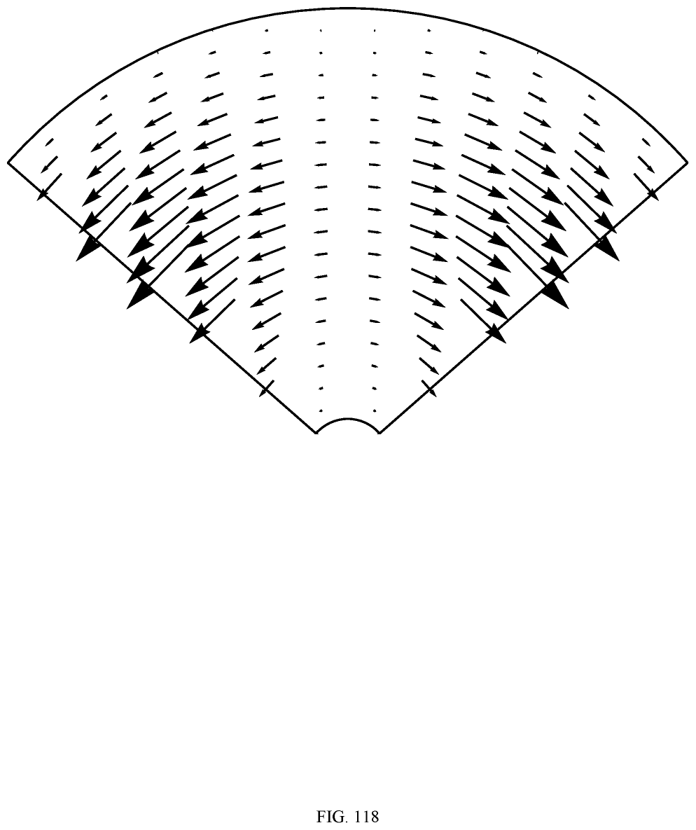

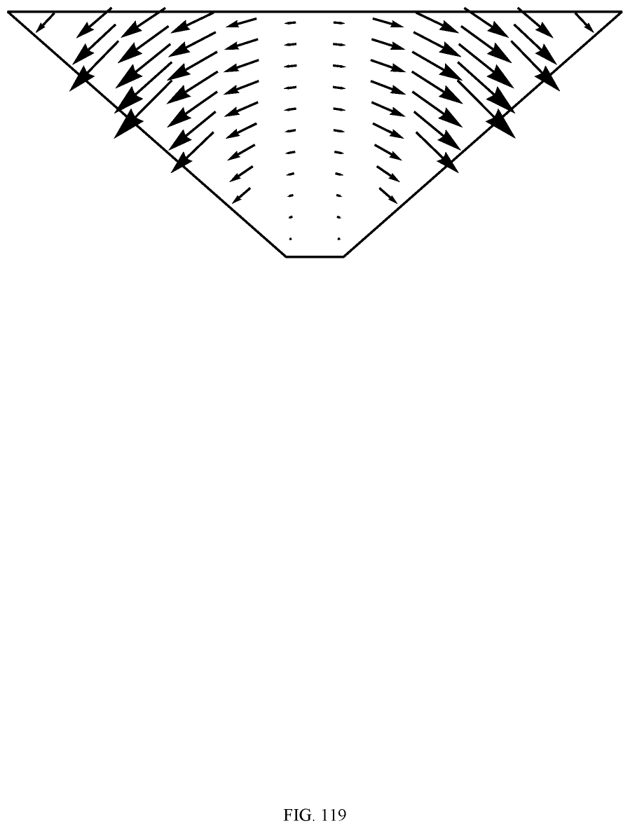

FIG. 118 is an exemplary radial cross section view of a first electric field transverse electric vector plot of a non-limiting truncated pyramidal cavity resonator. FIG. 119 is an exemplary radial cross section view of a first electric field transverse electric vector plot of a non-limiting truncated pyramidal resonator comprising a substantially flat base and truncated interior surfaces.

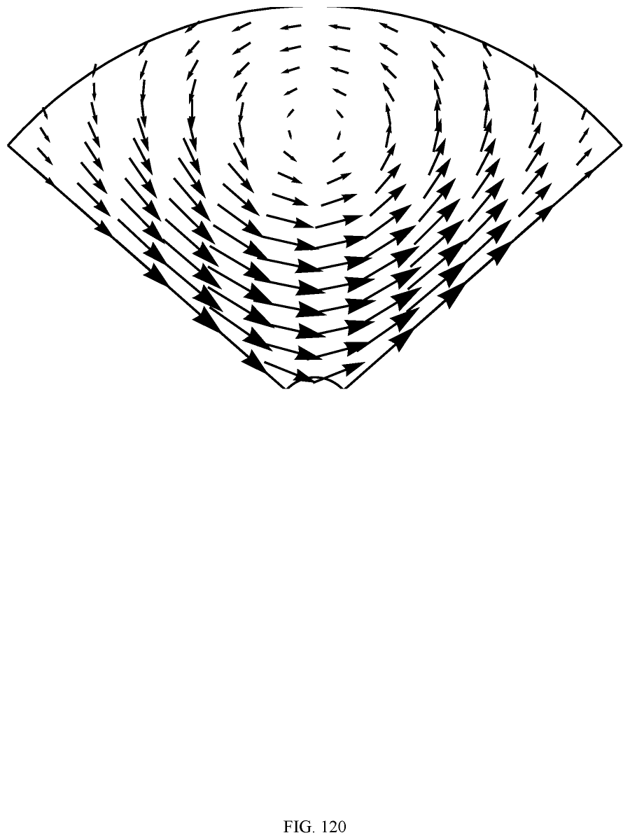

FIG. 120 is an exemplary radial cross section view of a first magnetic field transverse electric vector plot of a non-limiting truncated pyramidal cavity resonator. FIG. 121 is an exemplary radial cross section view of a first magnetic field transverse electric vector plot of a non-limiting truncated pyramidal cavity resonator comprising a substantially flat base and truncated interior surfaces.

As the size of the arrows in the above figures are positively correlated with an electric field and an electric field density, or with a magnetic field and a magnetic field density, the non-limiting pyramidal cavity resonator exhibits one or both a highly asymmetric electric field and a highly asymmetric electric field density, and a highly asymmetric magnetic field and a highly asymmetric magnetic field density, wherein the electric field and the electric field density, and the magnetic field and the magnetic field density, are more concentrated away from the base interior surface.

### Example 8—Transverse Magnetic Wave Frequency of a Truncated Pyramidal Cavity Resonator

In some embodiments, a frequency of a hollow pyramidal cavity resonator is calculated per the equations below:

For an azimuthal eigenvalue (m) and a taper angle (φ₀) of the resonator:

$$m = \frac{n π}{{ϕ}_{0}} where n = 0 , 1 , 2 , …$$

For a polar eigenvalue (l), an azimuthal eigenvalue (m), a taper angle (θ₀), a polar wave equation (Pₗ^{m}(cos θ)), and a polar wave equation (Qₗ^{m}(cos θ)) of the resonator:

$${[ {P}_{l}^{m} ( cos \frac{{θ}_{0}}{2} ) {Q}_{l}^{m} ( - cos \frac{{θ}_{0}}{2} ) - {P}_{l}^{m} ( - cos \frac{{θ}_{0}}{2} ) {Q}_{l}^{m} ( cos \frac{{θ}_{0}}{2} ) ]}_{θ = {θ}_{0}} = 0$$

For a radial eigenvalue (k), a polar eigenvalue (l), a truncated radial length (r₀), a radial length (r₁), and a radial wave equation (hₗ(kr)) of the resonator:

$${[ \frac{d}{dr} [ ( kr ) {h}_{l} ( kr ) ] ]}_{r = {r}_{0}} = 0 {and [ \frac{d}{dr} [ ( kr ) {h}_{l} ( kr ) ] ]}_{r = {r}_{1}} = 0$$

For a radial eigenvalue (k), a polar eigenvalue (l), a truncated radial length (r₀), a radial length (r₁), and a radial wave equation (hₗ(kr)) of the resonator:

[(kr)hₗ(kr)]ᵣ₌ᵣ_{₀}=0 or [(kr)hₗ(kr)]ᵣ₌ᵣ_{₁}=0

For a frequency (f), a radial eigenvalue (k), and a speed of light (c) of the resonator:

$$f = \frac{kc}{2 π}$$

FIGS. 36 and 37 are non-limiting exemplary plots of a first and a second azimuthal eigenfunction of a pyramidal cavity resonator, respectively. FIGS. 38 and 39 are non-limiting exemplary plots of a first and a second transverse magnetic polar eigenfunction of a pyramidal cavity resonator, respectively. FIGS. 40 and 41 are non-limiting exemplary plots of a first and a second transverse magnetic radial eigenfunction of a pyramidal cavity resonator, respectively. FIGS. 42 and 43 are non-limiting exemplary plots of a first and a second transverse magnetic evanescent radial eigenfunction of a pyramidal cavity resonator, respectively.

FIG. 86 is an exemplary perspective view of a first transverse magnetic three-dimensional electric field vector plot of a non-limiting pyramidal cavity resonator. FIG. 87 is an exemplary perspective view of a first transverse magnetic three-dimensional magnetic field vector plot of a non-limiting pyramidal cavity resonator.

FIG. 88 is an exemplary axial cross section view of a first electric field transverse magnetic density plot of a non-limiting pyramidal cavity resonator. FIG. 89 is an exemplary axial cross section view of a first magnetic field transverse magnetic vector plot of a non-limiting pyramidal cavity resonator.

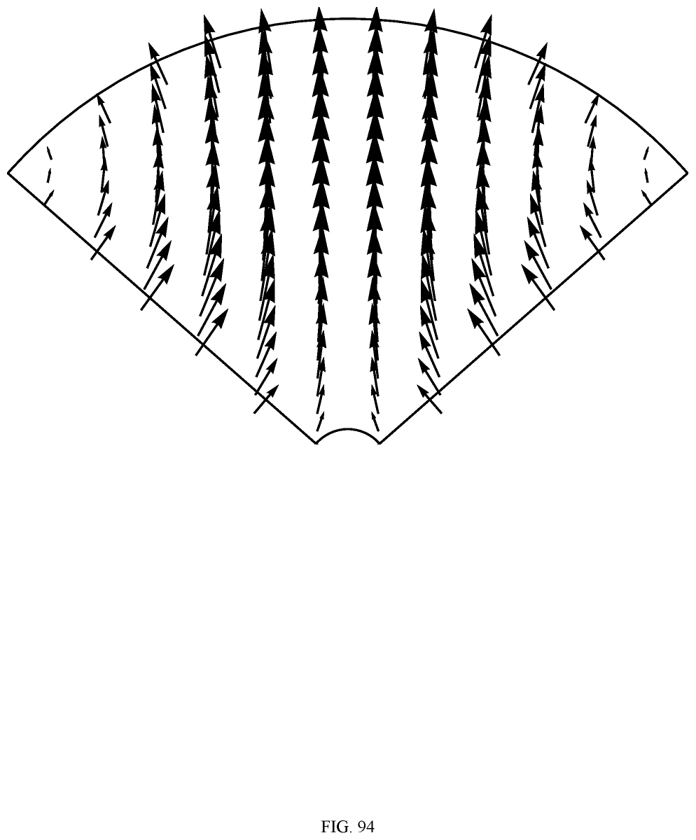

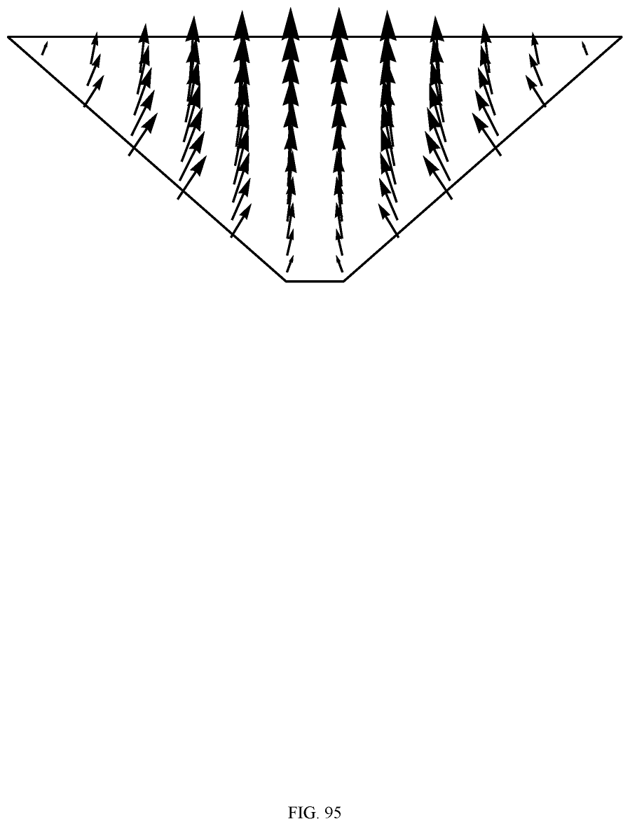

FIG. 94 is an exemplary radial cross section view of a first electric field transverse magnetic vector plot of a non-limiting truncated pyramidal cavity resonator. FIG. 95 is an exemplary radial cross section view of a first electric field transverse magnetic vector plot of a non-limiting truncated pyramidal cavity resonator comprising a substantially flat base and truncated interior surfaces.

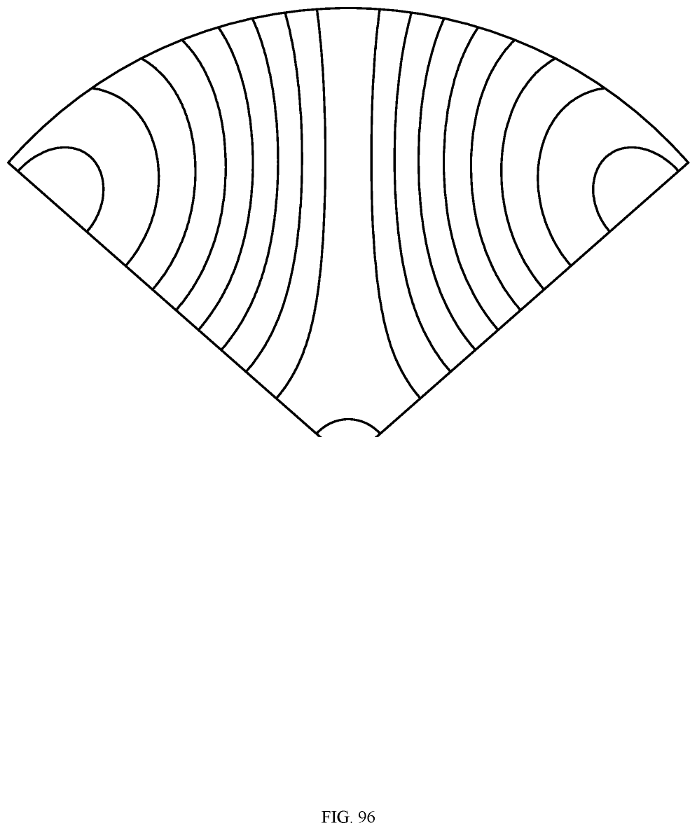

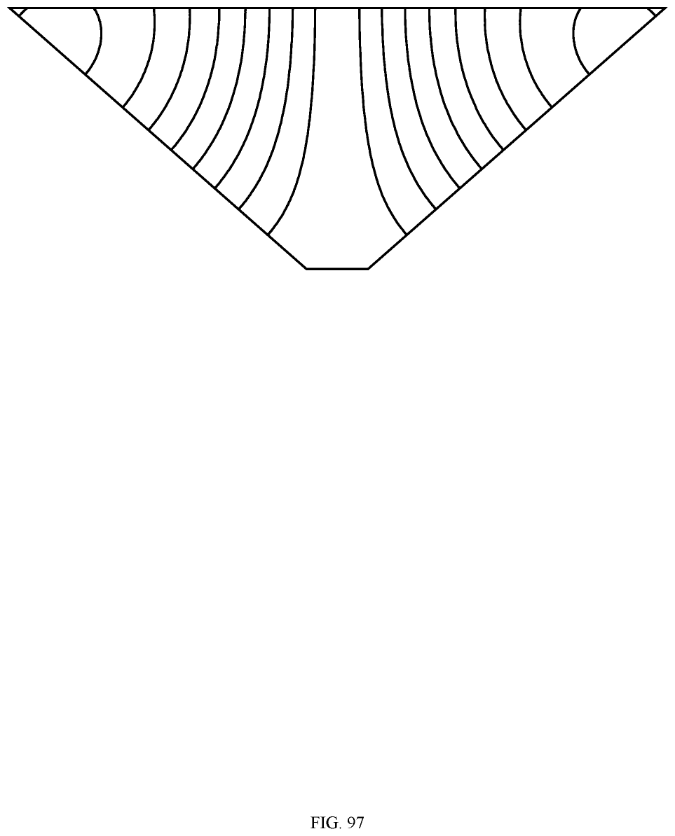

FIG. 96 is an exemplary radial cross section view of a first magnetic field transverse magnetic density plot of a non-limiting truncated pyramidal cavity resonator. FIG. 97 is an exemplary radial cross section view of a first magnetic field transverse magnetic density plot of a non-limiting truncated pyramidal cavity resonator comprising a substantially flat base and truncated interior surfaces.

FIG. 98 is an exemplary perspective view of a second transverse magnetic three-dimensional electric field vector plot of a non-limiting pyramidal cavity resonator. FIG. 99 is an exemplary perspective view of a second transverse magnetic three-dimensional magnetic field vector plot of a non-limiting pyramidal cavity resonator.

FIG. 100 is an exemplary axial cross section view of a second electric field transverse magnetic density plot of a non-limiting pyramidal cavity resonator. FIG. 101 is an exemplary axial cross section view of a second magnetic field transverse magnetic vector plot of a non-limiting pyramidal cavity resonator.

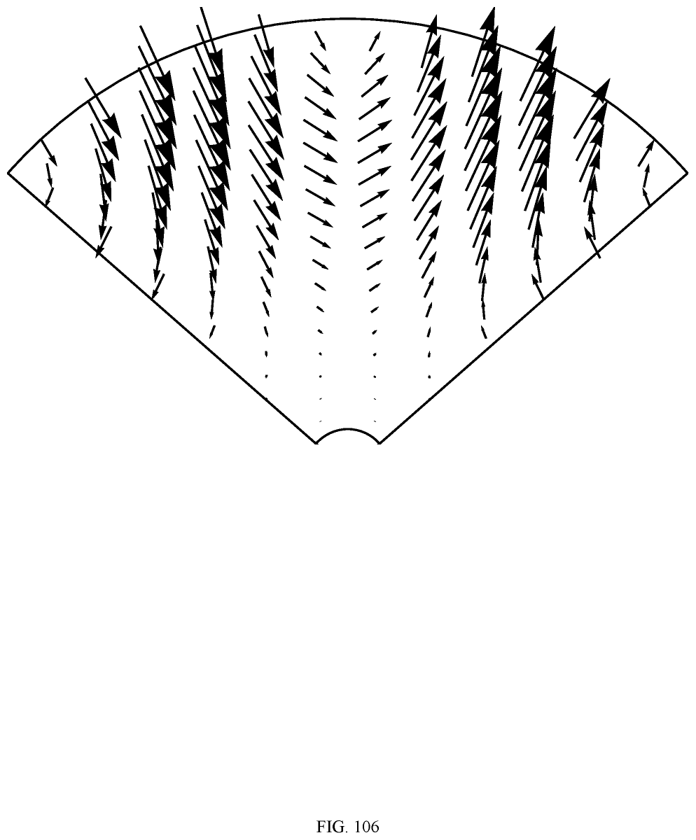

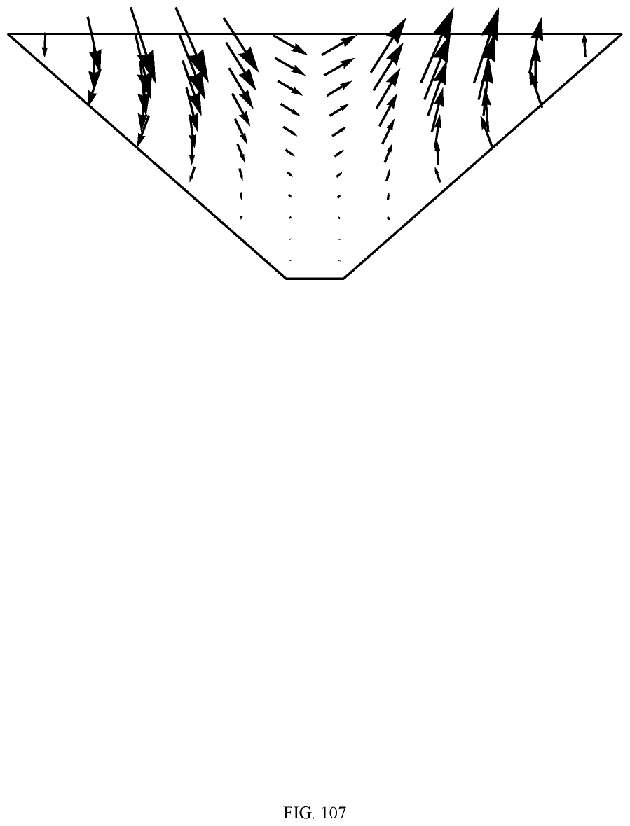

FIG. 106 is an exemplary radial cross section view of a second electric field transverse magnetic vector plot of a non-limiting truncated pyramidal cavity resonator. FIG. 107 is an exemplary radial cross section view of a second electric field transverse magnetic vector plot of a non-limiting truncated pyramidal cavity resonator comprising a substantially flat base and truncated interior surfaces.

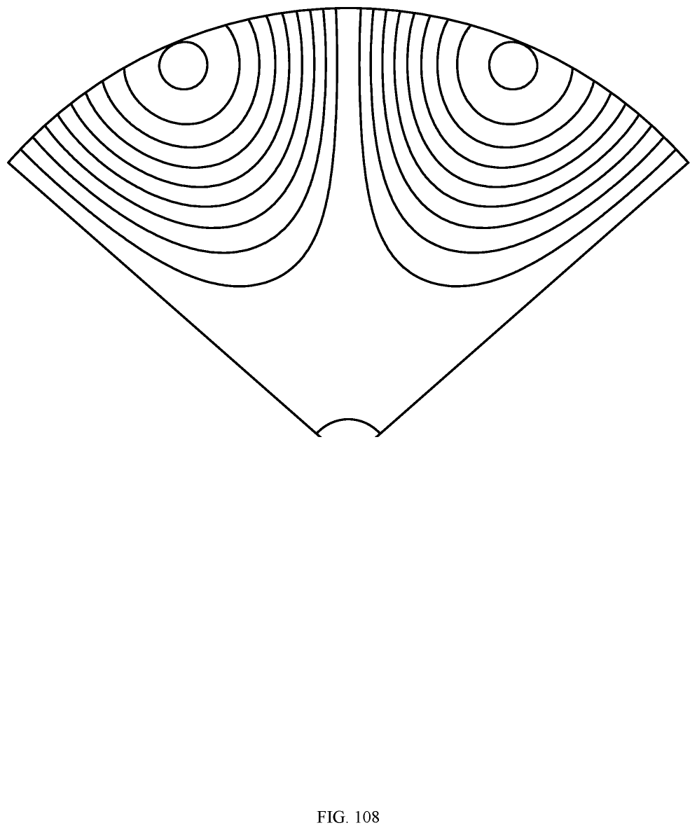

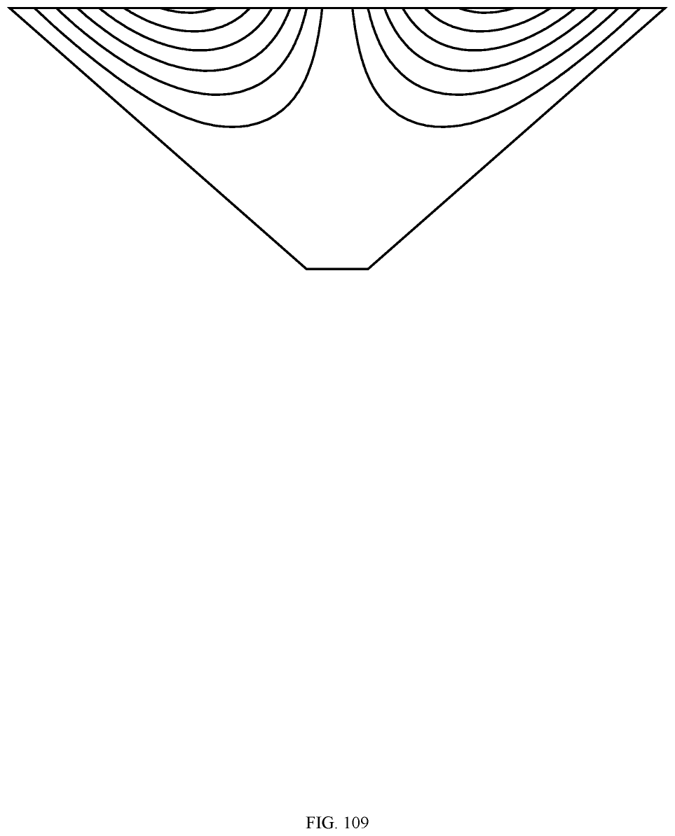

FIG. 108 is an exemplary radial cross section view of a second magnetic field transverse magnetic density plot of a non-limiting truncated pyramidal cavity resonator. FIG. 109 is an exemplary radial cross section view of a second magnetic field transverse magnetic density plot of a non-limiting truncated pyramidal cavity resonator comprising a substantially flat base and truncated interior surfaces.

As the size of the arrows in the above figures are positively correlated with an electric field and an electric field density, or with a magnetic field and a magnetic field density, the non-limiting pyramidal cavity resonator exhibits one or both a highly asymmetric electric field and a highly asymmetric electric field density, and a highly asymmetric magnetic field and a highly asymmetric magnetic field density, wherein the electric field and the electric field density, and the magnetic field and the magnetic field density, are more concentrated away from one or more of the at least three tapered interior surfaces and the truncated interior surface.

### Terms and Definitions

Unless otherwise defined, all technical terms used herein have the same meaning as commonly understood by one of ordinary skill in the art to which this disclosure belongs.

As used herein, the singular forms “a,” “an,” and “the” include plural references unless the context clearly dictates otherwise.

As used herein, the term “about” refers to an amount that is near the stated amount by about 10%, 5%, or 1%, including increments therein.

The embodiments of the invention described above are intended to be merely exemplary; numerous variations and modifications will be apparent to those skilled in the art. Such variations and modifications are intended to be within the scope of the present invention as defined by any of the appended claims.

What is claimed is:

1. An electromagnetic energy momentum thruster comprising:
a) a cavity resonator forming a cavity having a base interior surface and a tapered interior surface, the tapered interior surface converging to an apex point; and
b) an electromagnetic radiation source in communication with the cavity resonator, the electromagnetic radiation source configured to emit an electromagnetic wave having a frequency between about 1.0 MHz to about 1000 THz into the cavity resonator.

2. The thruster of claim 1, wherein the electromagnetic radiation source is configured to produce the frequency of the electromagnetic wave in evanescence so that the electromagnetic wave has a maximum field amplitude and an asymptotic field amplitude, the maximum field amplitude being at, or adjacent to, the base interior surface, the asymptotic field amplitude being at, or adjacent to, one or both the tapered interior surface and the apex point.

3. The thruster of claim 1, wherein the electromagnetic radiation source is configured to produce the frequency of the electromagnetic wave in evanescence so that the electromagnetic wave has a maximum field amplitude and an asymptotic field amplitude, the maximum field amplitude being at, or adjacent to, one or both the tapered interior surface and the apex point, and the asymptotic field amplitude being at, or adjacent to, the base interior surface.

4. The thruster of claim 1, wherein the cavity includes an overall interior surface that includes the base and tapered interior surfaces, substantially the entire overall interior surface being electrically conductive, wherein the cavity resonator has a quality factor between about 10\hat{ }3 to about 10\hat{ }9.

5. The thruster of claim 1, wherein the cavity includes an overall interior surface that includes the base and tapered interior surfaces, the overall interior surface comprises aluminum, antimony, arsenic, barium, beryllium, bismuth, cadmium, calcium, carbon, chromium, cobalt, copper, gallium, gold, hydrogen, indium, iron, lanthanum, lead, lithium, magnesium, manganese, mercury, molybdenum, nickel, niobium, nitrogen, oxygen, palladium, phosphorus, platinum, scandium, silicon, silver, strontium, sulfur, tantalum, technetium, tin, titanium, tungsten, vanadium, yttrium, zinc, zirconium, or any combination thereof.

6. The thruster of claim 1, wherein the cavity includes an overall interior surface that includes the base and tapered interior surfaces, substantially the entire overall interior surface being superconductive, wherein the cavity resonator has a quality factor between about 10\hat{ }6 to about 10\hat{ }15.

7. The thruster of claim 1, wherein the cavity includes an overall interior surface that includes the base and tapered interior surfaces, the overall interior surface comprises aluminum, barium, beryllium, bismuth, cadmium, calcium, copper, gallium, gadolinium, germanium, lanthanum, lead, lithium, indium, mercury, molybdenum, niobium, nitrogen, osmium, oxygen, protactinium, rhenium, ruthenium, silicon, strontium, sulfur, tantalum, technetium, thallium, thorium, titanium, tin, vanadium, yttrium, zinc, zirconium, NbTi, PbMoS, V₃Ga, NbN, V₃Si, Nb₃Sn, Nb₃Al, Nb₃(AlGe), Nb₃Ge, Bi₂Sr₂CuO₆, Bi₂Sr₂CaCu₂O₈, Bi₂Sr₂Ca₂Cu₃O₁₀, YBa₂Cu₃O₇, YBa₂Cu₄O₈, Y₂Ba₄Cu₇O₁₅, Y₃Ba₅Cu₈O₁₈, Tl₂Ba₂CuO₆, Tl₂Ba₂CaCu₂O₈, Tl₂Ba₂Ca₂Cu₃O₁₀, TlBa₂Ca₃Cu₄O₁₁, HgBa₂CuO₄, HgBa₂CaCu₂O₆, HgBa₂Ca₂Cu₃O₈, or any combination thereof.

8. The thruster of claim 1, wherein the cavity comprises a vacuum with a pressure between about 10\hat{ }-24 Torr to about 10\hat{ }3 Torr.

9. The thruster of claim 1, wherein the cavity comprises a thermal reservoir with a temperature between about 10\hat{ }-3 Kelvin to about 10\hat{ }3 Kelvin.

10. The thruster of claim 1, wherein the electromagnetic wave comprises a transverse magnetic wave with a polar mode number of N1 and an azimuthal mode number of N2, where N1 and N2 are an integers from 0 to 1000, and N1 is greater than or equal to N2.

11. The thruster of claim 1, wherein the electromagnetic wave comprises a transverse magnetic wave with a polar mode number of N and an azimuthal mode number of 0, where N is an integer from 0 to 1000.

12. The thruster of claim 1, wherein the electromagnetic wave comprises a transverse magnetic wave with a polar mode number of N and an azimuthal mode number of N, where N is an integer from 0 to 1000.

13. The thruster of claim 1, wherein the electromagnetic wave comprises a transverse electric wave with a polar mode number of N1 and an azimuthal mode number of N2, where N1 and N2 are an integers from 0 to 1000, and N1 is greater than or equal to N2.

14. The thruster of claim 1, wherein the electromagnetic wave comprises a transverse electric wave with a polar mode number of N and an azimuthal mode number of 0, where N is an integer from 0 to 1000.

15. The thruster of claim 1, wherein the electromagnetic wave comprises a transverse electric wave with a polar mode number of N and an azimuthal mode number of N, where N is an integer from 0 to 1000.

16. The thruster of claim 1, wherein the electromagnetic radiation source is located inside the cavity at, or adjacent to, a maximum field amplitude or an asymptotic field amplitude of the electromagnetic wave.

17. The thruster of claim 1, wherein the cavity has at least one of a width and a height between about 10\hat{ }-9 meters to about 10\hat{ }3 meters.

18. The thruster of claim 1, wherein the tapered interior surface forms an aperture angle between about 5 degrees to about 175 degrees.

19. The thruster of claim 1, wherein the cavity has a wall with a wall thickness between about 10\hat{ }-9 meters to about 1.0 meter.

20. The thruster of claim 1, wherein the base interior surface is one or more of substantially elliptical, substantially circular, and substantially flat.

21. The thruster of claim 1, wherein the electromagnetic wave forms an electromagnetic energy momentum tensor with an amplitude maximum at, or adjacent to, the base interior surface, which results in one or more of a metric tensor curvature, a thrust, and an acceleration of the thruster.

22. The thruster of claim 1, wherein the electromagnetic wave forms an electromagnetic energy momentum tensor with an amplitude maximum at, or adjacent to, one or both the tapered interior surface and the apex point, which results in one or more of a metric tensor curvature, a thrust, and an acceleration of the thruster.

23. An electromagnetic energy momentum thruster comprising:
a) a cavity resonator forming a cavity having a base interior surface, a tapered interior surface, and a truncated interior surface opposing the base interior surface, the tapered interior surface being between the base and truncated interior surfaces; and
b) an electromagnetic radiation source in communication with the cavity resonator, the electromagnetic radiation source configured to emit an electromagnetic wave having a frequency between about 1.0 MHz to about 1000 THz into the cavity resonator,
the electromagnetic radiation source configured to produce the electromagnetic wave in evanescence so that the electromagnetic wave has a maximum field amplitude and an asymptotic field amplitude.

24. The thruster of claim 23, wherein the maximum field amplitude is at, or adjacent to, the base interior surface, and the asymptotic field amplitude is at, or adjacent to, one or both the tapered interior surface and the truncated interior surface.

25. The thruster of claim 23, wherein the maximum field amplitude is at, or adjacent to, one or both the tapered interior surface and the truncated interior surface, and the asymptotic field amplitude is at, or adjacent to, the base interior surface.

26. The thruster of claim 23, wherein the cavity includes an overall interior surface that includes the base, tapered, and truncated interior surfaces, substantially the entire overall interior surface being electrically conductive, wherein the cavity resonator has a quality factor between about 10\hat{ }3 to about 10\hat{ }9.

27. The thruster of claim 23, wherein the cavity includes an overall interior surface that includes the base, tapered, and truncated interior surfaces, the overall interior surface comprises aluminum, antimony, arsenic, barium, beryllium, bismuth, cadmium, calcium, carbon, chromium, cobalt, copper, gallium, gold, hydrogen, indium, iron, lanthanum, lead, lithium, magnesium, manganese, mercury, molybdenum, nickel, niobium, nitrogen, oxygen, palladium, phosphorus, platinum, scandium, silicon, silver, strontium, sulfur, tantalum, technetium, tin, titanium, tungsten, vanadium, yttrium, zinc, zirconium, or any combination thereof.

28. The thruster of claim 23, wherein the cavity includes an overall interior surface that includes the base, tapered, and truncated interior surfaces, substantially the entire overall interior surface being superconductive, wherein the cavity resonator has a quality factor between about 10\hat{ }6 to about 10\hat{ }15.

29. The thruster of claim 23, wherein the cavity includes an overall interior surface that includes the base, tapered, and truncated interior surfaces, the overall interior surface comprises aluminum, barium, beryllium, bismuth, cadmium, calcium, copper, gallium, gadolinium, germanium, lanthanum, lead, lithium, indium, mercury, molybdenum, niobium, nitrogen, osmium, oxygen, protactinium, rhenium, ruthenium, silicon, strontium, sulfur, tantalum, technetium, thallium, thorium, titanium, tin, vanadium, yttrium, zinc, zirconium, NbTi, PbMoS, V₃Ga, NbN, V₃Si, Nb₃Sn, Nb₃Al, Nb₃(AlGe), Nb₃Ge, Bi₂Sr₂CuO₆, Bi₂Sr₂CaCu₂O₈, Bi₂Sr₂Ca₂Cu₃O₁₀, YBa₂Cu₃O₇, YBa₂Cu₄O₈, Y₂Ba₄Cu₇O₁₅, Y₃Ba₅Cu₈O₁₈, Tl₂Ba₂CuO₆, Tl₂Ba₂CaCu₂O₈, Tl₂Ba₂Ca₂Cu₃O₁₀, TlBa₂Ca₃Cu₄O₁₁, HgBa₂CuO₄, HgBa₂CaCu₂O₆, HgBa₂Ca₂Cu₃O₈, or any combination thereof.

30. The thruster of claim 23, wherein the cavity comprises a vacuum with a pressure between about 10\hat{ }-24 Torr to about 10\hat{ }3 Torr.

31. The thruster of claim 23, wherein the cavity comprises a thermal reservoir with a temperature between about 10\hat{ }-3 Kelvin to about 10\hat{ }3 Kelvin.

32. The thruster of claim 23, wherein the electromagnetic wave comprises a transverse magnetic wave with a polar mode number of N1 and an azimuthal mode number of N2, where N1 and N2 are an integers from 0 to 1000, and N1 is greater than or equal to N2.

33. The thruster of claim 23, wherein the electromagnetic wave comprises a transverse magnetic wave with a polar mode number of N and an azimuthal mode number of 0, where N is an integer from 0 to 1000.

34. The thruster of claim 23, wherein the electromagnetic wave comprises a transverse magnetic wave with a polar mode number of N and an azimuthal mode number of N, where N is an integer from 0 to 1000.

35. The thruster of claim 23, wherein the electromagnetic wave comprises a transverse electric wave with a polar mode number of N1 and an azimuthal mode number of N2, where N1 and N2 are an integers from 0 to 1000, and N1 is greater than or equal to N2.

36. The thruster of claim 23, wherein the electromagnetic wave comprises a transverse electric wave with a polar mode number of N and an azimuthal mode number of 0, where N is an integer from 0 to 1000.

37. The thruster of claim 23, wherein the electromagnetic wave comprises a transverse electric wave with a polar mode number of N and an azimuthal mode number of N, where N is an integer from 0 to 1000.

38. The thruster of claim 23, wherein the electromagnetic radiation source is located inside the cavity at, or adjacent to, a maximum field amplitude or an asymptotic field amplitude of the electromagnetic wave.

39. The thruster of claim 23, wherein the cavity has at least one of a width and a height between about 10\hat{ }-9 meters to about 10\hat{ }3 meters.

40. The thruster of claim 23, wherein the tapered interior surface forms an aperture angle between about 5 degrees to about 175 degrees.

41. The thruster of claim 23, wherein the cavity has a wall with a wall thickness between about 10\hat{ }-9 meters to about 1.0 meter.

42. The thruster of claim 23, wherein the base interior surface is one or more of substantially elliptical, substantially circular, and substantially flat.

43. The thruster of claim 23, wherein the electromagnetic wave forms an electromagnetic energy momentum tensor with an amplitude maximum at, or adjacent to, the base interior surface, which results in one or more of a metric tensor curvature, a thrust, and an acceleration of the thruster.

44. The thruster of claim 23, wherein the electromagnetic wave forms an electromagnetic energy momentum tensor with an amplitude maximum at, or adjacent to, one or both the tapered interior surface and the truncated interior surface, which results in one or more of a metric tensor curvature, a thrust, and an acceleration of the thruster.

45. An electromagnetic energy momentum thruster comprising:
a) a cavity resonator forming a pyramidal cavity having a base interior surface and at least three tapered interior surfaces, the tapered interior surfaces converging to an apex point; and
b) an electromagnetic radiation source in communication with the cavity resonator, the electromagnetic radiation source configured to emit an electromagnetic wave having a frequency between about 1.0 MHz to about 1000 THz into the cavity resonator.

46. The thruster of claim 45, wherein the electromagnetic radiation source is configured to produce the frequency of the electromagnetic wave in evanescence so that the electromagnetic wave has a maximum field amplitude and an asymptotic field amplitude, the maximum field amplitude being at, or adjacent to, the base interior surface, the asymptotic field amplitude being at, or adjacent to, one or more of the at least three tapered interior surfaces and the apex point.

47. The thruster of claim 45, wherein the electromagnetic radiation source is configured to produce the frequency of the electromagnetic wave in evanescence so that the electromagnetic wave has a maximum field amplitude and an asymptotic field amplitude, the maximum field amplitude being at, or adjacent to, one or more of the at least three tapered interior surfaces and the apex point, and the asymptotic field amplitude being at, or adjacent to, the base interior surface.

48. The thruster of claim 45, wherein the cavity includes an overall interior surface that includes the base and tapered interior surfaces, substantially the entire overall interior surface being electrically conductive, wherein the cavity resonator has a quality factor between about 10\hat{ }3 to about 10\hat{ }9.

49. The thruster of claim 45, wherein the cavity includes an overall interior surface that includes the base and tapered interior surfaces, the overall interior surface comprises aluminum, antimony, arsenic, barium, beryllium, bismuth, cadmium, calcium, carbon, chromium, cobalt, copper, gallium, gold, hydrogen, indium, iron, lanthanum, lead, lithium, magnesium, manganese, mercury, molybdenum, nickel, niobium, nitrogen, oxygen, palladium, phosphorus, platinum, scandium, silicon, silver, strontium, sulfur, tantalum, technetium, tin, titanium, tungsten, vanadium, yttrium, zinc, zirconium, or any combination thereof.

50. The thruster of claim 45, wherein the cavity includes an overall interior surface that includes the base and tapered interior surfaces, substantially the entire overall interior surface being superconductive, wherein the cavity resonator has a quality factor between about 10\hat{ }6 to about 10\hat{ }15.

51. The thruster of claim 45, wherein the cavity includes an overall interior surface that includes the base and tapered interior surfaces, the overall interior surface comprises aluminum, barium, beryllium, bismuth, cadmium, calcium, copper, gallium, gadolinium, germanium, lanthanum, lead, lithium, indium, mercury, molybdenum, niobium, nitrogen, osmium, oxygen, protactinium, rhenium, ruthenium, silicon, strontium, sulfur, tantalum, technetium, thallium, thorium, titanium, tin, vanadium, yttrium, zinc, zirconium, NbTi, PbMoS, V₃Ga, NbN, V₃Si, Nb₃Sn, Nb₃Al, Nb₃(AlGe), Nb₃Ge, Bi₂Sr₂CuO₆, Bi₂Sr₂CaCu₂O₈, Bi₂Sr₂Ca₂Cu₃O₁₀, YBa₂Cu₃O₇, YBa₂Cu₄O₈, Y₂Ba₄Cu₇O₁₅, Y₃Ba₅Cu₈O₁₈, Tl₂Ba₂CuO₆, Tl₂Ba₂CaCu₂O₈, Tl₂Ba₂Ca₂Cu₃O₁₀, TlBa₂Ca₃Cu₄O₁₁, HgBa₂CuO₄, HgBa₂CaCu₂O₆, HgBa₂Ca₂Cu₃O₈, or any combination thereof.

52. The thruster of claim 45, wherein the cavity comprises a vacuum with a pressure between about 10\hat{ }-24 Torr to about 10\hat{ }3 Torr.

53. The thruster of claim 45, wherein the cavity comprises a thermal reservoir with a temperature between about 10\hat{ }-3 Kelvin to about 10\hat{ }3 Kelvin.

54. The thruster of claim 45, wherein the electromagnetic wave comprises a transverse magnetic wave with a polar mode number of N1 and an azimuthal mode number of N2, where N1 and N2 are an integers from 0 to 1000, and N1 is greater than or equal to N2.

55. The thruster of claim 45, wherein the electromagnetic wave comprises a transverse magnetic wave with a polar mode number of N and an azimuthal mode number of 0, where N is an integer from 0 to 1000.

56. The thruster of claim 45, wherein the electromagnetic wave comprises a transverse magnetic wave with a polar mode number of N and an azimuthal mode number of N, where N is an integer from 0 to 1000.

57. The thruster of claim 45, wherein the electromagnetic wave comprises a transverse electric wave with a polar mode number of N1 and an azimuthal mode number of N2, where N1 and N2 are an integers from 0 to 1000, and N1 is greater than or equal to N2.

58. The thruster of claim 45, wherein the electromagnetic wave comprises a transverse electric wave with a polar mode number of N and an azimuthal mode number of 0, where N is an integer from 0 to 1000.

59. The thruster of claim 45, wherein the electromagnetic wave comprises a transverse electric wave with a polar mode number of N and an azimuthal mode number of N, where N is an integer from 0 to 1000.

60. The thruster of claim 45, wherein the electromagnetic radiation source is located inside the cavity at, or adjacent to, a maximum field amplitude or an asymptotic field amplitude of the electromagnetic wave.

61. The thruster of claim 45, wherein the cavity has at least one of a width and a height between about 10\hat{ }-9 meters to about 10\hat{ }3 meters.

62. The thruster of claim 45, wherein two or more of the at least three tapered interior surfaces form an aperture angle between about 5 degrees to about 175 degrees.

63. The thruster of claim 45, wherein the cavity has a wall with a wall thickness between about 10\hat{ }-9 meters to about 1.0 meter.

64. The thruster of claim 45, wherein the base interior surface of the cavity comprises one or more of the following features: a) comprises 3, 4, 5, 6, 7, 8, 9, 10, 11, 12, 13, 14, 15, 16, 17, 18, 19, 20, 21, 22, 23, or 24 sides, b) is substantially equilateral, and c) is substantially flat.

65. The thruster of claim 45, wherein the electromagnetic wave forms an electromagnetic energy momentum tensor with an amplitude maximum at, or adjacent to, the base interior surface, which results in one or more of a metric tensor curvature, a thrust, and an acceleration of the thruster.

66. The thruster of claim 45, wherein the electromagnetic wave forms an electromagnetic energy momentum tensor with an amplitude maximum at, or adjacent to, one or more of the at least three tapered interior surfaces and the apex point, which results in one or more of a metric tensor curvature, a thrust, and an acceleration of the thruster.

67. An electromagnetic energy momentum thruster comprising:
a) a cavity resonator forming a pyramidal cavity having a base interior surface, at least three tapered interior surfaces, and a truncated interior surface opposing the base interior surface, the tapered interior surfaces being between the base and truncated interior surfaces; and
b) an electromagnetic radiation source in communication with the cavity resonator, the electromagnetic radiation source configured to emit an electromagnetic wave having a frequency between about 1.0 MHz to about 1000 THz into the cavity resonator.

68. The thruster of claim 67, wherein the electromagnetic radiation source is configured to produce the frequency of the electromagnetic wave in evanescence so that the electromagnetic wave has a maximum field amplitude and an asymptotic field amplitude, the maximum field amplitude being at, or adjacent to, the base interior surface, the asymptotic field amplitude being at, or adjacent to, one or more of the at least three tapered interior surfaces and the truncated interior surface.

69. The thruster of claim 67, wherein the electromagnetic radiation source is configured to produce the frequency of the electromagnetic wave in evanescence so that the electromagnetic wave has a maximum field amplitude and an asymptotic field amplitude, the maximum field amplitude being at, or adjacent to, one or more of the at least three tapered interior surfaces and the truncated interior surface, the asymptotic field amplitude being at, or adjacent to, the base interior surface.

70. The thruster of claim 67, wherein the cavity includes an overall interior surface that includes the base, tapered, and truncated interior surfaces, substantially the entire overall interior surface being electrically conductive, wherein the cavity resonator has a quality factor between about 10\hat{ }3 to about 10\hat{ }9.

71. The thruster of claim 67, wherein the cavity includes an overall interior surface that includes the base, tapered, and truncated interior surfaces, the overall interior surface comprises aluminum, antimony, arsenic, barium, beryllium, bismuth, cadmium, calcium, carbon, chromium, cobalt, copper, gallium, gold, hydrogen, indium, iron, lanthanum, lead, lithium, magnesium, manganese, mercury, molybdenum, nickel, niobium, nitrogen, oxygen, palladium, phosphorus, platinum, scandium, silicon, silver, strontium, sulfur, tantalum, technetium, tin, titanium, tungsten, vanadium, yttrium, zinc, zirconium, or any combination thereof.

72. The thruster of claim 67, wherein the cavity includes an overall interior surface that includes the base, tapered, and truncated interior surfaces, substantially the entire overall interior surface being superconductive, wherein the cavity resonator has a quality factor between about 10\hat{ }6 to about 10\hat{ }15.

73. The thruster of claim 67, wherein the cavity includes an overall interior surface that includes the base, tapered, and truncated interior surfaces, the overall interior surface comprises aluminum, barium, beryllium, bismuth, cadmium, calcium, copper, gallium, gadolinium, germanium, lanthanum, lead, lithium, indium, mercury, molybdenum, niobium, nitrogen, osmium, oxygen, protactinium, rhenium, ruthenium, silicon, strontium, sulfur, tantalum, technetium, thallium, thorium, titanium, tin, vanadium, yttrium, zinc, zirconium, NbTi, PbMoS, V₃Ga, NbN, V₃Si, Nb₃Sn, Nb₃Al, Nb₃(AlGe), Nb₃Ge, Bi₂Sr₂CuO₆, Bi₂Sr₂CaCu₂O₈, Bi₂Sr₂Ca₂Cu₃O₁₀, YBa₂Cu₃O₇, YBa₂Cu₄O₈, Y₂Ba₄Cu₇O₁₅, Y₃Ba₅Cu₈O₁₈, Tl₂Ba₂CuO₆, Tl₂Ba₂CaCu₂O₈, Tl₂Ba₂Ca₂Cu₃O₁₀, TlBa₂Ca₃Cu₄O₁₁, HgBa₂CuO₄, HgBa₂CaCu₂O₆, HgBa₂Ca₂Cu₃O₈, or any combination thereof.

74. The thruster of claim 67, wherein the cavity comprises a vacuum with a pressure between about 10\hat{ }-24 Torr to about 10\hat{ }3 Torr.

75. The thruster of claim 67, wherein the cavity comprises a thermal reservoir with a temperature between about 10\hat{ }-3 Kelvin to about 10\hat{ }3 Kelvin.

76. The thruster of claim 67, wherein the electromagnetic wave comprises a transverse magnetic wave with a polar mode number of N1 and an azimuthal mode number of N2, where N1 and N2 are an integers from 0 to 1000, and N1 is greater than or equal to N2.

77. The thruster of claim 67, wherein the electromagnetic wave comprises a transverse magnetic wave with a polar mode number of N and an azimuthal mode number of 0, where N is an integer from 0 to 1000.

78. The thruster of claim 67, wherein the electromagnetic wave comprises a transverse magnetic wave with a polar mode number of N and an azimuthal mode number of N, where N is an integer from 0 to 1000.

79. The thruster of claim 67, wherein the electromagnetic wave comprises a transverse electric wave with a polar mode number of N1 and an azimuthal mode number of N2, where N1 and N2 are an integers from 0 to 1000, and N1 is greater than or equal to N2.

80. The thruster of claim 67, wherein the electromagnetic wave comprises a transverse electric wave with a polar mode number of N and an azimuthal mode number of 0, where N is an integer from 0 to 1000.

81. The thruster of claim 67, wherein the electromagnetic wave comprises a transverse electric wave with a polar mode number of N and an azimuthal mode number of N, where N is an integer from 0 to 1000.

82. The thruster of claim 67, wherein the electromagnetic radiation source is located inside the cavity at, or adjacent to, a maximum field amplitude or an asymptotic field amplitude of the electromagnetic wave.

83. The thruster of claim 67, wherein the cavity has at least one of a width and a height between about 10\hat{ }-9 meters to about 10\hat{ }3 meters.

84. The thruster of claim 67, wherein two or more of the at least three tapered interior surfaces form an aperture angle between about 5 degrees to about 175 degrees.

85. The thruster of claim 67, wherein the cavity has a wall with a wall thickness between about 10\hat{ }-9 meters to about 1.0 meter.

86. The thruster of claim 67, wherein the base interior surface of the cavity comprises one or more of the following features: a) comprises 3, 4, 5, 6, 7, 8, 9, 10, 11, 12, 13, 14, 15, 16, 17, 18, 19, 20, 21, 22, 23, or 24 sides, b) is substantially equilateral, or c) is substantially flat.

87. The thruster of claim 67, wherein the electromagnetic wave forms an electromagnetic energy momentum tensor with an amplitude maximum at, or adjacent to, the base interior surface, which results in one or more of a metric tensor curvature, a thrust, and an acceleration of the thruster.

88. The thruster of claim 67, wherein the electromagnetic wave forms an electromagnetic energy momentum tensor with an amplitude maximum at, or adjacent to, one or more of the at least three tapered interior surfaces and the truncated interior surface, which results in one or more of a metric tensor curvature, a thrust, and an acceleration of the thruster.
